(19) United States
(12) Patent Application Publication
(10) Pub. No.: US 2021/0163021 A1
(43) Pub. Date: Jun. 3, 2021

(54) REDUNDANCY IN AUTONOMOUS VEHICLES

(71) Applicant: Motional AD LLC, Boston, MA (US)

(72) Inventors: Emilio FRAZZOLI, Newton, MA (US); Andrea CENSI, Somerville, MA (US); Hsun-Hsien CHANG, Brookline, MA (US); Philipp ROBBEL, Cambridge, MA (US); Maria Antoinette MEIJBURG, Boston, MA (US); Eryk Brian NICE, Medford, MA (US); Eric WOLFF, Cambridge, MA (US); Omar Al ASSAD, Milton, MA (US); Francesco SECCAMONTE, Singapore (SG); Dmytro S. YERSHOV, Cambridge, MA (US); Jeong Hwan JEON, Somerville, MA (US); Shih-Yuan LIU, Cambridge, MA (US); Tichakorn WONGPIROMSARN, Singapore (SG); Oscar Olof BEIJBOM, Santa Monica, CA (US); Katarzyna Anna MARCZUK, Singapore (SG); Kevin SPIESER, Cambridge, MA (US); Marc Lars Ljungdahl ALBERT, Singapore (SG); William Francis COTE, Carlisle, MA (US); Ryan Lee JACOBS, Boston, MA (US)

(21) Appl. No.: 17/058,242

(22) PCT Filed: Oct. 30, 2019
(86) PCT No.: PCT/US2019/058949

§ 371 Date: Nov. 24, 2020

Related U.S. Application Data
(60) Provisional application No. 62/752,447, filed on Oct. 30, 2018.

(51) Int. Cl. B60W 50/02; B60W 60/00; B60W 50/023; G07C 5/08; G05D 1/00; G01D 3/10; H04W 4/38

(52) U.S. Cl. CPC B60W 50/0205; B60W 60/0015; B60W 50/023; G07C 5/0808; G05D 1/0077; G01D 3/10; H04W 4/40; B60W 2420/42; B60W 2420/52; B60W 2420/54; B60W 2520/10; B60W 2555/20; G05D 2201/0213; H04W 4/38

(57) ABSTRACT

Among other things, we describe techniques for redundancy in autonomous vehicles. For example, an autonomous vehicle can include two or more redundant autonomous vehicle operations subsystems.

### FIELD OF THE INVENTION

This description relates to redundancy in autonomous vehicles.

### BACKGROUND

Autonomous vehicles can be used to transport people and/or cargo from one location to another. An autonomous vehicle typically includes one or more systems, each of which performs one or more functions of the autonomous vehicle. For example, one system may perform a control function, while another system may perform a motion planning function.

### SUMMARY

According to an aspect of the present disclosure, a system includes two or more different autonomous vehicle operations subsystems, each of the two or more different autonomous vehicle operations subsystems being redundant with another of the two or more different autonomous vehicle operations subsystems. Each operations subsystem of the two or more different autonomous vehicle operations subsystems includes a solution proposer configured to propose solutions for autonomous vehicle operation based on current input data, and a solution scorer configured to evaluate the proposed solutions for autonomous vehicle operation based on one or more cost assessments. The solution scorer of at least one of the two or more different autonomous vehicle operations subsystems is configured to evaluate both the proposed solutions from the solution proposer of the at least one of the two or more different autonomous vehicle operations subsystems and at least one of the proposed solutions from the solution proposer of at least one other of the two or more different autonomous vehicle operations subsystems. The system also includes an output mediator coupled with the two or more different autonomous vehicle operations subsystems and configured to manage autonomous vehicle operation outputs from the two or more different autonomous vehicle operations subsystems.

According to an aspect of the present disclosure, the disclosed technologies can be implemented as a method for operating, within an autonomous vehicle (AV) system of an AV, two or more redundant pipelines coupled with an output mediator, a first pipeline of the two or more redundant pipelines comprising a first perception module, a first localization module, a first planning module, and a first control module, and a second pipeline of the two or more redundant pipelines including a second perception module, a second localization module, a second planning module, and a second control module, where each of the first and second controller modules are connected with an output mediator. The method includes receiving, by the first perception module, first sensor signals from a first set of sensors of an AV, and generating, by the first perception module, a first world view proposal based on the first sensor signals; receiving, by the second perception module, second sensor signals from a second set of the sensors of the AV, and generating, by the second perception module, a second world view proposal based on the second sensor signals; selecting, by the first perception module, one between the first world view proposal and the second world view proposal based on a first perception-cost function, and providing, by the first perception module, the selected one as a first world view to the first localization module; selecting, by the second perception module, one between the first world view proposal and the second world view proposal based on a second perception-cost function, and providing, by the second perception module, the selected one as a second world view to the second localization module; generating, by the first localization module, a first AV position proposal based on the first world view; generating, by the second localization module, a second AV position proposal based on the second world view; selecting, by the first localization module, one between the first AV position proposal and the second AV position proposal based on a first localization-cost function, and providing, by the first localization module, the selected one as a first AV position to the first planning module; selecting, by the second localization module, one between the first AV position proposal and the second AV position proposal based on a second localization-cost function, and providing, by the second localization module, the selected one as a second AV position to the second planning module; generating, by the first planning module, a first route proposal based on the first AV position; generating, by the second planning module, a second route proposal based on the second AV position; selecting, by the first planning module, one between the first route proposal and the second route proposal based on a first planning-cost function, and providing, by the first planning module, the selected one as a first route to the first control module; selecting, by the second planning module, one between the first route proposal and the second route proposal based on a second planning-cost function, and providing, by the second planning module, the selected one as a second route to the second control module; generating, by the first control module, a first control-signal proposal based on the first route; generating, by the second control module, a second control-signal proposal based on the second route; selecting, by the first control module, one between the first control-signal proposal and the second control-signal proposal based on a first control-cost function, and providing, by the first control module, the selected one as a first control signal to the output mediator; selecting, by the second control module, one between the first control-signal proposal and the second control-signal proposal based on a second control-cost function, and providing, by the second control module, the selected one as a second control signal to the output mediator; and selecting, by the output mediator, one between the first control signal and the second control signal, and providing, by the output mediator, the selected one as a control signal to an actuator of the AV.

Particular aspects of the foregoing disclosed technologies can be implemented to realize one or more of the following potential advantages. For example, generating solution proposals (e.g., candidates) on multiple computation paths (e.g., pipelines) and/or scoring the generated solution proposals also on multiple computation paths ensures that independence of each assessment is preserved. This is so, because each AV operations subsystem adopts another AV operation subsystem's solution proposal only if such an alternative solution is deemed superior to its own solution proposal based on a cost function internal to the AV operations subsystem. Such richness of solution proposals potentially leads to an increase of overall performance and reliability of each path. By performing cross-stack evaluations of solution proposals at multiple stages, consensus on the best candidates, which will then be proposed to the output mediator, can be built early on in the process (at early stages). This in turn can reduce the selection burden on the output mediator.

According to an aspect of the present disclosure, a system includes two or more different autonomous vehicle operations subsystems, each of the two or more different autonomous vehicle operations subsystems being redundant with another of the two or more different autonomous vehicle operations subsystems; and an output mediator coupled with the two or more different autonomous vehicle operations subsystems and configured to manage autonomous vehicle operation outputs from the two or more different autonomous vehicle operations subsystems. The output mediator is configured to selectively promote different ones of the two or more different autonomous vehicle operations subsystems to a prioritized status based on current input data compared with historical performance data for the two or more different autonomous vehicle operations subsystems.

According to an aspect of the present disclosure, the disclosed technologies can be implemented as a method performed by an output mediator for controlling output of two or more different autonomous vehicle operations subsystems of an autonomous vehicle, one of which having prioritized status. The method includes receiving, under a current operational context, outputs from the two or more different autonomous vehicle operations subsystems; in response to determining that at least one of the received outputs is different from the other ones, promoting one of the autonomous vehicle operations subsystems which corresponds to the current operational context to prioritized status; and controlling issuance of the output of the autonomous vehicle operations subsystem having the prioritized status for operating the autonomous vehicle.

Particular aspects of the foregoing techniques can provide one or more of the following advantages. For example, context selective promotion of AV operation modules that share a region of the operating envelope can lead to improved AV operation performance by active adaptation to driving context. More specifically, the foregoing disclosed technologies cause increased flexibility of operational control in AV perception stage, AV localization stage, AV planning stage, and/or AV control stage.

According to an aspect of the present disclosure, an autonomous vehicle includes a first control system. The first control system is configured to provide output, in accordance with at least one input, that affects a control operation of the autonomous vehicle while the autonomous vehicle is in an autonomous driving mode and while the first control system is selected. The autonomous vehicle also includes a second control system. The second control system is configured to provide output, in accordance with at least one input, that affects a control operation of the autonomous vehicle while the autonomous vehicle is in an autonomous driving mode and while the second control system is selected. The autonomous vehicle further includes at least one processor. The at least one processor is configured to select at least one of the first control system and the second control system to affect the control operation of the autonomous vehicle.

Particular aspects of the foregoing techniques can provide one or more of the following advantages. This technique provides redundancy in control operations in case one control system suffers failure or degraded performance. The redundancy in controls also allows an AV to choose which control system to use based on measured performance of the control systems.

According to an aspect of the present disclosure, systems and techniques are used for detecting and handling of sensor failures in autonomous vehicles. According to an aspect of the present disclosure, a technique for detecting and handling of sensor failures in autonomous vehicle includes producing, via a first sensor, a first sensor data stream from one or more environmental inputs external to the autonomous vehicle while the autonomous vehicle is in an operational driving state and producing, via a second sensor, a second sensor data stream from the one or more environmental inputs external to the autonomous vehicle while the autonomous vehicle is in the operational driving state. The first sensor and the second sensor can be configured to detect a same type of information. The technique further includes detecting an abnormal condition based on a difference between the first sensor data stream and the second sensor data stream; and switching among the first sensor, the second sensor, or both as an input to control the autonomous vehicle in response to the detected abnormal condition. These and other aspects, features, and implementations can be expressed as methods, apparatus, systems, components, program products, means or steps for performing a function, and in other ways.

According to an aspect of the present disclosure, an autonomous vehicle includes a first sensor configured to produce a first sensor data stream from one or more environmental inputs external to the autonomous vehicle while the autonomous vehicle is in an operational driving state and a second sensor configured to produce a second sensor data stream from the one or more environmental inputs external to the autonomous vehicle while the autonomous vehicle is in the operational driving state, the first sensor and the second sensor being configured to detect a same type of information. The vehicle includes a processor coupled with the first sensor and the second sensor, the processor being configured to detect an abnormal condition based on a difference between the first sensor data stream and the second sensor data stream. In some implementations, the processor is configured to switch among the first sensor, the second sensor, or both as an input to control the autonomous vehicle in response to a detection of the abnormal condition.

Particular aspects of the foregoing techniques can provide one or more of the following advantages. Detecting and handling sensor failures are important in maintaining the safe and proper operation of an autonomous vehicle. A described technology can enable an autonomous vehicle to efficiency switch among sensors inputs in response to a detection of an abnormal condition. Generating a replacement sensor data stream by transforming a functioning sensor data stream can enable an autonomous vehicle to continue to operate safely.

According to an aspect of the present disclosure, an autonomous vehicle includes a control system configured to affect a control operation of the autonomous vehicle, a control processor in communication with the control system, the control processor configured to determine instructions for execution by the control system, a telecommunications system in communication with the control system, the telecommunications system configured to receive instructions from an external source, wherein the control processor is configured to determine instructions that are executable by the control system from the instructions received from the external source and is configured to enable the external source in communication with the telecommunications system to control the control system when one or more specified conditions are detected.

According to an aspect of the present disclosure, an autonomous vehicle includes a control system configured to affect a first control operation of the autonomous vehicle, a control processor in communication with the control system, the control processor configured to determine instructions for execution by the control system, a telecommunications system in communication with the control system, the telecommunications system configured to receive instructions from an external source, and a processor configured to determine instructions that are executable by the control system from the instructions received from the external source and to enable the control processor or the external source in communication with the telecommunications system to operate the control system.

According to an aspect of the present disclosure, an autonomous vehicle includes a first control system configured to affect a first control operation of the autonomous vehicle, a second control system configured to affect the first control operation of the autonomous vehicle, and a telecommunications system in communication with the first control system, the telecommunications system configured to receive instructions from an external source, a control processor configured to determine instructions to affect the first control operation from the instructions received from the external source and is configured to determine an ability of the telecommunications system to communicate with the external source and in accordance with the determination select the first control system or the second control system.

According to an aspect of the present disclosure, a first autonomous vehicle has one or more sensors. The first autonomous vehicle determines an aspect of an operation of the first autonomous vehicle based on data received from the one or more sensors. The first autonomous vehicle also receives data originating at one or more other autonomous vehicles. The first autonomous vehicle uses the determination and the received data to carry out the operation.

Particular aspects of the foregoing techniques can provide one or more of the following advantages. For instance, the exchange of information between autonomous vehicles can improve the redundancy of a fleet of autonomous vehicles as a whole, thereby improving the efficiency, safety, and effectiveness of their operation. As an example, as a first autonomous vehicle travels along a particular route, it might encounter certain conditions that could impact its operation. The first autonomous vehicle can transmit information regarding these conditions to other autonomous vehicles, such that they also have access to this information, even if they have not yet traversed that same route. Accordingly, the other autonomous vehicles can preemptively adjust their operation to account for the conditions of the route and/or better anticipate the conditions of the route.

According to an aspect of the present disclosure, a method includes performing, by an autonomous vehicle (AV), an autonomous driving function of the AV in an environment, receiving, by an internal wireless communication device of the AV, an external message from an external wireless communication device that is located in the environment, comparing, by one or more processors of the AV, an output of the function with content of the external message or with data generated based on the content, and in accordance with results of the comparing, causing the AV to perform a maneuver.

According to an aspect of the present disclosure, a method includes discovering, by an operating system (OS) of an autonomous vehicle (AV), a new component coupled to a data network of the AV, determining, by the AV OS, if the new component is a redundant component, in accordance with the new component being a redundant component, performing a redundancy configuration of the new component, and in accordance with the new component not being a redundant component, performing a basic configuration of the new component, wherein the method is performed by one or more special-purpose computing devices.

Particular aspects of the foregoing techniques can provide one or more of the following advantages. Components can be added to an autonomous vehicle in a manner that accounts for whether or not the new module provides additional redundancy and/or will be the only component carrying out one or more functions of the autonomous vehicle.

According to an aspect of the present disclosure, redundant planning for an autonomous vehicle generally includes detecting that the autonomous vehicle is operating within its defined operational domain. If the autonomous vehicle is operating within its defined operational domain, at least two independent planning modules (that share a common definition of the operational domain) generate trajectories for the autonomous vehicle. Each planning module evaluates the trajectory generated by the other planning module for at least one collision with at least one object in a scene description. If one or both trajectories are determined to be unsafe (e.g., due to at least one collision being detected), the autonomous vehicle performs a safe stop maneuver or applies emergency braking using, for example, an autonomous emergency braking (AEB) system.

Particular aspects of the foregoing techniques can provide one or more of the following advantages. The disclosed redundant planning includes independent redundant planning modules with independent diagnostic coverage to ensure the safe and proper operation of an autonomous vehicle.

According to an aspect of the present disclosure, techniques are provided for using simulations to implement redundancy of processes and systems of an autonomous vehicle. In an embodiment, a method performed by an autonomous vehicle comprises: performing, by a first simulator, a first simulation of a first AV process/system using data output by a second AV process/system; performing, by a second simulator, a second simulation of the second AV process/system using data output by the first AV process/system; comparing, by one or more processors, the data output by the first and second process/system with data output by the first and second simulators; and in accordance with a result of the comparing, causing the AV to perform a safe mode maneuver or other action.

Particular aspects of the foregoing techniques can provide one or more of the following advantages. Using simulations for redundancy of processes/systems of an autonomous vehicle allows for the safe operation of the autonomous vehicle while also meeting performance requirements.

According to an aspect of the present disclosure, a system includes a component infrastructure including a set of interacting components implementing a system for an autonomous vehicle (AV), the infrastructure including a first component performing a function for operation of the AV, a second component performing the first function for operation of the AV concurrently with the first software component, a perception circuit confirmed for creating a model of an operating environment of the AV by combining or comparing a first output from the first component with a second output from the second component, and initiating an operation mode to perform the function on the AV based on the model of the operating environment.

Particular aspects of the foregoing techniques can provide one or more of the following advantages. Combining outputs of two components performing the same function to model the operating environment of the AV, then initiating an operation mode of the AV based on the operating environment model, can provide more accurate and complete information that can be used in perceiving the surrounding environment.

These and other aspects, features, and implementations can be expressed as methods, apparatus, systems, components, program products, means or steps for performing a function, and in other ways.

Details of one or more implementations are set forth in the accompanying drawings and the description below. Other features and advantages may be apparent from the description and drawings, and from the claims.

### BRIEF DESCRIPTION OF THE DRAWINGS

FIG. 1 shows an example of an autonomous vehicle having autonomous capability.

FIG. 2 shows an example “cloud” computing environment.

FIG. 3 shows an example of a computer system.

FIG. 4 shows an example architecture for an autonomous vehicle.

FIG. 5 shows an example of inputs and outputs that may be used by a perception module.

FIG. 6 shows an example of a LiDAR system.

FIG. 7 shows the LiDAR system in operation.

FIG. 8 shows the operation of the LiDAR system in additional detail.

FIG. 9 shows a block diagram of the relationships between inputs and outputs of a planning module.

FIG. 10 shows a directed graph used in path planning.

FIG. 11 shows a block diagram of the inputs and outputs of a control module.

FIG. 12 shows a block diagram of the inputs, outputs, and components of a controller.

FIG. 13 shows a block diagram of an example of an autonomous vehicle (AV) system that includes two or more synergistically redundant operations subsystems.

FIG. 14 shows an example of an architecture for an AV which includes synergistically redundant perception modules.

FIG. 15 shows an example of an architecture for an AV which includes synergistically redundant planning modules.

FIG. 16 shows a block diagram of an example of an AV system that includes two or more synergistically redundant operations pipelines.

FIG. 17 shows an example of an architecture for an AV which includes synergistically redundant two-stage pipelines, each of which includes a perception module and a planning module.

FIG. 18 shows an example of an architecture for an AV which includes synergistically redundant two-stage pipelines, each of which includes a planning module and a control module.

FIG. 19 shows an example of an architecture for an AV which includes synergistically redundant two-stage pipelines, each of which includes a localization module and a control module.

FIG. 20 shows a block diagram of another example of an AV system that includes two or more synergistically redundant operations pipelines.

FIG. 21 shows an example of an architecture for an AV which includes synergistically redundant pipelines, each of which includes three or more of a perception module, a localization module, a planning module, and a control module.

FIGS. 22-23 is a flow chart of an example of a process for operating a pair of synergistically redundant four-stage pipelines each of which includes a perception module, a localization module, a planning module, and a control module.

FIG. 24 shows a block diagram of an example of an AV system that includes four synergistically redundant operations pipelines, each of which includes a perception module and a planning module, each of the modules includes a solution proposer and a solution scorer.

FIG. 25 shows a block diagram of an example of an AV system that includes two synergistically redundant operations pipelines, each of which includes a perception module and a planning module, each of the perception modules includes a solution proposer and a solution scorer, each of the planning modules includes multiple solution proposers and a solution scorer.

FIG. 26 shows a block diagram of an example of an AV system that includes two synergistically redundant operations pipelines, each of which includes a perception module and a planning module, each of the perception modules includes a solution proposer and a solution scorer, each of the planning modules includes a solution proposer and multiple solution scorers.

FIG. 27 is a flow chart of an example of a process performed by an output mediator for managing AV operation outputs of different AV operations subsystems coupled with the output mediator.

FIGS. 28-29 show computational components and data structures used by an output mediator to perform the process of FIG. 27.

FIG. 30 shows a redundant control system 2900 for providing redundancy in control systems for an AV.

FIG. 31 shows a flowchart representing a method 3000 for providing redundancy in control systems according to at least one implementation of the present disclosure.

FIG. 32 shows an example of a sensor-related architecture of an autonomous vehicle for detecting and handling sensor failure.

FIG. 33 shows an example of a process to operate an autonomous vehicle and sensors therein.

FIG. 34 shows an example of a process to detect a sensor-related abnormal condition.

FIG. 35 shows an example of a process to transform a sensor data stream in response to a detection of an abnormal condition.

FIG. 36 illustrates example architecture of a teleoperation system.

FIG. 37 shows an example architecture of a teleoperation client.

FIG. 38 illustrates an example teleoperation system.

FIG. 39 shows a flowchart indicating a process for activating teleoperator control.

FIG. 40 shows a flowchart representing a process for activating redundant teleoperator and human control.

FIG. 41 shows a flowchart.

FIG. 42 shows an example exchange of information among a fleet of autonomous vehicles.

FIGS. 43-46 show an example exchange of information between autonomous vehicles.

FIGS. 47-50 show an example exchange of information between autonomous vehicles, and an example modification to a planned route of travel based on the exchanged information.

FIGS. 51-53 show an example formation of a platoon of autonomous vehicles.

FIGS. 54-56 show another example formation of a platoon of autonomous vehicles.

FIG. 57 is a flow chart diagram showing an example process for exchanging information between autonomous vehicles.

FIG. 58 shows a block diagram of a system for implementing redundancy in an autonomous vehicle using one or more external messages provided by one or more external wireless communication devices, according to an embodiment.

FIG. 59 shows an external message format, according to an embodiment.

FIG. 60 shows an example process for providing redundancy in an autonomous vehicle using external messages provided by one or more external wireless communication devices, according to an embodiment.

FIG. 61 shows a block diagram of an example architecture for replacing redundant components in an autonomous vehicle.

FIG. 62 shows a flow diagram of an example process of replacing redundant components in an autonomous vehicle.

FIG. 63 shows a block diagram of a redundant planning system.

FIG. 64 shows a table illustrating actions to be taken by an autonomous vehicle based on in-scope operation, diagnostic coverage and the outputs of two redundant planning modules.

FIG. 65 shows a flow diagram of a redundant planning process.

FIG. 66 shows a block diagram of system for implementing redundancy using simulations.

FIG. 67 shows a flow diagram of a process for redundancy using simulations.

FIG. 68 shows a block diagram of a system for unionizing perception inputs to model an operating environment, according to an embodiment.

FIG. 69 shows an example process for unionizing perception inputs to model an operating environment, according to an embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

In the drawings, specific arrangements or orderings of schematic elements, such as those representing devices, modules, instruction blocks and data elements, are shown for ease of description. However, it should be understood by those skilled in the art that the specific ordering or arrangement of the schematic elements in the drawings is not meant to imply that a particular order or sequence of processing, or separation of processes, is required. Further, the inclusion of a schematic element in a drawing is not meant to imply that such element is required in all embodiments or that the features represented by such element may not be included in or combined with other elements in some embodiments.

Further, in the drawings, where connecting elements, such as solid or dashed lines or arrows, are used to illustrate a connection, relationship or association between or among two or more other schematic elements, the absence of any such connecting elements is not meant to imply that no connection, relationship or association can exist. In other words, some connections, relationships or associations between elements are not shown in the drawings so as not to obscure the disclosure. In addition, for ease of illustration, a single connecting element is used to represent multiple connections, relationships or associations between elements. For example, where a connecting element represents a communication of signals, data or instructions, it should be understood by those skilled in the art that such element represents one or multiple signal paths (e.g., a bus), as may be needed, to affect the communication.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. Hardware Overview

2. Autonomous Vehicle Architecture

3. Autonomous Vehicle Inputs

4. Autonomous Vehicle Planning

5. Autonomous Vehicle Control

6. Cross-stack Evaluation

7. Context Selective Modules

8. Redundant Control Systems

9. Sensor Failure Redundancy

10. Teleoperation Redundancy

11. Fleet Redundancy

12. External Wireless Communication Devices

13. Replacing Redundant Components

14. Redundant Planning

15. Redundancy Using Simulations

16. Union of Perception Inputs

### Hardware Overview

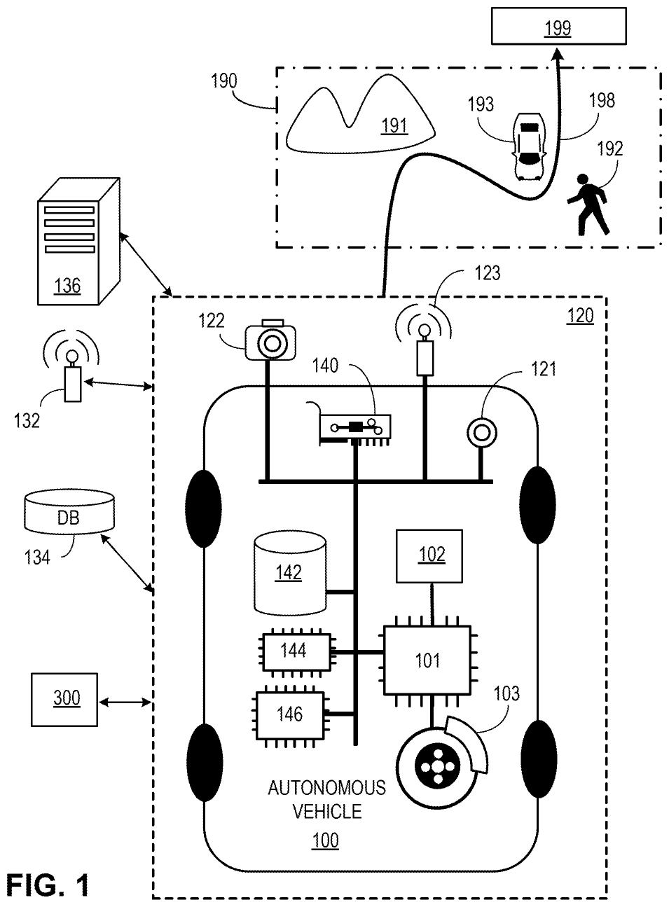

FIG. 1 shows an example of an autonomous vehicle 100 having autonomous capability.

As used herein, the term ‘autonomous capability’ refers to a function, feature, or facility that enables a vehicle to be partially or fully operated without real-time human intervention, including without limitation fully autonomous vehicles, highly autonomous vehicles, and conditionally autonomous vehicles.

As used herein, an autonomous vehicle (AV) is a vehicle that possesses autonomous capability.

As used herein, “vehicle” includes means of transportation of goods or people. For example, cars, buses, trains, airplanes, drones, trucks, boats, ships, submersibles, dirigibles, mobile robots, etc. A driverless car is an example of a vehicle.

As used herein, “trajectory” refers to a path or route generated to navigate from a first spatiotemporal location to second spatiotemporal location. In an embodiment, the first spatiotemporal location is referred to as the initial or starting location and the second spatiotemporal location is referred to as the goal or goal position or goal location. In an embodiment, the spatiotemporal locations correspond to real world locations. For example, the spatiotemporal locations are pick up or drop-off locations to pick up or drop-off persons or goods.

As used herein, “sensor(s)” includes one or more hardware components that detect information about the environment surrounding the sensor. Some of the hardware components can include sensing components (e.g., image sensors, biometric sensors), transmitting and/or receiving components (e.g., laser or radio frequency wave transmitters and receivers), electronic components such as analog-to-digital converters, a data storage device (such as a RAM and/or a nonvolatile storage), software or firmware components and data processing components such as an ASIC (application-specific integrated circuit), a microprocessor and/or a microcontroller.

As used herein, a “scene description” is a data structure (e.g., list) or data stream that includes one or more classified or labeled objects detected by one or more sensors on the AV vehicle or provided by a source external to the AV.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

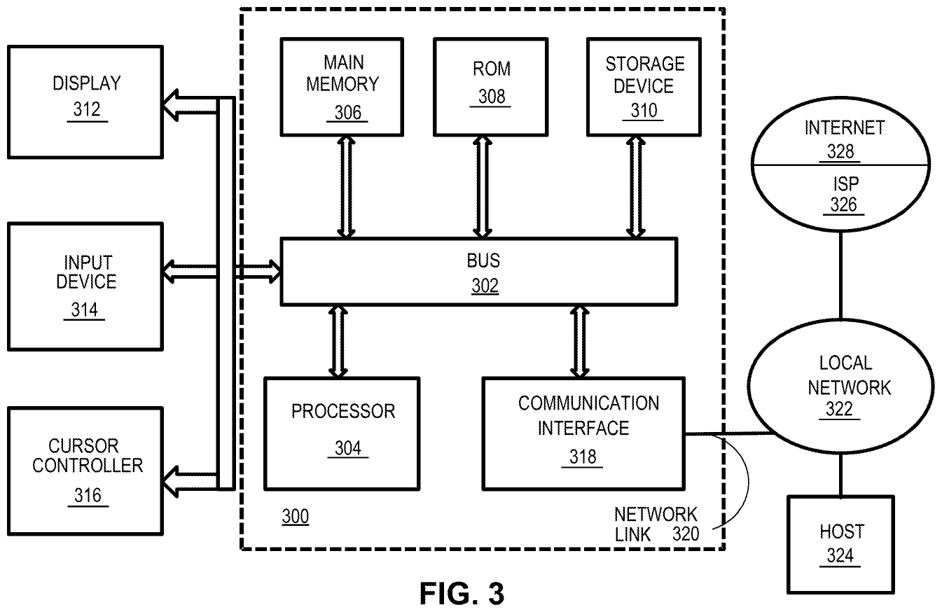

As used herein, an AV system refers to the AV along with the array of hardware, software, stored data, and data generated in real-time that supports the operation of the AV. In an embodiment, the AV system is incorporated within the AV. In an embodiment, the AV system may be spread across several locations. For example, some of the software of the AV system may be implemented on a cloud computing environment similar to cloud computing environment 300 described below with respect to FIG. 3.

In general, this document describes technologies applicable to any vehicles that have one or more autonomous capabilities including fully autonomous vehicles, highly autonomous vehicles, and conditionally autonomous vehicles, such as so-called Level 5, Level 4 and Level 3 vehicles, respectively (see SAE International's standard J3016: Taxonomy and Definitions for Terms Related to On-Road Motor Vehicle Automated Driving Systems, which is incorporated by reference in its entirety, for more details on the classification of levels of autonomy in vehicles). Vehicles with Autonomous Capabilities may attempt to control the steering or speed of the vehicles. The technologies descried in this document also can be applied to partially autonomous vehicles and driver assisted vehicles, such as so-called Level 2 and Level 1 vehicles (see SAE International's standard J3016: Taxonomy and Definitions for Terms Related to On-Road Motor Vehicle Automated Driving Systems). One or more of the Level 1, 2, 3, 4 and 5 vehicle systems may automate certain vehicle operations (e.g., steering, braking, and using maps) under certain operating conditions based on processing of sensor inputs. The technologies described in this document can benefit vehicles in any levels, ranging from fully autonomous vehicles to human-operated vehicles.

Referring to FIG. 1, an AV system 120 operates the AV 100 along a trajectory 198 through an environment 190 to a destination 199 (sometimes referred to as a final location) while avoiding objects (e.g., natural obstructions 191, vehicles 193, pedestrians 192, cyclists, and other obstacles) and obeying rules of the road (e.g., rules of operation or driving preferences).

In an embodiment, the AV system 120 includes devices 101 that are instrumented to receive and act on operational commands from the computer processors 146. In an embodiment, computing processors 146 are similar to the processor 304 described below in reference to FIG. 3. Examples of devices 101 include a steering control 102, brakes 103, gears, accelerator pedal, windshield wipers, side-door locks, window controls, and turn-indicators.

In an embodiment, the AV system 120 includes sensors 121 for measuring or inferring properties of state or condition of the AV 100, such as the AV's position, linear and angular velocity and acceleration, and heading (e.g., an orientation of the leading end of AV 100). Example of sensors 121 are GPS, inertial measurement units (IMU) that measure both vehicle linear accelerations and angular rates, wheel speed sensors for measuring or estimating wheel slip ratios, wheel brake pressure or braking torque sensors, engine torque or wheel torque sensors, and steering angle and angular rate sensors.

In an embodiment, the sensors 121 also include sensors for sensing or measuring properties of the AV's environment. For example, monocular or stereo video cameras 122 in the visible light, infrared or thermal (or both) spectra, LiDAR 123, RADAR, ultrasonic sensors, time-of-flight (TOF) depth sensors, speed sensors, temperature sensors, humidity sensors, and precipitation sensors.

In an embodiment, the AV system 120 includes a data storage unit 142 and memory 144 for storing machine instructions associated with computer processors 146 or data collected by sensors 121. In an embodiment, the data storage unit 142 is similar to the ROM 308 or storage device 310 described below in relation to FIG. 3. In an embodiment, memory 144 is similar to the main memory 306 described below. In an embodiment, the data storage unit 142 and memory 144 store historical, real-time, and/or predictive information about the environment 190. In an embodiment, the stored information includes maps, driving performance, traffic congestion updates or weather conditions. In an embodiment, data relating to the environment 190 is transmitted to the AV 100 via a communications channel from a remotely located database 134.

In an embodiment, the AV system 120 includes communications devices 140 for communicating measured or inferred properties of other vehicles' states and conditions, such as positions, linear and angular velocities, linear and angular accelerations, and linear and angular headings to the AV 100. These devices include Vehicle-to-Vehicle (V2V) and Vehicle-to-Infrastructure (V2I) communication devices and devices for wireless communications over point-to-point or ad hoc networks or both. In an embodiment, the communications devices 140 communicate across the electromagnetic spectrum (including radio and optical communications) or other media (e.g., air and acoustic media). A combination of Vehicle-to-Vehicle (V2V) Vehicle-to-Infrastructure (V2I) communication (and, in some embodiments, one or more other types of communication) is sometimes referred to as Vehicle-to-Everything (V2X) communication. V2X communication typically conforms to one or more communications standards for communication with, between, and among autonomous vehicles.

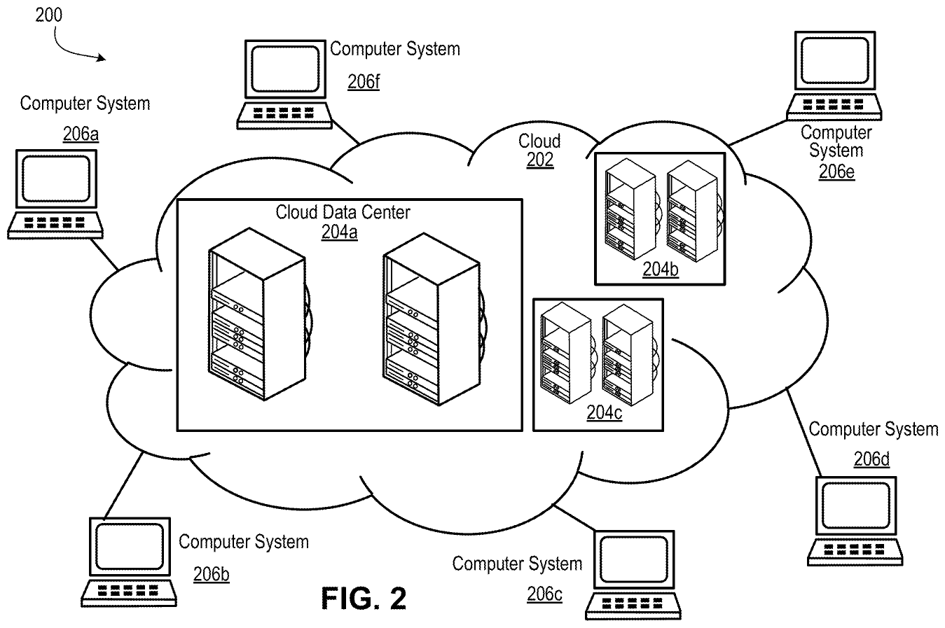

In an embodiment, the communication devices 140 include communication interfaces. For example, wired, wireless, WiMAX, Wi-Fi, Bluetooth, satellite, cellular, optical, near field, infrared, or radio interfaces. The communication interfaces transmit data from a remotely located database 134 to AV system 120. In an embodiment, the remotely located database 134 is embedded in a cloud computing environment 200 as described in FIG. 2. The communication interfaces 140 transmit data collected from sensors 121 or other data related to the operation of AV 100 to the remotely located database 134. In an embodiment, communication interfaces 140 transmit information that relates to teleoperations to the AV 100. In some embodiments, the AV 100 communicates with other remote (e.g., “cloud”) servers 136.

In an embodiment, the remotely located database 134 also stores and transmits digital data (e.g., storing data such as road and street locations). Such data may be stored on the memory 144 on the AV 100, or transmitted to the AV 100 via a communications channel from the remotely located database 134.

In an embodiment, the remotely located database 134 stores and transmits historical information about driving properties (e.g., speed and acceleration profiles) of vehicles that have previously traveled along trajectory 198 at similar times of day. Such data may be stored on the memory 144 on the AV 100, or transmitted to the AV 100 via a communications channel from the remotely located database 134.

Computing devices 146 located on the AV 100 algorithmically generate control actions based on both real-time sensor data and prior information, allowing the AV system 120 to execute its autonomous driving capabilities.

In an embodiment, the AV system 120 may include computer peripherals 132 coupled to computing devices 146 for providing information and alerts to, and receiving input from, a user (e.g., an occupant or a remote user) of the AV 100. In an embodiment, peripherals 132 are similar to the display 312, input device 314, and cursor controller 316 discussed below in reference to FIG. 3. The coupling may be wireless or wired. Any two or more of the interface devices may be integrated into a single device.

FIG. 2 shows an example “cloud” computing environment. Cloud computing is a model of service delivery for enabling convenient, on-demand network access to a shared pool of configurable computing resources (e.g. networks, network bandwidth, servers, processing, memory, storage, applications, virtual machines, and services). In typical cloud computing systems, one or more large cloud data centers house the machines used to deliver the services provided by the cloud. Referring now to FIG. 2, the cloud computing environment 200 includes cloud data centers 204a, 204b, and 204c that are interconnected through the cloud 202. Data centers 204a, 204b, and 204c provide cloud computing services to computer systems 206a, 206b, 206c, 206d, 206e, and 206f connected to cloud 202.

The cloud computing environment 200 includes one or more cloud data centers. In general, a cloud data center, for example the cloud data center 204a shown in FIG. 2, refers to the physical arrangement of servers that make up a cloud, for example the cloud 202 shown in FIG. 2, or a particular portion of a cloud. For example, servers can be physically arranged in the cloud datacenter into rooms, groups, rows, and racks. A cloud datacenter has one or more zones, which include one or more rooms of servers. Each room has one or more rows of servers, and each row includes one or more racks. Each rack includes one or more individual server nodes. Servers in zones, rooms, racks, and/or rows may be arranged into groups based on physical infrastructure requirements of the datacenter facility, which include power, energy, thermal, heat, and/or other requirements. In an embodiment, the server nodes are similar to the computer system described in FIG. 3. The data center 204a has many computing systems distributed through many racks.

The cloud 202 includes cloud data centers 204a, 204b, and 204c along with the network and networking resources (for example, networking equipment, nodes, routers, switches, and networking cables) that interconnect the cloud data centers 204a, 204b, and 204c and help facilitate the computing systems' 206a-f access to cloud computing services. In an embodiment, the network represents any combination of one or more local networks, wide area networks, or internetworks coupled using wired or wireless links deployed using terrestrial or satellite connections. Data exchanged over the network, is transferred using any number of network layer protocols, such as Internet Protocol (IP), Multiprotocol Label Switching (MPLS), Asynchronous Transfer Mode (ATM), Frame Relay, etc. Furthermore, in embodiments where the network represents a combination of multiple sub-networks, different network layer protocols are used at each of the underlying sub-networks. In some embodiments, the network represents one or more interconnected internetworks, such as the public Internet.

The computing systems 206a-f or cloud computing services consumers are connected to the cloud 202 through network links and network adapters. In an embodiment, the computing systems 206a-f are implemented as various computing devices, for example servers, desktops, laptops, tablet, smartphones, Internet of Things (IoT) devices, autonomous vehicles (including, cars, drones, shuttles, trains, buses, etc.) and consumer electronics. The computing systems 206a-f may also be implemented in or as a part of other systems.

FIG. 3 shows a computer system 300. In an implementation, the computer system 300 is a special purpose computing device. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, network devices or any other device that incorporates hard-wired and/or program logic to implement the techniques.

The computer system 300 may include a bus 302 or other communication mechanism for communicating information, and a hardware processor 304 coupled with a bus 302 for processing information. The hardware processor 304 may be, for example, a general-purpose microprocessor. The computer system 300 also includes a main memory 306, such as a random-access memory (RAM) or other dynamic storage device, coupled to the bus 302 for storing information and instructions to be executed by processor 304. The main memory 306 also may be used for storing temporary variables or other intermediate information during execution of instructions to be executed by the processor 304. Such instructions, when stored in non-transitory storage media accessible to the processor 304, render the computer system 300 into a special-purpose machine that is customized to perform the operations specified in the instructions.

In an embodiment, the computer system 300 further includes a read only memory (ROM) 308 or other static storage device coupled to the bus 302 for storing static information and instructions for the processor 304. A storage device 310, such as a magnetic disk, optical disk, or solid-state drive is provided and coupled to the bus 302 for storing information and instructions.

The computer system 300 may be coupled via the bus 302 to a display 312, such as a cathode ray tube (CRT), a liquid crystal display (LCD), plasma display, light emitting diode (LED) display, or an organic light emitting diode (OLED) display for displaying information to a computer user. An input device 314, including alphanumeric and other keys, is coupled to bus 302 for communicating information and command selections to the processor 304. Another type of user input device is a cursor controller 316, such as a mouse, a trackball, a touch-enabled display, or cursor direction keys for communicating direction information and command selections to the processor 304 and for controlling cursor movement on the display 312. This input device typically has two degrees of freedom in two axes, a first axis (e.g., x-axis) and a second axis (e.g., y-axis), that allows the device to specify positions in a plane.

According to one embodiment, the techniques herein are performed by the computer system 300 in response to the processor 304 executing one or more sequences of one or more instructions contained in the main memory 306. Such instructions may be read into the main memory 306 from another storage medium, such as the storage device 310. Execution of the sequences of instructions contained in the main memory 306 causes the processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as the storage device 310. Volatile media includes dynamic memory, such as the main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NV-RAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise the bus 302. Transmission media can also take the form of acoustic or light waves, such as those generated during radio-wave and infrared data communications.

Various forms of media may be involved in carrying one or more sequences of one or more instructions to the processor 304 for execution. For example, the instructions may initially be carried on a magnetic disk or solid-state drive of a remote computer. The remote computer can load the instructions into its dynamic memory and send the instructions over a telephone line using a modem. A modem local to the computer system 300 can receive the data on the telephone line and use an infrared transmitter to convert the data to an infrared signal. An infrared detector can receive the data carried in the infrared signal and appropriate circuitry can place the data on the bus 302. The bus 302 carries the data to the main memory 306, from which processor 304 retrieves and executes the instructions. The instructions received by the main memory 306 may optionally be stored on the storage device 310 either before or after execution by processor 304.

The computer system 300 also includes a communication interface 318 coupled to the bus 302. The communication interface 318 provides a two-way data communication coupling to a network link 320 that is connected to a local network 322. For example, the communication interface 318 may be an integrated service digital network (ISDN) card, cable modem, satellite modem, or a modem to provide a data communication connection to a corresponding type of telephone line. As another example, the communication interface 318 may be a local area network (LAN) card to provide a data communication connection to a compatible LAN. Wireless links may also be implemented. In any such implementation, the communication interface 318 sends and receives electrical, electromagnetic or optical signals that carry digital data streams representing various types of information.

The network link 320 typically provides data communication through one or more networks to other data devices. For example, the network link 320 may provide a connection through the local network 322 to a host computer 324 or to a cloud data center or equipment operated by an Internet Service Provider (ISP) 326. The ISP 326 in turn provides data communication services through the world-wide packet data communication network now commonly referred to as the “Internet” 328. The local network 322 and Internet 328 both use electrical, electromagnetic or optical signals that carry digital data streams. The signals through the various networks and the signals on the network link 320 and through the communication interface 318, which carry the digital data to and from the computer system 300, are example forms of transmission media. In an embodiment, the network 320 may contain or may be a part of the cloud 202 described above.

The computer system 300 can send messages and receive data, including program code, through the network(s), the network link 320, and the communication interface 318. In an embodiment, the computer system 300 may receive code for processing. The received code may be executed by the processor 304 as it is received, and/or stored in storage device 310, or other non-volatile storage for later execution.

### Autonomous Vehicle Architecture

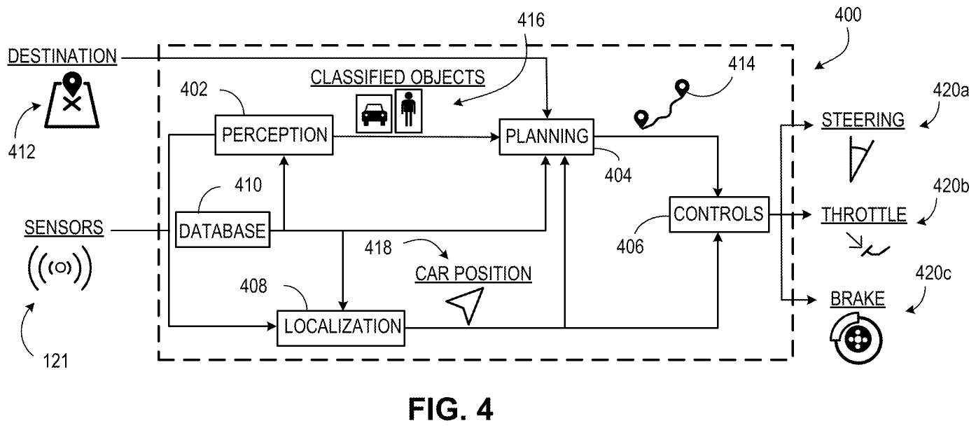

FIG. 4 shows an example architecture 400 for an autonomous vehicle (e.g., the AV 100 shown in FIG. 1). The architecture 400 includes a perception module 402, a planning module 404, a control module 406, a localization module 408, and a database module 410. Each module plays a role in the operation of the AV 100. Together, the modules 402, 404, 406, 408, and 410 may be part of the AV system 120 shown in FIG. 1.

In use, the planning module 404 receives data representing a destination 412 and determines data representing a route 414 that can be traveled by the AV 100 to reach (e.g., arrive at) the destination 412. In order for the planning module 404 to determine the data representing the route 414, the planning module 404 receives data from the perception module 402, the localization module 408, and the database module 410.

The perception module 402 identifies nearby physical objects using one or more sensors 121, e.g., as also shown in FIG. 1. The objects are classified (e.g., grouped into types such as pedestrian, bicycle, automobile, traffic sign, etc.) and a scene description including the classified objects 416 is provided to the planning module 404.

The planning module 404 also receives data representing the AV position 418 from the localization module 408. The localization module 408 determines the AV position by using data from the sensors 121 and data from the database module 410 (e.g., a geographic data) to calculate a position. For example, the localization module 408 might use data from a GNSS (Global Navigation Satellite System) sensor and geographic data to calculate a longitude and latitude of the AV. In an embodiment, data used by the localization module 408 includes high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations of them), and maps describing the spatial locations of road features such as crosswalks, traffic signs or other travel signals of various types.

The control module 406 receives the data representing the route 414 and the data representing the AV position 418 and operates the control functions 420a-c (e.g., steering, throttling, braking, ignition) of the AV in a manner that will cause the AV 100 to travel the route 414 to the destination 412. For example, if the route 414 includes a left turn, the control module 406 will operate the control functions 420a-c in a manner such that the steering angle of the steering function will cause the AV 100 to turn left and the throttling and braking will cause the AV 100 to pause and wait for passing pedestrians or vehicles before the turn is made.

### Autonomous Vehicle Inputs

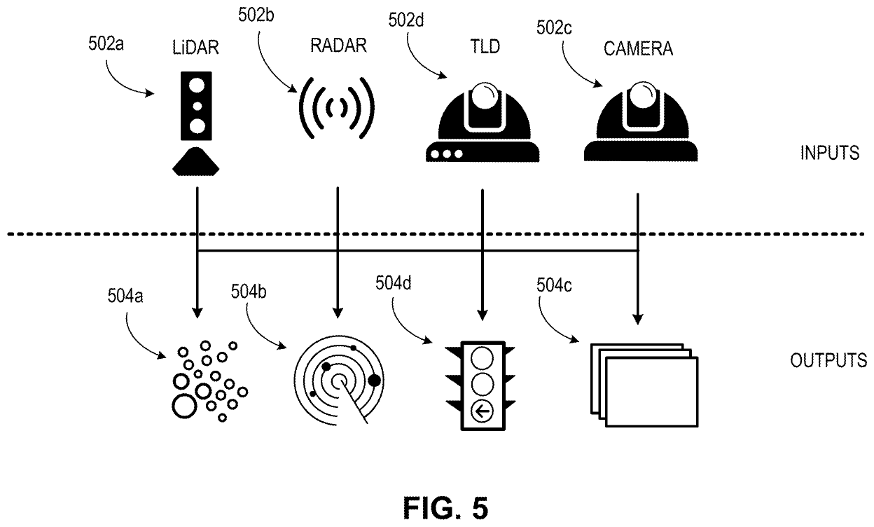

FIG. 5 shows an example of inputs 502a-d (e.g., sensors 121 shown in FIG. 1) and outputs 504a-d (e.g., sensor data) that may be used by the perception module 402 (FIG. 4). One input 502a is a LiDAR (Light Detection and Ranging) system (e.g., LiDAR 123 shown in FIG. 1). LiDAR is a technology that uses light (e.g., bursts of light such as infrared light) to obtain data about physical objects in its line of sight. A LiDAR system produces LiDAR data as output 504a. For example, LiDAR data may be collections of 3D or 2D points (also known as a point clouds) that are used to construct a representation of the environment 190.

Another input 502b is a RADAR system. RADAR is a technology that uses radio waves to obtain data about nearby physical objects. RADAR can obtain data about objects not within the line of sight of a LiDAR system. A RADAR system 502b produces RADAR data as output 504b. For example, RADAR data may be one or more radio frequency electromagnetic signals that are used to construct a representation of the environment 190.

Another input 502c is a camera system. A camera system uses one or more cameras (e.g., digital cameras using a light sensor such as a charge-coupled device [CCD]) to obtain information about nearby physical objects. A camera system produces camera data as output 504c. Camera data often takes the form of image data (e.g., data in an image data format such as RAW, JPEG, PNG, etc.). In some examples, the camera system has multiple independent cameras, e.g., for the purpose of stereopsis (stereo vision), which enables the camera system to perceive depth. Although the objects perceived by the camera system are described here as “nearby,” this is relative to the AV. In use, the camera system may be configured to “see” objects far, e.g., up to a kilometer or more ahead of the AV. Accordingly, the camera system may have features such as sensors and lenses that are optimized for perceiving objects that are far away.

Another input 502d is a traffic light detection (TLD) system. A TLD system uses one or more cameras to obtain information about traffic lights, street signs, and other physical objects that provide visual navigation information. A TLD system produces TLD data as output 504d. TLD data often takes the form of image data (e.g., data in an image data format such as RAW, JPEG, PNG, etc.). A TLD system differs from another system incorporating a camera in that a TLD system uses a camera with a wide field of view (e.g., using a wide-angle lens or a fish-eye lens) in order to obtain information about as many physical objects providing visual navigation information as possible, so that the AV 100 has access to all relevant navigation information provided by these objects. For example, the viewing angle of the TLD system may be about 120 degrees or more.

In some embodiments, outputs 504a-d can be combined using a sensor fusion technique. Thus, either the individual outputs 504a-d can be provided to other systems of the AV 100 (e.g., provided to a planning module 404 as shown in FIG. 4), or the combined output can be provided to the other systems, either in the form of a single combined output or multiple combined outputs of the same type (e.g., using the same combination technique or combining the same outputs or both) or different types type (e.g., using different respective combination techniques or combining different respective outputs or both). In some embodiments, an early fusion technique is used. An early fusion technique is characterized by combining outputs before one or more data processing steps are applied to the combined output. In some embodiments, a late fusion technique is used. A late fusion technique is characterized by combining outputs after one or more data processing steps are applied to the individual outputs.

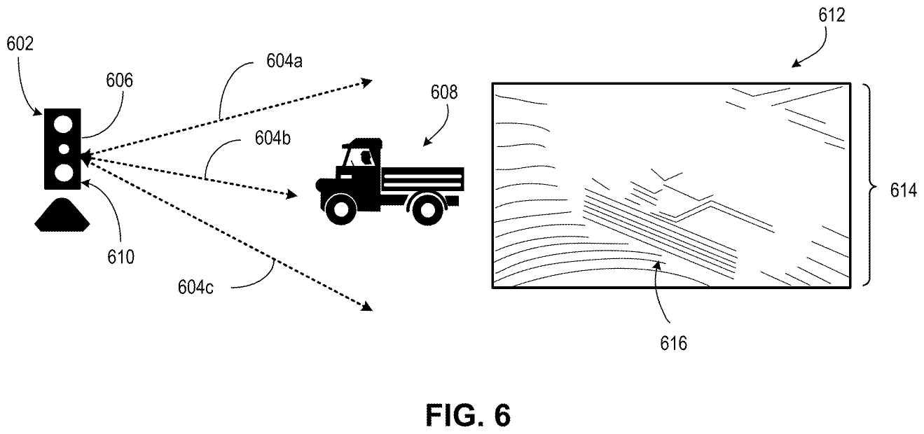

FIG. 6 shows an example of a LiDAR system 602 (e.g., the input 502a shown in FIG. 5). The LiDAR system 602 emits light 604a-c from a light emitter 606 (e.g., a laser transmitter). Light emitted by a LiDAR system is typically not in the visible spectrum; for example, infrared light is often used. Some of the light 604b emitted encounters a physical object 608 (e.g., a vehicle) and reflects back to the LiDAR system 602. (Light emitted from a LiDAR system typically does not penetrate physical objects, e.g., physical objects in solid form.) The LiDAR system 602 also has one or more light detectors 610, which detect the reflected light. One or more data processing systems associated with the LiDAR system can generate an image 612 representing the field of view 614 of the LiDAR system. The image 612 includes information that represents the boundaries 616 of a physical object 608. In this way, the image 612 can be used to determine the boundaries 616 of one or more physical objects near an AV.

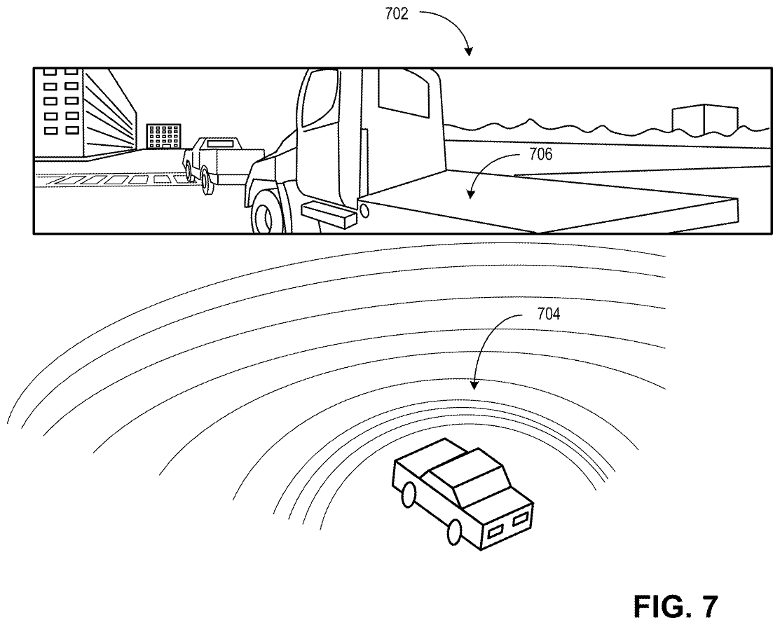

FIG. 7 shows the LiDAR system 602 in operation. In the scenario shown in this figure, the AV 100 receives both camera system output 504c in the form of an image 702 and LiDAR system output 504a in the form of LiDAR data points 704. In use, the data processing systems of the AV 100 can compare the image 702 to the data points 704. In particular, a physical object 706 identified in the image 702 can also be identified among the data points 704. In this way, the AV 100 can perceive the boundaries of the physical object based on the contour and density of the data points 704.

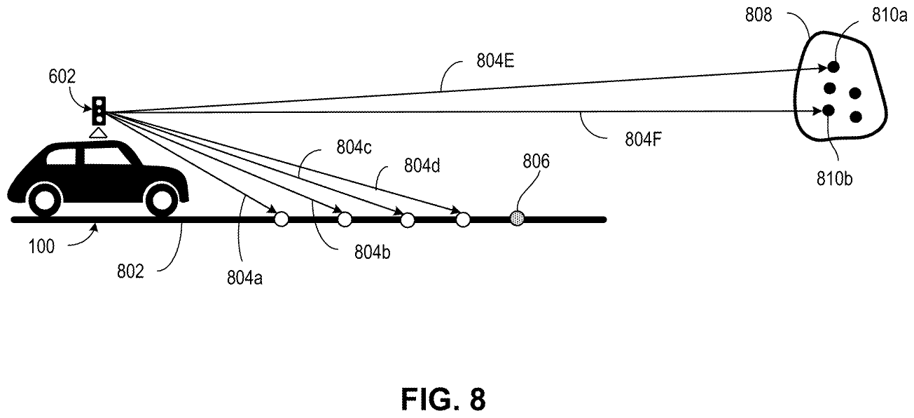

FIG. 8 shows the operation of the LiDAR system 602 in additional detail. As described above, the AV 100 can detect the boundary of a physical object based on characteristics of the data points detected by the LiDAR system 602. As shown in FIG. 8, a flat object, such as the ground 802, will reflect light 804a-d emitted from a LiDAR system 602 in a consistent manner. Put another way, because the LiDAR system 602 emits light using consistent spacing, the ground 802 will reflect light back to the LiDAR system 602 with the same consistent spacing. As the AV 100 travels over the ground 802, the LiDAR system 602 will continue to detect light reflected by the next valid ground point 806 if nothing is obstructing the road. However, if an object 808 obstructs the road, light 804e-f emitted by the LiDAR system 602 will be reflected from points 810a-b in a manner inconsistent with the expected consistent manner. From this information, the AV 100 can determine that the object 808 is present.

### Autonomous Vehicle Planning

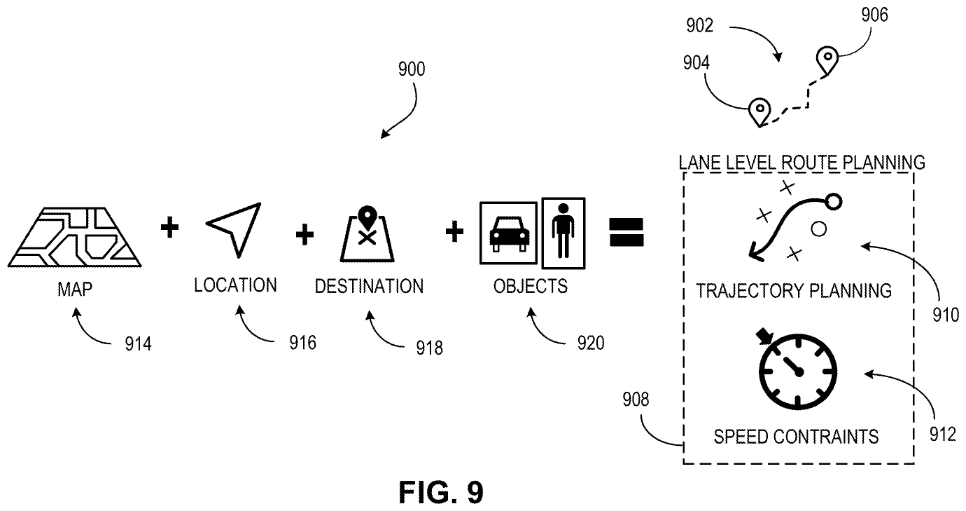

FIG. 9 shows a block diagram 900 of the relationships between inputs and outputs of a planning module 404 (e.g., as shown in FIG. 4). In general, the output of a planning module 404 is a route 902 from a start point 904 (e.g., source location or initial location), and an end point 906 (e.g., destination or final location). The route 902 is typically defined by one or more segments. For example, a segment may be a distance to be traveled over at least a portion of a street, road, highway, driveway, or other physical area appropriate for automobile travel. In some examples, e.g., if the AV 100 is an off-road capable vehicle such as a four-wheel-drive (4WD) or all-wheel-drive (AWD) car, SUV, pick-up truck, or the like, the route 902 may include “off-road” segments such as unpaved paths or open fields.

In addition to the route 902, a planning module also outputs lane-level route planning data 908. The lane-level route planning data 908 is used to traverse segments of the route 902 based on conditions of the segment at a particular time. For example, if the route 902 includes a multi-lane highway, the lane-level route planning data 908 may include path planning data 910 that the AV 100 can use to choose a lane among the multiple lanes, e.g., based on whether an exit is approaching, whether one or more of the lanes have other vehicles, or other factors that may vary over the course of a few minutes or less. Similarly, the lane-level route planning data 908 may include speed constraints 912 specific to a segment of the route 902. For example, if the segment includes pedestrians or un-expected traffic, the speed constraints 912 may limit the AV 100 to a travel speed slower than an expected speed, e.g., a speed based on speed limit data for the segment.

The inputs to the planning module 404 can include database data 914 (e.g., from the database module 410 shown in FIG. 4), current location data 916 (e.g., the AV position 418 shown in FIG. 4), destination data 918 (e.g., for the destination 412 shown in FIG. 4), and object data 920 (e.g., the classified objects 416 as perceived by the perception module 402 as shown in FIG. 4). In some embodiments, the database data 914 includes rules used in planning. Rules are specified using a formal language, e.g., using Boolean logic. In any given situation encountered by the AV 100, at least some of the rules will apply to the situation. A rule applies to a given situation if the rule has conditions that are met based on information available to the AV 100, e.g., information about the surrounding environment. Rules can have priority. For example, a rule that says, “if the road is a freeway, move to the leftmost lane” can have a lower priority than “if the exit is approaching within a mile, move to the rightmost lane.”

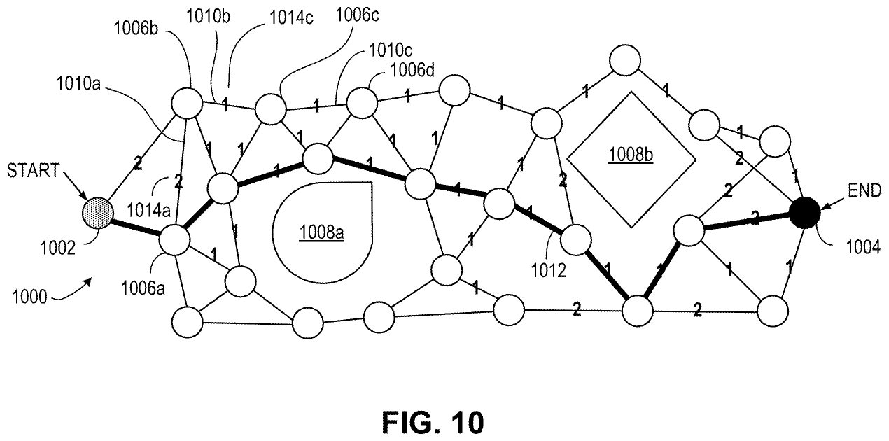

FIG. 10 shows a directed graph 1000 used in path planning, e.g., by the planning module 404 (FIG. 4). In general, a directed graph 1000 like the one shown in FIG. 10 can be used to determine a path between any start point 1002 and end point 1004. In real-world terms, the distance separating the start point 1002 and end point 1004 may be relatively large (e.g., in two different metropolitan areas) or may be relatively small (e.g., two intersections abutting a city block or two lanes of a multi-lane road).

The directed graph 1000 has nodes 1006a-d representing different locations between the start point 1002 and end point 1004 that could be occupied by an AV 100. In some examples, e.g., when the start point 1002 and end point 1004 represent different metropolitan areas, the nodes 1006a-d may represent segments of roads. In some examples, e.g., when the start point 1002 and end point 1004 represent different locations on the same road, the nodes 1006a-d may represent different positions on that road. In this way, the directed graph 1000 may include information at varying levels of granularity. A directed graph having high granularity may also be a subgraph of another directed graph having a larger scale. For example, a directed graph in which the start point 1002 and end point 1004 are far away (e.g., many miles apart) may have most of its information at a low granularity and is based on stored data, but can also include some high granularity information for the portion of the graph that represents physical locations in the field of view of the AV 100.

The nodes 1006a-d are distinct from objects 1008a-b which cannot overlap with a node. When granularity is low, the objects 1008a-b may represent regions that cannot be traversed by automobile, e.g., areas that have no streets or roads. When granularity is high, the objects 1008a-b may represent physical objects in the field of view of the AV 100, e.g., other automobiles, pedestrians, or other entities with which the AV 100 cannot share physical space. Any of the objects 1008a-b can be a static object (e.g., an object that does not change position such as a street lamp or utility pole) or a dynamic object (e.g., an object that is capable of changing position such as a pedestrian or other car).

The nodes 1006a-d are connected by edges 1010a-c. If two nodes 1006a-b are connected by an edge 1010a, it is possible for an AV 100 to travel between one node 1006a and the other node 1006b, e.g., without having to travel to an intermediate node before arriving at the other node 1006b. (When we refer to an AV 100 traveling between nodes, we mean that the AV 100 can travel between the two physical positions represented by the respective nodes.) The edges 1010a-c are often bidirectional, in the sense that an AV 100 can travel from a first node to a second node, or from the second node to the first node. However, edges 1010a-c can also be unidirectional, in the sense that an AV 100 can travel from a first node to a second node, but cannot travel from the second node to the first node. Edges 1010a-c are unidirectional when they represent, for example, one-way streets, individual lanes of a street, road, or highway, or other features that can only be traversed in one direction due to legal or physical constraints.

In use, the planning module 404 can use the directed graph 1000 to identify a path 1012 made up of nodes and edges between the start point 1002 and end point 1004.

An edge 1010a-c has an associated cost 1014a-b. The cost 1014a-b is a value that represents the resources that will be expended if the AV 100 chooses that edge. A typical resource is time. For example, if one edge 1010a represents a physical distance that is twice that as another edge 1010b, then the associated cost 1014a of the first edge 1010a may be twice the associated cost 1014b of the second edge 1010b. Other factors that can affect time include expected traffic, number of intersections, speed limit, etc. Another typical resource is fuel economy. Two edges 1010a-b may represent the same physical distance, but one edge 1010a may require more fuel than another edge 1010b, e.g., because of road conditions, expected weather, etc.

When the planning module 404 identifies a path 1012 between the start point 1002 and end point 1004, the planning module 404 typically chooses a path optimized for cost, e.g., the path that has the least total cost when the individual costs of the edges are added together.

In an embodiment, two or more redundant planning modules 404 can be included in an AV, as described in further detail in reference to FIGS. N1-N3.

### Autonomous Vehicle Control

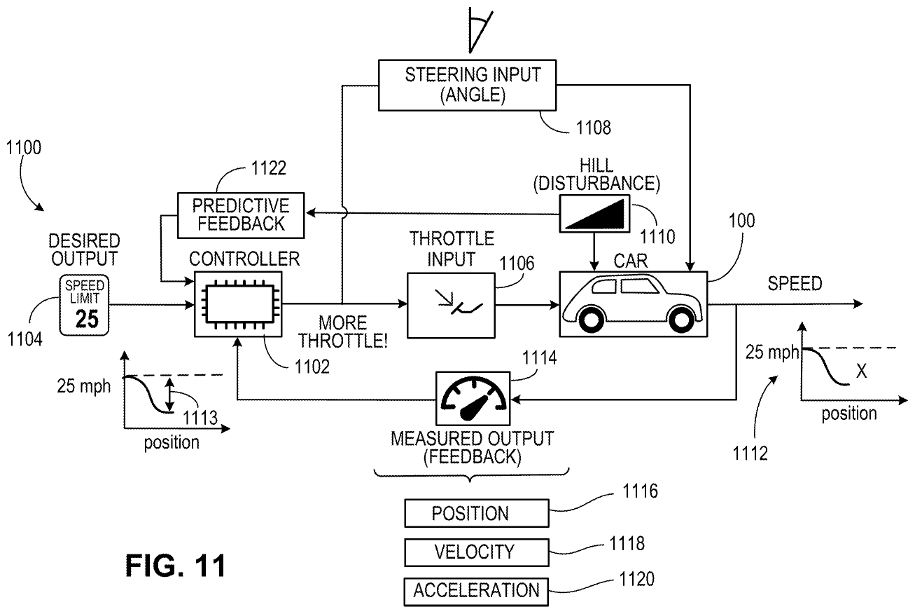

FIG. 11 shows a block diagram 1100 of the inputs and outputs of a control module 406 (e.g., as shown in FIG. 4). A control module operates in accordance with a controller 1102 which includes, for example, one or more processors (e.g., one or more computer processors such as microprocessors or microcontrollers or both), short-term and/or long-term data storage (e.g., memory random-access memory or flash memory or both), and instructions stored in memory that carry out operations of the controller 1102 when the instructions are executed (e.g., by the one or more processors).

In use, the controller 1102 receives data representing a desired output 1104. The desired output 1104 typically includes a velocity, e.g., a speed and heading. The desired output 1104 can be based on, for example, data received from a planning module 404 (e.g., as shown in FIG. 4). In accordance with the desired output 1104, the controller 1102 produces data usable as a throttle input 1106 and a steering input 1108. The throttle input 1106 represents the magnitude in which to engage the throttle (e.g., acceleration control) of an AV 100, e.g., by engaging the steering pedal, or engaging another throttle control, to achieve the desired output 1104. In some examples, the throttle input 1106 also includes data usable to engage the brake (e.g., deceleration control) of the AV 100. The steering input 1108 represents a steering angle, e.g., the angle at which the steering control (e.g., steering wheel, steering angle actuator, or other functionality for controlling steering angle) of the AV should be positioned to achieve the desired output 1104.

In use, the controller 1102 receives feedback that is used in adjusting the inputs provided to the throttle and steering. For example, if the AV 100 encounters a disturbance 1110, such as a hill, the measured speed 1112 of the AV 100 may lower below the desired output speed. Any measured output 1114 can be provided to the controller 1102 so that the necessary adjustments can be performed, e.g., based on the differential 1113 between the measured speed and desired output. The measured output 1114 can include measured position 1116, measured velocity 1118, (including speed and heading), measured acceleration 1120, and other outputs measurable by sensors of the AV 100.

Information about the disturbance 1110 can also be detected in advance, e.g., by a sensor such as a camera or LiDAR sensor, and provided to a predictive feedback module 1122. The predictive feedback module 1122 can then provide information to the controller 1102 that the controller 1102 can use to adjust accordingly. For example, if the sensors of the AV 100 detect (“see”) a hill, this information can be used by the controller 1102 to prepare to engage the throttle at the appropriate time to avoid significant deceleration.

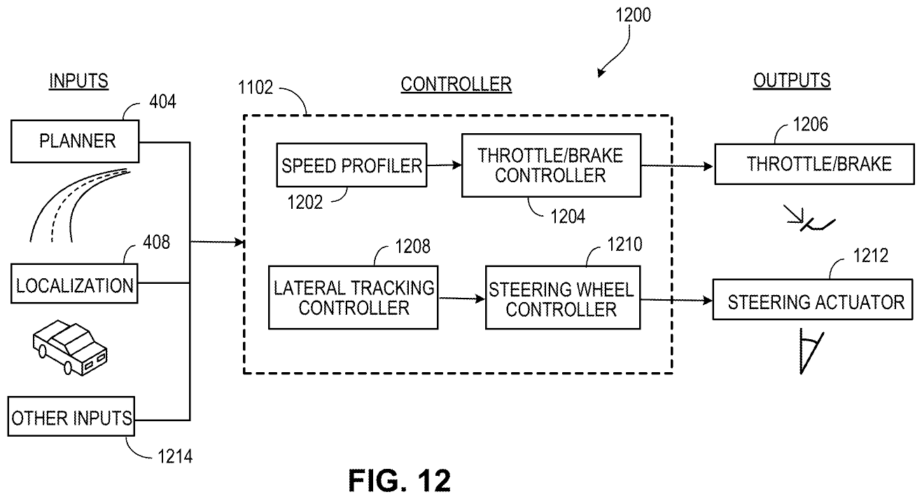

FIG. 12 shows a block diagram 1200 of the inputs, outputs, and components of the controller 1102. The controller 1102 has a speed profiler 1202 which affects the operation of a throttle/brake controller 1204. For example, the speed profiler 1202 can instruct the throttle/brake controller 1204 to engage acceleration or engage deceleration using the throttle/brake 1206 depending on, e.g., feedback received by the controller 1102 and processed by the speed profiler 1202.

The controller 1102 also has a lateral tracking controller 1208 which affects the operation of a steering controller 1210. For example, the lateral tracking controller 1208 can instruct the steering controller 1204 to adjust the position of the steering angle actuator 1212 depending on, e.g., feedback received by the controller 1102 and processed by the lateral tracking controller 1208.

The controller 1102 receives several inputs used to determine how to control the throttle/brake 1206 and steering angle actuator 1212. A planning module 404 provides information used by the controller 1102, for example, to choose a heading when the AV 100 begins operation and to determine which road segment to traverse when the AV 100 reaches an intersection. A localization module 408 provides information to the controller 1102 describing the current location of the AV 100, for example, so that the controller 1102 can determine if the AV 100 is at a location expected based on the manner in which the throttle/brake 1206 and steering angle actuator 1212 are being controlled. The controller 1102 may also receive information from other inputs 1214, e.g., information received from databases, computer networks, etc.

### Cross-stack Evaluation

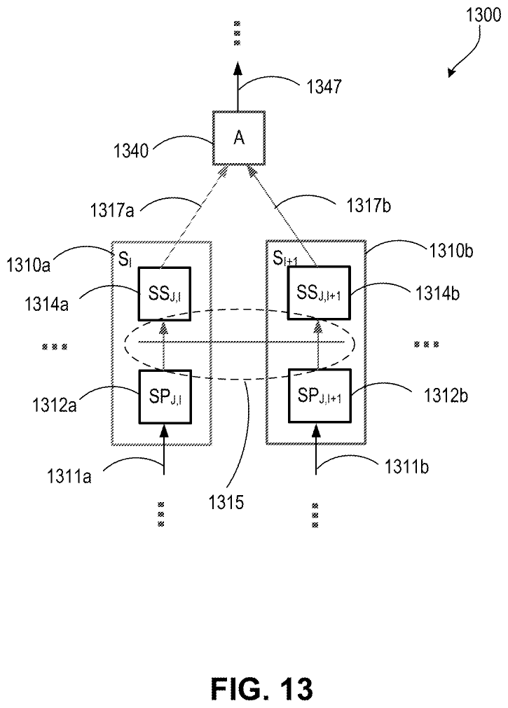

The system 400 useable to operate an autonomous vehicle (AV), also referred to as the AV architecture 400, can be modified as shown in FIG. 13. A system 1300 useable to operate an AV, a portion of the system 1300 being shown in FIG. 13, includes two or more different autonomous vehicle operations subsystems (S) 1310a, 1310b, each of the two or more different AV operations subsystems, e.g., 1310a, being redundant with another of the two or more different AV operations subsystems, e.g., 1310b (e.g., redundant versions of the perception module 402, localization module 408, planning module 404, control module 406 or combinations (e.g., pipelines) of at least two of these modules). Here, two different AV operations subsystems 1310a, 1310b are redundant with each other because each can independently operate the AV in the common/shared region of an operating envelope.

Partial redundancy/overlap is applicable, for example, when the modules being integrated with each other address at least one common aspect of AV operation. In such cases, at least one of the two or more different AV operations subsystems is configured to provide additional AV operations solutions that are not redundant with the AV operations solutions of at least one other of the two or more different AV operations subsystems. Here, either of the two subsystems, or both, can provide functionality that is not redundant with that provided by the other, in addition to the redundant aspects of operation.

Full overlap is applicable when the modules being integrated with each other are entirely redundant modules, with no other responsibilities. In such cases, at least one of the two or more different AV operations subsystems is configured to only provide AV operations solutions that are redundant with the AV operations solutions of at least one other of the two or more different AV operations subsystems.

In some implementations, the different AV operations subsystems 1310a, 1310b can be implemented as one or more software algorithms that perform respective functions of the AV operations subsystems 1310a, 1310b. In some implementations, the different AV operations subsystems 1310a, 1310b can be implemented as integrated circuits that perform respective functions of the AV operations subsystems 1310a, 1310b.

In addition, the system 1300 includes an output mediator (A) 1340 coupled with the two or more different AV operations subsystems 1310a, 1310b through respective connections 1317a, 1317b. In some implementations, the output mediator 1340 can be implemented as one or more software algorithms that perform the function of the output mediator 1340. In some implementations, the output mediator 1340 can be implemented as one or more integrated circuits that perform the function of the output mediator 1340. The output mediator 1340 is configured to manage AV operation outputs from the two or more different AV operations subsystems 1310a, 1310b. In particular, the output mediator 1340 can be implemented as an AV operations arbiter that selects one output over another. In general, there are numerous ways for an output mediator to select a “winning” AV operation output from among AV operations outputs of two or more redundant AV operations subsystems.

For example, an output mediator can be operated in accordance with “substitution redundancy”. For two redundant AV operations subsystems, this arbiter technique can be applied, based on the “1-out-of-2” (1oo2) assumption, when the failure modes of the two redundant AV operations subsystems are independent. Here, the output mediator selects the AV operation output from the one of the two redundant AV operations subsystems which is still working. If AV operation outputs are available from both redundant AV operations subsystems, the output mediator must select one of the two outputs. However, the two AV operation outputs may be quite different from each other. In some cases, the output mediator can be configured as an “authoritative” arbiter to be capable of selecting the appropriate AV operation output based on predetermined criteria. In other cases, the output mediator can be configured as a trivial arbiter which uses a “bench-warming” approach to perform the selection. Here, one of the two redundant AV operations subsystems is a designated backup, so its output is ignored unless the prime AV operations subsystem fails. For this reason, the bench-warming approach cannot leverage the backup AV operations subsystem.

As another example, an output mediator can be operated in accordance with “majority redundancy” in multiple-redundant AV operations subsystems. For example, in three redundant AV operations subsystems, this arbiter technique can be applied, based on the “triple-redundancy” assumption, when the algorithm/model used to obtain the AV operation outputs is considered to be correct, while its HW and/or SW implementation may be faulty in one of the three redundant AV operations subsystems. Here, the output mediator selects the AV operation output from two of the three redundant AV operations subsystems (or equivalently, drops the AV operation output that is different from the other two). For this approach, the output mediator can be configured as a trivial arbiter. Although this approach can provide a form of fault detection, e.g., it can identify the one among the three redundant AV operations subsystems in which the algorithm/model's HW and/or SW implementation is faulty, the majority redundancy approach does not necessarily increase failure tolerance.

As yet another example, an output mediator can be operated in accordance with “mobbing redundancy” when, for N>3 redundant AV operations subsystems, each of the AV operations subsystems uses different models. Here, the output mediator will select the winning AV operation output as the one that is common among the largest number of AV operations subsystems. Once again, when using this approach, the output mediator can be configured as a trivial arbiter. However, in some cases, the AV operation output is common between a subset of AV operations subsystems not necessarily because it is the “most correct”, but because the different models used by the subset of AV operations subsystems are highly correlated. In such cases, the “minority report” may be the correct one, i.e., the AV operation output produced by a number of AV operations subsystems that is smaller than the subset of AV operations subsystems.

With reference to FIG. 13, another redundancy approach, called “synergistic redundancy”, will be used in the examples described below. The approach of synergistic redundancy can be used to create highly redundant architectures with improved performance and reliability. It will be shown that the approach of synergistic redundancy can be applied to complex algorithms for perception and decision making. Synergistic redundancy can be applied to most engineering problems, e.g., when a particular engineering problem is cast as a problem-solving algorithm, which includes a proposal mechanism and a scoring mechanism. For example, Table 1 below shows that planning, e.g., as performed by the planning module 404 of the AV architecture 400—also see FIGS. 9-10, and perception, e.g., as performed by the perception module 402 of the AV architecture 400—also see FIGS. 5-8, fit the same proposal mechanism & scoring mechanism pattern.

TABLE 1

| | Planning | Perception |
|---|---|---|
| Objects of interest | Trajectories | State estimates |
| Proposal | Random sampling | Bottom-up perception |
| | MPC (mean preserving | (object detection) |
| | contraction) | Top-down task-driven |
| | Deep learning | attention |
| | Pre-defined primitives | Prior |
| | | Occupancy grids |
| Scoring | Trajectory scoring | Computation of |
| | based on safety, | likelihood from |
| | comfort, etc. | sensor model |

The structure of the information summarized in Table 1 suggests that the approach of synergistic redundancy can be applied in the system 1300 for operating an AV because each of the two or more of the different AV operations subsystem 1310a, 1310b is implemented to have one or more different components relating to the proposal aspect, and one or more different components relating to the scoring aspect, as illustrated in FIG. 13.

FIG. 13 shows that each AV operations subsystem 1310a,b of the two or more different AV operations subsystems 1310a, 1310b includes a solution proposer (SP) 1312a,b configured to propose solutions for AV operation based on current input data, and a solution scorer (SS) 1314a,b configured to evaluate the proposed solutions for AV operation based on one or more cost assessments. The solution proposer 1312a,b is coupled through respective connection 1311a,b with corresponding sensors of the system 1300 or another AV operations subsystem, which is disposed “up-stream” on the same stack (or pipeline) as the AV operations subsystem 1310a,b, to receive the current input data. The solution scorer 1314a,b of at least one of the two or more different AV operations subsystems 1310a, 1310b is configured to evaluate both the proposed solutions from the solution proposer 1312a,b of the at least one of the two or more different AV operations subsystems 1310a, 1310b and at least one of the proposed solutions from the solution proposer 1312b,a of at least one other of the two or more different AV operations subsystems 1310a, 1310b. In this manner, synergistic redundancy is made possible through the information exchange between a solution scorer 1314a,b of an AV operations subsystem 1310a,b with a solution proposer 1312a,b of its own AV operations subsystem 1310a,b and with at least one solution proposer 1312b,a of another AV operations subsystem 1310b,a, as the solution scorer evaluates 1314a,b both proposed solutions to select the winning one between them. An intra-inter-stack connection 1315, e.g., implemented as a multi-lane bus, is configured to couple the solution proposer 1312a,b of an AV operations subsystem 1310a,b with both the solution scorer 1314a,b of the same AV operations subsystem 1310a,b and the solution scorer 1314b,a of another AV operations subsystem 1310b,a.

The solution scorer 1314a,b of the AV operations subsystem 1310a,b is configured to operate in the following manner. A solution scorer 1314a,b of an AV operations subsystem 1310a,b receives, through the intra-inter-stack connection 1315, a proposed solution from a solution proposer 1312a,b of the same AV operations subsystem 1310a,b, also referred to as the local (or native) proposed solution, and another proposed solution from a solution proposer 1312b,a of another AV operations subsystem 1310b,a, also referred to as the remote (or non-native or cross-platform) proposed solution. To allow for cross-evaluation, the solution scorer 1314a,b performs some translation/normalization between the remotely and locally proposed solutions. In this manner, the solution scorer 1314a,b can evaluate both the locally proposed solution and the remotely proposed solution using a local cost function (or metric). For instance, the solution scorer 1314a,b applies the local cost function to both the locally proposed solution and the remotely proposed solution to determine their respective costs. Finally, the solution scorer 1314a,b selects between the locally proposed solution and the remotely proposed solution as the one which has the smaller of the costs evaluated based on the local cost function. The selected solution corresponds to a proposed model (locally or remotely generated) that maximizes the likelihood of the current input data if the proposed model is correct.

In this manner, the solution scorer 1314a provides the solution it has selected, as the AV operations subsystem 1310a's output, to the output mediator 1340 through the connection 1317a. Also, the solution scorer 1314b provides the solution it has selected, as the AV operations subsystem 1310b's output, to the output mediator 1340 through the connection 1317b. The output mediator 1340 can implement one or more selection processes, described in detail in the next section, to select either one of the AV operations subsystem 1310a's output or the AV operations subsystem 1310b's output. In this manner, the output mediator 1340 provides, through output connection 1347, a single output from the two or more redundant operations subsystems 1310a, 1310b, in the form of the selected output, to one or more “down-stream” modules of the system 1300, or one or more actuators of the AV which use the system 1300.

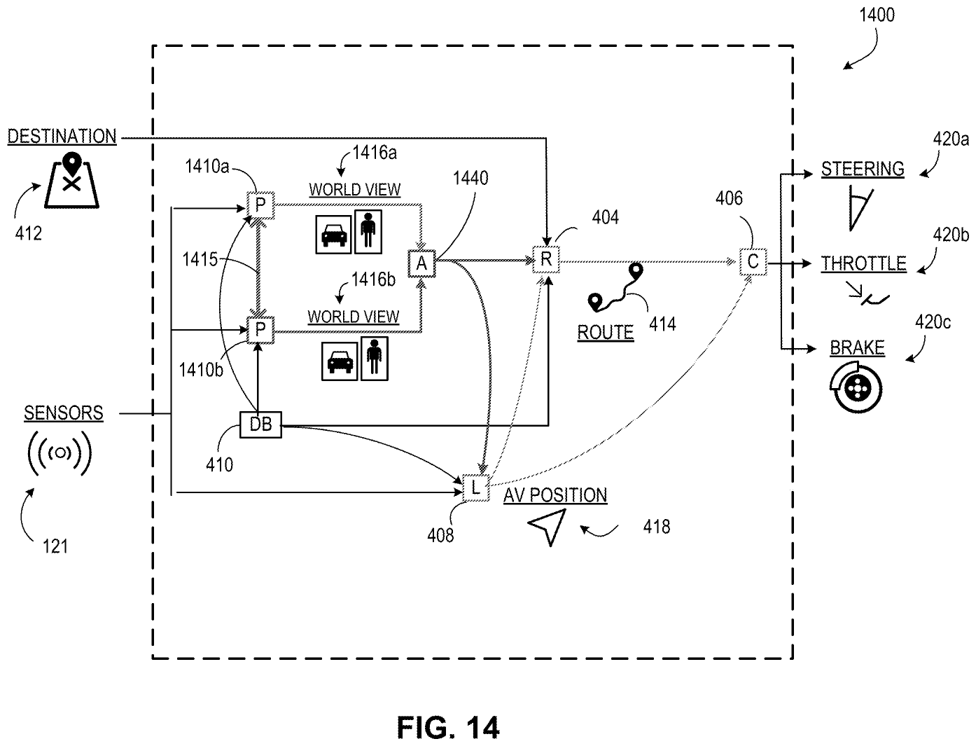

FIG. 14 shows an example of a system 1400 which represents a modified version of the system 400, the modification being that the perception module 402 was replaced by redundant perception modules 1410a, 1410b and perception-output mediator 1440. Here, the perception modules 1410a, 1410b were implemented like the AV operations subsystems 1310a, 1310b, and the perception-output mediator 1440 was implemented like the output mediator 1340. Solutions proposed by the solution proposers (implemented like the solution proposers 1312a, 1312b) of the redundant perception modules 1410a, 1410b include world-view proposals, for instance. As noted in previous sections of this specification, the perception subsystems 1410a, 1410b can receive data from one or more sensors 121, e.g., LiDAR, RADAR, video/image data in visible, infrared, ultraviolet or other wavelengths, ultrasonic, time-of-flight (TOF) depth, speed, temperature, humidity, and/or precipitation sensors, and from a database (DB) 410. The respective solution proposers of the redundant perception modules 1410a, 1410b can generate respective world-view proposals based on, e.g., perception proposal mechanisms, such as bottom-up perception (object detection), top-down task-driven attention, priors, occupancy grids, etc., as described above in connection with FIGS. 5-8, for instance. The solution proposers of the redundant perception modules 1410a, 1410b can generate their respective world-view proposals based on information from current sensor signals received from corresponding subsets of sensors of the AV, for instance. Additionally, respective solution scorers (implemented like the solution scorers 1314a, 1314b) of the redundant perception modules 1410a, 1410b can evaluate the world-view proposals based on one or more cost assessments, e.g., based on evaluation of respective perception-cost functions, such as computation of likelihood from sensor models, etc. To implement synergistic redundancy, the solution scorer of each perception module 1410a,b uses a respective perception-cost function to evaluate at least one world-view proposal generated by the solution proposer of the perception module 1410a,b, and at least one world-view proposal received through the intra-inter-stack connection 1415 from the solution proposer of another perception module 1410b,a. Note that the intra-inter-stack connection 1415 is implemented like the intra-inter-stack connection 1315. As such, the solution scorer of the perception module 1410a selects one between the world-view proposal from the solution proposer of the perception module 1410a and the world-view proposal from the solution proposer of the perception module 1410b, the selected one corresponding to a minimum of a first perception-cost function, and provides the selected world-view 1416a as the perception module 1410a's output to the perception-output mediator 1440. Also, the solution scorer of the perception module 1410b selects one between the world-view proposal from the solution proposer of the perception module 1410b and the world-view proposal from the solution proposer of the perception module 1410a, the selected one corresponding to a minimum of a second perception-cost function different from the first perception-cost function, and provides the selected world-view 1416b as the perception module 1410b's output to the perception-output mediator 1440. In this manner, a world view proposal avoids being tied to a non-optimal solution in the perception module 1410a,b, e.g., due to convergence to a local minimum during optimization, because the other perception module 1410b,a uses different initial conditions, or because the other perception module 1410b,a uses a different world-view forming approach, even if it were to use the exact same initial conditions.

Moreover, the perception-output mediator 1440 selects one of the two world-views 1416a, 1416b and provides it down-stream to the planning module 404 and the localization module 408 where it will be used to determine route 414, and AV position 418, respectively.

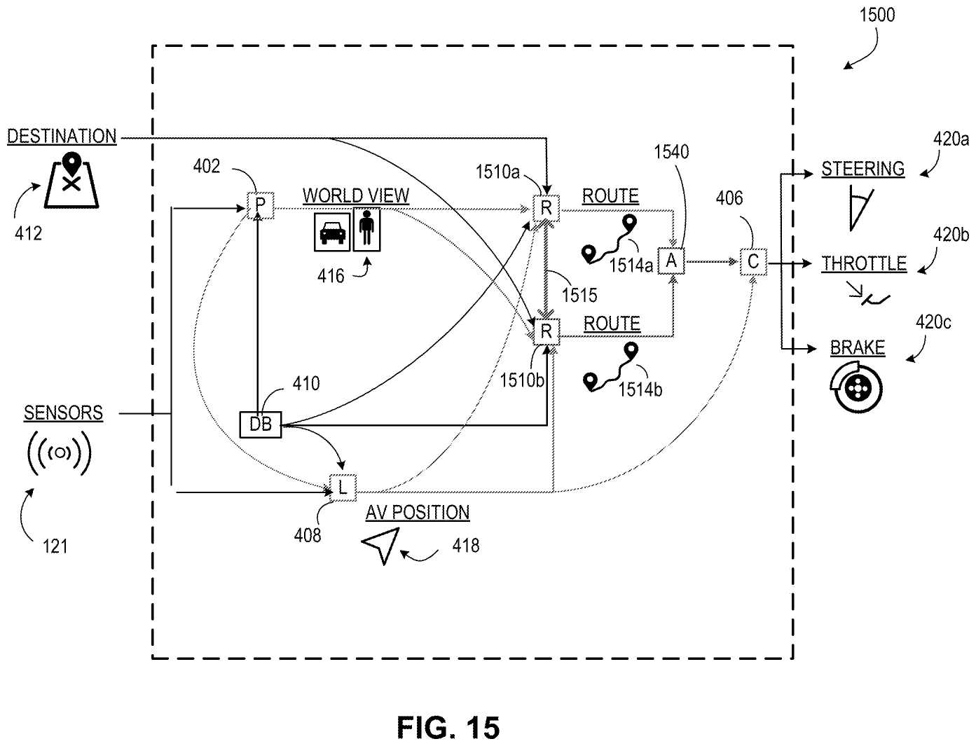

FIG. 15 shows an example of a system 1500 which represents a modified version of the system 400, the modification being that the planning module 404 was replaced by redundant planning modules 1510a, 1510b and planning-output mediator 1540. Here, the planning modules 1510a, 1510b were implemented like the AV operations subsystems 1310a, 1310b, and the planning-output mediator 1540 was implemented like the output mediator 1340. Solutions proposed by the solution proposers (implemented like the solution proposers 1312a, 1312b) of the redundant planning modules include route proposals, for instance. As noted above in connection with FIGS. 9-10, route proposals, also referred to as candidate routes, can be determined by inferring behavior of the AV and other AVs in accordance with physics of the environment, and driving rules for a current location 418 (provided by the localization module 408), e.g., by using sampling based methods and/or optimization based methods. The respective solution proposers of the redundant planning modules 1510a, 1510b can generate route proposals, based on, e.g., planning proposal mechanisms, such as random sampling, MPC, deep learning, pre-defined primitives, etc. The solution proposers of the redundant planning modules 1510a, 1510b can generate their respective solution proposals based on information from a current world-view 416 received from a perception module 402 of the AV, the AV's position 418, a destination 412 and other data from a database (DB) 410, for instance. Additionally, respective solution scorers (implemented like the solution scorers 1314a, 1314b) of the redundant planning modules 1510a, 1510b can evaluate the route proposals based on one or more cost assessments, e.g., using cost function evaluation of respective planning-cost functions, such as trajectory scoring based on trajectory length, safety, comfort, etc. To implement synergistic redundancy, the solution scorer of each planning module 1510a,b evaluates at least one route proposal generated by the solution proposer of the planning module 1510a,b, and at least one route proposal received through the intra-inter-stack connection 1515 from the solution proposer of another planning module 1510b,a. Note that the intra-inter-stack connection 1515 is implemented like the intra-inter-stack connection 1315. As such, the solution scorer of the planning module 1510a selects one between the route proposal from the solution proposer of the planning module 1510a and the route proposal from the solution proposer of the planning module 1510b, the selected one corresponding to a minimum of a first planning-cost function, and provides the selected route 1514a as the planning module 1510a's output to the planning-output mediator 1540. Also, the solution scorer of the planning module 1510b selects one between the route proposal from the solution proposer of the planning module 1510b and the route proposal from the solution proposer of the planning module 1510a, the selected one corresponding to a minimum of a second planning-cost function different from the first planning-cost function, and provides the selected route 1514b as the planning module 1510b's output to the planning-output mediator 1540. In this manner, a route proposal avoids being tied to a non-optimal solution in the planning module 1510a,b, e.g., due to convergence to a local minimum during optimization, because the other planning module 1510b,a uses different initial conditions, or because the other planning module 1510b,a uses a different route forming approach, even if it were to use the exact same initial conditions.

Moreover, the planning-output mediator 1540 selects one of the two routes 1514a, 1514b and provides it down-stream to the controller module 406 where it will be used to determine control signals for actuating a steering actuator B210a, a throttle actuator 420b, and/or a brake actuator 420c.

Note that these examples correspond to the different AV operations subsystems 1310a, 1310b, etc., that are being used at a single level of operation. In some implementations, synergistic redundancy can be implemented for two or more operations pipelines, also referred to as stacks, each of which including multiple levels of operation, e.g., a first level of operation corresponding to perception followed by a second level of operation corresponding to planning. Note that levels of operation in a pipeline are also referred to as stages of the pipeline.

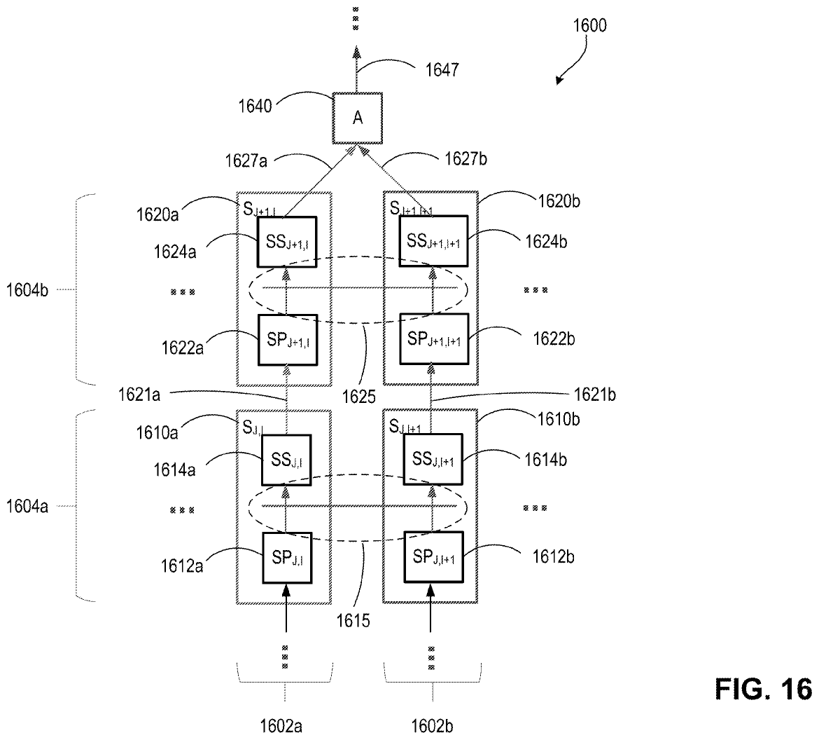

A system 1600 useable to operate an AV, a portion of the system 1600 being shown in FIG. 16, includes two or more operations pipelines 1602a, 1602b, each of which including two or more levels 1604a, 1604b. Synergistic redundancy can be implemented in the system 1600 with cross-evaluation at one or more levels. As described in detail below, AV operations subsystems configured like the AV operations subsystems 1310a, 1310b are used at various operational stages 1604a, 1604b of each of two or more operations pipelines 1602a, 1602b, such that each stage 1604a,b in the pipeline 1602a,b includes at least one solution scorer configured to evaluate proposed solutions from at least one solution proposer in the stage 1604a,b and proposed solutions from the same stage 1604a,b of another pipeline 1602b,a. In addition, the system 1600 includes an output mediator 1640 connected to the last stage of each of the two or more operations pipelines 1602a, 1602b.

In the example of system 1600 shown in FIG. 16, a first pipeline of operational stages 1602a includes a first stage 1604a implemented as a first AV operations subsystem 1610a, and a second stage 1604b implemented as a second AV operations subsystem 1620a. A second pipeline of operational stages 1602b includes the first stage 1604a implemented as another first AV operations subsystem 1610b and the second stage 1604b implemented as another second AV operations subsystem 1620b. Note that, in some implementations, the first AV operations subsystem 1610b and the second AV operations subsystem 1620b of the second pipeline 1602b share a power supply. In some implementations, the first AV operations subsystem 1610b and the second AV operations subsystem 1620b of the second pipeline 1602b have their own respective power supplies. Moreover, the second AV operations subsystem 1620a of the first pipeline 1602a communicates with the first AV operations subsystem 1610a of the first pipeline 1602a through an intra-stack connection 1621a, and with the output mediator 1640 through an end-stack connection 1627a, while the second AV operations subsystem 1620b of the second pipeline 1602b communicates with the first AV operations subsystem 1610b of the second pipeline 1602b through another intra-stack connection 1621b, and with the output mediator 1640 through another end-stack connection 1627b. Additionally, the first AV operations subsystem 1610a of the first pipeline 1602a and the first AV operations subsystem 1610b of the second pipeline 1602b communicate with each other through a first intra-inter-stack connection 1615, also the second AV operations subsystem 1620a of the first pipeline 1602a and the second AV operations subsystem 1620b of the second pipeline 1602b communicate with each other through a second intra-inter-stack connection 1625, as described below.

The first AV operations subsystem 1610a of the first pipeline 1602a includes a solution proposer 1612a and a solution scorer 1614a. The solution proposer 1612a of the first AV operations subsystem 1610a of the first pipeline 1602a is configured to use first input data available to the first AV operations subsystem 1610a of the first pipeline 1602a to propose first stage solutions. The first AV operations subsystem 1610b of the second pipeline 1602b includes another solution proposer 1612b and another solution scorer 1614b. The other solution proposer 1612b of the first AV operations subsystem 1610b of the second pipeline 1602b is configured to use second input data available to the first AV operations subsystem 1610b of the second pipeline 1602b to propose alternative first stage solutions.

The solution scorer 1614a of the first AV operations subsystem 1610a of the first pipeline 1602a is configured to evaluate the first stage solutions from the solution proposer 1612a of the first AV operations subsystem 1610a of the first pipeline 1602a and the alternative first stage solutions from the other solution proposer 1612b of the first AV operations subsystem 1610b of the second pipeline 1602b. The solution scorer 1614a of the first AV operations subsystem 1610a of the first pipeline 1602a is configured to provide, to the second AV operations subsystem 1620a of the first pipeline 1602a, first pipeline 1602a's first stage output which consists of, for each first stage solution and corresponding alternative first stage solution, one of either the first stage solution or the alternative first stage solution. The solution scorer 1614b of the first AV operations subsystem 1610b of the second pipeline 1602b is configured to evaluate the first stage solutions from the solution proposer 1612a of the first AV operations subsystem 1610a of the first pipeline 1602a and the alternative first stage solutions from the other solution proposer 1612b of the first AV operations subsystem 1610b of the second pipeline 1602b. The solution scorer 1614b of the first AV operations subsystem 1610b of the second pipeline 1602b is configured to provide, to the second AV operations subsystem 1620b of the second pipeline 1602b, second pipeline 1602b's first stage output which consists of, for each first stage solution and corresponding alternative first stage solution, one of either the first stage solution or the alternative first stage solution.

The second AV operations subsystem 1620a of the first pipeline 1602a includes a solution proposer 1622a and a solution scorer 1624a. The solution proposer 1622a of the second AV operations subsystem 1620a of the first pipeline 1602a is configured to use first pipeline 1602a's first stage output from the solution scorer 1614a of the first AV operations subsystem 1610a of the first pipeline 1602a to propose second stage solutions. The second AV operations subsystem 1620b of the second pipeline 1602b includes another solution proposer 1622b and another solution scorer 1624b. The other solution proposer 1622b of the second AV operations subsystem 1620b of the second pipeline 1602b is configured to use second pipeline 1602b's first stage output from the solution scorer 1614b of the first AV operations subsystem 1610b of the second pipeline 1602b to propose alternative second stage solutions.

The solution scorer 1624a of the second AV operations subsystem 1620a of the first pipeline 1602a is configured to evaluate the second stage solutions from the solution proposer 1622a of the second AV operations subsystem 1620a of the first pipeline 1602a and the alternative second stage solutions from the other solution proposer 1622b of the second AV operations subsystem 1620b of the second pipeline 1602b. The solution scorer 1624a of the AV operations subsystem 1620a of the first pipeline 1602a is configured to provide, to the output mediator 1640, first pipeline 1602a's second stage output which consists of, for each second stage solution and corresponding alternative second stage solution, one of either the second stage solution or the alternative second stage solution. The solution scorer 1624b of the second AV operations subsystem 1620b of the second pipeline 1602b is configured to evaluate the second stage solutions from the solution proposer 1622a of the second AV operations subsystem 1620a of the first pipeline 1602a and the alternative second stage solutions from the other solution proposer 1622b of the second AV operations subsystem 1620b of the second pipeline 1602b. The solution scorer 1624b of the second AV operations subsystem 1620b of the second pipeline 1602b is configured to provide, to the output mediator 1640, second pipeline 1602b's second stage output which consists of, for each second stage solution and corresponding alternative second stage solution, one of either the second stage solution or the alternative second stage solution.

The output mediator 1640 can implement one or more selection processes, described in detail in the next section, to select either one of the first pipeline 1602a's second stage output or the second pipeline 1602b's second stage output. In this manner, the output mediator 1640 provides, through output connection 1647, a single output from the two or more redundant pipelines 1602a, 1602b, in the form of the selected output, to one or more “down-stream” modules of the system 1600, or one or more actuators of the AV which use the system 1600.

The system 1600 which implements cross-stack evaluation of intermediate solution proposals from AV modules that share a region of the operating envelope, e.g., implemented as the first AV operations subsystems 1610a, 1610b, or as the second AV operations subsystems 1620a, 1620b, ensure higher failure tolerance, and potentially improved solutions in multi-level AV operation stacks/pipelines, during AV operation. These benefits will become apparent based on the examples described below.

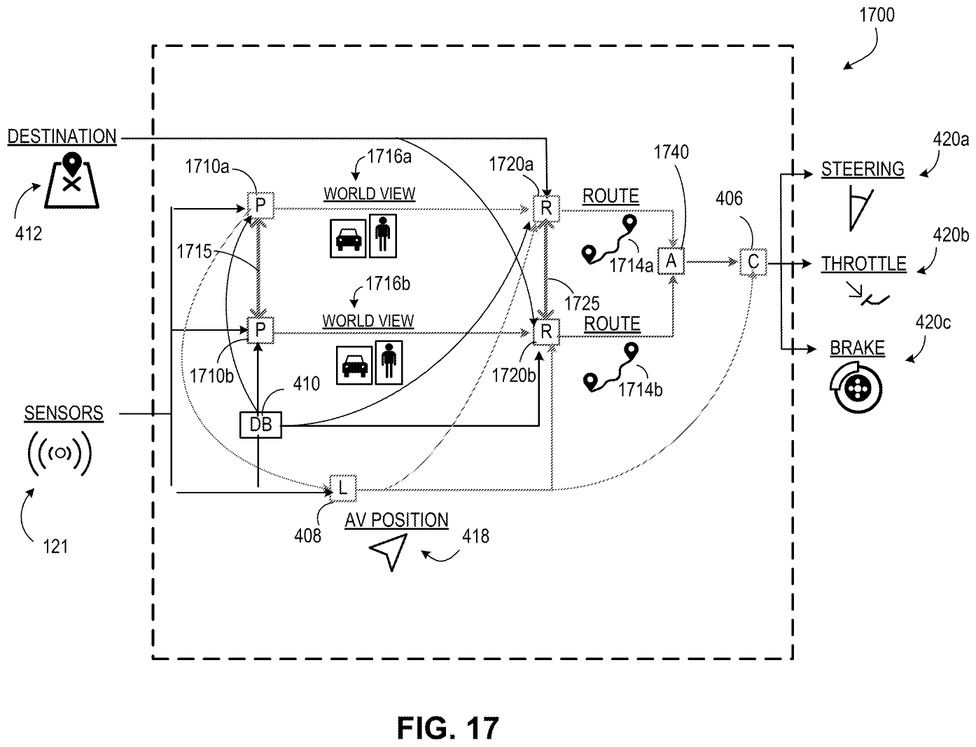

FIG. 17 shows an example of a system 1700 which represents a modified version of the system 400, the modification being that a two-stage pipeline having a first stage implemented as the perception module 402 and a second stage implemented as the planning module 404 was replaced by two redundant two-stage pipelines and an output mediator 1740. The first two-stage pipeline has a first stage implemented as a first perception module 1710a and a second stage implemented as a first planning module 1720a, and the second two-stage pipeline has the first stage implemented as a second perception module 1710b and the second stage implemented as a second planning module 1720b.

Here, the perception modules 1710a and 1710b are implemented like the AV operations subsystems 1610a of the first pipeline 1602a, and 1610b of the second pipeline 1602b. Operation of the perception modules 1710a and 1710b is similar to the operation of the perception modules 1410a, 1410b described above in connection with FIG. 14. For instance, solutions proposed by the solution proposers (implemented like the solution proposers 1612a, 1612b) of the perception modules 1710a, 1710b include world-view proposals. The solution proposers of the perception modules 1710a, 1710b can generate their respective world-view proposals based on information from current sensor signals received from corresponding subsets of sensors 121 associated with the system 1700, for instance. Additionally, respective solution scorers (implemented like the solution scorers 1614a, 1614b) of the perception modules 1710a, 1710b can evaluate the world-view proposals based on one or more cost assessments, e.g., based on evaluation of respective perception-cost functions. To implement synergistic redundancy, the solution scorer of each perception module 1710a,b evaluates at least one world-view proposal generated by the solution proposer of the perception module 1710a,b, and at least one world-view proposal received through the intra-inter-stack connection 1715 from the solution proposer of another perception module 1710b,a. In this manner, the solution scorer of the first perception module 1710a selects one between the world-view proposal from the solution proposer of the first perception module 1710a and the world-view proposal from the solution proposer of the second perception module 1710b, the selected one corresponding to a minimum of a first perception-cost function, and provides, down-stream the first pipeline, the selected world-view 1716a as the first perception module 1710a's output to the first planning module 1720a. Also, the solution scorer of the second perception module 1710b selects one between the world-view proposal from the solution proposer of the second perception module 1710b and the world-view proposal from the solution proposer of the first perception module 1710a, the selected one corresponding to a minimum of a second perception-cost function different from the first perception-cost function, and provides, down-stream the second pipeline, the selected world-view 1716b as the second perception module 1710b's output to the second planning module 1720b.

Moreover, the planning modules 1720a, 1720b are implemented like the AV operations subsystems 1620a of the first pipeline 1602a, and 1620b of the second pipeline 1602b, while the output mediator 1740 is implemented like the output mediator 1640. Operation of the planning modules 1720a and 1720b and of the output mediator 1740 is similar to the operation of the planning modules 1510a, 1510b and of the planning-output mediator 1540 described above in connection with FIG. 15. For instance, solutions proposed by the solution proposers (implemented like the solution proposers 1622a, 1622b) of the planning modules 1720a, 1720b include route proposals. The solution proposer of the first planning module 1720a generates its route proposal based on the world view 1716a output by the first perception module 1710a, and the solution proposer of the second planning module 1720b generates its route proposal based on the alternative world view 1716b output by the second perception module 1710b, while both can generate their respective route proposals based on the destination 412, the AV position 418 received from the localization module 408, and further on information received from the database (DB) 410. Additionally, respective solution scorers (implemented like the solution scorers 1624a, 1624b) of the planning modules 1720a, 1720b can evaluate the route proposals based on one or more cost assessments, e.g., based on evaluation of respective planning-cost functions. To implement synergistic redundancy, the solution scorer of each planning module 1720a,b evaluates at least one route proposal generated by the solution proposer of the planning module 1720a,b, and at least one route proposal received through the intra-inter-stack connection 1725 from the solution proposer of another planning module 1720b,a. Note that the intra-inter-stack connections 1715, 1725 are implemented like the intra-inter-stack connections 1615, 1625. In this manner, the solution scorer of the first planning module 1720a selects one between the route proposal from the solution proposer of the first planning module 1720a and the route proposal from the solution proposer of the second planning module 1720b, the selected one corresponding to a minimum of a first planning-cost function, and provides the selected route 1714a as the first pipeline's planning stage output to the output mediator 1740. Also, the solution scorer of the second planning module 1720b selects one between the route proposal from the solution proposer of the second planning module 1720b and the route proposal from the first solution proposer of the planning module 1720a, the selected one corresponding to a minimum of a second planning-cost function different from the first planning-cost function, and provides the selected route 1714b as the second pipeline's planning stage output to the output mediator 1740. In turn, the output mediator 1740 selects one of the two routes 1714a, 1714b and provides it down-stream to the controller module 406 where it will be used to determine control signals for actuating a steering actuator B210a, a throttle actuator 420b, and a brake actuator 420c.

As shown in the case of the system 1700 illustrated in FIG. 17, cross-evaluation of world-view proposals generated by redundant pipelines can be implemented at the perception stage, and cross-evaluation of route proposals generated by the redundant pipelines can be implemented at the planning stage. However, note that cross-evaluation of the world-view proposals generated by redundant pipelines can be implemented at the perception stage, without implementing cross-evaluation of the route proposals generated by the redundant pipelines at the planning stage. In some implementations this can be accomplished by using an intra-inter-stack connection 1725 which can be automatically reconfigured to function as a pair of intra-module connections, one connecting the route proposer and the route scorer of the first planning module 1720a, and the other one connecting the route proposer and the route scorer of the second planning module 1720b. Note that the cross-evaluation of the route proposals generated by the redundant pipelines at the planning stage can be restored by automatically reconfiguring the pair of intra-module connections to function as the intra-inter-stack connection 225. Moreover, cross-evaluation of the route proposals generated by redundant pipelines can be implemented at the planning stage, without implementing cross-evaluation of the world-view proposals generated by the redundant pipelines at the perception stage. In some implementations this can be accomplished by using an intra-inter-stack connection 1715 which can be automatically reconfigured to function as a pair of intra-module connections, one connecting the world-view proposer and the world-view scorer of the first perception module 1710a, and the other one connecting the world-view proposer and the world-view scorer of the second perception module 1710b. Note that the cross-evaluation of the world-view proposals generated by the redundant pipelines at the perception stage can be restored by automatically reconfiguring the pair of intra-module connections to function as the intra-inter-stack connection 215. In some situations, it may be necessary to drop both the cross-evaluations of the world-view proposals and the cross-evaluations of the route proposals. These situations, which correspond to standard 1oo2 substitution redundancy, can be accomplished by reconfiguring both intra-inter-stack connections 1715, 1715 as described above, and by using an authoritative output mediator 1740.

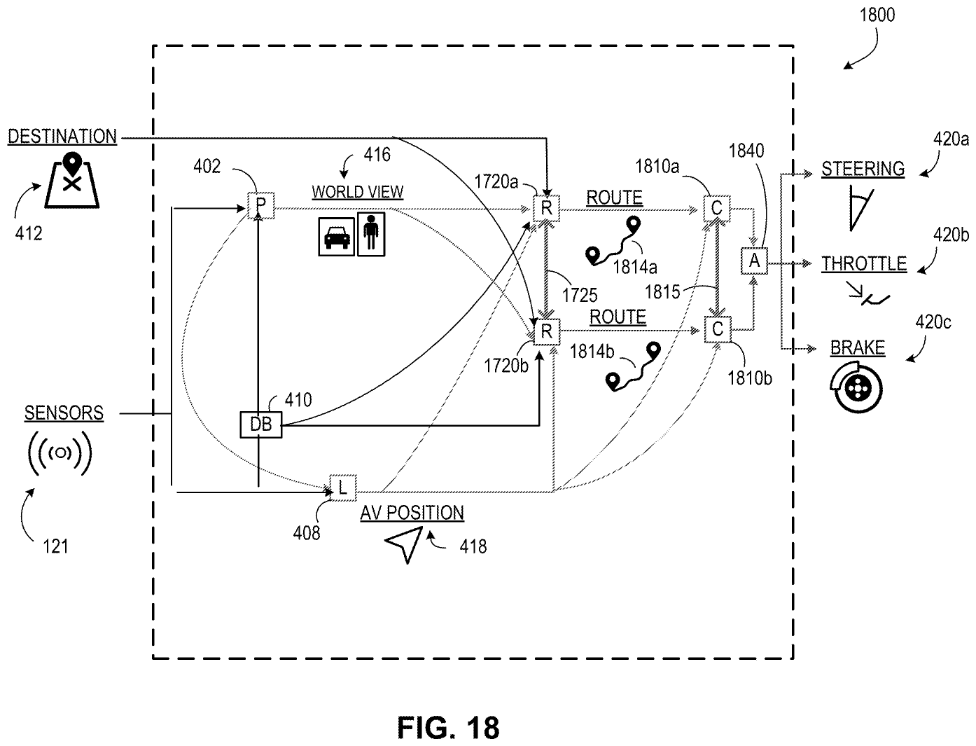

FIG. 18 shows an example of a system 1800 which represents a modified version of the system 400, the modification being that a two-stage pipeline having a first stage implemented as the planning module 404 and a second stage implemented as the controller module 406 was replaced by two redundant two-stage pipelines and an output mediator 1840. The first two-stage pipeline has a first stage implemented as a first planning module 1720a and a second stage implemented as a first controller module 1810a, and the second two-stage pipeline has the first stage implemented as a second planning module 1720b and the second stage implemented as a second controller module 1810b.

Here, the planning modules 1720a, 1720b are implemented like the AV operations subsystems 1610a of the first pipeline 1602a, and 1610b of the second pipeline 1602b. Operation of the planning modules 1720a and 1720b is similar to the operation of the planning modules 1510a, 1510b described above in connection with FIG. 15. For instance, solutions proposed by the solution proposers (implemented like the solution proposers 1612a, 1612b) of the planning modules 1720a, 1720b include route proposals. The solution proposers of the planning modules 1720a, 1720b generate their respective route proposals based on the world view 416 output by the perception module 402, on the AV position 418 received from the localization module 408, the destination 412, and further on information received from the database (DB) 410. Additionally, respective solution scorers (implemented like the solution scorers 1614a, 1614b) of the planning modules 1720a, 1720b can evaluate the route proposals based on one or more cost assessments, e.g., based on evaluation of respective planning-cost functions. To implement synergistic redundancy, the solution scorer of each planning module 1720a,b evaluates at least one route proposal generated by the solution proposer of the planning module 1720a,b, and at least one route proposal received through the intra-inter-stack connection 1725 from the solution proposer of another planning module 1720b,a. In this manner, the solution scorer of the first planning module 1720a selects one between the route proposal from the solution proposer of the first planning module 1720a and the route proposal from the solution proposer of the second planning module 1720b, the selected one corresponding to a minimum of a first planning-cost function, and provides, down-stream the first pipeline, the selected route 1814a as the first planning module 1720a's output to the first controller module 1810a. Also, the solution scorer of the second planning module 1720b selects one between the route proposal from the solution proposer of the second planning module 1720b and the route proposal from the solution proposer of the first planning module 1720a, the selected one corresponding to a minimum of a second planning-cost function different from the first planning-cost function, and provides, down-stream the second pipeline, the selected route 1814b as the second planning module 1720b's output to the second controller module 1810b.

Moreover, the controller modules 1810a, 1810b are implemented like the AV operations subsystems 1620a of the first pipeline 1602a, and 1620b of the second pipeline 1602b, while the output mediator 1840 is implemented like the output mediator 1640. Here, solutions proposed by the solution proposers (implemented like the solution proposers 1622a, 1622b) of the controller modules 1810a, 1810b include control-signal proposals. The solution proposer of the first controller module 1810a generates its control-signal proposal based on the route 1814a output by the first planning module 1720a, and the solution proposer of the second controller module 1810b generates its control-signal proposal based on the alternative route 1814b output by the second planning module 1720b, while both can generate their respective control-signal proposals based on the AV position 418 received from the localization module 408. Additionally, respective solution scorers (implemented like the solution scorers 1624a, 1624b) of the controller modules 1810a, 1810b can evaluate the control-signal proposals based on one or more cost assessments, e.g., based on evaluation of respective control-cost functions. To implement synergistic redundancy, the solution scorer of each controller module 1810a,b evaluates at least one control-signal proposal generated by the solution proposer of the controller module 1810a,b, and at least one control-signal proposal received through the intra-inter-stack connection 1815 from the solution proposer of another controller module 1810b,a. Note that the intra-inter-stack connection 1815 is implemented like the intra-inter-stack connection 1625. As such, the solution scorer of the first controller module 1810a selects one between the control-signal proposal from the solution proposer of the first controller module 1810a and the control-signal proposal from the solution proposer of the second controller module 1810b, the selected one corresponding to a minimum of a first control-cost function, and provides the selected control-signal as the first pipeline's controller stage output to the output mediator 1840. Also, the solution scorer of the controller module 1810b selects one between the control-signal proposal from the solution proposer of the second controller module 1810b and the control-signal proposal from the solution proposer of the first controller module 1810a, the selected one corresponding to a minimum of a second control-cost function different from the first control-cost function, and provides the selected control-signal as the second pipeline's controller stage output to the output mediator 1840. In this manner, a control-signal proposal avoids being tied to a non-optimal solution in the control module 1810a,b, e.g., due to convergence to a local minimum during optimization, because the other control module 1810b,a uses different initial conditions, or because the other control module 1810b,a uses a different control-signal forming approach, even if it were to use the exact same initial conditions.

Moreover, the output mediator 1840 selects one of the two control signals and provides it down-stream for actuating a steering actuator B210a, a throttle actuator 420b, and/or a brake actuator 420c.

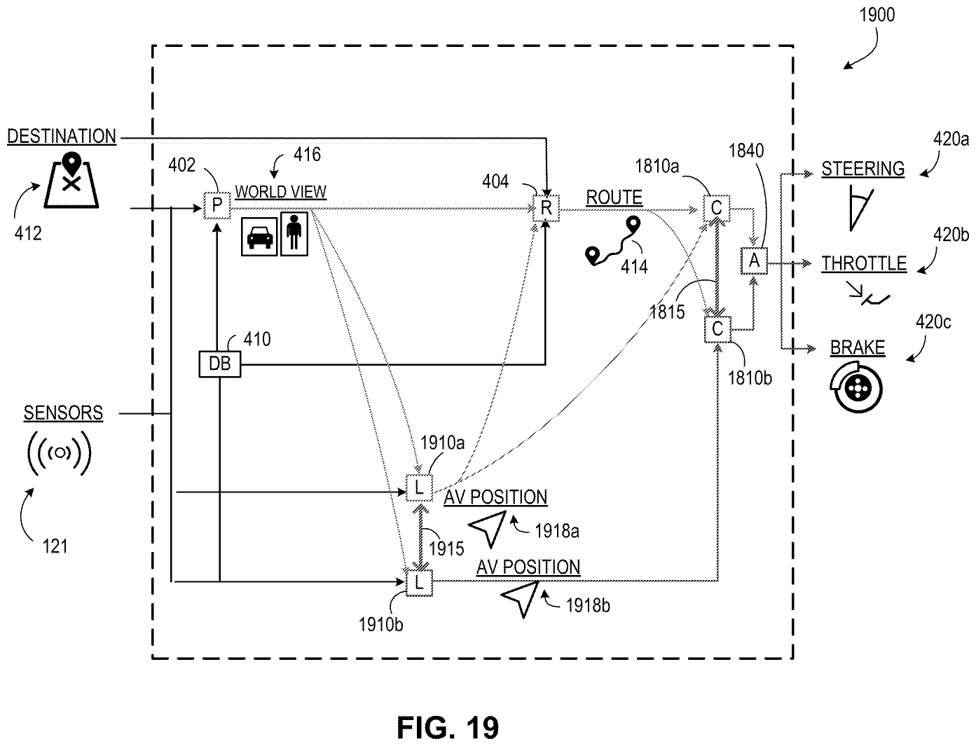

FIG. 19 shows an example of a system 1900 which represents a modified version of the system 400, the modification being that a two-stage pipeline having a first stage implemented as the localization module 408 and a second stage implemented as the controller module 406 was replaced by two redundant two-stage pipelines and an output mediator 1840. The first two-stage pipeline has a first stage implemented as a first localization module 1910a and a second stage implemented as a first controller module 1810a, and the second two-stage pipeline has the first stage implemented as a second localization module 1910b and the second stage implemented as a second controller module 1810b.

Here, the localization modules 1910a, 1910b are implemented like the AV operations subsystems 1610a of the first pipeline 1602a, and 1610b of the second pipeline 1602b. Here, solutions proposed by the solution proposers (implemented like the solution proposers 1612a, 1612b) of the localization modules 1910a, 1910b include AV position proposals. The solution proposers of the localization modules 1910a, 1910b generate their respective AV position proposals based on information from current sensor signals received from corresponding subsets of sensors 121 associated with the system 1900, on the world view 416 output by the perception module 402, and further on information received from a database (DB) 410. Note that, the AV position proposals may be constrained by known factors, such as roads, legal/illegal positions, altitude, etc. Additionally, respective solution scorers (implemented like the solution scorers 1614a, 1614b) of the localization modules 1910a, 1910b can evaluate the AV location proposals based on one or more cost assessments, e.g., based on evaluation of respective localization-cost functions. To implement synergistic redundancy, the solution scorer of each localization module 1910a,b evaluates at least one AV location proposal generated by the solution proposer of the localization module 1910a,b, and at least one AV location proposal received through the intra-inter-stack connection 1915 from the solution proposer of another localization module 1910b,a. Note that the intra-inter-stack connections 1915 is implemented like the intra-inter-stack connection 1615. As such, the solution scorer of the first localization module 1910a selects one between the AV position proposal from the solution proposer of the first localization module 1910a and the AV position proposal from the solution proposer of the second localization module 1910b, the selected one corresponding to a minimum of a first localization-cost function, and provides, down-stream the first pipeline, the selected AV position 1918a as the first localization module 1910a's output to the first controller module 1810a. Also, the solution scorer of the second localization module 1910b selects one between the AV location proposal from the solution proposer of the second localization module 1910b and the AV location proposal from the solution proposer of the first localization module 1910a, the selected one corresponding to a minimum of a second localization-cost function different from the first localization-cost function, and provides, down-stream the second pipeline, the selected AV position 1918b as the second localization module 1910b's output to the second controller module 1810b. In this manner, an AV position proposal avoids being tied to a non-optimal solution in the localization module 1910a,b, e.g., due to convergence to a local minimum during optimization, because the other localization module 1910b,a uses different initial conditions, or because the other localization module 1910b,a uses a different AV location forming approach, even if it were to use the exact same initial conditions.

Further in the example illustrated in FIG. 19, the first controller module 1810a at the second stage of the first pipeline and the second controller module 1810b at the second stage of the second pipeline are implemented and operated as described above in connection with FIG. 18, except that the solution proposer of the first controller module 1810a generates its control-signal proposal based on the AV position 1918a output by the first localization module 1910a, and the solution proposer of the second controller module 1810b generates its control-signal proposal based on the alternative route 1918b output by the second localization module 1910b. Furthermore in the example illustrated in FIG. 19, the output mediator 1840 is implemented and operated as described above in connection with FIG. 18.

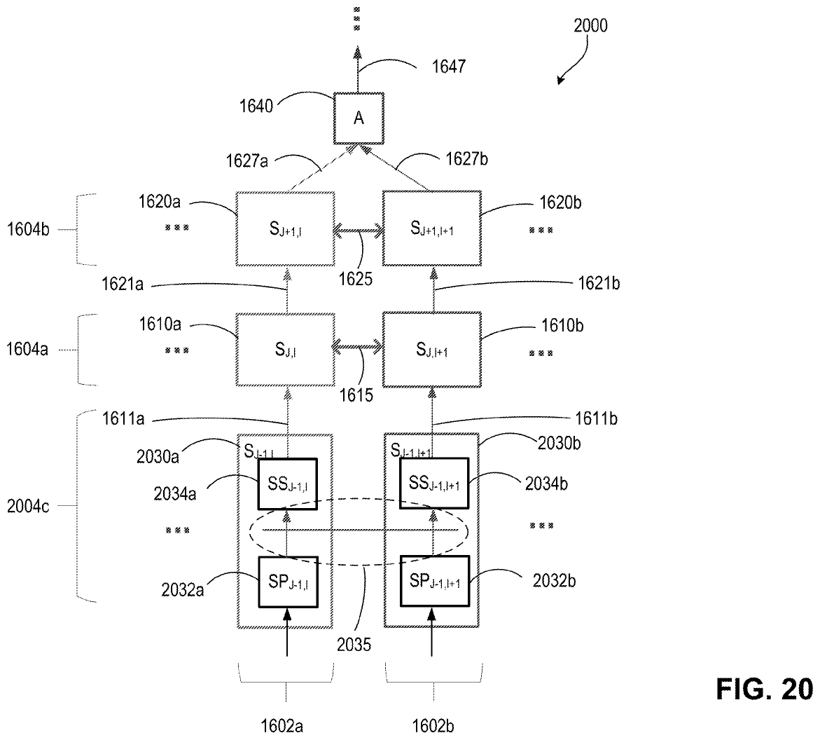

As described above in connection with FIG. 16, the first and second redundant pipelines 1602a, 1602b each can include two or more stages 1604a, 1604b. A system 2000 useable to operate an AV, a portion of the system 2000 being shown in FIG. 20, includes the two operations pipelines 1602a, 1602b, each of which including three stages 1604a, 1604b, 2004c. The system 2000 also includes the output mediator 1640 connected to the last stage of each of the two operations pipelines 1602a, 1602b. Synergistic redundancy can be implemented in the system 2000 with cross-evaluation at each of the three stages, as described below.

Here, the first and second stages 1604a, 1604b of the system 2000 were implemented as described above in connection with system 1600. The third stage 2004c of the first pipeline 1602a was implemented as a third AV operations subsystem 2030a, and the third stage 2004c of the second pipeline 1602b was implemented as another third AV operations subsystem 2030b. Note that, in some embodiments, the first AV operations subsystem 1610b, the second AV operations subsystem 1620b, and the third AV operations subsystem 2030b of the second pipeline 1602b share a power supply. In some embodiments, the first AV operations subsystem 1610b, the second AV operations subsystem 1620b, and the third AV operations subsystem 2030b of the second pipeline 1602b each have their own power supply. Moreover, the third AV operations subsystem 2030a communicates with the first AV operations subsystem 1610a through an intra-stack connection 1611a of the first pipeline 1602a, and the other third AV operations subsystem 2030b communicates with the other first AV operations subsystem 1610b through another intra-stack connection 1611b of the second pipeline 1602b. Additionally, the third AV operations subsystem 2030a of the first pipeline 1602a and the third AV operations subsystem 2030b of the second pipeline 1602b communicate with each other through a third intra-inter-stack connection 2035, as described below.

The third AV operations subsystem 2030a of the first pipeline 1602a includes a solution proposer 2032a and a solution scorer 2034a. The solution proposer 2032a of the third AV operations subsystem 2030a of the first pipeline 1602a is configured to use first input data available to the third AV operations subsystem 2030a of the first pipeline 1602a to propose third stage solutions. The third AV operations subsystem 2030b of the second pipeline 1602b includes another solution proposer 2032b and another solution scorer 2034b. The other solution proposer 2032b of the third AV operations subsystem 2030b of the second pipeline 1602b is configured to use second input data available to the third AV operations subsystem 2030b of the second pipeline 1602b to propose alternative third stage solutions.

The solution scorer 2034a of the third AV operations subsystem 2030a of the first pipeline 1602a is configured to evaluate the third stage solutions from the solution proposer 2032a of the third AV operations subsystem 2030a of the first pipeline 1602a and the alternative first stage solutions from the other solution proposer 2032b of the third AV operations subsystem 2030b of the second pipeline 1602b. The solution scorer 2034a of the third AV operations subsystem 2030a of the first pipeline 1602a is configured to provide, to the first AV operations subsystem 1610a of the first pipeline 1602a, first pipeline 1602a's third stage output which consists of, for each third stage solution and corresponding alternative third stage solution, one of either the third stage solution or the alternative third stage solution. The solution scorer 2034b of the third AV operations subsystem 2030b of the second pipeline 1602b is configured to evaluate the third stage solutions from the solution proposer 2032a of the third AV operations subsystem 2030a of the first pipeline 1602a and the alternative third stage solutions from the other solution proposer 2032b of the third AV operations subsystem 2030b of the second pipeline 1602b. The solution scorer 2034b of the third AV operations subsystem 2030b of the second pipeline 1602b is configured to provide, to the first AV operations subsystem 1610b of the second pipeline 1602b, second pipeline 1602b's third stage output which consists of, for each third stage solution and corresponding alternative third stage solution, one of either the third stage solution or the alternative third stage solution.

The first stage 1604a was implemented, as the first AV operations subsystem 1610a for the first pipeline 1602a, and as the other first AV operations subsystem 1610b for the second pipeline 1602b. The first AV operations subsystem 1610a of the first pipeline 1602a, and the other first AV operations subsystem 1610b of the second pipeline 1602b were implemented and operated as described above in connection with FIG. 16, except that the solution proposer of the first AV operations subsystem 1610a generates its solution proposals based on the first pipeline 1602a's third stage output received from the third AV operations subsystem 2030a, and the solution proposer of the other first AV operations subsystem 1610b generates its solution proposal based on the second pipeline 1602b's third stage output received from the other third AV operations subsystem 2030b.

Further for the system 2000, the second stage 1604b was implemented as the second AV operations subsystem 1620a for the first pipeline 1602a, and as the other second AV operations subsystem 1620b for the second pipeline 1602b. The second AV operations subsystem 1620a of the first pipeline 1602a, and the other second AV operations subsystem 1620b of the second pipeline 1602b were implemented and operated as described above in connection with FIG. 16. Furthermore for the system 2000, the output mediator 1640 was implemented and operated as described above in connection with FIG. 16.

Various ways to modify the system 400 to implement the synergistic redundancy of the system 2000 will be described below.

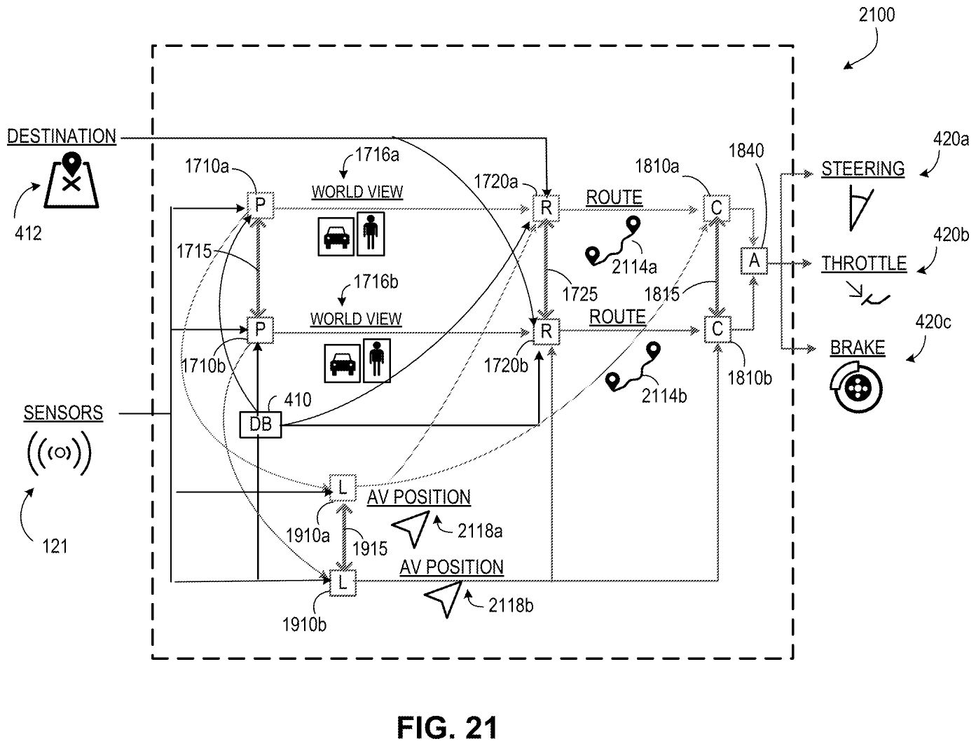

FIG. 21 shows an example of a system 2100 which represents a modified version of the system 400, one modification being that a three-stage pipeline having a beginning stage implemented as the perception module 402, an intermediate stage implemented as the planning module 404, and a last stage implemented as the control module 406 was replaced by a first pair of redundant three-stage pipelines and an output mediator 1840. Here, the first three-stage pipeline has a beginning stage implemented as a first perception module 1710a, an intermediate stage implemented as a first planning module 1720a, and a last stage implemented as a first control module 1810a, while the second three-stage pipeline has the beginning stage implemented as a second perception module 1710b, the intermediate stage implemented as a second planning module 1720b, and the last stage implemented as a second control module 1810b.

For the first pair of redundant three-stage pipelines of the system 2100, the perception modules 1710a, 1710b were implemented like the AV operations subsystems 2030a of the first pipeline 1602a, and 2030b of the second pipeline 1602b. As described above in connection with FIG. 17, the solution proposers of the perception modules 1710a, 1710b generate their respective world-view proposals based on information from current sensor signals received from corresponding subsets of sensors 121 associated with the system 2100, for instance. To implement synergistic redundancy, the solution scorer of each perception module 1710a,b evaluates at least one world-view proposal generated by the solution proposer of the perception module 1710a,b, and at least one world-view proposal received through the intra-inter-stack connection 1715 from the solution proposer of another perception module 1710b,a, selects the one of these two world-view proposals which minimizes a perception-cost function corresponding to the perception module 1710a,b, and outputs, down-stream the respective pipeline, the selected proposal as a world-view 1716a,b to the planning module 1720a,b.

Further for the first pair of redundant three-stage pipelines of the system 2100, the planning modules 1720a, 1720b were implemented and operated as described above in connection with FIG. 17. Here, the solution proposers of the planning modules 1720a, 1720b generate their respective route proposals based on the world-views 1716a, 1716b from the respective perception modules 1710a, 1710b, for instance. To implement synergistic redundancy, the solution scorer of each planning module 1720a,b evaluates at least one route proposal generated by the solution proposer of the planning module 1720a,b, and at least one route proposal received through the intra-inter-stack connection 1725 from the solution proposer of another planning module 1720b,a, selects the one of these two route proposals which minimizes a planning-cost function corresponding to the planning module 1720a,b, and outputs, down-stream the respective pipeline, the selected proposal as a route 2114a,b to the control module 1810a,b.

Furthermore for the first pair of redundant three-stage pipelines of the system 2100, the control modules 1810a, 1810b and the output mediator 1840 were implemented and operated as described above in connection with FIG. 18. Here, the solution proposers of the control modules 1810a, 1810b generate their respective control-signal proposals based on the routes 2114a, 2114b from the respective planning modules 1720a, 1720b, for instance. To implement synergistic redundancy, the solution scorer of each control module 1810a,b evaluates at least one control-signal proposal generated by the solution proposer of the control module 1810a,b, and at least one control-signal proposal received through the intra-inter-stack connection 1815 from the solution proposer of another control module 1810b,a, selects the one of these two control-signal proposals which minimizes a control-cost function corresponding to the control module 1810a,b, and outputs the selected proposal as the control signal to the output mediator 1840. In turn, the output mediator 1840 selects one of the two control signals provided by the control modules 1810a, 1810b and provides it down-stream for actuating a steering actuator B210a, a throttle actuator 420b, and/or a brake actuator 420c.

Another modification of the system 400 embodied by the system 2100 is that a three-stage pipeline having a beginning stage implemented as the perception module 402, an intermediate stage implemented as the localization module 408, and a last stage implemented as the control module 406 was replaced by a second pair of redundant three-stage pipelines and the output mediator 1840. Here, the first three-stage pipeline has a beginning stage implemented as a first perception module 1710a, an intermediate stage implemented as a first localization module 1910a, and a last stage implemented as a first control module 1810a, while the second three-stage pipeline has the beginning stage implemented as a second perception module 1710b, the intermediate stage implemented as a second localization module 1910b, and the last stage implemented as a second control module 1810b.

For the second pair of redundant three-stage pipelines of the system 2100, the perception modules 1710a, 1710b are implemented and operated as described above in connection with the first pair of redundant three-stage pipelines of the system 2100, except that each perception module 1710a,b outputs, down-stream the respective pipeline, the selected proposal as a world-view 1716a,b to the localization module 1910a,b.

Further for the second pair of redundant three-stage pipelines of the system 2100, the localization modules 1910a, 1910b were implemented and operated as described above in connection with FIG. 19. Here, the solution proposers of the localization modules 1910a, 1910b generate their respective AV position proposals based on the world-views 1716a, 1716b from the respective perception modules 1710a, 1710b, for instance. To implement synergistic redundancy, the solution scorer of each localization module 1910a,b evaluates at least one AV position proposal generated by the solution proposer of the localization module 1910a,b, and at least one AV position proposal received through the intra-inter-stack connection 1915 from the solution proposer of another localization module 1910b,a, selects the one of these two AV position proposals which minimizes a localization-cost function corresponding to the localization module 1910a,b, and outputs, down-stream the respective pipeline, the selected proposal as an AV position 2118a,b to the control module 1810a,b.

Furthermore for the second pair of redundant three-stage pipelines of the system 2100, the control modules 1810a, 1810b and the output mediator 1840 are implemented and operated as described above in connection with the first pair of redundant three-stage pipelines of the system 2100.

Yet another modification of the system 400 embodied by the system 2100 is that a four-stage pipeline having a beginning stage implemented as the perception module 402, a first intermediate stage implemented as the localization module 408, a second intermediate stage implemented as the planning module 404, and a last stage implemented as the control module 406 was replaced by a pair of redundant four-stage pipelines and the output mediator 1840. Here, the first four-stage pipeline has a beginning stage implemented as a first perception module 1710a, a first intermediate stage implemented as a first localization module 1910a, a second intermediate stage implemented as a first planning module 1720a, and a last stage implemented as a first control module 1810a, while the second four-stage pipeline has the beginning stage implemented as a second perception module 1710b, the first intermediate stage implemented as a second localization module 1910b, the second intermediate stage implemented as a second planning module 1720b, and the last stage implemented as a second control module 1810b.

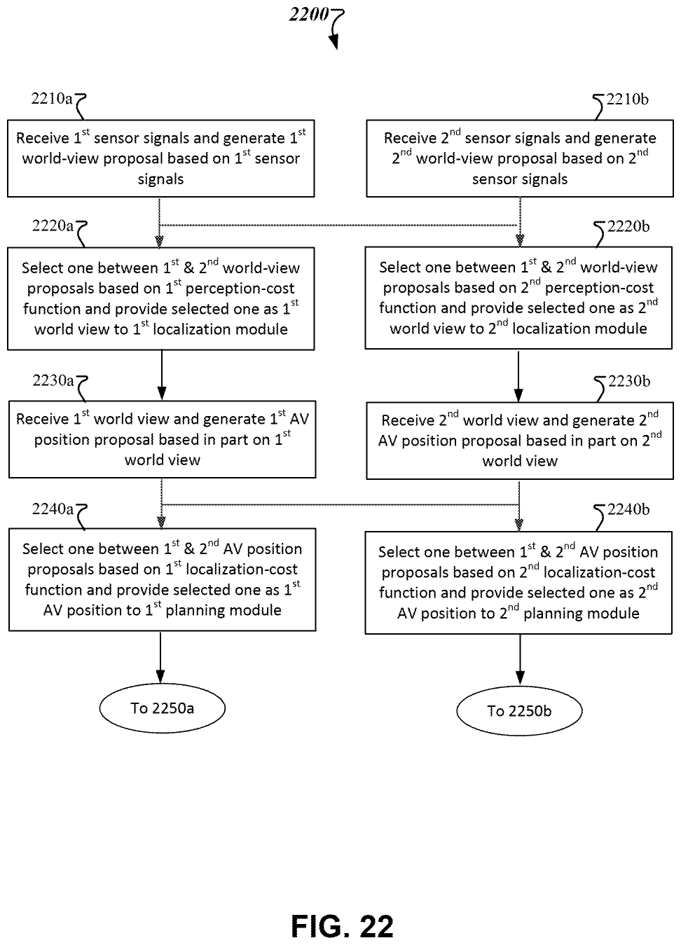

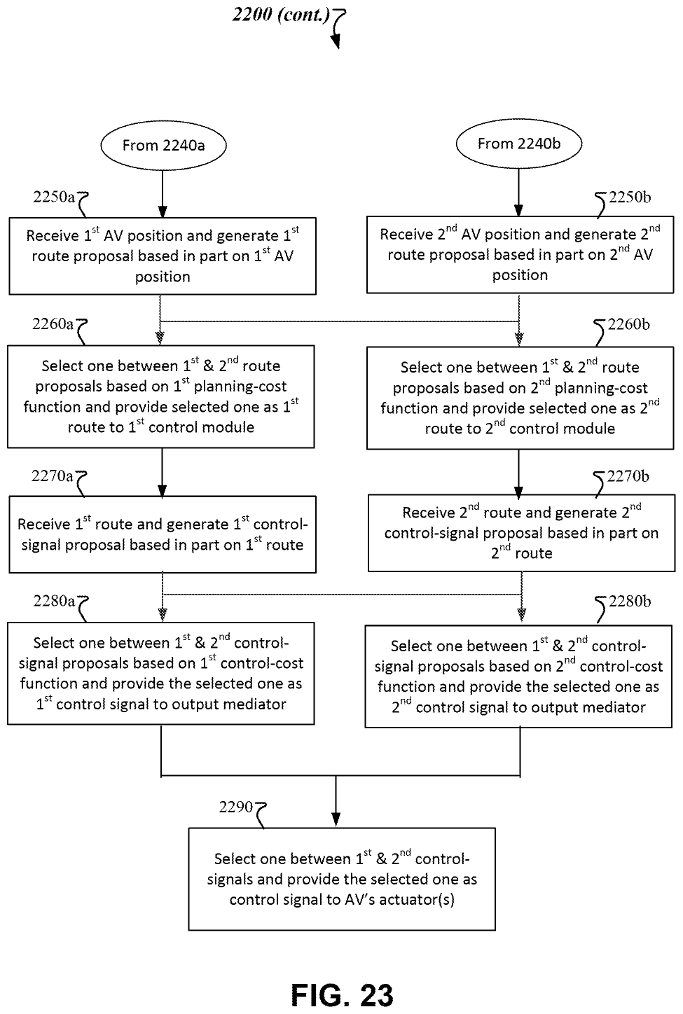

For the pair of redundant four-stage pipelines of the system 2100, the perception modules 1710a, 1710b are implemented as described above in connection with each of the first and second pairs of redundant three-stage pipelines of the system 2100, except that each perception module 1710a,b outputs, down-stream the respective pipeline, its selected proposal as a world-view 1716a,b to the localization module 1910a,b and the planning module 1720a,b. Also for the pair of redundant four-stage pipelines of the system 2100, the localization modules 1910a, 1910b were implemented as described above in connection with the second pair of redundant three-stage pipelines of the system 2100, except that each localization module 1910a,b outputs, down-stream the respective pipeline, its selected proposal as an AV position 2118a,b to the control module 1810a,b and the planning module 1720a,b. Further, for the pair of redundant four-stage pipelines of the system 2100, the planning modules 1720a, 1720b are implemented as described above in connection with the first pair of redundant three-stage pipelines of the system 2100. Furthermore, for the pair of redundant four-stage pipelines of the system 2100, the control modules 1810a, 1810b and the output mediator 1840 are implemented as described above in connection with the first pair of redundant three-stage pipelines of the system 2100. The pair of redundant four-stage pipelines of the system 2100 can be operated using a process 2200 described below in connection with FIGS. 22-23.

At 2210a, the first perception module 1710a receives first sensor signals from a first set of the sensors 121 of an AV, and generates a first world view proposal based on the first sensor signals. At 2210b, the second perception module 1710b receives second sensor signals from a second set of the sensors 121 of the AV, and generates a second world view proposal based on the second sensor signals.

As noted above, the first set of sensors can be different from the second set of sensors. For example, the two sets are partially overlapping, i.e., they can have at least one sensor in common. As another example, the two set have no common sensor.

In some implementations, the first sensor signals received from the first set of the sensors 121 include one or more lists of objects detected by corresponding sensors of the first set, and the second sensor signals received from the second set of the sensors 121 include one or more lists of objects detected by corresponding sensors of the second set. In some implementations, these lists are created by the perception modules. As such, the generating of the first world view proposal by the first perception module 1710a can include creating one or more first lists of objects detected by corresponding sensors of the first set. And, the generating of the second world view proposal by the second perception module 1710b can include creating one or more second lists of objects detected by corresponding sensors of the second set.

In some implementations, the generating of the first world view proposal can be performed by the first perception module 1710a based on a first perception proposal mechanism. And, the generating of the second world view proposal can be performed by the second perception module 1710b based on a second perception proposal mechanism different from the first perception proposal mechanism. In other implementations, the second perception module 1710b can generate the second world view proposal based on the first perception proposal mechanism to be different than the first world view proposal. That is because the second sensor signals used by the second perception module 1710b are different than the first sensor signals used by the first perception module 1710a to generate their respective world view proposals.

At 2220a, the first perception module 1710a selects one between the first world view proposal and the second world view proposal based on a first perception-cost function, and provides the selected one as a first world view 1716a to the first localization module 1910a. At 2220b, the second perception module 1710b selects one between the first world view proposal and the second world view proposal based on a second perception-cost function, and provides the selected one as a second world view 1716b to the second localization module 1910b.

In some implementations, the first world view 1716a provided to the first localization module 1910a and to the first planning module 1720a can include a first object track of one or more objects detected by the first set of sensors. Also, the second world view 1716b provided to the second localization module 1910b and to the second planning module 1720b can include a second object track of one or more objects detected by the second set of sensors.

At 2230a, the first localization module 1910a receives the first world view 1716a from the first perception module 1710a, and generates a first AV position proposal based on the first world view 1716a. At 2230b, the second localization module 1910b receives the second world view 1716b from the second perception module 1710b, and generates a second AV position proposal based on the second world view 1716b.

Note that the first localization module 1910a can receive at least a portion of the first sensor signals from the first set of the sensors 121. In this manner, the generating of the first AV position proposal is performed by the first localization module 1910a based on a combination of the first sensor signals and the first world view 1716a. Also note that the second localization module 1910b can receive at least a portion of the second sensor signals from the second set of the sensors 121. In this manner, the generating of the second AV position proposal is performed by the second localization module 1910b based on another combination of the second sensor signals and the second world view 1716b. For instance, to generate the first and second AV position proposals, the first and second localization modules 1910a, 1910b can use one or more localization algorithms including map-based localization, LiDAR map-based localization, RADAR map-based localization, visual map-based localization, visual odometry, and feature-based localization.

In some implementations, the generating of the first AV position proposal can be performed by the first localization module 1910a based on a first localization algorithm. And, the generating of the second AV position proposal can be performed by the second localization module 1910b based on a second localization algorithm different from the first localization algorithm. In other implementations, the second localization module 1910b can use the first localization algorithm to generate the second AV position proposal and obtain a second AV position proposal that is different than the first AV position proposal. That is so because the combination of second sensor signals and second world view 1716b used by the second localization module 1910b as input to the first localization algorithm is different than the combination of first sensor signals and first world view 1716a used by the first localization module 1910a as input to the first localization algorithm. Applying the first localization algorithm to different inputs can result in different AV position proposals.

At 2240a, the first localization module 1910a selects one between the first AV position proposal and the second AV position proposal based on a first localization-cost function, and provides the selected one as a first AV position 2118a to the first planning module 1720a. At 2240b, the second localization module 1910b selects one between the first AV position proposal and the second AV position proposal based on a second localization-cost function, and provides the selected one as a second AV position 2118b to the second planning module 1720b. Note that the first AV position 2118a provided to the first planning module 220a and to the first control module 1810a can include a first estimate of a current position of the AV, and the second AV position 2118b provided to the second planning module 220b and to the second control module 1810b can include a second estimate of the current position of the AV.

At 2250a, the first planning module 1720a receives the first AV position 2118a from the first localization module 1910a, and generates a first route proposal based on the first AV position 2118a. At 2250b, the second planning module 1720b receives the second AV position 2118b from the second localization module 1910b, and generates a second route proposal based on the second AV position 2118b.

Note that the first planning module 1720a can receive the first world view 1716a from the first perception module 1710a. In this manner, the generating of the first route proposal is performed by the first planning module 1720a based on a combination of the first AV position 2118a and the first world view 1716a. Also note that the second planning module 1720b can receive the second world view 1716b from the second perception module 1710b. In this manner, the generating of the second route proposal is performed by the second planning module 1720b based on another combination of the second AV position 2118b and the second world view 1716b.

In some implementations, the generating of the first route proposal can be performed by the first planning module 1720a based on a first planning algorithm. And, the generating of the second route proposal can be performed by the second planning module 1720b based on a second planning algorithm different from the first planning algorithm. In other implementations, the second planning module 1720b can use the first planning algorithm to generate the second route proposal and obtain a second route proposal that is different than the first route proposal. That is so because the combination of second AV position 2118b and the second world view 1716b used by the second localization module 1910b as input to the first planning algorithm is different than the combination of first AV position 2118a and first world view 1716a used by the first planning module 1720a as input to the first planning algorithm. Applying the first planning algorithm to different inputs can result in different route proposals.

In some implementations, generating the route proposals by the planning modules 1720a, 1720b can include proposing respective paths between the AV's current position and a destination 412 of the AV.

In some implementations, generating the route proposals by the planning modules 1720a, 1720b can include inferring behavior of the AV and one or more other vehicles. In some cases, the behavior is inferred by comparing a list of detected objects with driving rules associated with a current location of the AV. For example, cars drive on the right side of the road in the USA, and the left side of the road in the UK, and are expected to stay on their legal side of the road. In other cases, the behavior is inferred by comparing a list of detected objects with locations in which vehicles are permitted to operate by driving rules associated with a current location of the vehicle. For example, cars are not allowed to drive on sidewalks, off road, through buildings, etc. In some cases, the behavior is inferred through a constant velocity or constant acceleration model for each detected object. In some implementations, generating the route proposals by the planning modules 1720a, 1720b can include proposing respective paths that conform to the inferred behavior and avoid one or more detected objects.

At 2260a, the first planning module 1720a selects one between the first route proposal and the second route proposal based on a first planning-cost function, and provides the selected one as a first route 2114a to the first control module 1810a. At 2260b, the second planning module 220b selects one between the first route proposal and the second route proposal based on a second planning-cost function, and provides the selected one as a second route 2114b to the second control module 1810b.

In some implementations, selecting one between the first route proposal and the second route proposal can include evaluating collision likelihood based on the respective world view 1716a,b and a behavior inference model.

At 2270a, the first control module 1810a receives the first route 2114a from the first planning module 1720a, and generates a first control-signal proposal based on the first route 2114a. At 2270b, the second control module 1810b receives the second route 2114b from the second planning module 1720b, and generates a second control-signal proposal based on the second route 2114b.

Note that the first control module 1810a can receive the first AV position 2118a from the first localization module 1910a. In this manner, the generating of the first control-signal proposal is performed by the first control module 1810a based on a combination of the first AV position 2118a and the first route 2114a. Also note that the second control module 1810b can receive the second AV position 2118b from the second localization module 1910b. In this manner, the generating of the second control-signal proposal is performed by the second control module 1810b based on another combination of the second AV position 2118b and the second route 1714b

At 2280a, the first control module 1810a selects one between the first control-signal proposal and the second control-signal proposal based on a first control-cost function, and provides the selected one as a first control signal to the output mediator 1840. At 2280b, the second control module 1810b selects one between the first control-signal proposal and the second control-signal proposal based on a second control-cost function, and provides the selected one as a second control signal to the output mediator 1840.

At 2290, the output mediator 1840 receives, or accesses, the first control signal from the first control module 1810a, and the second control signal from the second control module 1810b. Here, the output mediator 1840 selects one between the first control signal and the second control signal by using selection procedures described in detail in the next section. In this manner, the output mediator 1840 provides the selected one as a control signal to one or more actuators, e.g., 420a, 420b, 42c of the AV. Ways in which the output mediator 1840 either transmits, or instructs transmission of, the selected control signal to an appropriate actuator of the AV are described in detail in the next section.

The examples of systems 1300, 1600 and 2000, which implement synergistic redundancy, indicate that each scorer 1314a,b, 1614a,b, 1624a,b, 2034a,b, of respective AV operation subsystems 1310a,b, 1610a,b, 1620a,b, 2030a,b can adopt a solution proposed by another AV operation subsystems 1310b,a, 1610b,a, 1620b,a, 2030b,a if “convinced” of its superiority. As described above, the “convincing” includes performing cost function evaluations of the alternative solutions received from proposers 1312b,a, 1612b,a, 1622b,a, 2032b,a of the other AV operation subsystems side-by-side to the native solution received from the proposers 1312a,b, 1612a,b, 1622a,b, 2032a,b of its own AV operation subsystem. In this manner, each of the AV operation subsystems at the same stage of a pipeline performs better than if the AV operation subsystems could not evaluate each other's solution proposal. This leads to potentially higher failure tolerance.

In some implementations, it is desirable to increase the diversity of solutions at a particular stage of a pair of pipelines, which would be the equivalent of increasing the “creativity” of this stage. For instance, an AV system integrator may desire to provide a route to a controller module that has been selected based on generating, and then evaluating, N>2 different route proposals, e.g., where N=4. Various examples of redundant pipelines that achieve this goal are described below.

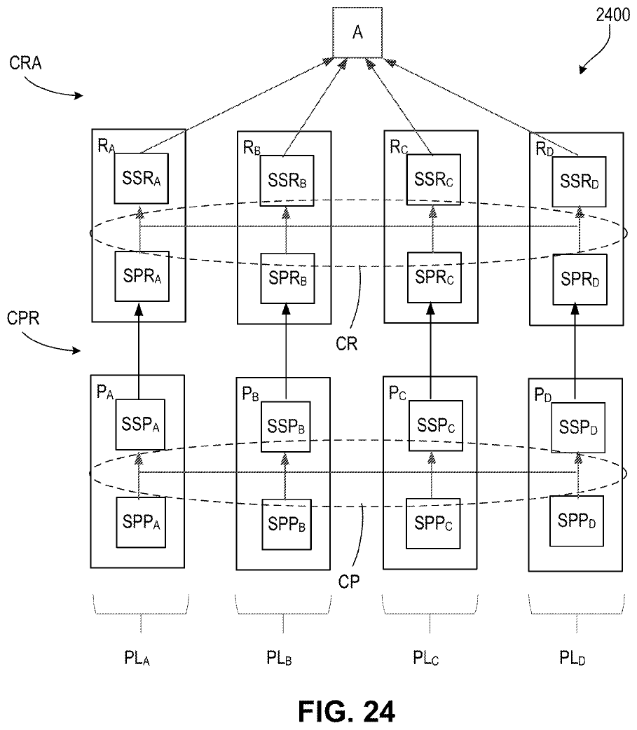

FIG. 24 shows a system 2400 which achieves the goal of generating and synergistically evaluating N different route proposals, by using N redundant pipelines PL_{A}, PL_{B}, PL_{C}, PL_{D} and an output mediator A. Here, each redundant pipeline PL_{A, B, C, D} includes a first stage implemented as a respective perception module P_{A, B, C, D}, and a second stage implemented as a respective planning module R_{A, B, C, D}. In the example illustrate in FIG. 24, each perception module P_{A,B,C,D} includes a respective solution proposer SPP_{A,B,C,D} and a respective solution scorer SSP_{A,B,C,D}. And each planning module R_{A,B,C,D} includes a respective solution proposer SPR_{A,B,C,D} and a respective solution scorer SSR_{A,B,C,D}. Note that, within the same pipeline PL_{A,B,C,D}, the solution scorer SSP_{A,B,C,D} of the perception module P_{A,B,C,D} communicates with the solution proposer SPR_{A,B,C,D} of the planning module R_{A,B,C,D} through a respective intra-stack connection CPR. Also note that the solution scorer SSR_{A, B, C, D} of the planning module R_{A, B, C, D} communicates with the output mediator A through a respective end-stack connection CRA. Moreover, the solution proposer SPPⱼ of each perception module Pⱼ communicates through an intra-inter-stack connection CP with the solution scorer SSPⱼ of the perception module Pⱼ to which it belongs and with respective solution scorers SSPk_{k≠j} of the remaining perception modules Pₖ, where j, k∈{A,B,C,D}. For instance, the solution proposer SPP_{A} communicates with the solution scorer SSP_{A} within the same pipeline PL_{A}, and with each of the solution scorers SSP_{B}, SSP_{C} and SSP_{D} across the redundant pipelines, PL_{B}, PL_{C} and PL_{D}, respectively. And so on. Also, the solution proposer SPRⱼ of each planning module Rⱼ communicates through another intra-inter-stack connection CR with the solution scorer SSRⱼ of the planning module Rⱼ to which it belongs and to respective solution scorers SSR_{k≠j} of the remaining planning modules Pₖ, where j, k∈{A,B,C,D}. For instance, the solution proposer SPR_{A} communicates with the solution scorer SSR_{A} within the same pipeline PL_{A}, and with each of the solution scorers SSR_{B}, SSR_{C} and SSR_{D} across the redundant pipelines, PL_{B}, PL_{C} and PL_{D}, respectively. And so on. Note that the intra-inter-stack connections CP, CR can be implemented as respective multi-lane buses, e.g., like the intra-inter-stack connections 1315, 1415, 1515, 1615, 1625, 1715, 1725, 1815, 1915, 2035, etc., described above.

Synergistic redundancy can be implemented at the perception stage of the system 2400 in the following manner. The solution proposer SPPⱼ of each perception module Pⱼ generates a respective world-view proposal based on available sensor signals from corresponding subsets of sensors associated with the system 2400 (not shown in FIG. 24.) The solution scorer SSPⱼ of each perception module P_{k≠j} receives, through the intra-inter-stack connection CP, respective world-view proposals from the solution proposer SPPⱼ of the perception module Pⱼ and from the solution proposers SPP_{k≠j} of the remaining perception modules Pₖ, where j, k∈{A, B, C, D}, and evaluates all the received proposals by using a perception-cost function associated with the solution scorer SSPⱼ. For instance, the solution scorer SSP_{A} of the perception module P_{A} evaluates the world view proposals received from the solution proposers SPP_{A}, SPP_{B}, SPP_{C}, SPP_{D} using a first perception-cost function, while the solution scorer SSP_{B} of the perception module P_{B} evaluates the world view proposals received from the solution proposers SPP_{A}, SPP_{B}, SPP_{C}, SPP_{D} using a second perception-cost function, and so on and so forth. The solution scorer SSPⱼ of each perception module Pⱼ selects as the winning world view the one from among the received world-view proposals which corresponds to the smallest value of the perception-cost function associated with the solution scorer SSPⱼ. For instance, the solution scorer SSP_{A} of the perception module P_{A} applies the first perception-cost function to the world view proposals received from the solution proposers SPP_{A}, SPP_{B}, SPP_{C}, SPP_{D} and can determine that a first perception-cost function value corresponding to the world view proposed by the solution proposer SPP_{B} is smaller than first perception-cost function values corresponding to each of the remaining world views proposed by the solution proposers SPP_{A}, SPP_{C}, SPP_{D}. For this reason, the solution scorer SSP_{A} of the perception module P_{A} will provide, through the intra-stack connection CPR of the pipeline PL_{A}, to the solution proposer SPR_{A} of the planning module R_{A}, the world view proposed by the solution proposer SPP_{B} of the perception module P_{B}. Note that this situation corresponds to the case where a “remote solution” wins over a “local solution” and other remote solutions. In the meantime, the solution scorer SSP_{B} of the perception module P_{B} applies the second perception-cost function to the world view proposals received from the solution proposers SPP_{A}, SPP_{B}, SPP_{C}, SPP_{D} and can determine that a second perception-cost function value corresponding to the world view proposed by the solution proposer SPP_{B} is smaller than second perception-cost function values corresponding to each of the remaining world views proposed by the solution proposers SPP_{A}, SPP_{C}, SPP_{D}. For this reason, the solution scorer SSP_{B} of the perception module P_{B} will provide, through the intra-stack connection CPR of the pipeline PL_{B}, to the solution proposer SPR_{B} of the planning module R_{B}, the world view proposed by the solution proposer SPP_{B} of the perception module P_{B}. Note that this situation corresponds to the case where the “local solution” wins over multiple “remote solutions.” And so on, and so forth.

Synergistic redundancy can be implemented at the planning stage of the system 2400 in the following manner. The solution proposer SPRⱼ of each planning module Rⱼ generates a respective route proposal based on a respective winning world view received, through the intra-stack connection CPR of the pipeline PLⱼ, from the solution scorer SSPⱼ of the perception module Pⱼ. The solution scorer SSRⱼ of each planning module Rⱼ receives, through the intra-inter-stack connection CR, respective route proposals from the solution proposer SPRⱼ of the planning module Rⱼ and from the solution proposers SPR_{k≠j} of the remaining planning modules Rₖ, where j, k∈{A,B,C,D}, and evaluates all the received proposals by using a planning-cost function associated with the solution scorer SSRⱼ. For instance, the solution scorer SSR_{A} of the planning module R_{A} evaluates the route proposals received from the solution proposers SPR_{A}, SPR_{B}, SPR_{C}, SPR_{D} using a first planning-cost function, while the solution scorer SSR_{B} of the planning module R_{B} evaluates the route proposals received from the solution proposers SPR_{A}, SPR_{B}, SPR_{C}, SPR_{D} using a second planning-cost function, and so on and so forth. The solution scorer SSRⱼ of each planning module Rⱼ selects as the winning route the one from among the received route proposals which corresponds to the smallest value of the planning-cost function associated with the solution scorer SSRⱼ. For instance, the solution scorer SSR_{A} of the planning module R_{A} applies the first planning-cost function to the route proposals received from the solution proposers SPR_{A}, SPR_{B}, SPR_{C}, SPR_{D} and can determine that a first planning-cost function value corresponding to the route proposed by the solution proposer SPR_{B} is smaller than first planning-cost function values corresponding to each of the remaining routes proposed by the solution proposers SPR_{A}, SPR_{C}, SPR_{D}. For this reason, the solution scorer SSR_{A} of the planning module R_{A} will provide, through the end-stack connection CRA corresponding to the pipeline PL_{A}, to the output mediator A, the route proposed by the solution proposer SPR_{B} of the planning module R_{B}. In the meantime, the solution scorer SSR_{B} of the planning module R_{B} applies the second planning-cost function to the route proposals received from the solution proposers SPR_{A}, SPR_{B}, SPR_{C}, SPR_{D} and can determine that a second planning-cost function value corresponding to the route proposed by the solution proposer SPR_{B} is smaller than second planning-cost function values corresponding to each of the remaining routes proposed by the solution proposers SPR_{A}, SPR_{C}, SPR_{D}. For this reason, the solution scorer SSR_{B} of the planning module R_{B} will provide, through the end-stack connection CRA corresponding to the pipeline PL_{B}, to the output mediator A, the route proposed by the solution proposer SPR_{B} of the planning module R_{B}. And so on, and so forth.

The output mediator A can implement one or more selection processes, described in detail in the next section, to select one of the routes provided by the pipelines PL_{A}, PL_{B}, PL_{C}, PL_{D}. In this manner, the output mediator A can provide to a controller module, or instruct provision to the controller module, a single route from among N=4 routes generated and evaluated within the redundant pipelines PL_{A}, PL_{B}, PL_{C}, PL_{D}.

In some cases, it may be too expensive to implement more than two multi-stage pipelines in order to provide a desired number of redundant solution proposals at a particular stage. For instance, an AV system integrator may require to keep the number of redundant pipelines to two, while desiring to provide a route to a controller module that has been selected based on generating, and then evaluating, N>2 different route proposals, e.g., N=4. Various examples of redundant pairs of pipelines that achieve this goal are described below.

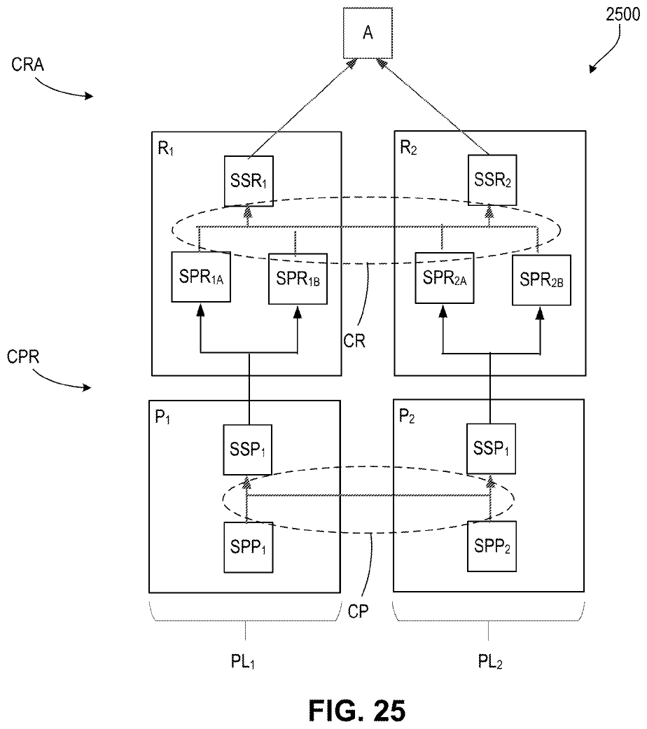

FIG. 25 shows a system 2500 which achieves the goal of generating, and synergistically evaluating, N different route proposals, by using a pair of redundant pipelines PL₁, PL₂ and an output mediator A, such that N₁ route proposals are provided by the first pipeline PL₁, and N₂ route proposals are provided by the second pipeline PL₂, where N₁+N₂=N. Here, each redundant pipeline PL_{1,2} includes a first stage implemented as a respective perception module P_{1,2}, and a second stage implemented as a respective planning module R_{1,2}. In the example illustrated in FIG. 25, each perception module P_{1,2} includes a respective solution proposer SPP_{1,2} and a respective solution scorer SSP_{1,2}. And each planning module R_{1,2} includes a respective number N_{1,2} of solution proposers SPR_{(1,2)i}, and a respective solution scorer SSR_{1,2}, where i∈{A, B, . . . }. In the example illustrated in FIG. 25, N₁=2 and N₂=2. Note that, within the same pipeline PL_{1,2}, the solution scorer SSP_{1,2} of the perception module P_{1,2} communicates with all N_{1,2} solution proposers SPR_{(1,2)i} of the planning module R_{1,2} through an intra-stack connection CPR of the pipeline PL_{1,2}. Also note that the solution scorer SSR_{1,2} of the planning module R_{1,2} communicates with the output mediator A through a respective end-stack connection CRA. Moreover, the solution proposer SPP_{1,2} of each perception module P_{1,2} communicates through an intra-inter-stack connection CP with the solution scorer SSP_{1,2} of the perception module P_{1,2} and with the solution scorer SSP_{2,1} of the other perception module P_{2,1}. Also, each solution proposer SPR_{(1,2)i} of each planning module R_{1,2} communicates through another intra-inter-stack connection CR with the solution scorer SSR_{1,2} of the planning module R_{1,2} and to the solution scorer SSR_{2,1} of the other planning module R_{2,1}.

Synergistic redundancy can be implemented at the perception stage of the system 2500 in the manner in which synergistic redundancy was implemented at the perception stage of the system 2400, except here N=2. Synergistic redundancy can be implemented at the planning stage of the system 2500 in the following manner. Each of the N₁ solution proposers SPR₁ᵢ of the planning module R₁ generates a respective route proposal based on a first world view received, through the intra-stack connection CPR of the pipeline PL₁, from the solution scorer SSP₁ of the perception module P₁, and each of the N₂ solution proposers SPR₂ᵢ of the planning module R₂ generates a respective route proposal based on a second world view received, through the intra-stack connection CPR of the pipeline PL₂, from the solution scorer SSP₂ of the perception module P₂. The solution scorer SSR_{1,2} of the planning module R_{1,2} receives, through the intra-inter-stack connection CR, respective route proposals from the N_{1,2} solution proposers SPR_{(1,2)i} of the planning module R_{1,2} and from the N_{2,1} solution proposers SPR_{(2,1)i} of the other planning module R_{2,1}, and evaluates all N=N₁+N₂ received proposals by using a planning-cost function associated with the solution scorer SSR_{1,2}. For instance, the solution scorer SSR₁ of the planning module R₁ evaluates the route proposals received from the first pipeline PL₁'s solution proposers SPR_{1A}, SPR_{1B} and from the second pipeline PL₂'s solution proposers SPR_{2A}, SPR_{2B} using a first planning-cost function, while the solution scorer SSR₂ of the planning module R₂ evaluates the route proposals received from the second pipeline PL₂'s solution proposers SPR_{2A}, SPR_{2B} and from the first pipeline PL₁'s solution proposers SPR_{1A}, SPR_{1B} using a second planning-cost function. The solution scorer SSRⱼ of each planning module Rⱼ selects as the winning route the one from among the received route proposals which corresponds to the smallest value of the planning-cost function associated with the solution scorer SSRⱼ. For instance, the solution scorer SSR₁ of the planning module R₁ applies the first planning-cost function to the route proposals received from the solution proposers SPR_{1A}, SPR_{1B}, SPR_{2A}, SPR_{2B} and can determine that a first planning-cost function value corresponding to the route proposed by the solution proposer SPR_{1B} is smaller than first planning-cost function values corresponding to each of the remaining routes proposed by the solution proposers SPR_{1A}, SPR_{2A}, SPR_{2B}. For this reason, the solution scorer SSR₁ of the planning module R₁ will provide, through the end-stack connection CRA corresponding to the pipeline PL₁, to the output mediator A, the route proposed by the solution proposer SPR_{1B} of the planning module R₁. Note that this situation corresponds to the case where a “local solution” wins over the other local solutions and over multiple “remote solutions.” In the meantime, the solution scorer SSR₂ of the planning module R₂ applies the second planning-cost function to the route proposals received from the solution proposers SPR_{1A}, SPR_{1B}, SPR_{2A}, SPR_{2B} and can determine that a second planning-cost function value corresponding to the route proposed by the solution proposer SPR_{1B} is smaller than second planning-cost function values corresponding to each of the remaining routes proposed by the solution proposers SPR_{1A}, SPR_{2A}, SPR_{2B}. For this reason, the solution scorer SSR₂ of the planning module R₂ will provide, through the end-stack connection CRA corresponding to the pipeline PL₂, to the output mediator A, the route proposed by the solution proposer SPR_{1B} of the planning module R₁. Note that this situation corresponds to the case where a “remote solution” wins over multiple “local solutions” and other remote solutions.

For the example illustrated in FIG. 25, the output mediator A can implement one or more selection processes, described in detail in the next section, to select one of the routes provided by the pair of redundant pipelines PL₁, PL₂. In this manner, the output mediator A can provide to a controller module a single route from among N=4 routes generated by, and evaluated within, the redundant pipelines PL₁, PL₂.

Note that in some implementations of the system 2500, the solution scorer SSR_{1,2} can use its local cost function to compare, and select a preferred one from among, the solutions proposed locally by the N_{1,2} local solution proposers SPR_{(1,2)i}. Subsequently, or concurrently, the solution scorer SSR_{1,2} can use its local cost function to compare, and select a preferred one from among, the solutions proposed remotely by the N_{2,1} remote solution proposers SPR_{(2,1)i}. Note that to perform the latter comparisons, the solution scorer SSR_{1,2} first translates and/or normalizes the received remote proposed solutions, so it can apply its local cost function to them. Next, the solution scorer SSR_{1,2} selects between the preferred locally proposed solution and the preferred remotely proposed solution as the one which has the smaller of the cost values evaluated based on the local cost function. By performing the selection in this manner, the solution scorer SSR_{1,2} compares among themselves scores of N_{2,1} proposed remote solutions that have gone through a translation/normalization operation, and only the best one of them is then compared to the best one of the N_{1,2} proposed native solutions that did not need to go through the translation/normalization operation. Thus, the number of direct comparisons between translated/normalized proposed remote solutions and proposed local solutions can be reduced to one.

In some implementations of the system 2500, the solution scorer SSR_{1,2} compares the two or more solutions proposed locally by the N_{1,2} local solution proposers SPR_{(1,2)i}, and the two or more solutions proposed remotely by the N_{2,1} remote solution proposers SPR_{(2,1)i} in the order in which they are received without first grouping them by provenance. Of course, the solution scorer SSR_{1,2} first translates/normalizes each of the remotely proposed solutions before it can apply the local cost functions to it. Here, the solution scorer SSR_{1,2} selects—between (i) the received proposed solution and (ii) the currently preferred proposed solution, the latter having resulted from the previous comparison between proposed solutions—a new preferred proposed solution as the one which has the smaller of the cost values evaluated based on the local cost function. By performing the selection in this manner, the solution scorer SSR_{1,2} can proceed immediately with the comparison of the most recently received proposed solution without having to wait for another solution of the same provenance, as described in the forgoing implementations.

In either of the foregoing implementations, by providing a solution scorer SSR_{1,2} of a planning module R_{1,2} (or in general of an AV operations subsystem) access to more than a single locally proposed solution, the solution scorer SSR_{1,2} can avoid a non-optimal solution without substantially reducing the speed of solution making for the overall system 2500.

In any of the comparisons described above, whether between two locally proposed solutions, two remotely proposed solutions, or a locally proposed solution and a remotely proposed solution, the solution scorer SSR_{1,2} selects the preferred one as the proposed solution having the smaller of the costs evaluated based on the local cost function if the difference exceeds a threshold, e.g., 10%, 5%, 1%, 0.5% or 0.1% difference. However, if the difference of the costs of the two proposed solutions does not exceed the threshold difference, then the solution scorer SSR_{1,2} is configured to compare and select between the proposed solutions based on an additional cost assessment that favors continuity with one or more prior solutions selected for operation of the AV. For example, if the local cost function value returned for a new proposed solution is lower by less than a threshold than the one returned for a “normally preferred” proposed solution, then the new proposed solution will be selected as the new preferred proposed solution only if it is different than the normally preferred proposed solution by a distance smaller than a predetermined distance. This avoids a jerk (non-smoothness) in AV operation when switching from the current operation to an operation corresponding to the winning solution. In some implementations, the solution scorer SSR_{1,2} can keep a track record of when one proposed solution was preferred over another and share that information around the fleet of AVs to track when the other solution may have been better after all.

In some cases, it may be sufficient to generate only one native solution per each of multiple redundant pipelines and implement synergistic redundancy as described above for the systems 1600, 2400, for instance. However, a more rich synergistic redundancy can be implemented by using multiple solution scorers per pipeline for a particular stage thereof to score a single native solution and a single remote solution generated at the particular stage. For example, for a pair of redundant pipelines, the first of the pipelines having N₁ solution scorers at a particular stage, can evaluate each of the native solution and the remote solution in N₁ ways, and the second of the pipelines having N₂ solution scorers at the particular stage, can evaluate each of the native solution and the remote solution in N₂ ways, as described below.

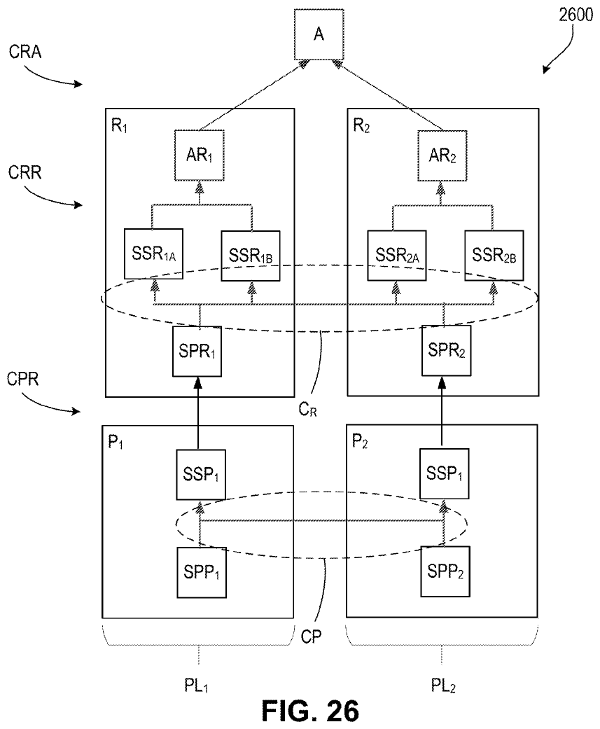

FIG. 26 shows a system 2600 which generates two different route proposal and synergistically evaluates them in N>2 ways, by using a pair of redundant pipelines PL₁, PL₂ and an output mediator A, such that a first route proposal is generated by the first pipeline PL₁ and a second route proposal is generated by the second pipeline PL₂, where the first and second route proposals are evaluated in N₁ ways by the first pipeline PL₁, and N₂ ways by the second pipeline PL₂. Here, each of the redundant pipelines PL_{1,2} includes a first stage implemented as a respective perception module P_{1,2}, and a second stage implemented as a respective planning module R_{1,2}. In the example illustrated in FIG. 26, each perception module P_{1,2} includes a respective solution proposer SPP_{1,2} and a respective solution scorer SSP_{1,2}. And each planning module R_{1,2} includes a respective solution proposer SPR_{1,2}, a respective number N_{1,2} of solution scorers SSR_{(1,2)i}, and a respective planning arbiter AR_{1,2}, where i∈{A, B, . . . }. In the example illustrated in FIG. 26, N₁=2 and N₂=2. Note that, within the same pipeline PL_{1,2}, the solution scorer SSP_{1,2} of the perception module P_{1,2} communicates with the solution proposer SPR_{1,2} of the planning module R_{1,2} through an intra-stack connection CPR of the pipeline PL_{1,2}. Within the planning module R_{1,2}, all N_{1,2} solution scorers SSR_{(1,2)i} communicate with the planning arbiter AR_{1,2} through an intra-module connection CRR. Also note that the planning arbiter AR_{1,2} of the planning module R_{1,2} communicates with the output mediator A through a respective end-stack connection CRA. Moreover, the solution proposer SPP_{1,2} of each perception module P_{1,2} communicates through an intra-inter-stack connection CP with the solution scorer SSP_{1,2} of the perception module P_{1,2} and with the solution scorer SSP_{2,1} of the other perception module P_{2,1}. Also, the solution proposer SPR_{1,2} of each planning module R_{1,2} communicates through another intra-inter-stack connection CR with each solution scorer SSR_{(1,2)i} of the planning module R_{1,2} and to each solution scorer SSR_{(2,1)i} of the other planning module R_{2,1}.

Synergistic redundancy can be implemented at the perception stage of the system 2600 in the manner in which synergistic redundancy was implemented at the perception stage of the system 2400, except here N=2. Synergistic redundancy can be implemented at the planning stage of the system 2600 in the following manner. The solution proposer SPR₁ of the planning module R₁ generates a first route proposal based on a first world view received, through the intra-stack connection CPR of the pipeline PL₁, from the solution scorer SSP₁ of the perception module P₁, and the solution proposer SPR₂ of the planning module R₂ generates a second route proposal based on a second world view received, through the intra-stack connection CPR of the pipeline PL₂, from the solution scorer SSP₂ of the perception module P₂.

Each of the N_{1,2} solution scorers SSR_{(1,2)i} of the planning module R_{1,2} receives, through the intra-inter-stack connection CR, the first route proposal from the solution proposer SPR₁ of the planning module R₁ and the second route proposal from the solution proposer SPR₂ of the planning module R₂, and evaluates both first and second route proposals by using a planning-cost function associated with the solution scorer SSR_{(1,2)i}. For instance, the solution scorer SSR_{1A} evaluates the first route proposal and the second route proposal using a first planning-cost function, and the solution scorer SSR_{1B} evaluates the first route proposal and the second route proposal using a second planning-cost function. Here, the first planning-cost function and the second planning-cost function may evaluate each of the first and second route proposals along different axes, e.g., safety, comfort, etc. Also, the solution scorer SSR_{2A} evaluates the first route proposal and the second route proposal using a third planning-cost function, and the solution scorer SSR_{2B} evaluates the first route proposal and the second route proposal using a fourth planning-cost function. Each solution scorer SSR_{(1,2)i} selects as the winning route the one from among the first and second route proposals which corresponds to the smallest value of the planning-cost function associated with the solution scorer SSR_{(1,2)i}. Here, the third planning-cost function and the fourth planning-cost function may evaluate each of the first and second route proposals along the same axis, but with different models, priors, etc.

For instance, the solution scorer SSR_{1A} applies the first planning-cost function to the first and second route proposals and can determine that a first planning-cost function value corresponding to the first route proposed by the solution proposer SPR₁ is smaller than first planning-cost function value corresponding to the second route proposed by the solution proposer SPR₂. For this reason, the solution scorer SSR_{1A} of the planning module R₁ will provide the first route, through the intra-module connection CRR of the planning module R₁, to the planning arbiter AR₁. In the meantime, the solution scorer SSR_{1B} applies the second planning-cost function to the first and second route proposals and can determine that a second planning-cost function value corresponding to the first route proposed by the solution proposer SPR₁ is smaller than second planning-cost function value corresponding to the second route proposed by the solution proposer SPR₂. For this reason, the solution scorer SSR_{1B} of the planning module R₁ will provide the first route, through the intra-module connection CRR of the planning module R₁, to the planning arbiter AR₁. The planning arbiter AR₁ can implement one or more selection processes, e.g., like the ones described in detail in the next section, to select one of the routes provided by the redundant solution scorers SSR_{1A}, SSR_{1B} of the planning module R₁. In the above described example situation, the solution scorers SSR_{1A}, SSR_{1B} provided the same route, so the planning arbiter AR₁ simply relays, through the end-stack connection CRA corresponding to the pipeline PL₁, the first route to the output mediator A. While these operations are performed at the pipeline PL₁, the solution scorer SSR_{2A} applies the third planning-cost function to the first and second route proposals and can determine that a third planning-cost function value corresponding to the second route proposed by the solution proposer SPR₂ is smaller than third planning-cost function value corresponding to the first route proposed by the solution proposer SPR₁. For this reason, the solution scorer SSR_{2A} of the planning module R₂ will provide the second route, through the intra-module connection CRR of the planning module R₂, to the planning arbiter AR₂. In the meantime, the solution scorer SSR_{2B} applies the fourth planning-cost function to the first and second route proposals and can determine that a fourth planning-cost function value corresponding to the first route proposed by the solution proposer SPR₁ is smaller than fourth planning-cost function value corresponding to the second route proposed by the solution proposer SPR₂. For this reason, the solution scorer SSR_{2B} of the planning module R₂ will provide the first route, through the intra-module connection CRR of the planning module R₂, to the planning arbiter AR₂. The planning arbiter AR₂ can implement one or more selection processes, e.g., like the ones described in detail in the next section, to select one of the routes provided by the redundant solution scorers SSR_{2A}, SSR_{2B} of the planning module R₂. In the above described situation, the solution scorers SSR_{2A}, SSR_{2B} provided different routes, so the planning arbiter AR₂ must first apply its own selection process, and then it can relay, through the end-stack connection CRA corresponding to the pipeline PL₂, the selected one between the first route and the second route to the output mediator A.

For the example illustrated in FIG. 26, the output mediator A can implement one or more selection processes, described in detail in the next section, to select one of the routes provided by the pair of redundant pipelines PL₁, PL₂. In this manner, the output mediator A can provide to a controller module a single route between the first and second routes generated within the redundant pipelines PL₁, PL₂, and evaluated N>2 ways within the redundant pipelines PL₁, PL₂.

The synergistic redundancy implemented in the examples of systems useable to operate an AV as described above corresponds to a plug-and-play architecture for the following reasons. As noted above, each of the AV operations subsystems described above include components that are either pure scorers, e.g., denoted above as X14, or pure proposers, e.g., denoted above as X12, where X∈{F, G, H, I, J, K}. This is in contrast with an AV operations subsystem having a solution proposer and a solution scorer which are integrated together, or a pipeline having two different AV operations subsystems integrated together within the pipeline. The aspect of using components that are either pure scorers or pure proposers for each AV operations subsystem allows using OEM components, i.e., AV operations subsystem (also referred to as modules) designed and/or fabricated by third parties. For instance, an AV system integrator need not fully understand the “under-the-hood” configuration of a third-party module as long as the third-party module is placed in a test pipeline integrated through the disclosed synergistic redundancy with one or more other pipelines which include trusted modules at the corresponding stage. In this manner, various situations can be tested, and the third-party module can be deemed useful and/or reliable if it contributes proposals which are being selected during cross-evaluations with a selection frequency that meets a target selection frequency. If, however, the selection frequency of the proposals contributed by the third-party module is not met during the disclosed cross-evaluations, then the third-party module can be removed from the test pipeline.

At an even more granular level, proposers (X12) can be designed and fabricated by any third party as long as the third-party proposers' union covers the use case. At the planning stage, examples of such proposers, which can be integrated in synergistically redundant AV operations systems like the ones described above, include third-party proposers for planning stereotypical plans, e.g., stop now, follow lane, follow vehicle ahead, etc. Other examples include third-party proposers for planning any ad-hoc heuristics to solve corner cases, for instance. A third-party proposer can be removed from an AV operations subsystem when it is detected that its proposals are not being selected often enough by one or more scorers—from the same AV operations subsystem or AV operations subsystems disposed at the same stage of other redundant pipelines—with which the third-party proposer communicates. The target selection frequency that must be met by the third-party proposer can be established based on performance of one or more currently used proposers. In this manner, the cross-evaluations implemented in the disclosed systems allow for the computation resources used by the “bad” proposer to be recovered by the AV system upon removal of the bad proposer.

The examples of systems 1300, 1600, 2000, 2400, 2500 and 2600 useable to operate an AV, each of which implementing synergistic redundancy, can potentially provide further advantages. Generating solution proposals (e.g., candidates) on multiple computation paths (e.g., pipelines) and/or scoring the generated solution proposals also on multiple computation paths ensures that independence of each assessment is preserved. This is so, because each AV operations subsystem adopts another AV operation subsystem's solution proposal only if such an alternative solution is deemed superior to its own solution proposal based on a cost function internal to the AV operations subsystem. Such richness of solution proposals potentially leads to an increase of overall performance and reliability of each path. By performing cross-stack evaluations of solution proposals at multiple stages, consensus on the best candidates, which will then be proposed to the output mediator, can be built early on in the process (at early stages). This in turn can reduce the selection burden on the output mediator.

Various selection procedures used by the output mediator 1340, 1640, A to select one output among respective outputs provided by two or more redundant pipelines are described next.

### Context Selective Modules

Referring to FIG. 13 (or 16, 20, 24, 25, 26), a system 1300 (or 1600, 2000, 2400, 2500, 2600) useable to operate an autonomous vehicle (AV) includes two or more different AV operations subsystems 1310a, 1310b (or 1620a, 1620b, R₁, R₂, . . . ) each of the two or more different AV operations subsystems 1310a,b (or 1620a, b, R_{1,2}) being redundant with another of the two or more different AV operations subsystems 1310b,a (or 1620b,a, R_{2,1}) and an output mediator 1340 (or 1640, A) coupled with the two or more different AV operations subsystems 1310a, 1310b (or 1620a, 1620b, R₁, R₂, . . . ) and configured to manage AV operation outputs from the two or more different AV operations subsystems 1310a, 1310b (or 1620a, 1620b, R₁, R₂, . . . ). Note that in the case of the system 1600, 2000, the two or more different AV operations subsystems 1620a, 1620b, with which the output mediator 1640 (or R₁, R₂, . . . with which the output mediator A) is coupled correspond to the last stage of the redundant pipelines 1602a, 1602b (or PL₁, PL₂, . . . )

In each of the examples described in the previous section, the output mediator 1340 (or 1640, or A) is configured to selectively promote a single one of the two or more different AV operations subsystems 1310a, 1310b (or 1620a, 1620b, or R₁, R₂, . . . ) to a prioritized status based on current input data compared with historical performance data for the two or more different AV operations subsystems 1310a, 1310b (or 1620a, 1620b, or R₁, R₂, . . . ). For example, one redundant subsystem may be designed for handling highway driving and the other for urban driving; either of the redundant subsystems may be prioritized based on the driving environment. Once promoted to a prioritized status, an AV operations module 1310a,b (or 1620a,b or R_{1,2}) has its output favored over outputs of remaining AV operations subsystems 1310b,a (or 1620b,a or R_{2,1}.) In this manner, the output mediator 1340 (or 1640) operates as a de facto AV operations arbitrator that selects one AV operation output received from an AV operations subsystem 1310a,b (or 1620a,b, or A) over all other outputs received from the remaining AV operations subsystems 1310b,a (or 1620b,a, R_{2,1}).

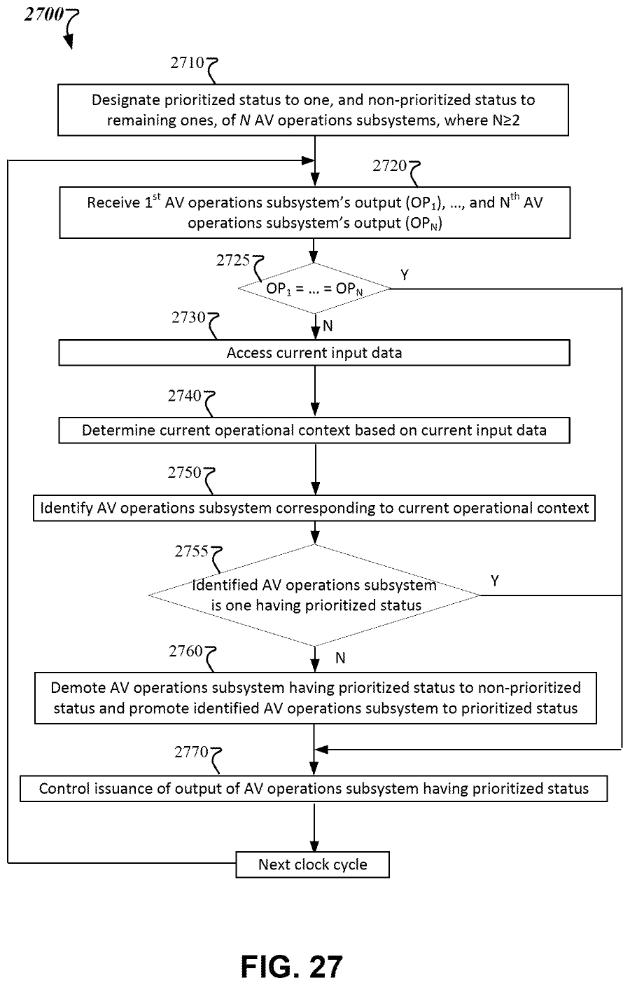

FIG. 27 is a flow chart of an example of a process 2700 used by an output mediator coupled with N different AV operations subsystems for managing AV operation outputs, denoted OP₁, OP₂, . . . , OP_{N}, from the N different AV operations subsystems, where N≥2. The process 2700 can be performed by output mediator 1340, 1640, or A of corresponding example systems 1300, 1600, 2000, 2500 or 2600, in which N=2, or 2400, in which N=4.

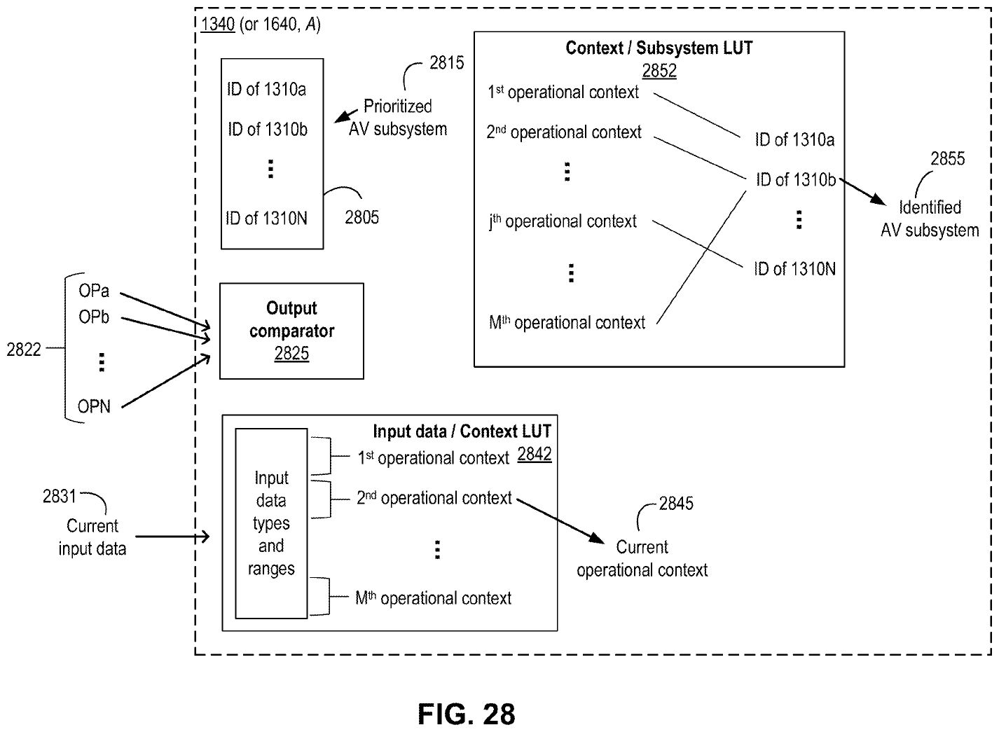

At 2710, the output mediator designates prioritized status to one, and non-prioritized status to remaining ones, of N different AV operations subsystems. This operation is performed at the beginning of the process 100, e.g., when the output mediator is powered ON, reset, or patched with upgraded software, etc., to assign initial statuses to each of the N different AV operations subsystems with which the output mediator communicates. In the example illustrated in FIG. 28, the output mediator 1340 (or 1640, A) has access to an array 28-05 of AV operations subsystem identifiers (IDs) of the N different AV operations subsystems 1310a, 1310b, . . . , FIG. 110N (or 1620a, 1620b, . . . , 1620N, or R₁, R₂, . . . ) Once it has designated prioritized status to one of the N different AV operations subsystems 1310a, 1310b, . . . , 1310N, e.g., to 1310b, the output mediator 1340 uses a priority pointer to point to the ID of the AV operations subsystem having the prioritized status 28-15, and thus to keep track of the fact that, in this example, it is 1310b who has prioritized status, and not another one from the remaining AV operations subsystems 1310a, . . . , 1310N.

Referring again to FIG. 27, at 2720, the output mediator receives N outputs from the N different AV operations subsystems, respectively, i.e., it receives the 1^{st} AV operations subsystem's output OP₁, . . . , and the N^{th} AV operations subsystem's output OP_{N}. In the example system 1400, which includes two redundant perception modules 1410a, 1410b, the output mediator 1440 receives two versions of the world view 1416a, 1416b. In the example system 1500 (or 1700) which includes two redundant planning modules 1510a, 1510b, (or 1720a, 1720b) the output mediator 1540 (or 1740) receives two versions of the route 1414a, 1414b (or 1714a, 1714b.) In each of the example systems 2500 or 2600, which includes two redundant planning modules R₁, R₂, the output mediator A also receives two versions of the route. However, in the example system 2400, which includes four redundant planning modules R₁, R₂, R₃, R₄, the output mediator A receives four versions of the route. Further in each of the example systems 1800, 1900 or 2100, which includes two redundant control modules 1810a, 1810b, the output mediator 1840 receives two versions of the control signal for controlling the steering actuator 420a, the throttle actuator 420b, and/or the brake actuator 420c.

At 2725, the output mediator (e.g., 1340, or 1640, A) determines whether the 1^{st} AV operations subsystem, . . . , and the N^{th} AV operations subsystem, each provided the same output OP. Equivalently, the output mediator determines, at 2725, whether the Pt AV operations subsystem's output OP₁, . . . , and the N^{th} AV operations subsystem's output OP_{N} are equal to each other.

Note that because the systems described in the previous section, e.g., 1300, 1600, 2000, 2400, 2500, 2600, have implemented synergistic redundancy, the N AV operations subsystems disposed at same stage of redundant pipelines are configured to evaluate each other's proposed solutions. For this reason, it is likely that a particular solution proposed by one of the N AV operations subsystems will be adopted independently by, and output from, all N AV operations subsystems. In such a case, when it receives the same output OP from all N AV operations subsystems, the output mediator will skip the set of operations 2730 to 2760, and thus save the computation resources that would have been used to perform the skipped operations.

In the example illustrated in FIG. 28, the output mediator 1340 (or 1640, A) uses an output comparator 2825 to compare the received AV operations subsystem outputs 2822.

In some implementations, the output comparator 2825 will compare the received AV operations subsystem outputs 2822 by comparing their respective provenance indicators. Here, the solution proposers 1312a,b, 1622a,b, SPR_{A,B,C,D} mark their respective solution proposals with a solution identifier indicating the ID of the AV operations subsystem to which it belongs. For instance, a solution proposed by the solution proposal 1312a will be marked with a provenance indicator specifying that the solution originated at the AV operations subsystem 1310a, while the alternative solution proposed by the solution proposal 1312b will be marked with a provenance indicator specifying that the solution originated at the redundant AV operations subsystem 1310b. In this manner, each of the Pt AV operations subsystem's output OP₁, . . . , and the N^{th} AV operations subsystem's output OP_{N} received by the output mediator will carry a respective provenance indicator identifying the AV operations subsystem where it originated. Thus, in these implementations, the output comparator 2825 of the output mediator will simply check the respective provenance indicators of the received AV operations subsystem outputs 2822 to determine whether they are the same, or at least one of them is different from the other. For example, if the output mediator A determines that each of the four routes received from the redundant planning modules R_{A}, R_{B}, R_{C}, R_{D} carries the same provenance indicator, e.g., identifying the planning module R_{B}, then the output mediator A treats the four routes as one and the same route, here the route that originated at the planning module R_{B} and was adopted by all four planning modules R_{A}, R_{B}, R_{C}, R_{D}. As another example, if the output mediator A determines that at least one of the four routes received from the redundant planning modules R_{A}, R_{B}, R_{C}, R_{D} carries a provenance indicator different from the other provenance indicators, then the output mediator A treats that route as being different from the other three routes.

In some implementations, the output comparator 2825 will compare the received AV operations subsystem outputs 2822 by evaluating relative distances between the outputs. If a distance between the i^{th} AV operations subsystem's output OPᵢ and the j^{th} AV operations subsystem's output OPⱼ is larger than a threshold distance, then these outputs are considered to be different, OPᵢ≠OPⱼ, where i≠j and i, j=1 . . . N. Else, if the distance between the i^{th} AV operations subsystem's output OPᵢ and the j^{th} AV operations subsystem's output OPⱼ is smaller than, or equal to, the threshold distance, then these outputs are considered to be the same or equal, OPᵢ=OPⱼ. In the example system 1400, the output mediator 1440 receives from the two redundant perception modules 1410a, 1410b, the two world views 1416a, 1416b. Here, the output mediator 1440 will treat the two world views 1416a, 1416b to be the same if a distance between the world views is smaller than, or equal to, a threshold world-view distance, or different if the distance between the world views is larger than the threshold world-view distance. In the example system 1500, the output mediator 1540 receives from the two redundant planning modules 1510a, 1510b, the two routes 1514a, 1514b. Here, the output mediator 1540 will treat the two routes 1514a, 1514b to be the same if a distance between the routes is smaller than, or equal to, a threshold route distance, or different if the distance between the routes is larger than the threshold route distance.

If, at 2725Y, the output mediator determines that the 1^{st} AV operations subsystem's output OP₁, . . . , and the N^{th} AV operations subsystem's output OP_{N} are equal to each other, then at 2770, the output mediator controls issuance of the output of the AV operations subsystem which has the prioritized status. Various ways in which the output mediator controls the issuance of the output of the AV operations subsystem, which has the prioritized status, are described in detail below.

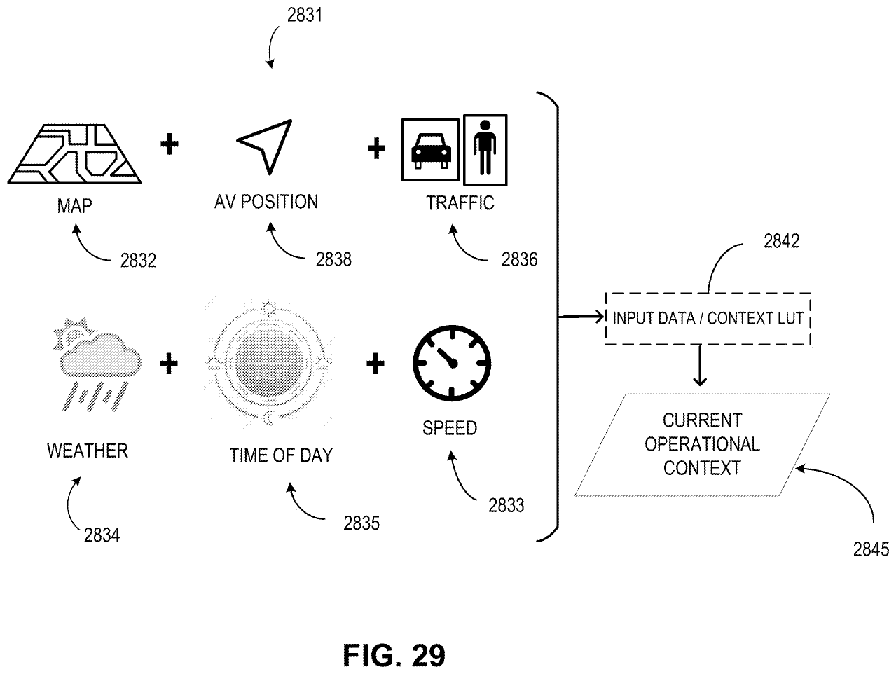

If however, at 2725N, the output mediator determines that at least one of the 1^{st} AV operations subsystem's output OP₁, . . . , and the N^{th} AV operations subsystem's output OP_{N} is different from the remaining ones, then at 2730, the output mediator accesses current input data. FIG. 28 shows that the output mediator 1340 (or 1640, A) has access to current input data L231. FIG. 29 shows that the current input data 28-31 includes map data 28-32, e.g., stored by the database module 410 or a remote geo-position system; position data 28-38 provided by the localization module 408, for instance; traffic data 28-36 provided by the perception module 402, for instance; weather data 28-34 provided by local sensors 121 or remote weather monitoring/forecast systems; time of day data 28-35 provided by a local or remote clock; and speed data 28-33 provided by a speedometer of the AV.

At 2740, the output mediator determines a current operational context based on the current input data. For instance, the output mediator can use a mapping of input data to operational contexts to (i) identify a portion of input data of the mapping that encompasses the current input data, and (ii) determine the current operational context as an operational context mapped to the identified input data portion. The mapping of input data to operational contexts can be implemented as a look-up-table (LUT), for instance.

Referring now to both FIGS. 28 and 29, the LUT used by the output mediator 1340 (or 1640, A) for this purpose is implemented as an input data/context look-up-table (LUT) 2842. The input data/context LUT 2842 includes M predefined operational contexts, and two or more groupings of input data types and ranges, the groupings being mapped to the M predefined operational contexts, where M≥2. For example, a grouping which includes position data 2838 and map data 2832 corresponding to freeways, and speed data 2833 in the range of 45-75 mph is mapped to an operational context called “freeway driving.” As another example, a grouping which includes position data 2838 and map data 2832 corresponding to surface streets, and speed data 2833 in the range of 5-45 mph is mapped to an operational context called “surface-street driving.” As yet another example, a grouping which includes traffic data 2838 corresponding to low- to medium-traffic, and time of day data 2835 in the range of 19:00 h to 06:00 h is mapped to an operational context called “night-time driving.” As yet another example, a grouping which includes traffic data 2838 corresponding to medium-to high-traffic, and time of day data 2835 in the range of 06:00 h to 19:00 h is mapped to an operational context called “day-time driving.” As yet another example, a grouping which includes weather data 2834 corresponding to rain, sleet or snow, and speed data 2833 in the range of 5-30 mph is mapped to an operational context called “inclement-weather driving.” As yet another example, a grouping which includes weather data 2834 corresponding to lack of precipitation, and speed data 2833 in the range of 30-75 mph is mapped to an operational context called “fair-weather driving.” Many other predefined operational context can be defined in the input data/context LUT 2842.

The output mediator 1340 (or 1640, A) identifies which of the groupings of input data types and ranges included in the input data/context LUT 2842 encompasses the current input data 2831. For instance, if the current input data 2831 includes position data 2838 and map data 2832 indicating that the AV is currently located on the 405 SANTA MONICA FREEWAY and the AV speed is 55 mph, then the output mediator 1340 (or 1640) identifies the input data/context LUT 2842's grouping of input data types and ranges that encompasses the current input data 2831 as the one which includes position data 2838 and map data 2832 corresponding to freeways, and speed data 2833 in the range of 45-75 mph. By identifying the grouping of the input data/context LUT 2842 that encompasses the current input data 2831, the output mediator 1340 (or 1640, A) determines a current operational context 2845 of the AV, as the operational context mapped to the identified grouping. In the foregoing example, by identifying the grouping which includes position data 2838 and map data 2832 corresponding to freeways, and speed data 2833 in the range of 45-75 mph, the output mediator 1340 (or 1640, A) determines that the current operational context 2845 of the AV is “freeway driving.” Once the output mediator 1340 (or 1640, A) determines the current operational context 2845 in this manner, it can use a context pointer which points to an identifier of the current operational context 2845, to keep track of the fact that, in this example, it is “freeway driving” that is the current operational context, and not another one from the remaining operational contexts referenced in the input data/context LUT 2842.

At 2750, the output mediator identifies the AV operations subsystem corresponding to the current operational context. For instance, the output mediator can use a mapping of operational contexts to IDs of AV operations subsystems to (i) select an operational context of the mapping that matches the current operational context, and (ii) identify the AV operations subsystem corresponding to the current operational context as an AV operations subsystem having an ID mapped to the selected operational context. The mapping of operational contexts to IDs of AV operations subsystems represents historical performance data of the N different AV operations subsystems.

In some implementations, the output mediator uses machine learning to determine the mapping of specific operational contexts to IDs of AV operations subsystems. For instance, a machine learning algorithm operates on AV operations subsystems' historical data to determine one or more specific operational contexts for the AV in which each one of its N different AV operations subsystems performs differently, better or worse, than remaining ones of the N different AV operations subsystems. In some implementations, the historical data include data that is collected on the current trip and the determination of the mapping of operational contexts to IDs of AV operations subsystems is run in real time. In some implementations, the historical data include data that was collected on previous trips and the determination of the mapping of operational contexts to IDs of AV operations subsystems was run, e.g., overnight, before the current trip.

In some implementations, the machine learning algorithm maps an AV operations subsystem to a specific operational context only after substantial improvement is determined for the AV operations subsystem. For instance, the AV operations subsystem will be mapped to the specific operational context only once the historical performance data shows a substantially better performance in the specific operational context. As an example, if a particular AV operations subsystem has, 52 out of 100 times, better performance than the AV operations subsystem preferred for the specific operational context, then the particular AV operations subsystem will not be promoted to preferred status for this specific operational context. For example, the performance improvement must be 20% higher for the change in preferred status to be implemented. As such, if the particular AV operations subsystem has, 61 out of 100 times, better performance than the AV operations subsystem preferred for the specific operational context, then the particular AV operations subsystem will be promoted to preferred status for this specific operational context. The performance improvement is measured in terms of the solutions provided by the particular AV operations subsystem having costs that are lower by a predetermined delta than solutions provided by a previously preferred AV operations subsystem, but also in terms of distances between the solutions provided by the particular AV operations subsystem and solutions provided by the previously preferred AV are less than a predetermined difference.

The results of the determination of the mapping of operational contexts to IDs of AV operations subsystems are shared across a fleet of AVs. For instance, the machine learning algorithm operates on historical performance data relating to use of the N different AV operations subsystems in different AVs in a fleet of AVs. The results obtained by the machine learning algorithm in this manner can be shared with other AVs of the fleet either directly, e.g., through ad-hoc communications with AVs that are in the proximity of each other, or through a central control system for coordinating the operation of multiple AVs, e.g., like the one described above in connection with FIG. 2. By sharing the results of determinations of N different AV operations subsystems across a fleet of AVs, individual AV performance can be improved by using analyses of data spanning a fleet of AVs using the same subsystems.

The mapping of operational contexts to IDs of AV operations subsystems can be implemented as another LUT, for instance. Referring again to FIG. 28, the other LUT used by the output mediator 1340 (or 1640, A) for this purpose is implemented as a context/subsystem LUT 2852. The context/subsystem LUT 2852 includes N AV operations subsystem IDs, and M predefined operational contexts, the N IDs being mapped to the M operational contexts, where M, N≥2. Note that in this example context/subsystem LUT 2852 shown in FIG. 28, an AV operations subsystem ID is mapped to one or more of the M operational contexts, while an operational context has a single AV operations subsystem ID mapped to it. For example, the ID of AV operations subsystem 1310a is mapped to the 1^{st} operational context, e.g., “freeway driving,” while the ID of AV operations subsystem 1310N is mapped to the j^{th} operational context, e.g., “night-time driving”. As another, example, the ID of AV operations subsystem 1310b is mapped to the 2^{nd} operational context, e.g., “surface-street driving,” and to the operational M^{th} context, e.g., “inclement-weather driving.” With reference to FIG. 24, the ID of the planning module R_{A} can be mapped to an operational context “freeway, fair-weather driving,” the ID of the planning module R_{B} can be mapped to another operational context “freeway, inclement-weather driving,” the ID of the planning module R_{C} can be mapped to yet another operational context “surface-street, fair-weather driving,” and the ID of the planning module R_{D} can be mapped to yet another operational context “surface-street, inclement-weather driving.” In this example, the ID of the planning module R_{D} can be mapped, at the same time, to the operational context “heavy-traffic driving,” for instance.

The output mediator 1340 (or 1640) selects the operational context included in the context/subsystem LUT 2852 that matches the current operational context 2845. For instance, if the current operational context 2845 is “surface-street driving,” then the output mediator 1340 (or 1640, A) selects the 2^{nd} operational context, which is labeled “surface-street driving”, from among the operational contexts included in the context/subsystem LUT 2852. By selecting the operational context included in the context/subsystem LUT 2852 that matches the current operational context 2845, the output mediator 1340 (or 1640, A) identifies an ID of an AV operations subsystem 2855, as the ID of the AV operations subsystem mapped to the selected operational context, and, thus, identifies the mapped AV operations subsystem 2855 as corresponding to the current operational context 2845. In the foregoing example, by selecting the 2^{nd} operational context included in the context/subsystem LUT 2852, the output mediator 1340 (or 1640, A) identifies the ID of the AV operations subsystem 1310b from among the IDs of the AV operations subsystems 1310a, 1310b, . . . , 1310N, and, thus, identifies the AV operations subsystem 1310b as corresponding to “surface-street driving.” Once the output mediator 1340 (or 1640, A) identifies the AV operations subsystem 2855 in this manner, it can use a subsystem pointer which points to an identifier of the AV operations subsystem 2855, to keep track of the fact that, in this example, it is 1310b that is the identified AV operations subsystem, and not another one from the remaining AV operations subsystems 1310a, . . . , 1310N referenced in the context/subsystem LUT 2852.

At 2755, the output mediator verifies whether the identified AV operations subsystem is the AV operations subsystem having prioritized status. In the example illustrated in FIG. 28, the output mediator 1340 (or 1640, A) can determine that the ID of the AV operations subsystem 2855 from the context/subsystem LUT 2852 corresponding to the current operational context 2845 is the same as the ID of the AV operations subsystem having the prioritized status 2815, and, thus, verifies that the identified AV operations subsystem 2855 has prioritized status. Or, the output mediator 1340 (or 1640) can determine that the ID of the AV operations subsystem 2855 from the context/subsystem LUT 2852 corresponding to the current operational context 2845 is different from the ID of the AV operations subsystem having the prioritized status 2815, and, thus, verifies that the identified AV operations subsystem has non-prioritized status.

If, at 2755Y, the output mediator determines that the identified AV operations subsystem is the AV operations subsystem having prioritized status, then at 2770 the output mediator controls issuance of the output of the AV operations subsystem which has the prioritized status. Various ways in which the output mediator controls the issuance of the output of the AV operations subsystem, which has the prioritized status, is described in detail below.

If however, at 2755N, the output mediator determines that the identified AV operations subsystem is different from the AV operations subsystem having prioritized status, then, at 2760, the output mediator demotes the AV operations subsystem having prioritized status to non-prioritized status, and promotes the identified AV operations subsystem to prioritized status. In the example illustrated in FIG. 28, the output mediator 1340 (or 1640, A) redirects the priority pointer from pointing to the ID of the AV operations subsystem 2815, which had prioritized status prior to being demoted at 2755N, to pointing to the ID of the AV operations subsystem 2855, which has prioritized status since being promoted, at 2755N.

In this manner, in some implementations, the output mediator, e.g., 1340 or 1640, A, promotes an AV operations subsystem based on a type of a street on which the AV currently is. For instance, the output mediator is configured to selectively promote the identified AV operations subsystem 2855 from among the N different AV operations subsystems to the prioritized status based on the following two factors. The first factor is the current input data 2831 indicates (based on the input data/context LUT 2842) a current operational context 2845 is either city streets or highway driving conditions. The second factor is the historical performance data, represented in the form of the context/subsystem LUT 2852, indicates that the identified AV operations subsystem 2855 performs better in the current operational context 2845 than remaining ones of the N different AV operations subsystems.

In some implementations, the output mediator, e.g., 1340 or 1640, A, promotes an AV operations subsystem based on traffic currently experienced by the AV. For instance, the output mediator is configured to selectively promote the identified AV operations subsystem 2855 from among the N different AV operations subsystems to the prioritized status based on the following two factors. The first factor is the current input data 2831 indicates (based on the input data/context LUT 2842) a current operational context 2845 involves specific traffic conditions. The second factor is the historical performance data, represented in the form of the context/subsystem LUT 2852, indicates that the identified AV operations subsystem 2855 performs better in the current operational context 2845 than remaining ones of the N different AV operations subsystems.

In some implementations, the output mediator, e.g., 1340 or 1640, A, promotes an AV operations subsystem based on weather currently experienced by the AV. For instance, the output mediator is configured to selectively promote the identified AV operations subsystem 2855 from among the N different AV operations subsystems to the prioritized status based on the following two factors. The first factor is the current input data 2831 indicates (based on the input data/context LUT 2842) a current operational context 2845 involves specific weather conditions. The second factor is the historical performance data, represented in the form of the context/subsystem LUT 2852, indicates that the identified AV operations subsystem 2855 performs better in the current operational context 2845 than remaining ones of the N different AV operations subsystems.

In some implementations, the output mediator, e.g., 1340 or 1640, A, promotes an AV operations subsystem based on the time of day when the AV is currently operated. For instance, the output mediator is configured to selectively promote the identified AV operations subsystem 2855 from among the N different AV operations subsystems to the prioritized status based on the following two factors. The first factor is the current input data 2831 indicates (based on the input data/context LUT 2842) a current operational context 2845 is a particular time of day. The second factor is the historical performance data, represented in the form of the context/subsystem LUT 2852, indicates that the identified AV operations subsystem 2855 performs better in the current operational context 2845 than remaining ones of the N different AV operations subsystems.

In some implementations, the output mediator, e.g., 1340 or 1640, A, promotes an AV operations subsystem based on the current speed of the AV. For instance, the output mediator is configured to selectively promote the identified AV operations subsystem 2855 from among the N different AV operations subsystems to the prioritized status based on the following two factors. The first factor is the current input data 2831 indicates (based on the input data/context LUT 2842) a current operational context 2845 involves specific speed ranges. The second factor is the historical performance data, represented in the form of the context/subsystem LUT 2852, indicates that the identified AV operations subsystem 2855 performs better in the current operational context 2845 than remaining ones of the N different AV operations subsystems.

Then, at 2770, the output mediator controls the issuance of the output of the AV operations subsystem which has the prioritized status. First, note that the process 2700 reaches operation 2770 after performing either one of operations 2725Y, 2755Y or 2760. That is, 2770 is performed by the output mediator upon confirming that the AV operations subsystem's output to be provided down-stream from the output mediator was received, at 2720, from the AV operations subsystem which has prioritized status, now at 2770, i.e., in the current operational context.

In some implementations, at 2770, the output mediator (e.g., 1340 or 1640, A) instructs the prioritized AV operations subsystem (e.g., 2815) to provide, down-stream therefrom, its AV operation output directly to the next AV operations subsystem or to an actuator of the AV. Here, the output mediator does not relay the prioritized AV operations subsystem's output to its destination, instead it is the prioritized AV operations subsystem itself that does so. In the example system 17, once the output mediator 1740 has confirmed that the planning module 1720b has prioritized status in the current operational context, the output mediator 1740 instructs the planning module 1720b to provide, down-stream to the control module 406, the planning module 1720b′ route 1714b.

In other implementations, at 2770, it is the output mediator (e.g., 1340 or 1640, A) itself that provides, down-stream to the next AV operations subsystem or to an actuator of the AV, the prioritized AV subsystem (e.g., 2815)'s output, which was received by the output mediator, at 2720. In the example system 17, once the output mediator 1740 has confirmed that the planning module 1720b has prioritized status in the current operational context, the output mediator 1740 relays, down-stream to the control module 406, the planning module 1720b′ route 1714b.

The sequence of operations 2720 through 2770 is performed by the output mediator (e.g., 1340, or 1640, A) in each clock cycle. As such, these operations are performed iteratively during future clock cycles. By performing the process 2700 in this manner, the AV operation performance of the system 1300 (or 1600, 2000, etc.) will be improved by performing context sensitive promotion, e.g., by actively adapting to driving context.

### Redundant Control Systems

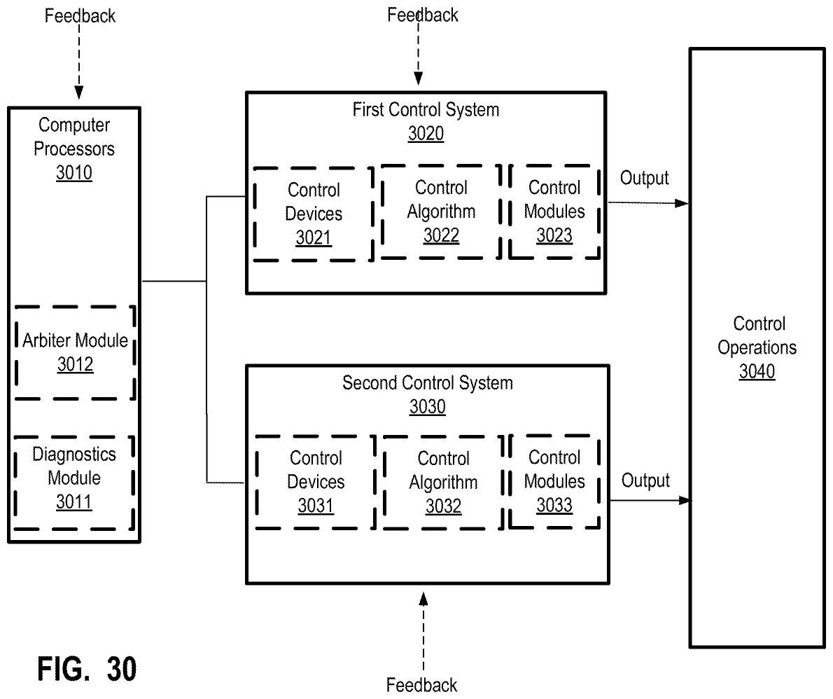

FIG. 30 shows a redundant control system 3000 for providing redundancy in control systems for an AV. AVs, such as the AV 100 of FIG. 1, may include the redundant control system 3000. The redundant control system 3000 includes computer processors 3010, a first control system 3020, and a second control system 3030. In an embodiment, the computer processors 3010 include only one processor. In an embodiment, the computer processors 3010 include more than one processors. The computer processors 3010 are configured to algorithmically generate control actions based on both real-time sensor data and prior information. In an embodiment, the computer processors 3010 are substantially similar to the computer processors 146 referenced in FIG. 1. The computer processors 3010 may include a diagnostics module 3011 and an arbiter module 3012.

In an embodiment, the first control system 3020 and the second control system 3030 include control modules 3023, 3033. In an embodiment, the control modules 3023, 3033 are substantially similar to the control module 406 described previously with reference to FIG. 4. In an embodiment, control modules 3023, 3033 include controllers substantially similar to the controller 1102 described previously with reference to FIG. 11. In an embodiment, one control system uses the data output by the other control system, e.g., as previously described in reference to FIGS. 13-29.

The first control system 3020 and the second control system 3030 are configured to receive and act on operational commands from the computer processors 3010. However, the first control system 3020 and the second control system 3030 may include various other types of controllers, such as door lock controllers, window controllers, turn-indicator controllers, windshield wiper controllers, and brake controllers.

The first control system 3020 and the second control systems 3030 also include control devices 3021, 3031. In an embodiment, the control devices 3021, 3031 facilitate the control systems' 3020, 3030 ability to affect the control operations 3040. Examples of control devices 3021, 3031 include, but are not limited to, a steering mechanism/column, wheels, axels, brake pedals, brakes, fuel systems, gear shifter, gears, throttle mechanisms (e.g., gas pedals), windshield wipers, side-door locks, window controls, and turn-indicators. In an example, the first control system 3020 and the second control system 3030 include a steering angle controller and a throttle controller. The first control system 3020 and the second control system 3030 are configured to provide output that affects at least one control operation 3040. In an embodiment, the output is data that is used for acceleration control. In an embodiment, the output is data used for steering angle control. In an embodiment, the control operations 3040 includes affecting the direction of motion of the AV 100. In an embodiment, the control operations 3040 includes changing the speed of the AV 100. Examples of control operations include, but are not limited to, causing the AV 100 to accelerate/decelerate and steering the AV 100.

In an embodiment, the control systems 3020, 3030 affects control operations 140 that include managing change in speeds and orientations of the AV 100. As described herein, speed profile relates to the change in acceleration or jerk to cause the AV 100 to transition from a first speed to at least a second speed. For example, a jagged speed profile describes rapid change in the speed of the AV 100 via acceleration or deceleration. An AV 100 with a jagged speed profile transitions between speeds quickly and therefore, may cause a passenger to experience an unpleasant/uncomfortable amount of force due to the rapid acceleration/deceleration. Furthermore, a smooth speed profile describes a gradual change in the speed of the AV 100 to transition the AV 100 from a first speed to a second speed. A smooth speed profile ensures that the AV 100 transitions between speeds at a slower rate and therefore, reduces the force of acceleration/deceleration experienced by a passenger. In an embodiment, the control systems 3020, 3030 control various derivatives of speed over time, including acceleration, jerk, jounce, snap, crackle, or other higher-order derivatives of speed with respect to time, or combinations thereof.

In an embodiment, the control systems 3020, 3030 affects the steering profile of the AV 100. Steering profile relates to the change in steering angle to orient the AV 100 from a first direction to a second direction. For example, a jagged steering profile includes causing the AV 100 to transition between orientations at higher/sharper angles. A jagged steering profile may cause passenger discomfort and may also lead to increased probability of the AV 100 tipping over. A smooth steering profile includes causing the AV 100 to transition between orientations at lower/wider angles. A smooth steering profile leads to increased passenger comfort and safety while operating the AV 100 under varied environmental conditions.

In an embodiment, the first control system 3020 and the second control system 3030 include different control devices 3021, 3031 that facilitate the control systems' 3020, 3030 ability to affect substantially similar control operations 3040. For example, the first control system 3020 may include a throttle mechanism, a brake pedal, and a gear shifter to affect throttle control operations, while the second control system 3030 may include the fuel systems, brakes and gears to affect throttle control operations. In an embodiment, the steering mechanism is a steering wheel. However, the steering mechanism can be any mechanism used to steer the direction of the AV 100, such as joysticks or lever steering apparatuses. For steering the AV 100, the first control system 3020 may include the steering mechanism of the AV 100, while the second control system 3030 may include the wheels or axels. Thus, the first control system 3020 and the second control system 3030 may act together to allow for two redundant control systems that can both perform the same control operations (e.g., steering, throttle control, etc.) while controlling separate devices. In an embodiment, the first control system 3020 and the second control system 3030 affect the same control operations while including the same devices. For example, the first control system 3020 and the second control system 3030 may both include the steering mechanism, brake pedal, gear shifter, and gas pedal to affect steering and throttle operations. Furthermore, the first control system 3020 and the second control system 3030 may simultaneously include overlapping devices as well as separate devices. For example, the first control system 3020 and the second control system 3030 may include the AV's 100 steering column to control steering operations, while the first control system 3020 may include a throttle mechanism to control throttle operations and the second control system 3030 may include the AV's 100 wheels to control throttle operations.

The first control system 3020 and the second control system 3030 provide their respective output in accordance with at least one input. For example, as indicated earlier with reference to FIG. 12, the control systems 3020, 3030 may receive input from a planning module, such as the planning module 404 discussed previously with reference to FIG. 4, that provides information used by the control systems 3020, 3030 to choose a heading for the AV 100 and determine which road segments to traverse. The input may also correspond to information received from a localization module, such as the localization module 408 discussed previously with reference to FIG. 4, which provides information to the control systems 3020, 3030 describing the AV's 100 current location so that the control systems 3020, 3030 can determine if the AV 100 is at a location expected based on the manner in which the AV's 100 devices are being controlled. The input may also correspond to feedback modules, such as the predictive feedback module 1122 described earlier with reference to FIG. 11. The input may also include information received from databases, computer networks, etc. In an embodiment, the input is a desired output. The desired output may include speed and heading based on the information received by, for example, the planning module 404. In an embodiment, the first control system 3020 and the second control system 3030 provide output based on the same input. In an embodiment, the first control system 3020 provides output based on a first input, while the second control system 3030 provide output based on a second input.

The computer processors 3010 are configured to utilize the arbiter module 3012 to select at least one of the first control system 3020 and the second control system 3030 to affect the control operation of the AV 100. Selection of either control system may be based on various criteria. For example, in an embodiment, the arbiter module 3012 is configured to evaluate the performance of the control systems 3020, 3030 and select at least one of the first control system 3020 or the second control system 3030 based on the performance of the first control system 3020 and the second control system 3030 over a period of time. For example, evaluating control system performance may include evaluating the responsiveness of the control systems 3020, 3030 or the accuracy of the control systems' responses. In an embodiment, evaluation of responsiveness includes determining the lag between the control system receiving input, for example to affect a change in acceleration, and the control system 3020 or 3030 acting on the throttle control mechanism to change the acceleration. Similarly, the evaluation of accuracy includes determining the error or difference between the required actuation of an actuator by a control system and the actual actuation applied by the control system. In an embodiment, the computer processors 3010 includes a diagnostics module 3011 configured for identifying a failure of at least one of the first control system 3020 and the second control system 3030. The failure may be partial or complete, or the control systems 3020, 3030 can satisfy at least one failure condition. A partial failure may generally refer to a degradation of service while a complete failure may generally refer to a substantially complete loss of service. For example, regarding the control of the AV 100 with respect to steering, a complete failure may be a complete loss of the ability to steer the AV 100, while a partial failure may be a degradation in the AV's 100 responsiveness to steering controls. Regarding throttle control, a complete failure may be a complete loss of the ability to cause the AV 100 to accelerate, while a partial failure may be a degradation in the AV's 100 responsiveness to throttle controls.

In an embodiment, failure conditions include a control system becoming nonresponsive, a potential security threat to the control system, a steering device/throttle device becoming locked/jammed, or various other failure conditions that increases the risk of the AV 100 to deviate from its desired output. For example, assuming that the first control system 3020 is controlling a steering column (or other steering mechanisms) on the AV 100, and the second control system 3030 is controlling the wheels (or axels) of the AV 100 directly, the computer processors 3010 may select the second control system 3030 to carry out steering operations if the steering column becomes locked in place (e.g., control system failure condition). Also, assuming that the first control system 3020 is controlling a gas pedal (or other throttle mechanisms) on the AV 100, and the second control system 3030 is directly controlling the fuel system of the AV 100, the computer processors 3010 may select the second control system 3030 to carry out throttle operations if the gas pedal becomes unresponsive to commands sent from the computer processors 3010 (e.g., control system failure condition). These scenarios are illustrative and are not meant to be limiting, and various other system failure scenarios may exists.

As indicated above with reference to FIG. 11, in an embodiment, the controllers of the first control system 3020 and the second control system 3030 are configured to receive and utilize feedback from a first and second feedback system, respectively. A feedback system can include sets of sensors, a type of sensor, or feedback algorithms. In an embodiment, the first control system 3020 and the second control system 3030 are configured to receive feedback from the same feedback system. In an embodiment, the first control system 3020 is configured to receive feedback from a first feedback system, while the second control system 3030 is configured to receive feedback from a second feedback system. For example, the first control system 3020 may receive feedback from only a Lidar sensor on the AV 100, while the second control system 3030 may receive feedback from only a camera on the AV 100. The feedback can include measured output feedback, such as the AV's 100 position, velocity or acceleration. The feedback can also include predictive feedback from a predictive feedback module, such as the predictive feedback module 1122 described above with reference to FIG. 11. In an embodiment, the computer processors 3010 are configured to compare the feedback from the first feedback system and the second feedback system to identify a failure, if any, of at least one of the first control system 3020 and the second control system 3030.

For example, assume that the first control system 3020 and the second control system 3030 are configured to affect throttle operations of the AV 100 with a desired speed output of 25 MPH within certain bounds of error. For example, if the first feedback system, which corresponds to the first control system 3020, measures the average speed of the AV 100 to be 15 MPH over a time period of 5 minutes, and the second feedback module measures the average speed of the AV 100 to be 24 MPH over a time period of 5 minutes, the computer processors 3010 may determine that the first control system 3010 is experiencing a failure condition. As previously indicated, when the computer processors 3010 identify a failure of one control system, the computer processors 3010 may select the other control system to affect control operations.

The control systems 3020, 3030 may use control algorithms 3022, 3032 to affect the control operations 3040. For example, in an embodiment, the control algorithms 3022/3032 adjust the steering angle of the AV 100. In an embodiment, the control algorithms 3022/3032 adjust the throttle control of the AV 100. In an embodiment, the first control system 3020 uses a first control algorithm 3022 when affecting the control operations 3040. In an embodiment, the second control system 3030 uses a second control algorithm 3032 when affecting the control operations. For instance, the first control system 3020 may use a first control algorithm 3022 to adjust the steering angle applied to the AV 100, while the second control system 3030 may use a second control algorithm 3032 to adjust the throttle applied to the AV 100.

In an embodiment, both control systems 3020, 3030 use the same algorithm to affect the control operations 3040. In an embodiment, the control algorithms 3022, 3032 are control feedback algorithms, which are algorithms corresponding to feedback modules, such as the measured feedback module 1114 and the predictive feedback module 1122 as previously described with reference to FIG. 11.

In an embodiment, the computer processors 3010 are configured to identify at least one environmental condition that interferes with the operation of one or both of the first control system 3020 and the second control system 3030 based on, for example, information detected by the AV's 100 sensor. Environmental conditions include rain, snow, fog, dust, insufficient sun light, or other conditions that may cause responsive steering/throttle operations to become more important. For example, slippery conditions caused by rain or snow may increase the importance of responsiveness corresponding to steering control. Based on the measured performance regarding responsiveness of the first control system 3020 and the second control system 3030, the computer processors 3010 may select the control system with the highest measured performance pertaining to steering responsiveness. As another example, during low-visibility conditions caused by fog, dust or sunlight, throttle control responsiveness may become more important. In that case, the computer processors 3010 may choose the control system with the highest measured performance for throttle control responsiveness.

A redundant control system having two control systems capable of controlling the AV 100 mitigates the risks associated with control failure. Also, because the computer processors may select between control systems based on performance diagnostics, feedback, and environmental conditions, the driving performance of the AV 100 (in terms of accuracy and efficiency) may increase.

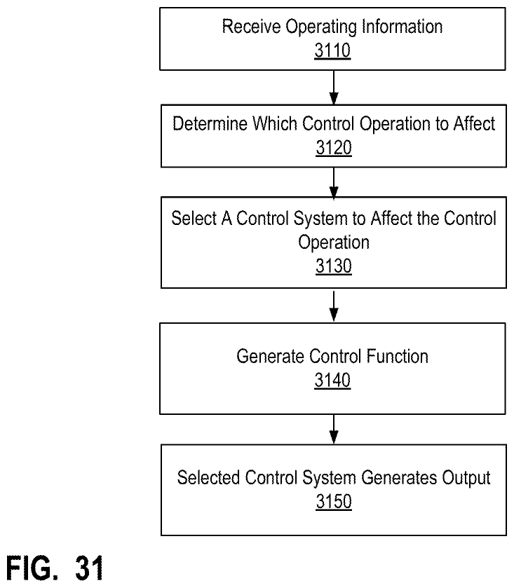

FIG. 31 shows a flowchart representing a method 3100 for providing redundancy in control systems according to at least one implementation of the present disclosure. In an embodiment, the redundant control system 3000 described above with reference to FIG. 30 performs the method 3100 for providing redundancy in control systems. The method 3100 includes receiving operating information (block 3110), determining which control operation to affect (block 3120), and selecting a control system to affect the control operation (block 3130). Once the control system is selected, the method 3100 includes generating control functions (block 3140) and generating output by the selected control system (block 3150).

The method 3100 for providing redundancy in control systems includes receiving operating information (block 3110). This includes receiving, by at least one processor, information about an AV system, the AV system's control systems, and/or the surrounding environment in which the AV is operating. In an embodiment, the at least one processor is the computer processors 3010 as previously described with reference to FIG. 30. For example, in an embodiment when the redundant control system 3000 is performing the method 3100, the computer processors 3010 receive information relating to performance statistics of each control system 3020, 3030 over a period of time. For instances, the performance statistics may relate to the responsiveness and/or the accuracy of each control system 3020, 3030. Diagnostics modules, such as the diagnostics module 3011 of FIG. 30 may analyze and compare the received performance information. In an embodiment, the received performance information is feedback information received from a feedback system. The feedback systems may correspond to one or more control systems. In an embodiment, each control system corresponds to a separate feedback system. For example, a first control system may correspond to a first feedback system, while a second control system can correspond to a second feedback system.

In an embodiment, the diagnostics module identifies a failure, either full or partial, of at least one control system based on the operating information received. A failure can be based on a failure condition. A failure condition can include a control system becoming at least partially inoperable or a control system consistently failing to provide a desired output. In an embodiment, the computer processors 3010 receive information about regarding environmental conditions, such as rain, snow, fog, dust, or other environmental conditions that can affect the AV system's ability to detect, and navigate through, the surrounding environment.

The method 3100 also includes determining which control operation to affect (block 3120). In an embodiment, the computer processors determine which control operations to affect. This determination may be based on a planning module, as described previously with reference to FIG. 30. The control operations may include throttle operations and/or steering operations.

The method 3100 further includes selecting a control system to affect the control operation (block 3130). As indicated earlier with reference to FIG. 30, control systems, such as the control systems 3020, 3030 of FIG. 30, may be configured to affect substantially similar control operations using either the same control devices or they may affect similar control operations using different control devices. In an embodiment, the computer processors utilize the received operating information to select which control system to use to affect the control operation. For instance, the computer processors may use the received performance statistics to analyze the performance of each control system and select the control system corresponding to the more desirable performance statistics (e.g., the control system with performance statistics that show a higher responsiveness or accuracy). As another example, the computer processors may identify a failure (either full or partial) in one control system, and select another control system to affect control operations based on identifying the failure. The computer processors may also use the received information relating to the environmental condition, and use this information to select which control system to use to affect control operations. For instance, assume that the AV is operating in rainy conditions, the computer processors may select the control system that may be more suitable for operating in rainy conditions.

The method 3100 includes generating control functions (block 3140). Once the control system is selected for use, the computer processors algorithmically generate and send control functions to the control systems. These control functions may be based on real time sensor data and/or prior information.

The method 3100 also includes generating output by the selected control system (block 3150). In response to receiving control functions, the selected control system provides output that affects at least one control operation. The output can be data useable for acceleration control and/or data useable for steering angle control. The output can include control algorithms. For example, the algorithms can be feedback algorithms based on feedback received from feedback systems. In an embodiment, a first control system uses a first algorithm to affect control operations while a second control system uses a second algorithm to affect control operations. In an embodiment, one algorithm includes a bias towards adjusting steering angle as an adjustment technique. In an embodiment, one algorithm includes a bias towards adjusting throttle as an adjustment technique.

The output can be generated in accordance with at least one input. The input may be input from a planning module that provides information used by the control system to choose a heading for the AV and determine which road segments to traverse. The input may correspond to information received from a localization module, which provides information describing the AV's current location so that the control system can determine if the AV is at a location expected based on the manner in which the AV's devices are being controlled. The input may also correspond to feedback modules, as described earlier with reference to FIG. 11. The input may also include information received from databases, computer networks, etc. In an embodiment, the input is a desired output. The desired output may include speed and heading based on the information received by, for example, the planning module. In an embodiment, the control systems provide output based on the same input. In an embodiment, one control system provides output based on a first input, while another control system provides output based on a second input.

### Sensor Failure Redundancy

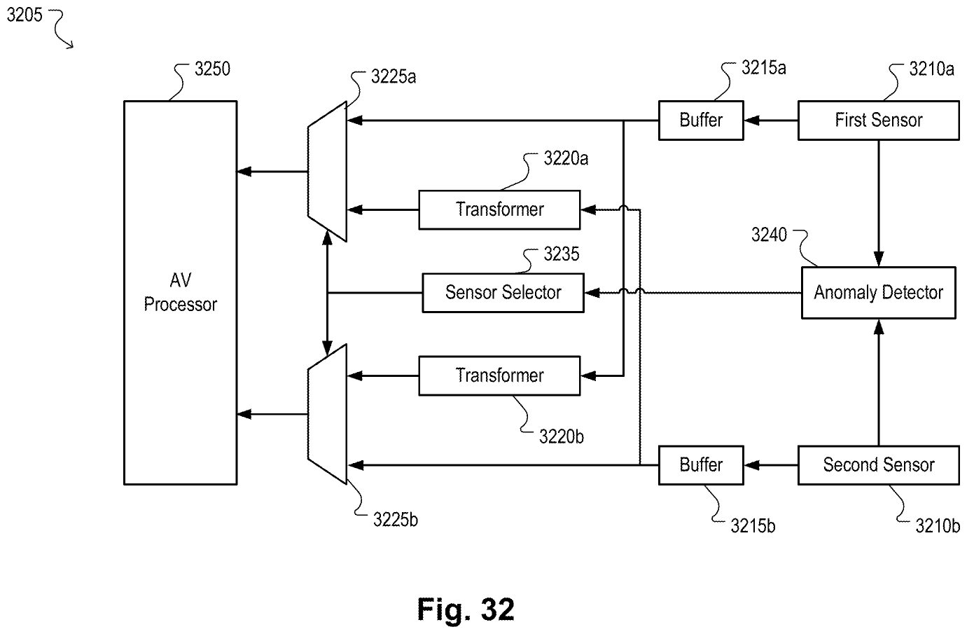

FIG. 32 shows an example of a sensor-related architecture of an autonomous vehicle 3205 (e.g., the AV 100 shown in FIG. 1) for detecting and handling sensor failure. The autonomous vehicle 3205 includes first sensor 3210a, first buffer 3215a, first multiplexer 3225a, second sensor 3210b, second buffer 3215b, second multiplexer 3225b, first transformer 3220a, second transformer 3220b, anomaly detector 3240, sensor selector 3235, and autonomous vehicle processor 3250. Various examples of sensors 3210a-b include LiDAR, RADAR, camera, radio frequency (RF), ultrasound, infrared, and ultraviolet. Other types of sensors are possible. While two sensors are shown, the autonomous vehicle 3205 can use any number of sensors.

In an embodiment, the sensors 3210a-b are configured to produce respective sensor data streams from one or more environmental inputs such as objects, weather conditions, or road conditions external to the autonomous vehicle 3205 while the autonomous vehicle is in an operational driving state. For example, the processor 3250 uses the sensor data streams to detect and avoid objects such as natural obstructions, other vehicle, pedestrians, or cyclists. The sensors 3210a-b are configured to detect a same type of information. The sensors 3210a-b use one or more different sensor characteristics such as sensing frequencies, sensor placement, range of sensing signal, or amplitude of sensing signal. In some implementations, the autonomous vehicle is in an operational driving state when the vehicle has been turned on or activated.

In an embodiment, the processor 3250 is communicatively coupled with the sensors 3210a-b via buffers 3215a-b and multiplexers 3225a-b. In some implementations, the sensors 3210a-b produce sensor data streams that include samples generated by analog-to-digital converters (ADCs) within the sensors 3210a-b. The samples from different streams are stored in respective buffers 3215a-b. The sensor selector 3235 is configured to control the multiplexers 3225a-b to switch among sensor data streams. In a nominal state where the sensors 3210a-b are functioning normally, the sensor selector 3235 sends a signal to multiplexer 3225a to cause the stream from sensor 3210a to flow to the processor 3250, and sends a signal to multiplexer 3225b to cause the stream from sensor 3210b to flow to the processor 3250.

In an embodiment, the anomaly detector 3240 is configured to detect an abnormal condition based on a difference between the sensor data streams being produced by respective sensors 3210a-b. In some implementations, an abnormal condition is detected based on one or more samples values that are indicative of a sensor malfunction or a sensor blockage such as one caused by dirt or another substance covering a sensor 3210a-b. In some implementations, an abnormal condition is detectable based on one or more missing samples. For example, the first sensor 3210a may have produced a sample for a particular time index, but the second sensor 3210b did not produce a sample for the same time index. In an embodiment, an abnormal condition is a result of external intrusion or attack from a malicious actor on the AV 100 or sub-systems of the AV 100. For example, a hacker may attempt to gain access to AV 100 to send false data, steal data, cause AV 100 to malfunction, or for other nefarious purposes.

In the event of an abnormal condition, a transformer 3220a-b transforms a sensor data stream from a functioning sensor 3210a-b to generate a replacement stream for a sensor 3210a-b that is not functioning normally. If the anomaly detector 3240 detects an abnormal condition associated with the second sensor 3210b for example, the sensor selector 3235 can send a signal to multiplexer 3225b to cause the output, e.g., replacement stream, from transformer 3220b to flow to the processor 3250.

The sensors 3210a-b, for example, captures video of the road ahead of the autonomous vehicle 3205 at different angles such as from the left and right sides of the autonomous vehicle 3205. In one implementation, if the right-side sensor 3210b fails, then transformer 3220b performs an affine transformation of the stream being produced by the left side sensor 3210a to generate a replacement version of the stream that was being produced by the right-side sensor 3210b. As such, a video processing routine running on processor 3250 that is expecting two different camera angles can continue to function by using the replacement stream.

In another example, the sensors 3210a-b captures images at different wavelength ranges such as visual and infrared. In one implementation, if the visual range sensor experiences an abnormal condition, then a transformer transforms the infrared data into a visual range such that a routine configured to detect pedestrians using visual range image data can continue to function by using the transformed version of the infrared sensor stream.

In some implementations, the processor 3250 includes the anomaly detector 3240 and the sensor selector 3235. For example, the processor 3250 is configured to switch among the sensors 3210a-b as an input to control the autonomous vehicle 3205. In some implementations, the processor 3250 communicates with a diagnostic module to resolve the abnormal condition by performing tests or resets of the sensors 3210a-b.

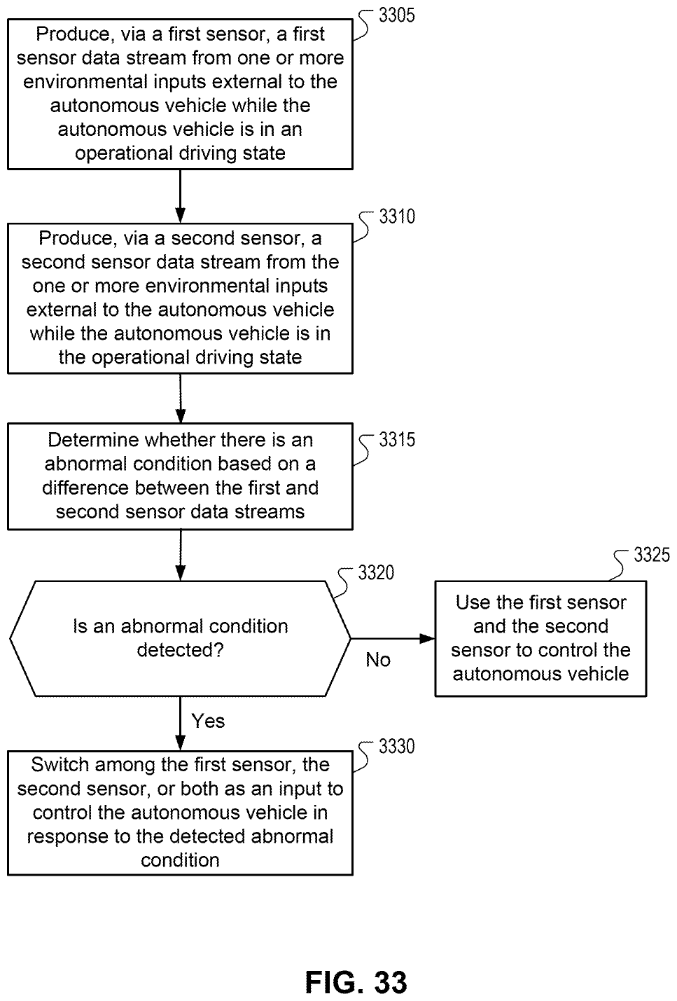

FIG. 33 shows an example of a process to operate an autonomous vehicle and sensors therein. At 3305, the autonomous vehicle produces, via a first sensor, a first sensor data stream from one or more environmental inputs external to the autonomous vehicle while the autonomous vehicle is in an operational driving state. Various examples of sensors include LiDAR, RADAR, camera, RF, ultrasound, infrared, and ultraviolet. Other types of sensors are possible. Various examples of environmental inputs include nearby objects, weather conditions, or road conditions. Other types of environmental inputs are possible. In some implementations, a processor performing this process within the autonomous vehicle is configured to send a command to cause a sensor to start producing a sensor data stream.

At 3310, the autonomous vehicle produces, via a second sensor, a second sensor data stream from the one or more environmental inputs external to the autonomous vehicle while the autonomous vehicle is in the operational driving state. In one implementation, the first sensor and the second sensor are configured to detect a same type of information. For example, these sensors can detect the same kinds of inputs such as a nearby object, weather condition, or road conditions. In some implementations, the sensors can use one or more different sensor characteristics to detect the same type of information. Various examples of sensor characteristics include sensing frequencies, camera placement, range of sensing signal, and amplitude of sensing signal. Other types of sensor characteristics are possible. In some implementations, the second sensor is identical to the first sensor by having the same sensor characteristics. In some implementations, the second sensor operates under one or more different sensor characteristics such as different frequency, different range or amplitude, or different facing angle. For example, two sensors can detect the same type of information, e.g., the presence of a road hazard, by using two different frequency ranges.

At 3315, the autonomous vehicle determines whether there is an abnormal condition based on a difference between the first and second sensor data streams. Various examples of an abnormal condition include a sensor value variance exceeding a threshold or a sensor or system malfunction. Other types of abnormal conditions are possible. For example, the difference may occur based on one or more missing samples in one of the sensor data streams. In some implementations, the difference is determined by comparing values among two or more sensor data streams. In some implementations, the difference is determined by comparing image frames among two or more sensor data streams. For example, dirt blocking one camera sensor but not the other may produce image frames with mostly black pixels or pixel values that do not change from frame-to-frame, whereas the unblock camera sensor may produce image frames having a higher dynamic range of colors. In some implementations, the difference is determined by comparing values of each stream to historic norms for respective sensors. In some implementations, the difference is determined by counting the number of samples obtained within a sampling window for each stream. In some implementations, the difference is determined by computing a covariance among sensor streams.

At 3320, the autonomous vehicle determines whether an abnormal condition has been detected. In some implementations, a predetermined number of missing sensor samples can trigger an abnormal condition detection. In some implementations, a sample deviation among different streams that is greater than a predetermined threshold triggers an abnormal condition detection. In some implementations, a sensor reports a malfunction code, which in turn, triggers an abnormal condition detection.

At 3325, if no such detection, the autonomous vehicle uses the first sensor and the second sensor to control the autonomous vehicle. In an embodiment, the sensor data streams are used to avoid hitting near-by objects, adjust speed, or adjust braking. For example, the autonomous vehicle forwards samples from one or more of the sensors' streams to an autonomous vehicle's control routine such as a collision avoidance routine. At 3330, if an abnormal condition has been detected, the autonomous vehicle switches among the first sensor, the second sensor, or both the first and second sensors as an input to control the autonomous vehicle in response to the detected abnormal condition. In some implementations, if the first sensor is associated with the abnormal condition, the autonomous vehicle switches to the second sensor's stream or a replacement version derived from the second sensor's stream. In some implementations, the autonomous vehicle performs, in response to the detection of the abnormal condition, a diagnostic routine on the first sensor, the second sensor, or both to resolve the abnormal condition.

In some implementations, the autonomous vehicle accesses samples from different sensor data streams that correspond to a same time index and computes the difference at 3315 based on the samples. An abnormal condition is detected based on the difference exceeding a predetermined threshold. In some implementations, a difference for each stream is determined based on a comparison to the stream's expected values. In some implementations, the autonomous vehicle accesses samples from different sensor data streams that correspond to a same time range, computes an average sample value for each stream, and computes the difference at 3315 based on the averages.

In some implementations, the difference between the first and second sensor data streams is based on a detection of a missing sample within a sensor data stream. A sensor, for example, may experience a temporary or partial failure that results in one or more missing samples, e.g., a camera misses one or more frames. Also, the autonomous vehicle may drop a sample due to events such as vehicle network congestion, a processor slow-down, external attack (for example by a hacker), network intrusion, or a sample storage overflow. Missing samples can trigger the autonomous vehicle to switch to another sensor.

In an embodiment, one sensor system uses the data output by the other sensor system to detect an abnormal condition, e.g., as previously described in reference to FIGS. 13-29.

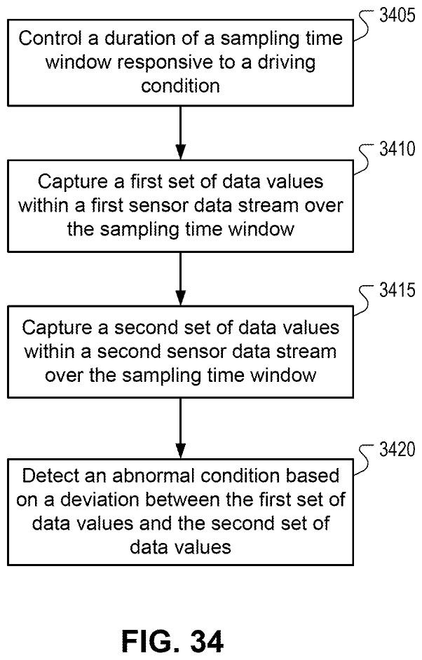

FIG. 34 shows an example of a process to detect a sensor-related abnormal condition. At 3405, the autonomous vehicle controls a duration of the sampling time window responsive to a driving condition. For examples, driving conditions such as fast speeds, weather conditions, and road conditions such rough or unpaved roads may provide less accurate sensor readings or more variance among samples. As such, if more samples are required in order to detect an abnormal condition, the sampling time window is increased. However, in some implementations, the duration of the sampling time window is predetermined. At 3410, the autonomous vehicle captures a first set of data values within a first sensor data stream over a sampling time window. In some implementations, data values are stored in a buffer. At 3415, the autonomous vehicle captures a second set of data values within a second sensor data stream over the sampling time window. At 3420, the autonomous vehicle detects an abnormal condition based on a deviation between the first set of data values and the second set of data values. In some implementations, the autonomous vehicle operates an anomaly detector to determine a difference among two or more sets of data values. In some implementations, a blocked sensor produces a low-variance series of data values, whereas an unblocked sensor produces a higher dynamic range of data values. For example, if mud is completely covering a camera lens, then the corresponding camera sensor produces values with minimal or no variation in color, brightness, or both. Note that if snow is covering the lens, the sensor will produce different values than the mud example, but will still produce values with minimal or no variation in pixel values. If the camera lens is free from obstructions or debris, then the camera produces values with more range in values such as more variations in color and brightness. Such a deviation in respective sets of data values may trigger an abnormal condition event.

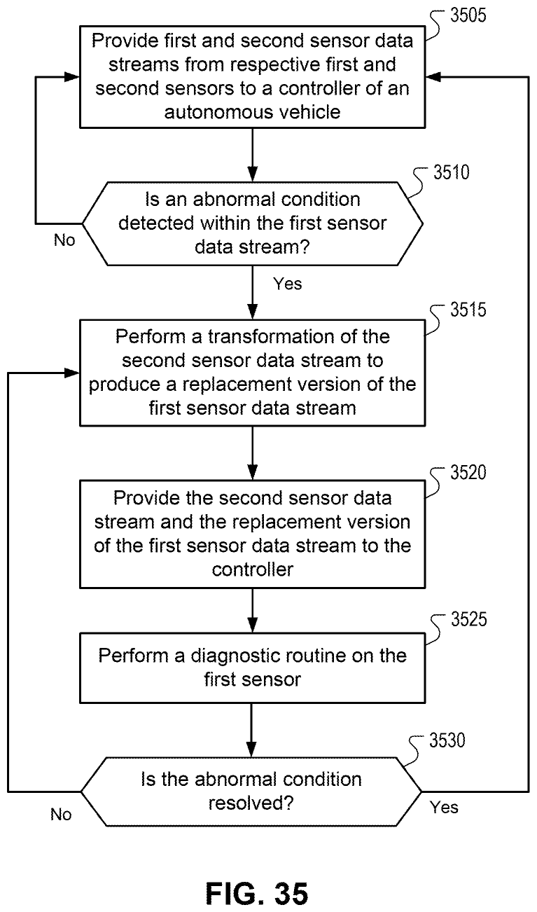

FIG. 35 shows an example of a process to transform a sensor data stream in response to a detection of an abnormal condition. At 3505, the process provides first and second sensor data streams to a controller of an autonomous vehicle. In this example, two data streams are used. However, additional data streams can be provided to the controller.

At 3510, the process determines whether an abnormal condition is detected within the first sensor data stream. At 3505, if an abnormal condition is not detected, the process continues to provide the sensor data streams. At 3515, if an abnormal condition is detected, the process performs a transformation of the second sensor data stream to produce a replacement version of the first sensor data stream. In an embodiment, performing the transformation of the second sensor data stream includes accessing values within the second sensor data stream and modifying the values to produce a replacement stream that is suitable to replace the first sensor data stream. In some implementations, modifying the values includes applying a transformation such as an affine-transformation. Examples of affine-transformations include translation, scaling, reflection, rotation, shear mapping, similarity transformation, and compositions of them in any combination and sequence. Other types of transformations are possible. In some implementations, modifying the values includes applying filters to change voltage ranges, frequencies, or both. For example, in some implementations, if the output value range of the second sensor is greater than the first sensor, the second sensor values is compressed to fit within the expected range of values for the first sensor. In some implementations, if the output frequency range of the second sensor is different than the first sensor, the second sensor values are compressed and/or shifted to fit within the expected frequency range for the first sensor.

At 3520, the process provides the second sensor data stream and the replacement version of the first sensor data stream to the controller. At 3525, the process performs a diagnostic routine on the first sensor. In one implementation, the diagnostic routine includes performing sensor checks, resets, or routines to identify what sensor component has failed, etc.

At 3530, the process determines whether the abnormal condition is resolved. In some implementations, the process receives a sensor status update which reports that the sensor is functioning. In some implementations, the process detects that a sensor is producing samples again. In some implementations, the process detects that the different sensor data streams once again have similar statistical properties. For example, in some implementations, the process computes running averages for each stream and determine whether the averages are within an expected range. In some implementations, the process computes running averages for each stream and determine whether a difference among the averages does not exceed a predetermined threshold. In some implementations, the process computes a deviation for each stream and determines whether the deviation does not exceed a predetermined threshold. At 3505, if the abnormal condition is resolved, the process continues to provide the nominal, untransformed sensor data streams to the controller. At 3515, if the abnormal condition is not resolved, the process continues to perform a transformation on the next set of data within the second sensor data stream.

In some implementations, an AV includes primary and secondary sensors. When a secondary sensor is triggered, an AV controller can determine whether the secondary sensor is identical to the primary sensor or if the secondary sensor has one or more different parametric settings, physical settings, or type. If identical, the AV controller can substitute the primary sensor data stream with the secondary sensor data steam. If different, the AV controller can transform raw sensor data from the secondary sensor to extract the desired information. In some implementations, if two cameras are facing the road at different angles, the data from the secondary camera is affine-transformed to match the primary camera's field of view. In some implementations, the primary sensor is a visual range camera (e.g., for detecting pedestrians) and the secondary sensor is an infrared range camera (e.g., for detecting heat signatures of objects and/or to confirm detection of an object based on heat signature, etc.). If the visual range camera experiences an issue, the AV controller transforms the infrared data into a visual range such that a visual-range-based image processing algorithm can continue to detect pedestrians.

### Teleoperation Redundancy

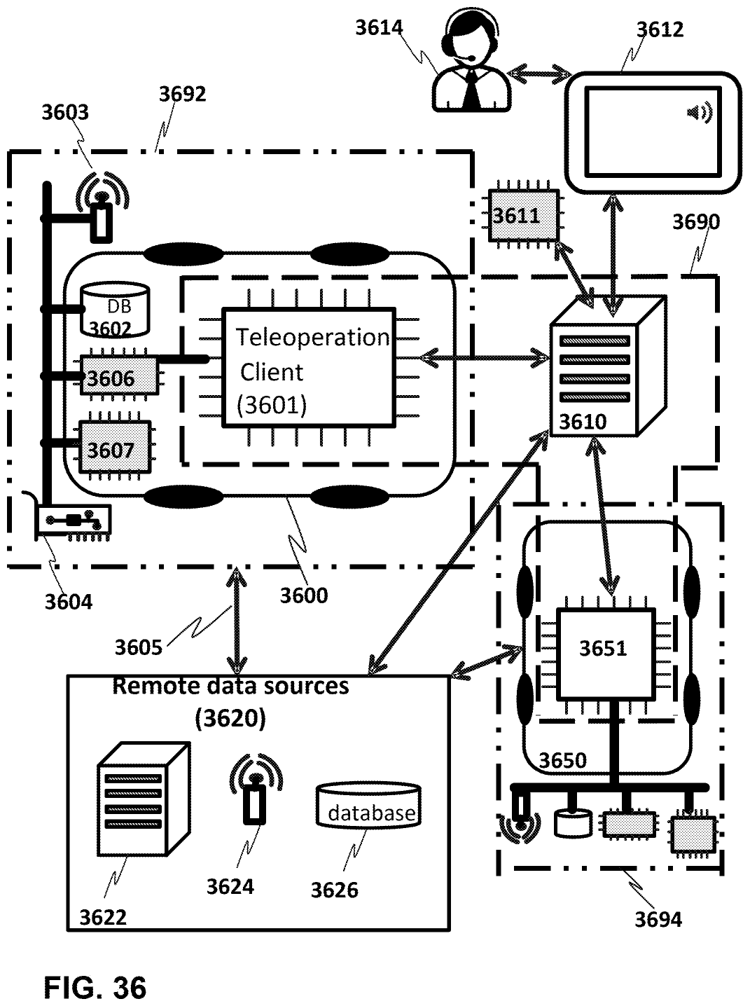

FIG. 36 illustrates example architecture of a teleoperation system 3690. In an embodiment, a teleoperation system 3690 includes a teleoperation client 3601 (e.g., hardware, software, firmware, or a combination of two or more of them), typically installed on an AV 3600 of an AV system 3692. The teleoperation client 3601 interacts with components (e.g., sensors 3603, communication devices 3604, user interface devices, processor 3606, a controller 3607, or functional devices, or combinations of them) of the AV system 3692, for example, sending and receiving information and commands. The teleoperation client 3601 communicates over a communication network 3605 (e.g., local network 322 and/or Internet 328 that may be at least partly wireless) with a teleoperation server 3610.

In an embodiment, a teleoperation server 3610 is located in a remote location away from the AV 3600. The teleoperation server 3610 communicates with the teleoperation client 3601 using the communication network 3605. In an embodiment, the teleoperation server 3610 communicates simultaneously with multiple teleoperation clients; for example, the teleoperation server 3610 communicates with another teleoperation client 3651 of another AV 3650 that is part of another AV system 3694. The clients 3601 and 3651 communicate with one or more data sources 3620 (e.g., a central server 3622, a remote sensor 3624, and a remote database 3626 or combinations of them) to collect data (e.g., road networks, maps, weather, and traffics) for implementing autonomous driving capabilities. The teleoperation server 3610 also communicates with the remote data sources 3620 for teleoperations for the AV system 3692 or 3694 or both.

In an embodiment, a user interface 3612 presented by the teleoperation server 3610 allows a human teleoperator 3614 to engage in teleoperations for the AV system 3692. In an embodiment, the interface 3612 renders to the teleoperator 3614 what the AV system 3692 has perceived or is perceiving. The rendering is typically based on sensor signals or based on simulations. In an embodiment, the user interface 3612 is replaced by an automatic intervention process 3611 that makes any decisions on behalf of the teleoperator 3614. In an embodiment, the human teleoperator 3614 uses augmented reality (AR) or virtual reality (VR) devices to engage in teleoperations for the AV system 3692. For example, the human teleoperator 3614 is seated in a VR box or use VR headsets to receive sensor signals in real-time. Similarly, the human teleoperator 3614 utilizes an AR headset to project or superimpose the AV system's 3692 diagnostic information on the received sensor signals.

In an embodiment, the teleoperation client 3601 communicates with two or more teleoperation servers that send and aggregate various information for a single teleoperator 3614 to conduct a teleoperation session on a user interface 3612. In an embodiment, the teleoperation client 3601 communicates with two or more teleoperation servers that present individual user interfaces to different teleoperators, allowing the two or more teleoperators to jointly participate in a teleoperation session. In an embodiment, the teleoperation client 3601 includes logic for deciding which of the two or more teleoperators to participate in the teleoperation session. In an embodiment, automatic processes automate teleoperation on behalf of the interfaces and teleoperators. In an embodiment, the two or more teleoperators use AR and VR device to collaboratively teleoperate the AV system 3692. In an embodiment, each of the two or more teleoperators teleoperate a separate subsystem of the AV system 3692.

In an embodiment, based on a generated teleoperation event, a teleoperation request is generated, which requests the teleoperation system to begin an interaction between the AV and a remote operator (a tele-interaction) with the AV system 3692. In response to the request, the teleoperation system allocates an available teleoperator and present the teleoperation request to the teleoperator. In an embodiment, the teleoperation request includes information (e.g., a planned trajectory, a perceived environment, a vehicular component, or a combination of them, among other things) of the AV system 3692. Meanwhile, while awaiting a teleoperation to be issued by the teleoperator, the AV system 3692 implements a fallback or default operation.

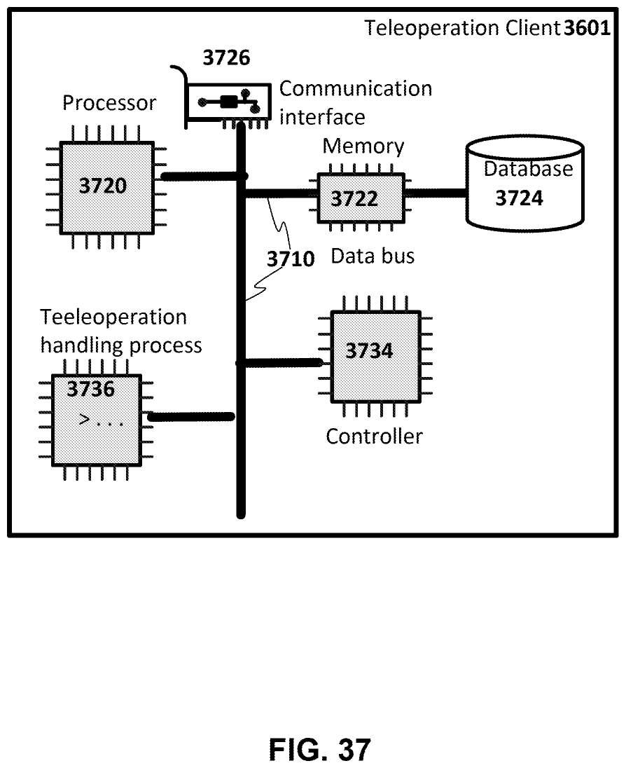

FIG. 37 shows an example architecture of a teleoperation client 3601. In an embodiment, the teleoperation client 3601 is implemented as a software module, stored on memory 3722, being executed by a processor 3720, and includes a teleoperation handling process 3736 that requests the teleoperation system to begin a tele-interaction with the AV system. In an embodiment, the teleoperation client 3601 is implemented as hardware including one or more of the following: a data bus 3710, a processor 3720, memory 3722, a database 3724, a controller 3734 and a communication interface 3726.

In an embodiment, the AV system 3692 operates autonomously. Tele-interactions can vary once the teleoperator 3614 accepts the teleoperation request and engages in the tele-interaction. For example, the teleoperation server 3610 recommends possible teleoperations through the interface 3612 to the teleoperator 3614, and the teleoperator 3614 selects one or more of the recommended teleoperations and causes the teleoperator sever 3610 to send signals to the AV system 3692 that causes the AV system 3692 to execute the selected teleoperations. In an embodiment, the teleoperation server 3610 renders an environment of the AV system through the user interface 3612 to the teleoperator 3614, and the teleoperator 3614 analyzes the environment to select an optimal teleoperation. In an embodiment, the teleoperator 3614 enters computer codes to initiate certain teleoperations. For example, the teleoperator 3614 uses the interface 3612 to draw a recommended trajectory for the AV along which to continue its driving.

Based on the tele-interaction, the teleoperator 3614 issue a suitable teleoperation, which is then processed by a teleoperation handling process 3736. The teleoperation handling process 3736 sends the teleoperation request to the AV system 3692 to affect the autonomous driving capabilities of the AV 3600. Once the AV system completes the execution of the teleoperation (or aborts the teleoperation) or the teleoperation is terminated by the teleoperator 3614, the teleoperation ends. The AV system 3692 returns to autonomous mode and the AV system 3692 listens for another teleoperation event.

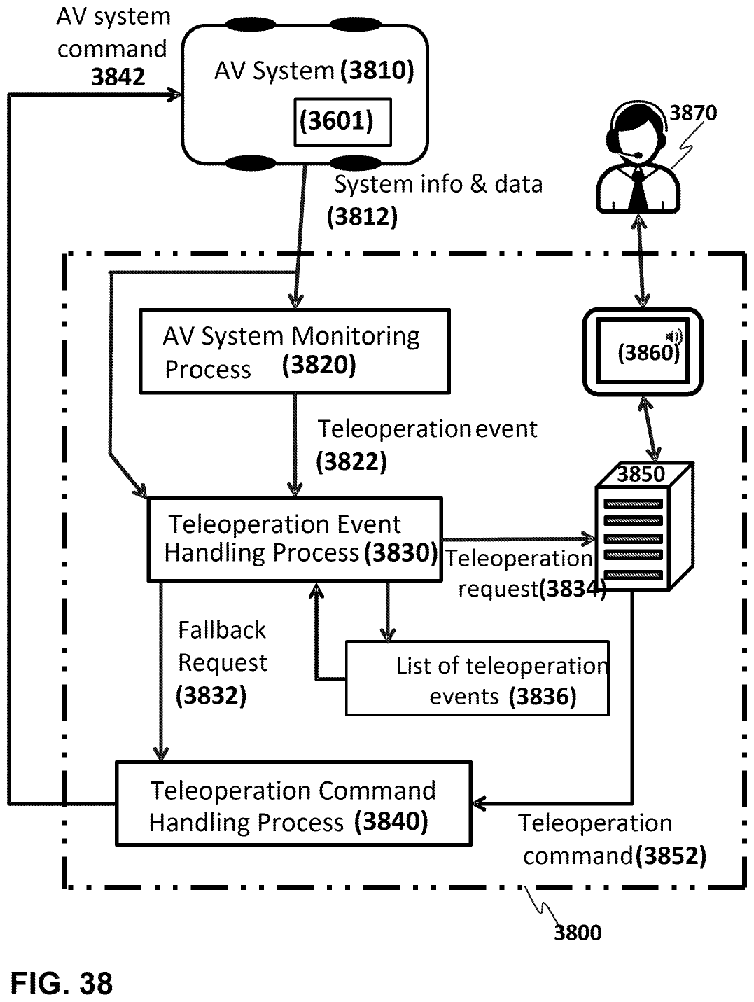

FIG. 38 illustrates an example teleoperation system 3800. In an embodiment, the teleoperation client 3601 (in FIGS. 36 and 37) is integrated as a part of an AV system 3692 (similar to AV system 3810). In an embodiment, the teleoperation client 3601 is distinct from the AV system 3692 and maintains communication with the AV system 3692 through a network link. In an embodiment, the teleoperation client 3601 includes an AV system monitoring process 3820, a teleoperation event handling process 3830, and a teleoperation command handling process 3840. In an embodiment, the AV system monitoring process 3820 reads system information and data 3692 for analysis, for example determining a status of the AV system 3692. An analysis result generates a teleoperation event 3822 to the teleoperation event handling process 3830. The teleoperation event handling process 3830 may send out a teleoperation request 3834 to a teleoperation server 3850 and a fallback request 3832 to the teleoperation command handling process 3840. In an embodiment, the teleoperation server 3850 presents a user interface 3860 for a teleoperator 3870 to perform tele-interaction with the AV system 3692. In response to actions of the teleoperator 3870 through the user interface, the teleoperation server issues a teleoperation command 3852 that expresses the teleoperation in a form for use by the teleoperation command handling process 3840. The teleoperation command handling process 3840 translates the teleoperation command into an AV system command 3842 expressed in a form useful for the AV system 3692 and sends the command to the AV system 3692.

Referring to FIGS. 36-38, in an embodiment, the AV system monitoring process 3820 receives system information and data 3812 to monitor the operation status (e.g., velocity, acceleration, steering, data communications, perception, and trajectory planning) of the AV system 3692. The operation status may be based on outputs of hardware components or software processes or both of the AV system 3692, or indirectly inferring, e.g., computationally or statistically, the outputs by measuring associated quantities, or both. In an embodiment, the AV system monitoring process 3820 derives information (e.g., computing a statistic, or comparing monitored conditions with knowledge in a database) from the operation status. In an embodiment, the monitoring process 3820 detects a teleoperation event 3822 based on the monitored operation status or derived information or both and generates a request for a teleoperation 3852.

In an embodiment, a teleoperation event 3822 occurs when one or more components of the AV system 3692 (e.g., 120 in FIG. 1) is in an abnormal or unexpected condition. In an embodiment, the abnormal condition is a malfunction in the hardware of the AV system 3692. For instance, a brake malfunctions; a flat tire occurs; the field of view of a vision sensor is blocked or a vision sensor stops functioning; a frame rate of a sensor drops below a threshold; the movement of the AV system 3692 does not match with a current steering angle, a throttle level, a brake level, or a combination of the above. Other abnormal conditions include malfunctions in software resulting in errors, such as a fault software code; a reduced signal strength such as a reduced ability to communicate with the communication network 3605 and thus with a teleoperator 3870; an increased noise level; an unknown object perceived in the environment of the AV system 3692; a failure of the motion planning process to find a trajectory towards the goal due to a planning error; inaccessibility to a data source (e.g., a database 3602 or 3626, a sensor, or a map data source); or combinations of the above. In an embodiment, the abnormal condition is a combination of hardware and software malfunctions. In an embodiment, the abnormal conditions occur as a result of abnormal environmental factors, for example heavy rain or snow, extreme weather conditions, presence of unusually high number of reflective surfaces, traffic jams, accidents etc.

In an embodiment, the AV system 3692 operates autonomously. During such operations, the control system 3607 (FIG. 36) affects control operations of the AV system 3692. For example, the control system 3607 includes the controller 1102 that controls the throttle/brake 1206 and steering angle actuator 1212 (FIG. 12). The controller 3607 determines instructions for execution by control components such as the throttle/brake 1206 and steering angle actuator 112. These instructions then control the various components, e.g., the steering actuator or other functionality for controlling steering angle; the throttle/brake 1206, the accelerator, or other mobility components of the AV system 3692.

In an embodiment, the AV system monitoring process 3820 includes a list of errors that generate a teleoperation event 3822. For example, critical errors such as a brake failure or a loss of visual data. In an embodiment, the AV system monitoring process 3820 detects a failure or an error and compares the detected error with the list of errors prior to generating a teleoperation event 3822. In such an instance, the teleoperation event 3822 is sent to the teleoperation event handling process 3830 which sends a teleoperation request 3834 to the server 3850. The teleoperator 3870 sends a teleoperation command 3852 to the teleoperation command handling process 3840 which is in communication with the teleoperation client 3601 via the communication interface 3604 that operates with the communication network 3605. The communication interface 3604 can include a network transceiver (a Wi-Fi transceiver, and/or WiMAX transceiver, a Bluetooth transceiver, a BLE transceiver, an IR transceiver, etc.). The communications network 3605 transmits instructions from an external source (e.g., from the teleoperator 3870 and via the server 3850) so that the teleoperation client 3601 receives the instructions.

Once received, the teleoperation client 3601 uses the instructions received from the external source (e.g., AV system command 3842 relayed from the teleoperator 3870) and determines instructions that are executable by the AV system 3692, such as by the throttle/brake 1206 and steering angle actuator 1212, enabling the teleoperator 3870 to control operations of the AV system 3692.

The teleoperation client 3601 switches to using instructions received from the teleoperator 3870 when one or more specified conditions are detected that trigger a teleoperation event 3822. These specified conditions are based on one or more inputs from one or more of the sensors 3603. The teleoperation client 3601 determines if data received from the sensors 3603 positioned on the vehicle meets the one or more specified conditions, and in accordance with the determination enables the teleoperator 3870 to control the AV system 3692 via the communications network 3605. The specified conditions detected by the teleoperation client 3601 include an emergency condition such as a failure of software and/or hardware of the vehicle. For example, a brake, throttle, or accelerator malfunction, a flat tire, an engine error such as the vehicle running out of gas or battery charge; a sensor ceasing to provide useful data, or detection that the vehicle is not responding to rules or inputs.

The specified conditions that lead to the vehicle switching a local control (controller 3607) to control by a teleoperator 3870 via the teleoperation client 3601 include input received from an occupant of the autonomous vehicle. For example, the occupant may be aware of an emergency not detected by the sensors (e.g., a medical emergency, a fire, an accident, a flood). The user or occupant of the vehicle may press a button or activate the teleoperation command using one of the computer peripherals 132 coupled to computing devices 146 (FIG. 1) or in input device 314 or cursor controller 316 such as a mouse, a trackball, a touch-enabled display (FIG. 3). This button is be located within an interior of the autonomous vehicle within easy reach of any occupant. In an embodiment, multiple buttons are available within the interior of the vehicle for multiple passengers.

The specified conditions causing activation of teleoperation include environmental conditions. These environmental conditions include weather-related conditions, such as a slippery road due to rain or ice, or loss of visibility due to fog or snow. Environmental conditions can be roadway-related, such as the presence of unknown objects on the road, a loss of lane markers (e.g., due to construction), or uneven surface due to road maintenance.

In an embodiment, the teleoperation client 3601 determines if the autonomous vehicle is currently located on a previously untraveled road. Presence on a previously unknown road is one of the specified conditions and enables the telecommunications system to provide instructions to the teleoperation client 3601 (e.g., from the teleoperator 3870). A previously unknown or untraveled road can be determined by comparing the current location of the AV with those located in the database 3602 of the AV which includes a listing of traveled roads. The teleoperation client 3601 also communicates via the communications network 3605 to query remote information, such as remotely located database 134 or 3626. The teleoperation client 3601 compares the location of the vehicle to all databases available before determining that the current location of the vehicle is on an unknown road.

Alternatively, an autonomous vehicle 3600 includes simply a local controller 3607 that affects control operation of the autonomous vehicle 3600. The second processor 3720, part of the teleoperation client 3601, is in communication with controller 3607. The processor 3720 determines instructions for execution by the controller 3607. The communications network 105 is in communication with the processor 3720 via communication device 3604, the telecommunications device configured to receive instructions from an external source such as the teleoperator 3614. The processor 3720 determines instructions that are executable by the controller 3607 from the instructions received from the external source and is configured to enable the received instructions to control the controller 3607 when one or more specified conditions are detected.

Referring again to FIGS. 36-38, the autonomous vehicle 3600 operates autonomously or is operated by a teleoperator 3614. In an embodiment, the AV system 3692 switches automatically between teleoperation and autonomous operation. The AV 3600 has a controller 3607 that controls operation of the autonomous vehicle, with a processor 3606 is in communication with the controller 3607. The processor 3606 determines instructions for execution by the controller 3607. These elements are part of the local control system.

A telecommunications device 3604 is in communication with the controller 3607. The telecommunications device 3604 receives instructions from an external source such as a teleoperator 3614 (via teleoperation server 3610 on a communications network 3605). The telecommunications device 3604 communicates with the AV system 3692 to send instructions to the teleoperation client 3601, which acts as a second, redundant control software module. A processor 3720 that is part of the teleoperation client 3601 determines instructions that are executable by the controller 3607 from the instructions received from the external source (e.g., from the teleoperator 3614 via teleoperation server 3610). The processor 3720 then takes control from the local controller 3607 when one or more specified conditions are detected.

Alternatively, the teleoperation client 3601 acts as a second, redundant control module that is part of and which also can control operation of the autonomous vehicle 3600. The second controller 3734 is in communication with the second processor 3720, which determines instructions for execution by the second controller 3734. The telecommunications network 105 is in communication with the processor 3734 via communication device 3604, which receives instructions from the teleoperator 3614. The processor 3720 determines instructions that are executable by the second controller 3734 from the signals received from the teleoperator 3614 and relays the signals to the second controller 3734 to operate the vehicle when one or more specified conditions are detected.

The specified conditions indicating switch of control to the vehicle from local control (e.g., by local controller 3607) to control by a teleoperator 3614 via the teleoperation client 3601 includes input received from an occupant of the autonomous vehicle. The occupant may be aware of an emergency not detected by the sensors (e.g., a medical emergency, a fire, an accident, a flood). The user or occupant of the vehicle may press a button or activate the teleoperation command using one of the computer peripherals 132 coupled to computing devices 146 (FIG. 1) or in input device 314 or cursor controller 316 such as a mouse, a trackball, a touch-enabled display (FIG. 3). This button is located within an interior of the autonomous vehicle within easy reach of any occupant. In an embodiment, multiple buttons are available within the interior of the vehicle.

The specified conditions causing activation of teleoperation include environmental conditions. These environmental conditions include weather-related conditions, such as a slippery road due to rain or ice, or loss of visibility due to fog or snow. Environmental conditions can also be roadway-related, such as the presence of unknown objects on the road, a loss of lane markers (e.g., due to construction), or uneven surface due to road maintenance.

In an embodiment, the teleoperation client 3601 determines if the autonomous vehicle is currently located on a previously untraveled road. Presence on a previously unknown road acts as one of the specified conditions and enables the telecommunications system to provide instructions to the teleoperation client 3601 (e.g., from the teleoperator 3870). A previously unknown or untraveled road can be determined by comparing the current location of the AV with those located in the database 3602 of the AV which includes a listing of traveled roads. The teleoperation client 3601 also communicates via the communications network 3605 to query remote information, such as remotely located database 134 or 3626. The teleoperation client 3601 compares the location of the vehicle to all databases available before determining that the current location of the vehicle is on an unknown road.

As mentioned above, and continuing to refer to FIGS. 36-38, during autonomous operation of an AV system 3692, the AV system 3692 may sometimes not be able to communicate with a teleoperator 3614. This communication failure can occur as a malfunction in the AV system 3692, such as a software malfunction or hardware malfunction (e.g., malfunction or damage of communication device 104). The communication failure can occur as a malfunction of the teleoperation system, such as server 3610 going offline due to software failure or power loss. The communication failure can also occur as a natural consequence of the AV 3600 moving around its environment and travelling into areas of reduced or absent network signal strength of the communications network 3605. The loss of signal strength can occur in “dead zones” that lack, for example, Wi-Fi coverage, in tunnels, parking garages, under bridges, or in places surrounded by signal blocking features such as buildings or mountains.

In an embodiment, the AV system 3692 employs a connectivity driving mode when in contact with the teleoperation system 3690, and a non-connectivity driving mode when not in contact with the teleoperation system. In an embodiment, the AV system 3692 detects that it has lost connection to a teleoperator 3614. The AV system 3692 utilizes the connectivity driving mode and employs driving strategies with lower risk. For example, driving strategies with lower risk include reducing the velocity of the vehicle, increasing a following distance between the AV and a vehicle ahead, reducing the size of an object detected by the sensors that causes the AV vehicle to slow down or stop, etc. The driving strategy may involve a single vehicle operation (e.g., change speed), or multiple vehicle operations.

In an embodiment, the AV 3600 waits a period of time before switching from connectivity mode to non-connectivity mode, e.g., wait 2 seconds, 5 seconds, 60 seconds. The delay allows the AV system 3692 to run diagnostics, or for the loss of connectivity to otherwise resolve itself (such as the AV 3600 clearing a tunnel) without causing frequent changes in the behavior of the vehicle.

To carry out connectivity and non-connectivity mode switching, the AV system 3692 has a controller 3607 that affects control operation of the AV 3600 during autonomous mode, and a second controller 3734 that affect control operations of the autonomous vehicle when in teleoperator mode. The telecommunications device 104 is communication with the second controller module 3734, the telecommunications device 104 being part of a communications network 105 and configured to receive instructions from a teleoperator 3614 via teleoperation server 3610.

The teleoperation client 3601 includes a processor 3720 that relays or converts instructions to be readable by the controller 3734 and affect the control operations from the instructions received from the teleoperator 3614. The processor 3720 also is configured to determine an ability of the telecommunications device 104 to communicate with the external source, e.g., communicate with communication network 3605. If the processor 3720 determines that communication is adequate, it sends a signal that local processor 3606 and controller 3607 controls the control operations, e.g., operate in connectivity mode. In an embodiment, the processor 3720 determines that communication is adequate and that signals are being received from the teleoperator 3614. The processor 3720 relays instructions to the controller 3607, or alternatively, cause the processor 3734 of the teleoperation client 3601 to assume control of the control operations. In an embodiment, the processor 3720 determines that communication is with the communication network 3605 is not adequate. In such a circumstance, the processor 3720 loads non-connectivity driving strategies, e.g., from memory 3722. The processor 3720 sends these non-connectivity driving strategies to the controller 3607 or alternatively to the controller 3734. The AV system 3692 continues to operate, but with a set of instructions different than during normal operations where intervention by a teleoperator 3614 can be expected.

In an embodiment, where the communications network 105 is a wireless network, the processor 3720 determines the ability of the telecommunications device 104 to communicate with the teleoperator 3614 by determining the signal strength of the wireless network. A threshold signal strength is chosen, and if the detected signal strength falls beneath this threshold the AV system 3692 switches to non-connectivity mode where the processor 3722 sends commands to the vehicle's operational systems.

During operations in connectivity mode, the processor 3606 uses an algorithm or set of algorithms for determining operations of the AV 3600. Alternatively, the processor 3722 uses the same algorithm or set of algorithms. When the system enters non-connectivity mode, the processor uses a second algorithm or set of algorithms different from the first. Typically, the output of the first algorithms affects the operation of the AV to generate movements and behaviors that are more aggressive than an output of the second algorithms. That is, when in connectivity mode, the controller 3607 executes operations that have a higher risk (e.g., higher speed) than the operations executed when the vehicle is in non-connectivity mode (and controlled by the controller 3822 for example). When the AV system 3692 has lost human teleoperator intervention, it exhibits behavior that is more conservative (e.g., reduces speed, increases a following distance between the vehicle and a vehicle ahead, reduces the size of an object detected by the sensors that causes the AV vehicle to slow down or stop) than when teleoperation interventions is possible. In an embodiment, the output of the first algorithms affects the operation of the AV to generate movements and behaviors that are more conservative than an output of the second algorithms. As a safety feature, the AV system 3692 defaults to use of the more conservative set of instructions.

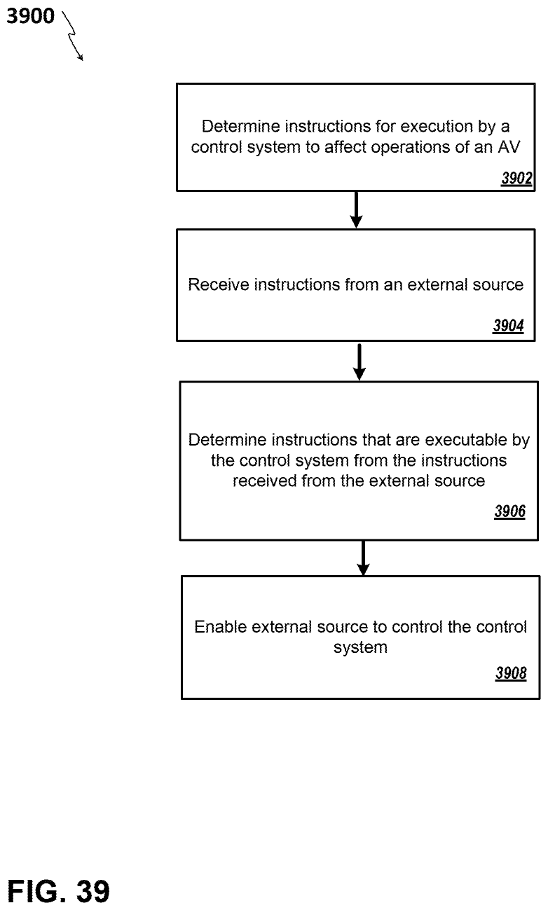

FIG. 39 shows a flowchart indicating a process 3900 for activating teleoperator control of an AV 3600 when an error is detected. In an embodiment, the process can be carried out by the teleoperation client 3601 component of the AV 3600. Referring to FIG. 39, an autonomous vehicle determines instructions for execution by a control system, at step 3902. The control system is configured to affect a control operation of the autonomous vehicle. A control processor is in communication with the control system and a telecommunications system. For example, the control system can be the control system 3607 and the telecommunications system can be the telecommunications system 3605 of FIG. 36. The telecommunications system receives instructions from an external source at step 3904. The control processor determines instructions that are executable by the control system from the instructions received from the external source at step 3906. It also enables the external source in communication with the telecommunications system to control the control system when one or more specified conditions are detected, step 3908. The control processor determines if data received from one or more sensors (e.g., sensors 3603 on FIG. 36) on the autonomous vehicle or from an occupant of the autonomous vehicle (e.g., from a notification interface within an interior of the autonomous vehicle) meets the one or more specified conditions, and in accordance with the determination enables the telecommunications system to operate/direct/initiate the control system. In an embodiment, the one or more specified conditions detected by the control processor includes an emergency condition, environmental conditions, a failure of the control processor, or if the autonomous vehicle is on a previously untraveled road (e.g., using data from a database of traveled roads). In an embodiment, the telecommunications system receives instructions based on inputs made by a teleoperator (e.g. teleoperator 3614).

FIG. 39 also shows a flowchart representing a process 3900 for activating redundant teleoperator and human control of an AV 3600. In an embodiment, the process can be carried out by the teleoperation client 3601 component of the AV 3600. Referring to FIG. 39, an autonomous vehicle determines instructions for execution by a control system, at step 3902. For example, the control system can be the control system 3607 of FIG. 36. The control system is configured to affect a control operation of the autonomous vehicle. A control processor is in communication with the control system and is in communication with a telecommunications system. For example, the telecommunications system can be the telecommunications system 3605 of FIG. 36. The telecommunications system receives instructions from an external source, step 3904, e.g., a teleoperator 3614 via a server 3600. The control processor relays instructions that are executable by the control system from the instructions received from the external source, step 3906. In an embodiment, instructions are relayed or a computation takes place to convert the instructions to a usable format. It also enables the external source in communication with the telecommunications system to control the control system, step 3908. In an embodiment, the control processor enables the telecommunications system to operate the control system when one or more specified conditions are detected. In an embodiment, the specified condition is based on data received from one or more sensors on the autonomous vehicle or from an occupant of the autonomous vehicle or from a notification interface within an interior of the autonomous vehicle, and in accordance with the determination enables the telecommunications system to control the control system. In an embodiment, the one or more specified conditions detected by the control processor also include an emergency condition, environmental conditions, a failure of the control processor, if the autonomous vehicle is on a previously untraveled road (e.g., using data from a database of traveled roads. In an embodiment, the telecommunications system receives instructions based on inputs made by a teleoperator.

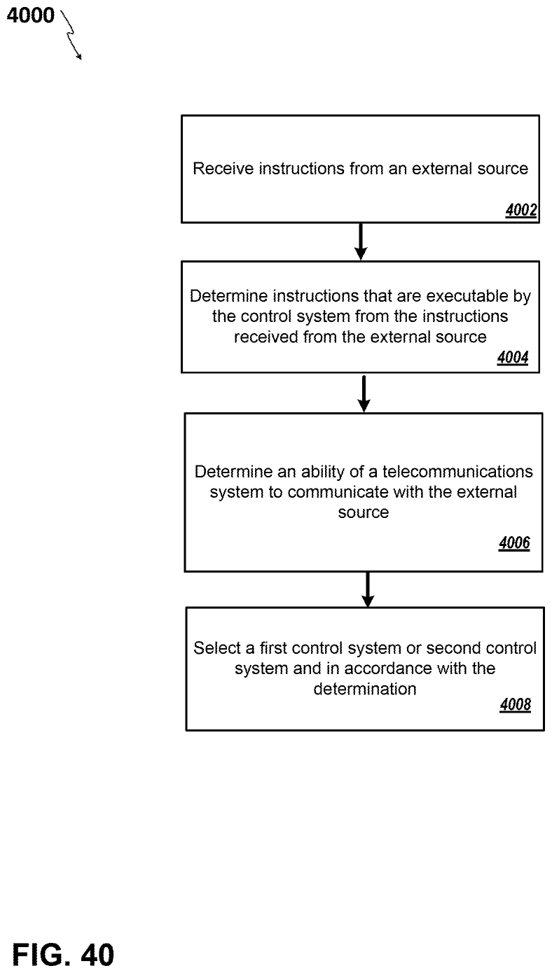

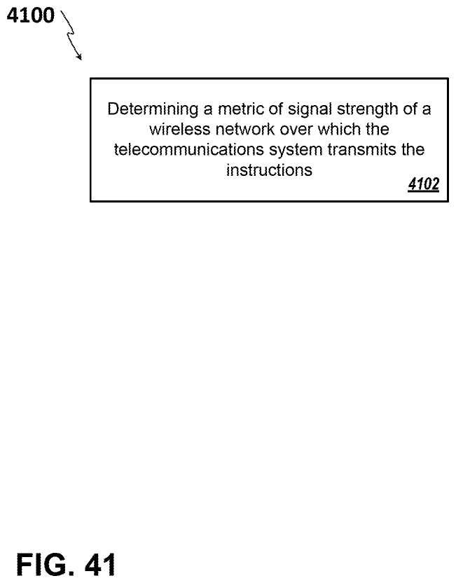

FIG. 40 shows a flowchart representing a process 4000 for controlling the operations of an AV 3600 according to different driving strategies depending on available connectivity to a teleoperator. In an embodiment, the process can be carried out by the teleoperation client 3601 of the AV 3600. Referring to FIG. 40, an autonomous vehicle receives instructions for execution by a control system from an external source, at step 4002. The control system can be a first or a second control system of the autonomous vehicle, for example, controller 3607 of FIG. 36, or controller 3734 of FIG. 37. A control processor is in communication with the control system and is in communication with a telecommunications system that transmits the instructions from the external source, for example processor 3720 or 3606. The system determines instructions that are executable by the control system from the instructions received from the external source, step 4004. The system determines an ability of the telecommunications system to communicate with the external source, step 4008, and then selects the first control system or the second control system and in accordance with the determination. In an embodiment, determining the ability of the telecommunications system to communicate with the external source includes determining a metric of signal strength of a wireless network over which the telecommunications system (e.g., telecommunications system 3605) transmits the instructions (step 4102 of flowchart 4100 in FIG. 41) or determining an indication that a wireless signal receiver on the autonomous vehicle is damaged. In an embodiment, the first control system uses a first algorithm and the second control system uses a second algorithm different from the first control system. In an embodiment, an output of the first algorithm affects the first control operation to generate a movement of the autonomous vehicle that is more aggressive or more conservative than an output of the second algorithm, and uses one algorithm as a default.

### Fleet Redundancy

In some embodiments, multiple autonomous vehicles (e.g., a fleet of autonomous vehicles) exchange information with one another, and perform automated tasks based on the exchanged information. As an example, each autonomous vehicle can individually generate and/or collect a variety of vehicle telemetry data, such as information regarding the autonomous vehicle itself (e.g., vehicle status, location, speed, heading or orientation, altitude, battery level, etc.), information regarding operations performed or to be performed by the autonomous vehicle (e.g., a route traversed by the autonomous vehicle, a planned route to be traversed by the autonomous vehicle, an intended destination of the autonomous vehicle, a task assigned to the autonomous vehicle, etc.), information regarding the environment of the autonomous vehicle (e.g., sensor data indicating objects in proximity to the autonomous vehicle, traffic information, signage information, etc.), or any other information associated with the operation of an autonomous vehicle. This information can be exchanged between autonomous vehicles, such that each autonomous vehicle has access to a greater amount of information with which to conduct its operations.

This exchange of information can provide various technical benefits. For instance, the exchange information between autonomous vehicles can improve the redundancy of a fleet of autonomous vehicles as a whole, thereby improving the efficiency, safety, and effectiveness of their operation. As an example, as a first autonomous vehicle travels along a particular route, it might encounter certain conditions that could impact its operation (e.g., obstructions in the road, traffic congestion, etc.). The first autonomous vehicle can transmit information regarding these conditions to other autonomous vehicles, such that they also have access to this information, even if they have not yet traversed that same route. Accordingly, the other autonomous vehicles can preemptively adjust their operation to account for the conditions of the route (e.g., avoid that route entirely, traverse more slowly in a particular area, use certain lanes in a particular area, etc.) and/or better anticipate the conditions of the route.

Similarly, when one or more additional autonomous vehicles traverse that same route, they can independently collect additional information regarding those conditions and/or any other conditions that the first autonomous vehicle did not observe, and transmit that information to other autonomous vehicles. Accordingly, redundant information regarding the route is collected and exchanged between the autonomous vehicles, thereby reducing the likelihood that any conditions are missed. Further, the autonomous vehicles can determine a consensus regarding the conditions of the route based on the redundant information, thereby improving the accuracy and reliability of the collective information (e.g., by reducing the likelihood of misidentification or misinterpretation of conditions). Thus, the autonomous vehicles can operate in a more effective, safer, and more efficient manner.

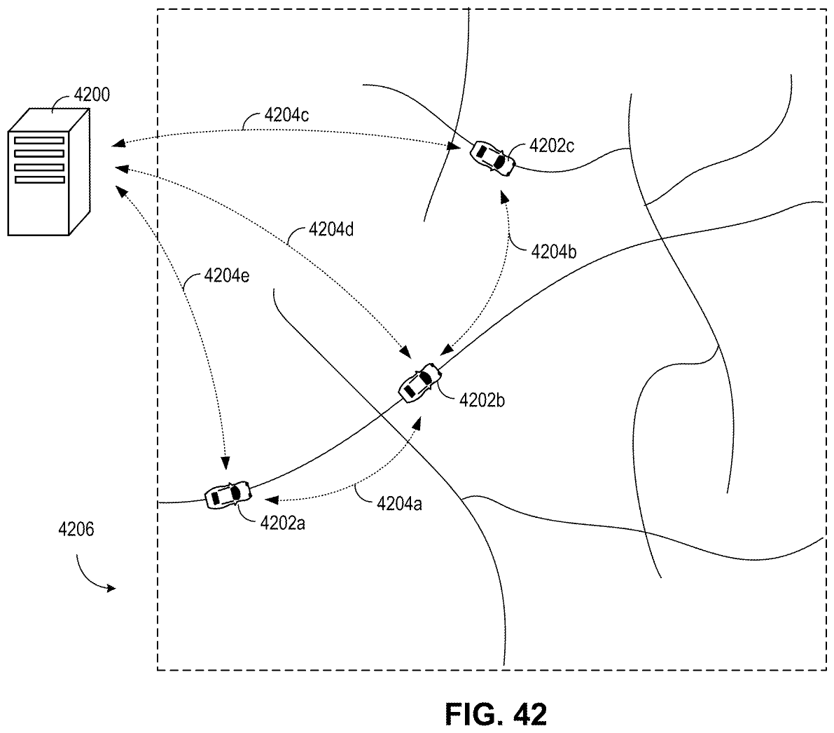

FIG. 42 shows an example exchange of information among a fleet of autonomous vehicles 4202a-c in a region 4206. In some embodiments, one or more of the autonomous vehicles 4202a-c is implemented in a similar manner as the autonomous vehicle 100 described with respect to FIG. 1.

In some embodiments, the fleet of autonomous vehicles 4202a-c exchange information directly with one another (e.g., via peer-to-peer network connections between them). As an example, information is exchanged between autonomous vehicles 4202a and 4202b (e.g., as indicated by line 4204a). As another example, information is exchanged between autonomous vehicles 4202b and 4202c (e.g., as indicated by line 4204b). In practice, an autonomous vehicle can exchange information any other number of other autonomous vehicles (e.g., one, two, three, four, or more).

In some embodiments, the fleet of autonomous vehicles 4202a-c exchange information through an intermediary. As an example, each of the autonomous vehicles 4202a-c transmits information to a computer system 4200 (e.g., as indicated by lines 4204c-e). In turn, the computer system 4200 can transmit some or all of the received information to one or more of the autonomous vehicles 4202a-c. In some embodiments, the computer system 4200 is remote from each of the autonomous vehicles 4202a-c (e.g., a remote server system). In some embodiments, the computer system 4200 is implemented in a similar manner as the remote servers 136 described with respect to FIG. 1 and/or the cloud computing environment 300 described with respect to FIGS. 1 and 3.

As another example, an autonomous vehicle can transmit information to another autonomous vehicle. In turn, that autonomous vehicle can transmit some or all of the received information to another autonomous vehicle. In some embodiments, information from an autonomous vehicle can be transmitted to other multiple autonomous vehicles in a chain, such that the information is sequentially distributed among several autonomous vehicles.

In some embodiments, the exchange of information is unidirectional (e.g., an autonomous vehicle transmits information to another autonomous vehicle, either directly or indirectly, but not receive any information from that autonomous vehicle in return). In some embodiments, the exchange of information is bidirectional (e.g., an autonomous vehicle transmits information to another autonomous vehicle, either directly or indirectly, and also receive information from that autonomous vehicle in return, either directly or indirectly).

In some embodiments, information from one autonomous vehicle is exchanged with every other autonomous vehicle in a fleet. For instance, as shown in FIG. 42, information from the autonomous vehicle 4202b is shared with each of the other autonomous vehicles 102a and 102c. In some embodiments, information from one autonomous vehicle is exchanged with a subset of the other autonomous vehicle in a fleet. For instance, as shown in FIG. 1, information from the autonomous vehicle 4202a is shared with another autonomous vehicle 102b, but not shared with another autonomous vehicle 102c.

In some embodiments, information is selectively exchanged between autonomous vehicles in a particular region (e.g., within the region 4206). For example, information can be exchanged between autonomous vehicles in a particular political region (e.g., a particular country, state, county, province, city, town, borough, or other political region), a particular pre-defined region (e.g., a region having particular pre-defined boundaries), a transiently-defined region (e.g., a region having dynamic boundaries), or any other region. In some embodiments, information is selectively exchanged between autonomous vehicles that are in proximity to each other (e.g., less than a particular threshold distance from one another). In some case, information is exchanged between autonomous vehicles, regardless of the region or their proximity to one another.

The autonomous vehicles 4202a-c and/or the computer system 4200 can exchange information via one or more communications networks. A communications network can be any network through which data can be transferred and shared. For example, a communications network can be a local area network (LAN) or a wide-area network (WAN), such as the Internet. A communications network can be implemented using various networking interfaces, for instance wireless networking interfaces (such as Wi-Fi, WiMAX, Bluetooth, infrared, cellular or mobile networking, radio, etc.). In some embodiments, the autonomous vehicles 4202a-c and/or the computer system 4200 exchange information via more than one communications network, using one or more networking interfaces.

A variety of information can be exchanged between autonomous vehicles. For instance, autonomous vehicles can exchange vehicle telemetry data (e.g., data including one or more measurements, readings, and/or samples obtained by one or more sensors of the autonomous vehicle). Vehicle telemetry data can include a variety of information. As an example, vehicle telemetry data can include data obtained from one or more sensors (e.g., photodetectors, camera modules, LiDAR modules, RADAR modules, traffic light detection modules, microphones, ultrasonic sensors, time-of-flight (TOF) depth sensors, speed sensors, temperature sensors, humidity sensors, and precipitation sensors, etc.). For instance, this can include one or more videos, images, or sounds captured by sensors of the autonomous vehicle.

As another example, vehicle telemetry data can include information regarding a current condition of the autonomous vehicle. For instance, this can include information regarding the autonomous vehicle's location (e.g., as determined by a localization module having a GNSS sensor), speed or velocity (e.g., as determined by a speed or velocity sensor), acceleration (e.g., as determined by an accelerometer), altitude (e.g., as determined by an altimeter), and/or heading or orientation (e.g., as determined by a compass or gyroscope). This can also include information regarding a status of the autonomous vehicle and/or one or more of its subcomponents. For example, this can include information indicating that the autonomous vehicle is operating normally, or information indicating one or more abnormalities related to the autonomous vehicle's operation (e.g., error indications, warnings, failure indications, etc.). As another example, this can include information indicating that one or more specific subcomponents of the autonomous vehicle are operating normally, or information indicating one or more abnormalities related to those subcomponents.

As another example, vehicle telemetry data can include information regarding historical conditions of the autonomous vehicle. For instance, this can include information regarding the autonomous vehicle's historical locations, speeds, accelerations, altitude, and/or heading or orientations. This can also include information regarding the historical statuses of the autonomous vehicle and/or one or more of its subcomponents.

As another example, vehicle telemetry data can include information regarding current and/or historical environmental conditions observed by the autonomous vehicle at a particular location and time. For instance, this can include information regarding a traffic condition of a road observed by the autonomous vehicle, a closure or an obstruction of a road observed by the autonomous vehicle, traffic volume and traffic speed observed by the autonomous vehicle, an object or hazard observed by the autonomous vehicle, weather observed by the autonomous vehicle, or other information.

In some embodiments, vehicle telemetry data includes indications of a specific location and/or time in which an observation or measurement was obtained. For example, vehicle telemetry data can include geographical coordinates and a time stamp associated with each observation or measurement.

In some embodiments, vehicle telemetry data also indicates a period of time for which the vehicle telemetry data is valid. This can be useful, for example, as autonomous vehicles can determine whether received data is sufficiently “fresh” (e.g., within 10 seconds, 30 seconds, 1 minute, 5 minutes, 10 minutes, 30 minutes, 1 hour, 2 hours, 3 hours, 12 hours, or 24 hours) for use, such that it can determine the reliability of the data. For instance, if an autonomous vehicle detects the presence of another vehicle in its proximity, the autonomous vehicle can indicate that information regarding the detected vehicle is valid for a relatively shorter period of time (e.g., as the detected vehicle is expected to remain at a particular location for a relatively short period of time). As another example, if an autonomous vehicle detects the presence of signage (e.g., a stop sign), the autonomous vehicle can indicate that information regarding the detected signage is valid for a relatively longer period of time (e.g., as signage is expected to remain at a location for a relatively longer period of time). In practice, the period of time for which vehicle telemetry data is valid can vary, depending on the nature of the vehicle telemetry data.

The autonomous vehicle 4202a-c can exchange information according to different frequency, rates, or patterns. For example, the autonomous vehicles 4202a-c can exchange information periodically (e.g., in a cyclically recurring manner, such as at a particular frequency). As another example, the autonomous vehicles 4202a-c can exchange information intermittently or sporadically. As another example, the autonomous vehicles 4202a-c can exchange information if one or more trigger conditions are met (e.g., when certain types of information are collected by the autonomous vehicle, at a certain type of time, when certain events occur, etc.). As another example, the autonomous vehicles can exchange information on a continuous or substantially continuous basis.

In some embodiments, the autonomous vehicles 4202a-c exchange a subset of the information that they collect. As an example, each autonomous vehicle 4202a-c can collect information (e.g., using one or more sensors), and selectively exchange a subset of the collected information with one or more other autonomous vehicles 4202a-c. In some embodiments, the autonomous vehicles 4202a-c exchange all or substantially all of the information that they collect. As an example, each autonomous vehicle 4202a-c can collect information (e.g., using one or more sensors), and selectively exchange all or substantially all of the collected information with one or more other autonomous vehicles 4202a-c.

The exchange information between autonomous vehicles can improve the redundancy of a fleet of autonomous vehicles as a whole, thereby improving the efficiency, safety, and effectiveness of their operation. As an example, autonomous vehicles can exchange information regarding conditions of a particular route, such that other autonomous vehicles can preemptively adjust their operation to account for those conditions and/or better anticipate the conditions of the route.

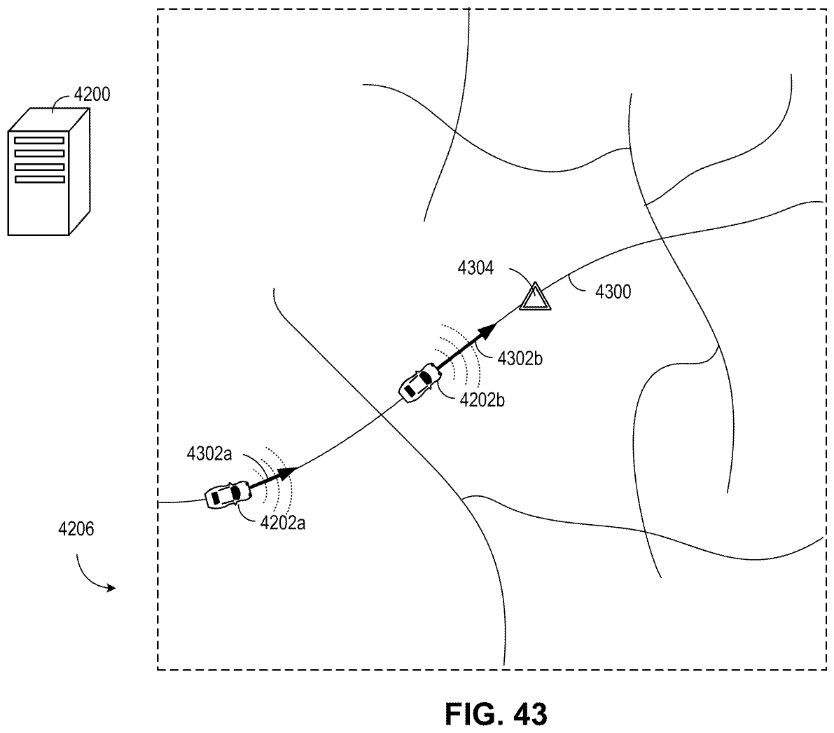

As an example, FIG. 43 shows two autonomous vehicles 4202a and 4202b in a region 4206. The autonomous vehicles 4202a and 4202b are both traveling along a road 4300 (e.g., in directions 4302a and 4302b, respectively). As they navigate, the autonomous vehicles 4202a and 4202b each collect information regarding their respective operations and surrounding environments (e.g., vehicle telemetry data).

In this example, a hazard 4302 is present on the road 4300. The hazard 4304 can be, for example, an obstruction to the road 4300, an object on or near the road 4300, a change in traffic pattern with respect to the road 4300 (e.g., a detour or lane closure), or another other condition that could impact the passage of a vehicle. When the leading autonomous vehicle 4202b encounters the hazard 4302, it collects information regarding the hazard 4302 (e.g., sensor data and/or other vehicle telemetry data identifying the nature of the hazard 4302, the location of the hazard, the time at which the observation was made, etc.).

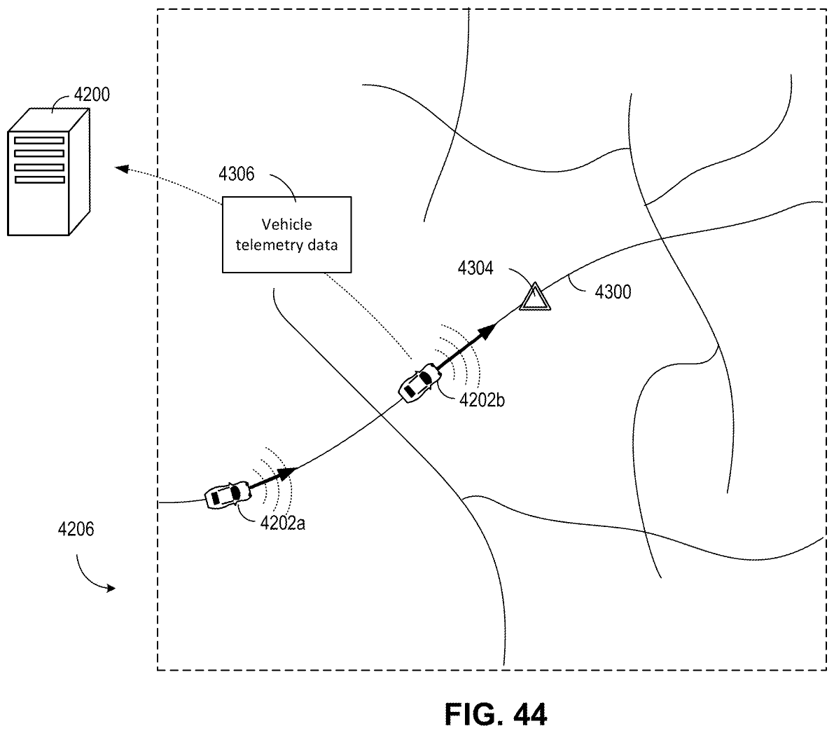

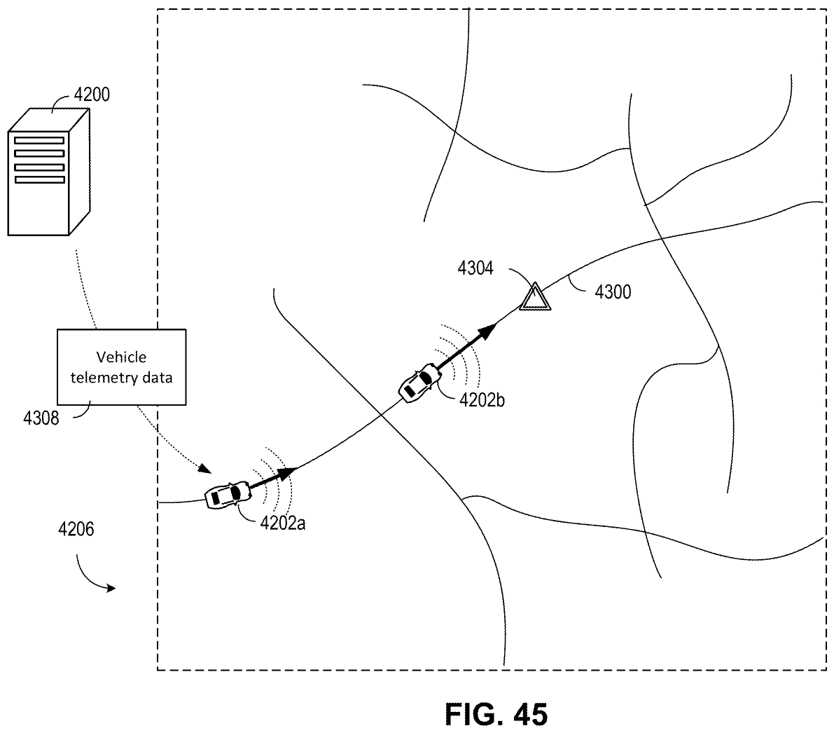

As shown in FIG. 44 the autonomous vehicle 4202b transmits some or all of the collected information to the computer system 4200 (e.g., in the form of one or more data items 4306). As shown in FIG. 45, in turn, the computer system 4200 transmits some or all of the received information to the autonomous vehicle 4202a (e.g., in the form of one or more data items 4308). Accordingly, although the autonomous vehicle 4202a is behind the autonomous vehicle 4202a along the road 4300 and has not yet encountered the hazard 4304, it has access to information regarding the hazard 4304.

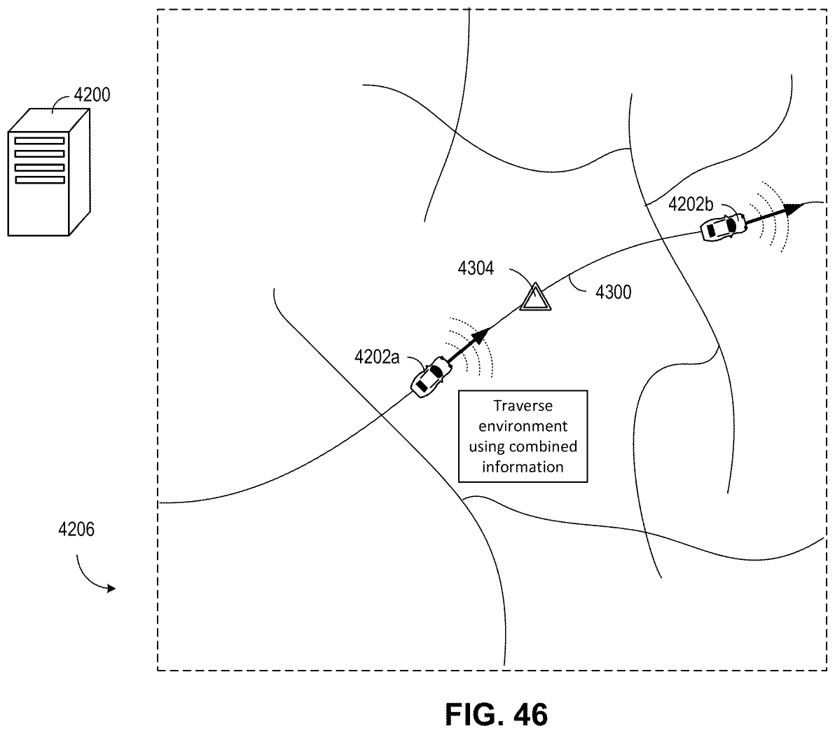

Using this information, the autonomous vehicle 4202a can take preemptive measures to account for the hazard 4302 (e.g., slow down as it approaches the hazard 4302, perform a lane change to avoid the hazard 4302, actively search for the hazard 4302 using one or more of its sensors, etc.). For example, as shown in FIG. 46, as the autonomous vehicle 4202a approaches the hazard 4302, it has access to the shared information from the autonomous vehicle 4202b, as well as information that the autonomous vehicle 4202a itself collects (e.g., based on its own sensors). Using this combined information, the autonomous vehicle 4202a can traverse the hazard 4302 in a safer and more effective manner.

In some embodiments, an autonomous vehicle modifies its route based on information received from one or more other autonomous vehicles. For example, if an autonomous vehicle encounters an obstruction, congestion, or any other condition that encumbers navigation over a particular portion of a road in a safe and/or efficient manner, other autonomous vehicles can modify their routes to avoid this particular portion of the road.

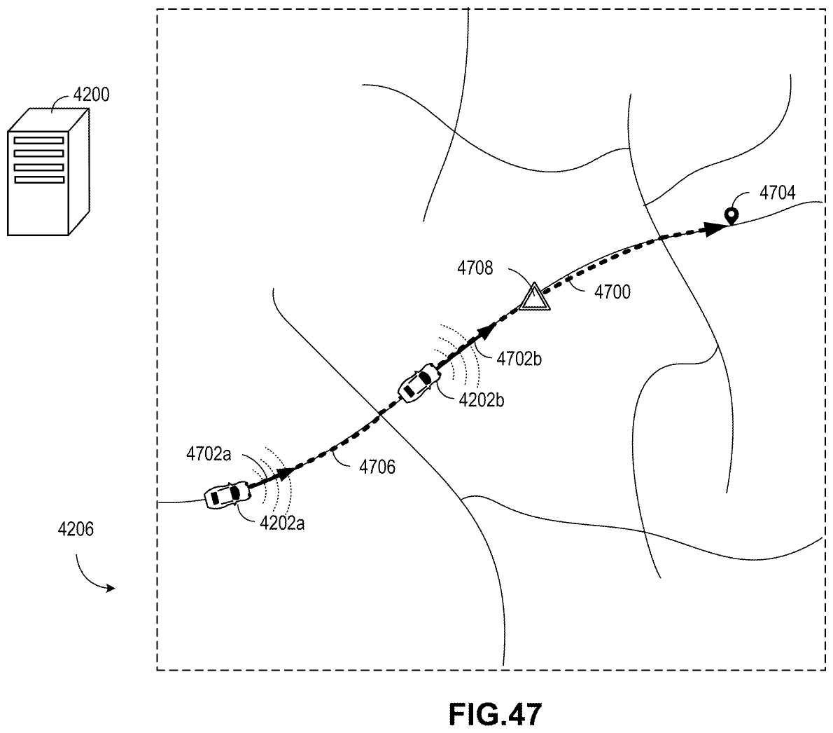

As an example, FIG. 47 shows two autonomous vehicles 4202a and 4202b in a region 4206. The autonomous vehicles 4202a and 4202b are both traveling along a road 4700 (e.g., in directions 4702a and 4702b, respectively). As they navigate, the autonomous vehicles 4202a and 4202b each collect information regarding their respective operations and surrounding environments (e.g., vehicle telemetry data).

In this example, the autonomous vehicle is planning on navigating to a destination location 4704 along a route 4706 (indicated by a dotted line), using the road 4700. However, the road 4700 is obstructed by a hazard 4708, preventing the efficient and/or safe flow of traffic past it. When the leading autonomous vehicle 4202b encounters the hazard 4708, it collects information regarding the hazard 4708 (e.g., sensor data and/or other vehicle telemetry data identifying the nature of the hazard 4302, the location of the hazard, the time at which the observation was made, etc.). Further, based on the collected information, the autonomous vehicle 4202b can determine that the hazard 4708 cannot be traversed in a safe and/or efficient manner (e.g., the hazard 4708 blocks the road 4700 entirely, slows down through traffic to a particular degree, renders the road unsafe for passage, etc.).

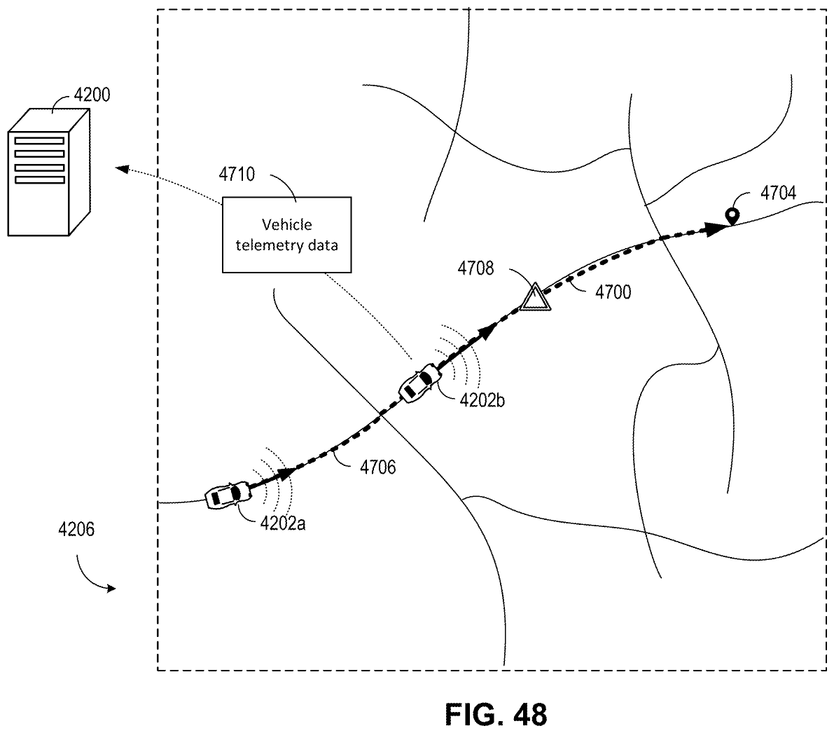

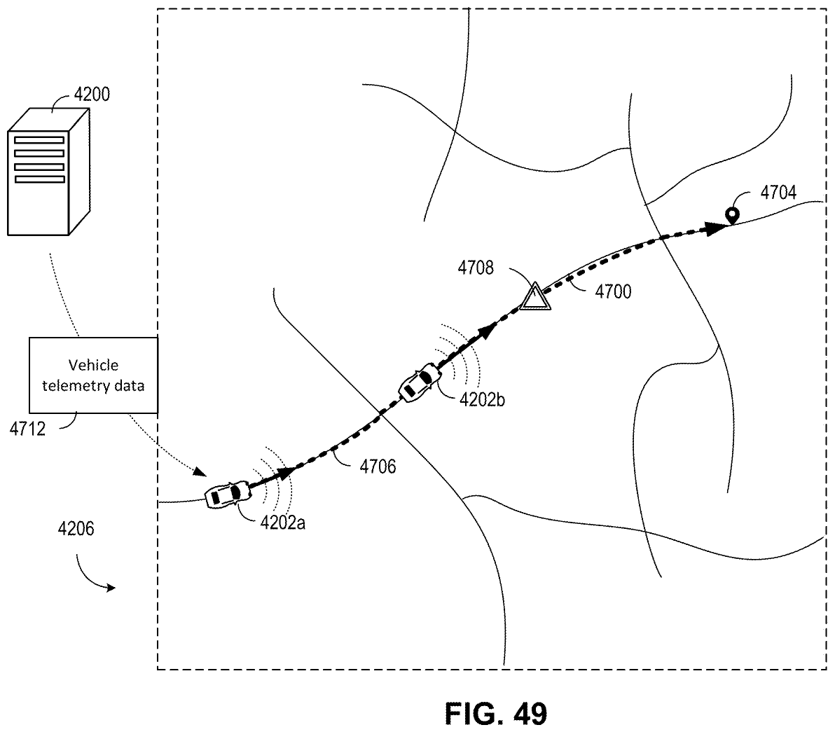

As shown in FIG. 48, the autonomous vehicle 4202b transmits some or all of the collected information to the computer system 4200 (e.g., in the form of one or more data items 4710). As shown in FIG. 49, in turn, the computer system 4200 transmits some or all of the received information to the autonomous vehicle 4202a (e.g., in the form of one or more data items 4712). Accordingly, although the autonomous vehicle 4202a is behind the autonomous vehicle 4202a along the road 4700 and has not yet encountered the hazard 4708, it has access to information regarding the hazard 4708 (e.g., information indicating that the hazard 4708 cannot be traversed in a safe and/or efficient manner).

Based on this information, the autonomous vehicle 4202a can modify its route to the location 4704. As an example, the autonomous vehicle 4202a can determine, based on information from the autonomous vehicle 4202b, a length of time needed to navigate to the location 4704 using the original route 4706 (e.g., including a time delay associated with traversing the hazard 4708). Further, the autonomous vehicle 4202a can determine one or more alternative routes for navigating to the location 4704 (e.g., one or more route that avoid the portion of the road having the hazard 478). If a particular alternative route can be traversed in a shorter amount of time, the autonomous vehicle 4202a can modify its planned route to align with the alternative route instead.

As an example, the autonomous vehicle 4202a can determine, based on information from the autonomous vehicle 4202b, that the portion of the road 4700 having the hazard 4708 is impassible and/or cannot be safely traversed. Further, the autonomous vehicle 4202a can determine one or more alternative routes for navigating to the location 4704 that do not utilize the portion of the road 4700 having the hazard 4708. Based on this information, the autonomous vehicle 4202a can modify its planned route to align with the alternative route instead.

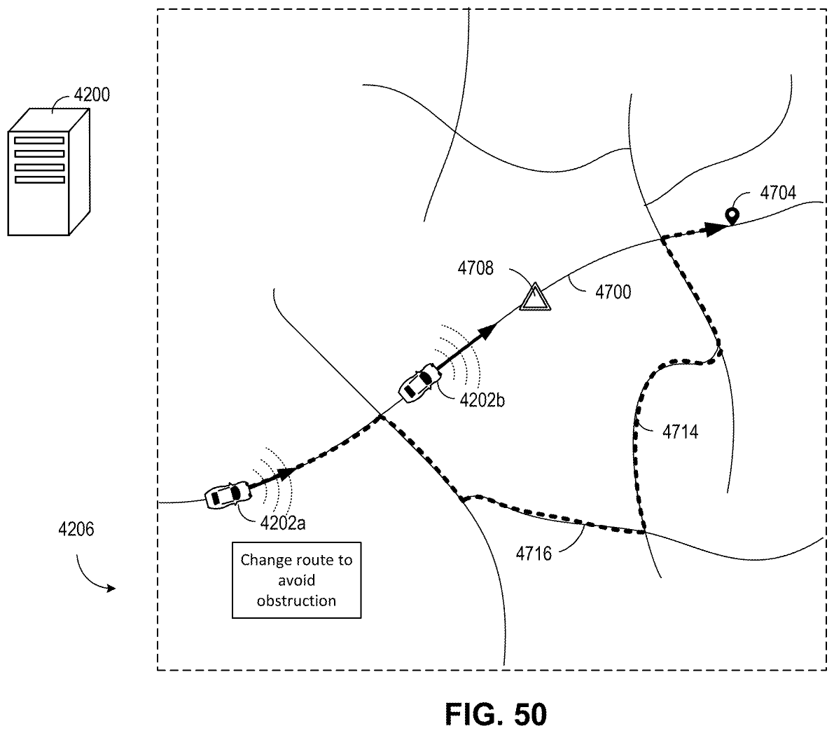

For instance, as shown in FIG. 50, the autonomous vehicle 4202a can determine, based on the information received from the autonomous vehicle 4202b, that the portion of the road 4700 having the hazard 4708 is impassible and/or cannot be safely traversed. In response, the autonomous vehicle 4202a can determine an alternative route 4714 that bypasses the portion of the road 4700 having the hazard 4708 (e.g., a route that utilizes other roads 4716). Accordingly, the autonomous vehicle 4202a can navigate to the location 4704 using the route 4714 and avoid the hazard 4708, even if it has not yet encountered the hazard 4708 itself.

Although FIGS. 43-46 and 47-50 show the exchange of information regarding hazards, these are merely illustrative examples. In practice, autonomous vehicles can exchange any information regarding any aspect of their surrounding environments to enhance the operation of the autonomous vehicles as a whole. As examples, autonomous vehicles can exchange information regarding traffic or congestion observed along a particular route, signage observed along a particular route, landmarks observed along a particular route (e.g., buildings, trees, businesses, intersections, crosswalks, etc.), traffic patterns observed along a particular route (e.g., direction of flow, traffic lanes, detours, lane closures, etc.), weather observed along a particular route (e.g., rain, snow, sleet, ice, wind, fog, etc.) or any other information. As further examples, autonomous vehicles can exchange information regarding changes to the environment (e.g., changes in traffic or congestion along a particular route, changes in signage along a particular route, changes to landmarks along a particular route, changes in traffic patterns along a particular route, changes in weather along a particular route, or any other change). Further, the autonomous vehicles can exchange information identifying the location at which the observations were made, the time at which those observations were made, and the period of time for which those observations are valid. Accordingly, each autonomous vehicle has access to not only the information that it collects itself, but also information collected by one or more other autonomous vehicles, thereby enabling it to traverse the environment in a safer and more effective manner.

Further, although FIGS. 43-46 and 47-50 show the exchange of information through an intermediary computer system 4200, this need not be the case. For instance, the autonomous vehicles autonomous 4202a and 4202b can exchange information from another intermediary (e.g., one or more other autonomous vehicles), or directly with one another (e.g., via peer-to-peer network connections).

In some embodiments, two or more autonomous vehicles form a “platoon” while navigating to their respective destinations. A platoon of autonomous vehicles can be, for example, a group of two or more autonomous vehicles that travel in proximity with one another over a period of time. In some embodiments, a platoon of autonomous vehicles is a group of two or more autonomous vehicles that are similar to one another in certain respects. As an example, each of the autonomous vehicles in a platoon can have the same hardware configuration as the other autonomous vehicles in the platoon (e.g., the same vehicle make, vehicle model, vehicle shape, vehicle dimensions, interior layout, sensor configurations, intrinsic parameters, on-vehicle computing infrastructure, vehicle controller, and/or communication bandwidth with another vehicle or with a server.) As another example, each of the autonomous vehicles in a platoon can have a particular hardware configuration from a limited or pre-defined pool of hardware configurations.

In some embodiments, a platoon of autonomous vehicles can travel such that they occupy one or more common lanes of traffic (e.g., in a single file line along a single lane, or in multiple lines along multiple lanes), travel within a certain area (e.g., a certain district, city, state, country, continent, or other region), travel at a generally similar speed, and/or maintain a generally similar distance from the autonomous vehicle ahead of it or behind it. In some embodiments, autonomous vehicles traveling in a platoon expend less power (e.g., consume less fuel and/or less electric power) than autonomous vehicles traveling individually (e.g., due to improved aerodynamic characteristics, fewer slowdowns, etc.).

In some embodiments, one or more autonomous vehicle in a platoon directs the operation of one or more other autonomous vehicles in the platoon. For example, a leading autonomous vehicle in a platoon can determine a route, rate of speed, lane of travel, etc., on behalf of the platoon, and instruct the other autonomous vehicles in the platoon to operate accordingly. As another example, a leading autonomous vehicle in a platoon can determine a route, rate of speed, lane of travel, etc., and the other autonomous vehicles in the platoon can follow the leading autonomous vehicle (e.g., in a single file line, or in multiple lines along multiple lanes).

In some embodiments, autonomous vehicles form platoons based on certain similarities with one another. For example, autonomous vehicles can form platoons if they are positioned at similar locations, have similar destination locations, are planning on navigating similar routes (either in part, in or their entirety), and/or other similarities.

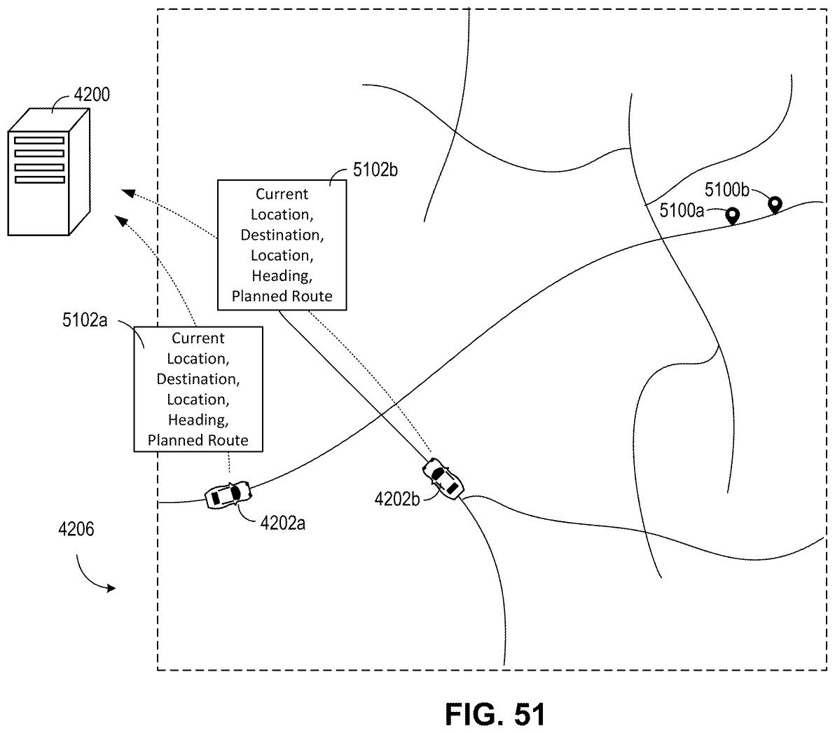

As an example, FIG. 51 shows two autonomous vehicles 4202a and 4202b in a region 4206. The autonomous vehicle 4202a is planning on navigating to a location 5100a, and the autonomous vehicle 4202b is planning on navigating to a location 5100b.

The autonomous vehicles 4202a and 4202b exchange vehicle telemetry data regarding their planned travel to their respective destination locations. For example, as shown in FIG. 51, the autonomous vehicles 4202a and 4202b each transmits vehicle telemetry data to the computer system 4200 (e.g., in the form of one or more data items 5102a and 5102b, respectively). The vehicle telemetry data can include, for example, an autonomous vehicle's current location, its destination location, its heading or orientation, and a route that it plans on navigating to the destination location.

Based on the received information, the computer system 4200 determines whether the autonomous vehicles 4202a and 4202b should form a platoon with one another. A variety of factors can be considered in determining whether autonomous vehicles should form a platoon. As an example, if two or more autonomous vehicles are nearer to each other, this can weigh in favor of forming a platoon. In contrast, if two or more autonomous vehicles are further from each other, this can weigh against forming a platoon.

As another example, if two or more autonomous vehicles have destination locations that are nearer to each other, this can weigh in favor of forming a platoon. In contrast, if two or more autonomous vehicles have destination locations that are further from each other, this can weigh against forming a platoon.

As another example, if two or more autonomous vehicles have similar planned routes (or portions of their planned routes are similar), this can weigh in favor of forming a platoon. In contrast, if two or more autonomous vehicles have dissimilar planned routes (or portions of their planned routes are dissimilar), this can weigh against forming a platoon.

As another example, if two or more autonomous vehicles have similar headings or orientations, this can weigh in favor of forming a platoon. In contrast, if two or more autonomous vehicles have dissimilar headings or orientations, this can weigh against forming a platoon.

In this example, the current locations of the autonomous vehicles 4202a and 4202b, their destination locations, and their planned routes are general similar. Accordingly, the computer system 4200 transmits instructions to the autonomous vehicles 4202a and 4202b to form a platoon with one another (e.g., by transmitting instructions 5104a to the autonomous vehicle 4202a to form a platoon with the autonomous vehicle 4202b, and instructions 5104b to the autonomous vehicle 4202b to form a platoon with the autonomous vehicle 4202a).

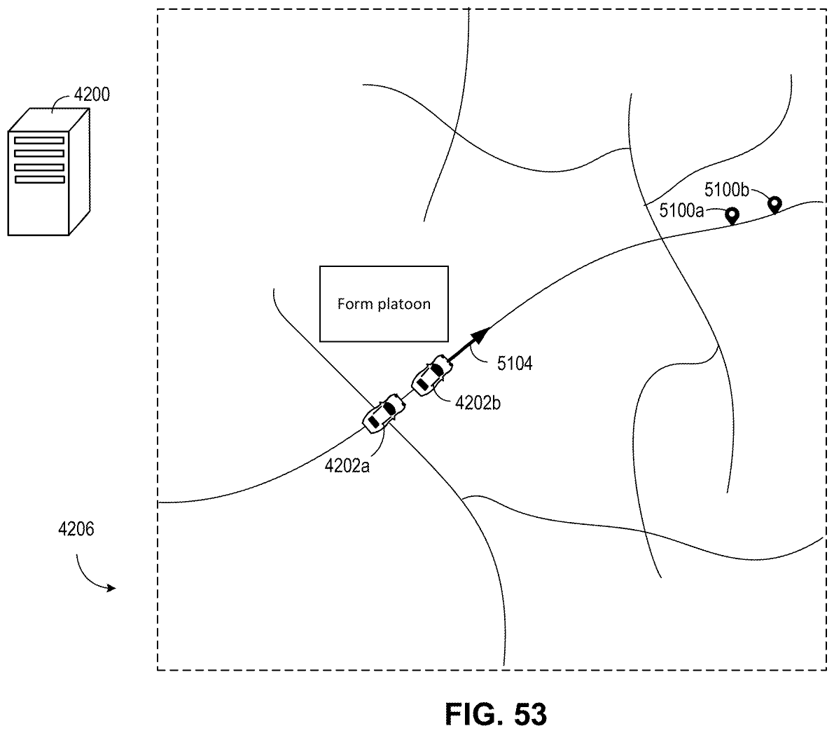

As shown in FIG. 53, in response, the autonomous vehicles 4202a and 4202b form a platoon, and collectively navigate towards their respective destination locations (e.g., by convening at a particular location, and collectively heading in a direction 5104).

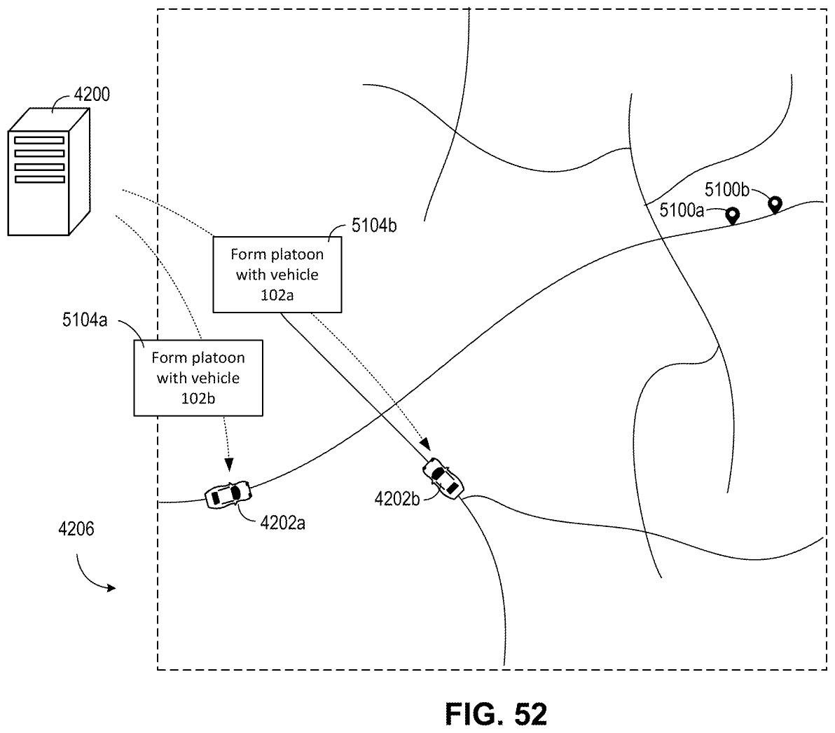

In the example shown in FIGS. 51-53, the autonomous vehicles 4202a and 4202b exchange of information through an intermediary computer system 4200. However, this need not be the case. For example, in some embodiments, autonomous vehicles exchange information directly with one another, and form platoons with one another without express instructions from a remote computer system.

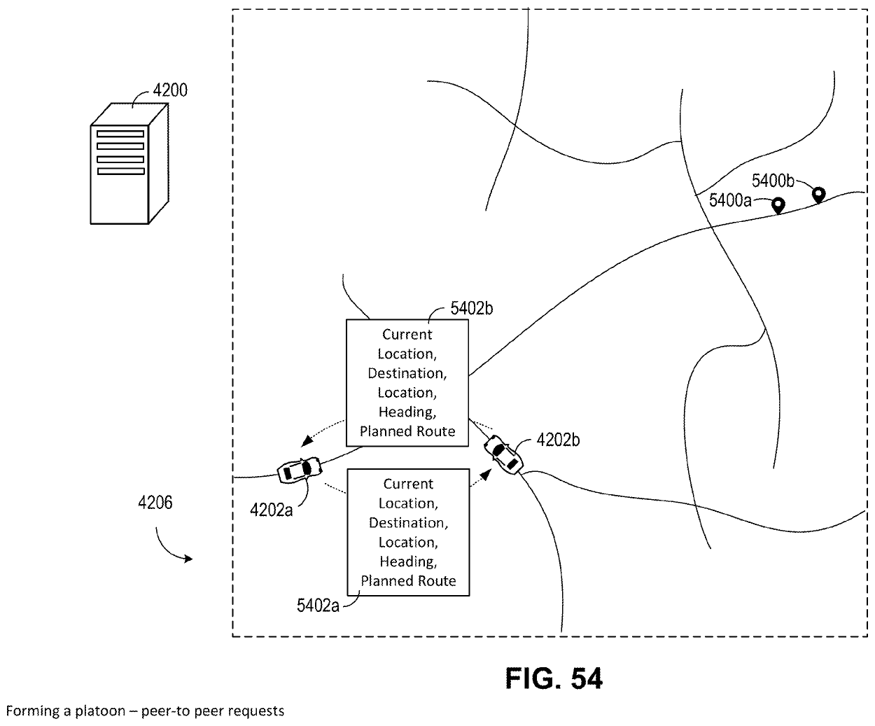

As an example, FIG. 54 shows two autonomous vehicles 4202a and 4202b in a region 4206. The autonomous vehicle 4202a is planning on navigating to a location 5400a, and the autonomous vehicle is planning on navigating to a location 5400b.

The autonomous vehicles 4202a and 4202b exchange vehicle telemetry data directly with one another regarding their planned travel to their respective destination locations. For example, as shown in FIG. 54, the autonomous vehicles 4202a and 4202b each transmits vehicle telemetry data to the other (e.g., in the form of one or more data items 5402a and 5402b, respectively). The vehicle telemetry data can include, for example, an autonomous vehicle's current location, its destination location, its heading or orientation, and a route that it plans on navigating to the destination location.

Based on the received information, one or both of the autonomous vehicles 4202a and 4202b can determine whether to form a platoon. As described above, a variety of factors can be considered in determining whether autonomous vehicles should form a platoon (e.g., similarities in the current location of the autonomous vehicles, destination locations of the autonomous vehicles, headings or orientations, and/or planned routes of the autonomous vehicles).

In some embodiments, an autonomous vehicle determines whether to form a platoon with one or more other autonomous vehicles, and if so, transmits invitations to those autonomous vehicles to join the platoon. Each invited autonomous vehicle can either accept the invitation and join the platoon, or decline the invitation and proceed without the platoon (e.g., travel with another platoon or travel individually).

In this example, the current locations of the autonomous vehicles 4202a and 4202b, their destination locations, and their planned routes are general similar. Based on this information, the autonomous vehicle 4202b determines that it should form a platoon with the autonomous vehicle 4202a, and transmits an invitation 5106 to the autonomous vehicle 4202a to join the platoon.

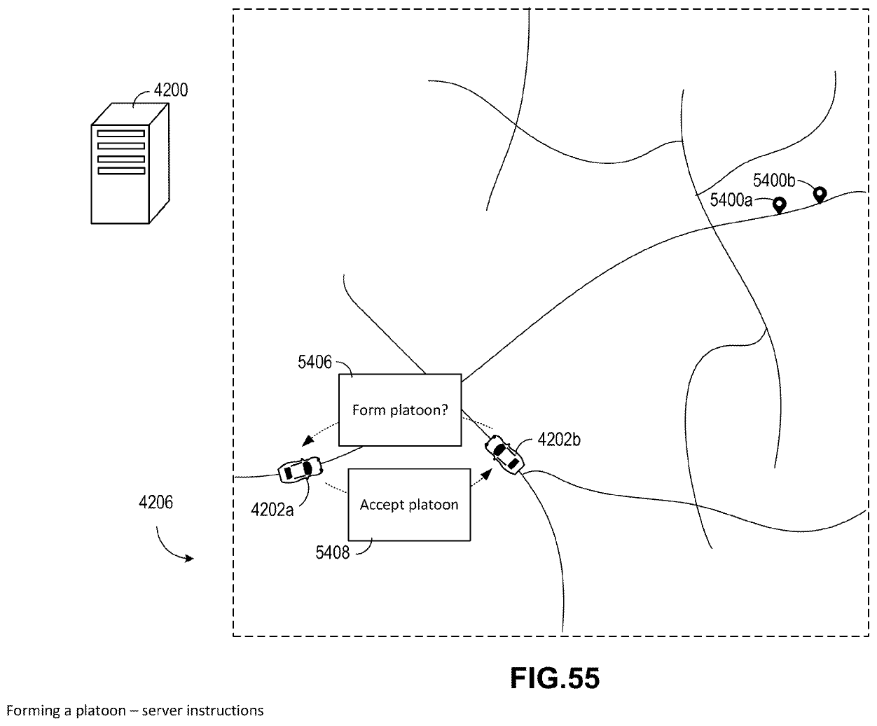

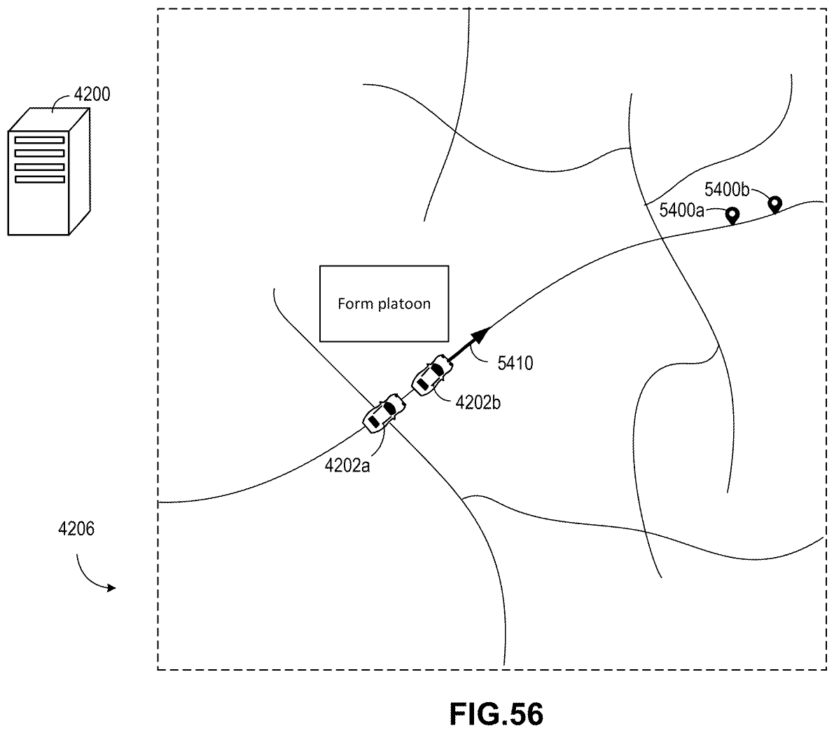

As shown in FIG. 55, in response, the autonomous vehicle 4202a can transmit a response 5108 to the autonomous vehicle 4202b accepting the invitation. As shown in FIG. 56, in response to the acceptance of the invitation, the autonomous vehicles 4202a and 4202b form a platoon, and collectively navigate towards their respective destination locations (e.g., by convening at a particular location, and collectively heading in a direction 5410).

Although FIGS. 51-53 and 54-56 show examples of two autonomous vehicles forming a platoon, these are merely illustrative examples. In practice, any number of autonomous vehicles can form a platoon (e.g., two, three, four, or more).

Further, in some embodiments, autonomous vehicles dynamically join and/or leave a platoon, depending on the circumstances. For instance, an autonomous vehicle can join a platoon to navigate a particular portion of a route common to the autonomous vehicle and those of the platoon. However, when the route of the autonomous vehicle diverges from others of the platoon, the autonomous vehicle can leave the platoon, and either join another platoon or continue to its destination individually.

As described above (e.g., with respect to FIGS. 51-53 and 54-56), two more autonomous vehicles can form a platoon with one another to navigate to their respective destinations. However, in practice, a platoon can also include one or more vehicles that are not autonomous and/or one or more vehicles that are not fully autonomous. Further, a platoon can include one or more autonomous vehicles that are capable of fully autonomous operation, but are currently being operated in a “manual” mode (e.g., being manually operated by human occupants). When a manually operated vehicle is a part of a platoon, instructions can be provided to the human occupant regarding the operation of her vehicle in accordance with the platoon (e.g., instructions to navigate to a certain location at a certain time, await other vehicles, travel in a particular lane of traffic, travel at a particular speed, maintain a particular distance from another vehicle ahead of it or behind it, etc.). In some embodiments, the instructions are generated by a computer system (e.g., the computer system 4200) and presented to the occupant of the vehicle for execution (e.g., using the occupant's mobile electronic device, such as a smartphone, and/or an on-board electronic device in the vehicle).

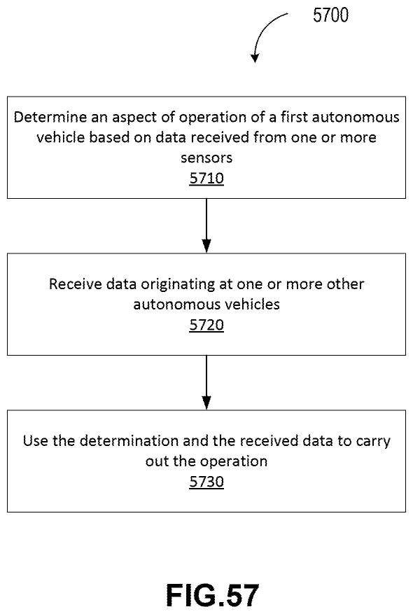

FIG. 57 shows an example process 5700 for exchanging information between autonomous vehicles. The process 5700 can be performed, at least in part, using one or more of the systems described herein (e.g., using one or more computer systems, AV systems, autonomous vehicles, etc.). In some embodiments, the process 5700 is performed, in part or in its entirety, by an autonomous vehicle having one or more sensors (e.g., one or more LiDAR sensors, RADAR sensors, photodetectors, ultrasonic sensors, etc.).

In the process 5700, a first autonomous vehicle determines an aspect of an operation of the first autonomous vehicle based on data received from the one or more sensors (step 5710). As an example, the first autonomous vehicle can collect and/or generate vehicle telemetry data regarding the planning a route of travel, the identification an object in the surrounding environment (e.g., another vehicle, a sign, a pedestrian, a landmark, etc.), the evaluation of a condition of a road (e.g., the identification of traffic patterns, congestion, detours, hazards, obstructions, etc. along the road to be traversed by the first autonomous vehicle), the interpretation of signage in the environment of the autonomous vehicle, or any other aspect associated with operating the first autonomous vehicle.

In some embodiments, the data received from the one or more sensors includes an indication of an object in the environment of the autonomous vehicle (e.g., other vehicles, pedestrians, barriers, traffic control devices, etc.), and/or a condition of the road (e.g., potholes, surface water/ice, etc.). In some embodiments, sensors detect objects in proximity to the vehicle and/or road conditions, enabling the vehicle to navigate more safely through the environment. This information can be shared with other vehicles, improving overall operation.

The first autonomous vehicle also receives data originating at one or more other autonomous vehicles (step 5720). For example, the first autonomous vehicle can receive vehicle telemetry data from one or more other autonomous vehicles, such as nearby autonomous vehicles, other autonomous vehicles in a particular fleet of autonomous vehicles, and/or autonomous vehicles that traversed a particular section of a road or a particular route in the past.

The first autonomous vehicle uses the determination and the received data to carry out the operation (step 5730). For example, information collected or generated by the first autonomous vehicle can be enriched or supplemented with data originating at other autonomous vehicles to improve its overall operation (e.g., plan a more efficient route of travel, identify an object in the surrounding environment more accurately, evaluate a condition of a road more accurately, interpret signage in the environment of the autonomous vehicle more accurately, etc.).

In some embodiments, the first autonomous vehicle also shares information that it collects or generates with one or more other autonomous vehicles. For instance, the first autonomous vehicle can transmit at least a portion of the data received from the one or more sensors to at least one of the other autonomous vehicles. Accordingly, data available to the first autonomous vehicle can be shared with other autonomous vehicles, improving their overall operation.

In some embodiments, the data originating at the one or more other autonomous vehicles includes an indication of a period of time for which the data originating at the one or more other autonomous vehicles is valid. This can be useful, for example, as autonomous vehicles can determine whether received data is sufficiently “fresh” for use, such that it can determine the reliability of the data.

In some embodiments, the one or more other autonomous vehicles from which the first autonomous vehicle receives data may have traversed the road prior to the first autonomous vehicle traversing the road. Further, the data originating at the one or more other autonomous vehicles includes an indication of the condition of the road when the one or more other autonomous vehicles traversed the road. This can be useful, for example, as sensor data is shared among autonomous vehicles that traverse the same road, and thus is more likely to be relevant to each of the vehicles

In some embodiments, the data originating at the one or more other autonomous vehicles includes an indication of one or more paths traversed by the one or more other autonomous vehicles. This can be usage, for example, as autonomous vehicles can share routing data to improve routing decisions.

In some embodiments, data originating at the one or more other autonomous vehicles includes an indication of one or more modifications to a traffic pattern along the one or more paths traversed by the one or more other autonomous vehicles. This can be beneficial, for example, as autonomous vehicles can share changes in traffic patterns, such as a one-way street becoming a two-way street, to improve the future routing of other vehicles.

In some embodiments, the data originating at the one or more other autonomous vehicles further includes an indication of one or more obstacles or obstructions along the one or more paths traversed by the one or more other autonomous vehicles. This can be useful, for example, as autonomous vehicles can share information regarding obstacle or obstructions, such as observed potholes or barriers, to improve the future routing of other autonomous vehicles.

In some embodiments, the data originating at the one or more other autonomous vehicles includes an indication of a change with respect to one or more objects along the one or more paths traversed by the one or more other autonomous vehicles. For example, vehicles can share information regarding landmarks on the side of the road, such as trees or signs, to improve the future routing of other vehicles.

In some embodiments, autonomous vehicles form platoons with one or more other autonomous vehicles, and collectively navigate towards their respective destination locations. For example, the first autonomous vehicle can determine, based on the data originating at the one or more other autonomous vehicles, that a destination of the one or more other autonomous vehicles is similar to a destination of the first autonomous vehicle. In response to this determination, the first autonomous vehicle can transmit a request or invitation to the one or more other autonomous vehicles to form a vehicular platoon. This can be useful, for example, as vehicles traveling to the same location can “platoon” to that location to expend less power (e.g., consume less fuel and/or less electric power).

In some embodiments, the data originating at the one or more other autonomous vehicles includes an indication of a condition of the environment of the one or more other autonomous vehicle. Accordingly, autonomous vehicles can receive information regarding their surrounding environment from other vehicles, improving the reliability/redundancy of sensor systems.

In some embodiments, an autonomous vehicle adjusts its planned route of travel based on information regarding an environmental condition received from one or more other autonomous vehicles. For example, the first autonomous vehicle can modify its route based on the indication of the condition of the environment of the one or more other autonomous vehicles. Accordingly, this enables autonomous vehicles to reroute themselves based on information received from other autonomous vehicles.

In some embodiments, the data originating at the one or more other autonomous vehicles includes a status of the one or more other autonomous vehicles. The status of the one or more other autonomous vehicles can include information regarding a location of the one or more other autonomous vehicles, a speed or velocity of the one or more other autonomous vehicles, or an acceleration of the one or more other autonomous vehicles. This can be beneficial, for example, as it enables vehicles to share telemetry data, such that vehicles can operate more consistently with respect to one another.

In some embodiments, the autonomous vehicles exchange information via an intermediary, such as a central computer system. As an example, the first autonomous vehicle can use a communications engine (e.g., a Wi-Fi, WiMAX, or cellular transceiver) of the first autonomous vehicle to transmit information to and/or receive information from an external control system configured to control an operation of the first autonomous vehicle and the one or more other autonomous vehicles (e.g., a central control system for coordinating the operation of multiple autonomous vehicles). This enables vehicles to exchange information with a central control system, improving the overall operation.

In some embodiments, the autonomous vehicles directly exchange information (e.g., via peer-to-peer connections). As an example, the first autonomous vehicle can use a communications engine (e.g., a Wi-Fi, WiMAX, or cellular transceiver) of the first autonomous vehicle to transmit information to and/or receive information from the one or more autonomous vehicles through one or more peer-to-peer network connections. This enables vehicles to exchange information with other vehicles on an ad hoc basis without the need for a central computer system, improving the flexibility of operation.

### External Wireless Communication Devices

In an embodiment, redundancy can be implemented in an autonomous vehicle using information provided by one or more wireless communication devices that are located external to the autonomous vehicle. As used herein, “wireless communication device” means any device that transmits and/or receives information to/from one or more autonomous vehicles using one or more wireless communication protocols and technologies, including but not limited to: Bluetooth, Near Field, Wi-Fi, infrared, free-space optical, acoustic, paging, Cellular, satellite, microwave and television, radio broadcasting and dedicated short-range radio communication (DSRC) wireless protocol. Wireless communication devices that are located external to the autonomous vehicle are hereinafter referred to as “external” wireless communication devices, and wireless communication devices that are located on or in the autonomous vehicle are hereinafter referred to as “internal” wireless communication devices. Wireless communication devices can be installed on or in: physical structures (e.g., buildings, bridges, towers, bridges, traffic lights, traffic signs, billboards), road segments, vehicles, aerial drones, mobile devices (e.g., smart phones, smart watches, fitness bands, tablet computers, identification bracelets) and carried or worn by humans or other animals (e.g., attached to a pet collar). In an embodiment, the wireless communication devices can receive and/or send radio frequency (RF) signals in a frequency range from about 1 MHz to about 10 GHz.

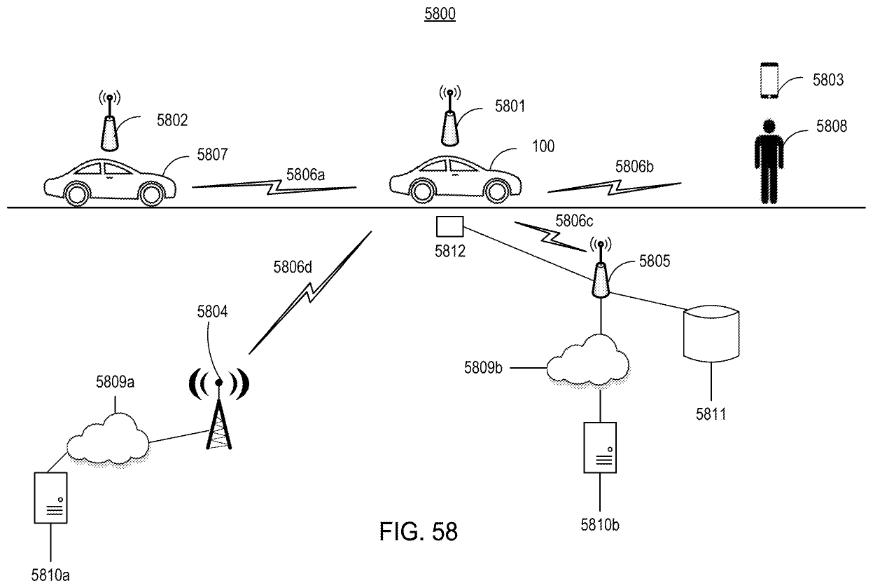

In some embodiments, an external wireless communication device is configured to broadcast signals (unidirectional) over a wireless communication medium to one or more autonomous vehicles using one or more wireless communication protocols. In such embodiments, the external wireless communication device needs not pair with or “handshake” with the internal wireless communication device of the autonomous vehicle. In other embodiments, the external wireless communication device “pairs” with the internal wireless communication device to establish a bi-directional communication session with the internal wireless communication device. The internal wireless communication device includes a receiver that decodes one or more messages in the signal, and parses or extracts one or more payloads from the messages (hereinafter referred to as “external message”). The payloads include content that is used to implement redundancy in the autonomous vehicle, as described in reference to FIGS. 58-60.

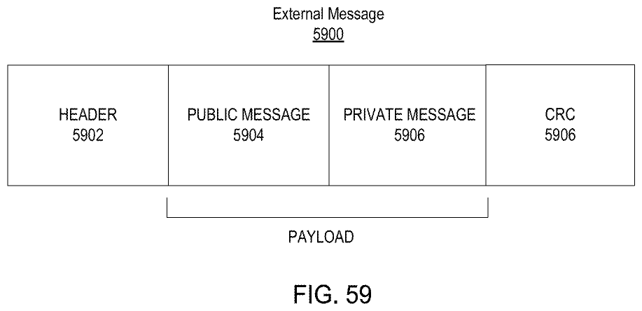

An external message can have any desired format, including without limitation a header, payload and error detection and correcting codes, as described in reference to FIG. 59. In an embodiment, one or more steps of authentication are required before the payload can be extracted from the message by the internal wireless communication device. In an embodiment, the payload is encrypted, and therefore must be decrypted before it can be read by the internal wireless communication device using cryptographic keys or other secret information. In other embodiments, the payload is accessible to the public without authentication or encryption (e.g., public broadcast messages). The contents of the payload are used to provide redundancy for various functions performed by the autonomous vehicle, including but not limited to: planning, localization, perception and control functions, as described in further detail below.

FIG. 58 shows a block diagram of a system 5800 for implementing redundancy in an autonomous vehicle using one or more external messages provided by one or more external wireless communication devices, according to an embodiment. System 5800 includes AV 100 having internal wireless communication device 5801 that communicates with external wireless communication devices 5802-5805. Wireless communication devices 5802-5805 communicate one or more external messages to AV 100 over communication links 5806a-5806b, respectively. In the example shown, device 5802 is installed in another vehicle 5807 following AV 100, device 5804 is a cell tower transmitter, device 5805 is a roadside RF beacon and device 5803 is a mobile device (e.g., a smartphone or wearable computer) carried or worn by user 5808. Each of devices 5802-5805 is wired or wirelessly coupled to one or more information sources that provide content for external messages that are related to the operational domain of the AV 100. Some examples of information sources include but are not limited to: storage devices, sensors, signaling systems and online services. An example sensor is a stereo camera mounted on a building that captures images of a particular geographic region (e.g., a street intersection) or a speed sensor located on a road segment. An example signaling system is a traffic signal at a street intersection. Some examples of online services include but are not limited to: traffic services, government services, vehicle manufacturer or OEM services, over-the-air (OTA) services for software updates, remote operator services, weather forecast services, entertainment services, navigation assistance services, etc. In the example shown, cell tower 5804 is coupled to online service 5810a through network 5809a, and roadside RF beacon 5805 is coupled to online service 5810b through network 5809b, and is also coupled to storage device 5811 and speed sensor 5812.

In an embodiment, external wireless communication device 5805 is a roadside RF beacon that is located on a road segment and is coupled to one or more speed sensors 5812 to detect the speed of the AV 100. When the AV 100 is located within communication range of the roadside RF beacon 5805, the AV 100 receives and decodes an RF signal broadcast by the external wireless communication device 5805 over communication link 5806c. In an embodiment, the RF signal includes a payload that includes speed data for AV 100 generated by the one or more speed sensors 5812. The AV 100 compares the speed data received from the wireless communication device 5805 with the speed detected by a speedometer or other sensor onboard the AV 100. If a discrepancy between the speed data is detected, the AV 100 infers a failure of an onboard sensor (e.g., a speedometer) or subsystem of the AV 100 and performs a “safe stop” maneuver or other suitable action (e.g., slows down).

In another embodiment, external wireless communication device 5802 installed on the vehicle 5807 (in this example following AV 100) can send an external message to AV 100 that includes the driving state of AV 100 as observed by onboard sensors (e.g., LiDAR, stereo cameras) of vehicle 5807. Driving state can include a number of driving parameters of AV 100 that are observed by vehicle 5807, including but are not limited to speed, lane information, unusual steering or braking patterns, etc. This information captured by sensors of vehicle 5807 can be sent in a payload of an external message transmitted to AV 100 over communication line 5806a. When received, AV 100 compares this externally generated driving state with its internally generated driving state to discover any discrepancies between the driving parameters. If a discrepancy is discovered, the AV 100 can initiate a “safe stop” maneuver or another action (e.g., slow down, steer the AV 100 into a different lane). For example, an external message from vehicle 5807 could include a driving state that indicates that the AV 100 is traveling in Lane 1 of a highway, wherein the onboard sensors of the AV 100 could indicate that the AV 100 is traveling in Lane 2 of the highway due to a system or sensor failure. In this example, the external message provided redundant control information that can be used to steer the AV 100 to the correct to Lane 1 or perform some other action like slow down or perform a “safe stop” maneuver.

In an embodiment, an external wireless communication device can be used to enforce a speed limit or some other constraint on the operation of the AV 100. For example, law enforcement or state, city, or municipal authorities may enforce a speed limit of 30 mph in school zones or construction zones by transmitting control information to an AV through an external wireless communication device that prevents the AV from bypassing that speed limit while within the school zone or near a construction site. Similarly, the AV 100 can adjust its venting system automatically to close vents and recirculate air to avoid dust from entering the vehicle. In another example, wireless communication device devices are used to safely guide the AV 100 (e.g., guide by wire) into a loading zone, charging station or other stopping places by computing distance measurements.

In another example, external wireless communication devices 5803-5805 can broadcast information about a particular geographic region in which they are located. For example, external wireless communication devices 5803-5805 can advertise to AV 100 when entering a school zone, construction site, loading zone, drone landing port, train track crossing, bridge, tunnel, etc. Such location external information can be used to update maps, routing, and scene descriptions and to potentially place the AV 100 in an alert mode if necessary. For example, an external wireless communication device located in a school zone can advertise that the school is currently in session and therefore many students may be roaming in the school zone. This information may be different than a scene description provided by a perception module of the AV 100. If there is a discrepancy detected, there may be a system or sensor failure and the AV 100 can be commanded to slow down, change its route or lane and/or adjust its sensors and/or scan rate to avoid collision with students. In another example, an external wireless communication device located in a construction zone can advertise that construction activities are in progress, and if the construction zone is not included in the scene description, the AV 100 can be commanded to slow its speed, change lanes and/or compute a detour route to avoid the construction zone and a potential collision with construction workers and/or heavy machinery.

In an embodiment, an external wireless communication device is coupled to one or more perception sensors such as cameras, LiDARs, RADARs, etc. In an embodiment, the external wireless communication device 5804 is positioned at an elevated position to provide an unobstructed view of a portion of the road segment traveled by AV 100. In the example shown, the external wireless communication device 5804 is placed on utility tower provides a scene description to the AV 100. The AV 100 compares the externally generated scene description with its internally generated scene description to determine if an object is missing from the internally generated scene description indicating a potential sensor failure. For example, the internally generated scene description may not include a yield sign on the road segment because the AV's LiDAR is partially occluded by an object (e.g., a large truck). In this example, a comparison of the externally and internally generated scene descriptions would discover the missing yield sign, causing the AV 100 to be controlled to obey the yield sign by slowing down or stopping until its onboard sensors indicate that the AV 100 can proceed.

In an embodiment, an external wireless communication device is coupled to a traffic light and sends a signal indicating the traffic light state to the AV 100. For example, when the AV 100 approaches an intersection, the AV 100 can establish a connection with an external wireless communication device coupled to the traffic light to receive a signal indicating the current state of the traffic light. If the external traffic light state is different from a traffic light state perceived by the AV 100 (e.g., perceived using its onboard camera sensors), the AV 100 can slow down or initiate a “safe stop” maneuver. In another example, the external wireless communication device coupled to the traffic light can transmit an external message that indicates a time that the traffic signal will change, allowing the AV 100 to perform operations such as stopping or re-starting its engine in advance of the signal change to conserve power.

In another embodiment, the external wireless communication device 5803 is a portable device (e.g., mobile phone, smart watch, fitness band, identification device) that is carried or worn by a pedestrian or animal. For example, the external wireless communication processor 5803 can send the location (or distance) and/or a speed of a pedestrian to the AV 100. The AV 100 can compare the pedestrian's location with an internally generate scene description. If there is a discrepancy, the AV 100 can perform a “safe stop” maneuver or other action. In some embodiment, the external wireless communication device 5803 can be programmed to provide identifying information such as indicating that the wearer is a child, a physically impaired person, an elderly person, a pet, etc. In another example, signal strengths from a large number of external wireless communication devices received in a wireless signal scan by a vehicle can be used to indicate crowds of people that may not have been included in an internally generated scene description due to sensor failure or because the sensors were compromised (e.g., occluded by an object).

In an embodiment, the wireless communication device 5801 of the AV 100 establishes a connection with three external wireless communication devices, and uses signal strength measurements and advertised locations of the externally wireless communication devices to determine the position of the AV 100 using, for example, a trilateration algorithm. In another embodiment, the position of AV 100 can be estimated by a cellular network or external sensors (e.g., external cameras) and provided to the AV 100 in the payload of an external message. The AV 100 can compare the position generated from information provided by the external wireless communication devices with a position of the AV 100 computed by an onboard GNSS receiver or cameras using visual odometry. If a sensor is failing or providing poor navigation solutions (e.g., high horizontal position error), the position determined using externally generated information can be used by the AV 100 in a “safe stop” maneuver or other action.

In an embodiment, vehicles that are parked and equipped with wireless communication device devices are used to form an ad hoc wireless network for providing position information to the AV 100. For example, parked or out-of-service vehicles that are located in the same geographic region and belong to the same fleet service can be used to provide short-range-communication-based localization service that is redundant to the GNSS receiver and visual odometer localization techniques performed by the AV 100. The parked or out-of-service vehicles can transmit their locations to the cloud so the fleet can determine their locations or send their locations directly to AV 100. The RF signals transmitted by the parked or out-of-service vehicles can be used by the AV 100, together with the known locations of the parked or out-of-service vehicles, to determine the location of the AV 100.

FIG. 59 illustrates an external message format 5900, according to an embodiment. External message format 5900 includes header 5902, public message 5904, one or more private (e.g., encrypted) messages 5906 and error detection/correction code 5906. The public message 5904 and the one or more private message 5906 are collectively referred to as the “payload” of the external message.

The header 5902 includes metadata that can be used by wireless communication receivers to parse and decode the external message, including but not limited to: a timestamp and the number, type and size of each payload. The public message 5904 is unencrypted and includes content that can be consumed by anyone wireless communication receiver, including but not limited to: traffic condition information, Amber alerts, weather reports, public service announcements, etc. In an embodiment, the one or more private messages 5906 are encrypted and include content that can be consumed by wireless communication receivers that are authorized to access the content, including but not limited to: more detailed traffic and weather reports, customized entertainment content, URLs to websites or portals, etc.

In an embodiment, the external message format 5900 includes private messages 5906 that include content provided by different service providers and each private message requires a private key to decrypt that can be provided to subscribers of the services. This feature allows different AV fleet services to use share a single external message to deliver their respective private messages 5906 to their subscriber base. Each fleet service can provide a private key to its subscribers to get enhanced or premium content delivered in a private message 5906 in the external message. This feature allows a single external wireless communication device to deliver contents for a variety of different content providers rather than each content provider installing their own proprietary wireless communication device. For example, a city can install and operate wireless communication devices, and then license private message slots in the external message to the content providers for a license fee.

In an embodiment, an external message can be received by single vehicle from an external wireless communication device, and then be rebroadcast by the single vehicle to other vehicles within the vicinity of the single vehicle, and therefore propagating the external message in a viral manner in geographic regions that are not within the coverage area of the external wireless communication device.

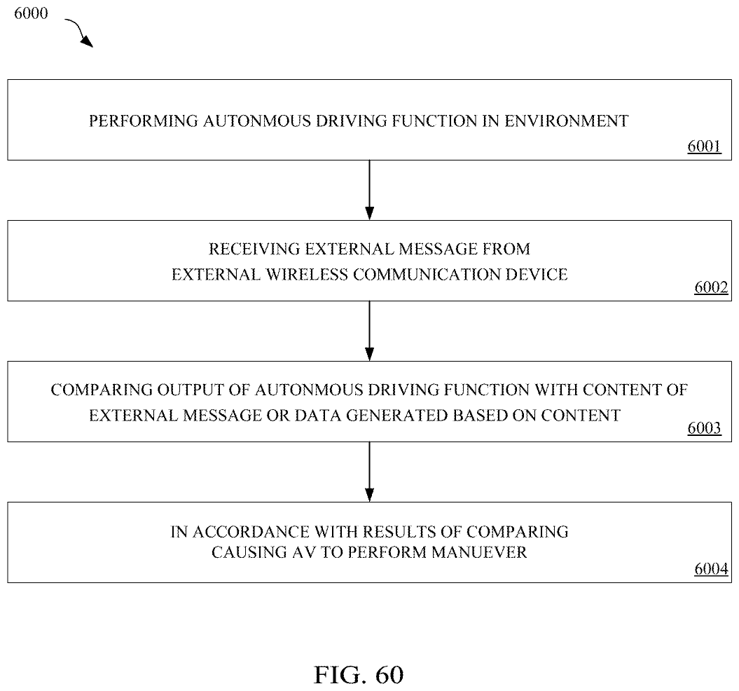

FIG. 60 shows an example process 300 for providing redundancy in an autonomous vehicle using external information provided by one or more external wireless communication devices according to an embodiment. In an embodiment, a method comprises: performing, by an AV, an autonomous driving function (e.g., localization, planning, perception, control functions) of the AV in an environment (6001); receiving, by an internal wireless communication device of the AV, an external message from an external wireless communication device (e.g., RF beacon, infrared device, free-space optical device, acoustic device, microwave device) that is located in the environment (6002) (e.g., installed in another vehicle, carried or worn on a pedestrian or animal, installed on a utility tower); comparing, by one or more processors of the AV, an output of the function with content of the external message or with data generated based on the content (6003) (e.g., comparing scene descriptions, comparing position coordinates of the AV, comparing driving states); and in accordance with results of the comparing, causing the AV to perform a maneuver (6004) (e.g., perform a safe stop maneuver, change the speed of the AV, apply braking, initiate a lane change).

### Replacing Redundant Components

Large fleets of AVs are difficult to maintain due to the large number of additional components (e.g., sensors, ECUs, actuators) for performing autonomous functions, such as perception. To maximize the uptime of fleet vehicles, AV components that have been damaged or that require an upgrade will need to be replaced quickly. Like personal computers, an AV can leverage “plug 'n play” (PnP) technology to reduce the amount of time an AV is in the repair shop. Using PnP, a hardware component added to the AV can be automatically discovered without the need for a physical device configuration or a technician intervention resolving resource conflicts.

However, unlike personal computers, AVs may have redundancy built-in to their critical systems. In some cases, redundant components are required to be compatible with a redundancy model to ensure the safe operation of the AV. For example, one sensor may use the data output by another sensor to determine if one of the sensors has have failed or will fail in the future, as previously described in reference to FIGS. 13-29. If an incompatible replacement component is installed that is redundant to another component of the AV, and the replacement component relies on data from the other component, the replacement component may cause the AV to malfunction.

Compatibility can include but is not limited to: compatibility in specifications (e.g., hardware, software and sensor attributes), version compatibility, compatible data rates, and algorithm compatibility (e.g., matching/detection algorithms). For example, a replacement stereo camera may use a matching algorithm that is identical to a matching algorithm used in a corresponding LiDAR sensor, where the redundancy model requires that the two algorithms be different.

To address redundancy incompatibility, a separate redundancy configuration process is performed in place of, or in addition to, a basic PnP configuration process. In an embodiment, the redundancy configuration process includes the basic PnP configuration steps but also performs additional steps to detect if the replacement component violates a redundancy model.

In an embodiment, the components being added to the AV are PnP compatible, such that the components are capable of identifying themselves to an AV operating system (OS) and able to accept resource assignments from the AV OS. As part of the identifying, a list of characteristics can be provided to the AV OS that describes the capabilities of the component in sufficient detail that the AV OS can determine if the component violates a redundancy model. Some example characteristics include but are not limited to: the make, model and version of the hardware, and the software/firmware version for the component if the component uses software/firmware. Other characteristics can be component specific performance specifications, such as range, resolution, accuracy and objection detection algorithm for a LiDAR sensor, or sensor resolution, depth resolution (for z axis), bit depth, pixel size, framerate, focal length, field-of-view (FOV), exposure range and matching algorithm (e.g., OpenCV Block Matcher, OpenCV SGBM matcher) for a stereo camera.

In an embodiment, non-volatile firmware running on a host computer (e.g., basic input/output service (BIOS)) includes routines that collect information about the different components in the AV and allocate resources to the components. The firmware also communicates this information to the AV OS, which uses the information to configure its drivers and other software to make the AV components work correctly in accordance with the redundancy model. In an embodiment, the AV OS sets up device drivers for the components that are necessary for the components to be used by AV applications. The AV OS also communicates with the driver of the AV (or with a technician in a repair shop), notifying her of changes to the configuration and allowing the technician to make changes to resource settings if necessary. This communication may be through a display in the AV, through the display of diagnostic equipment, AV telematics data stream, or through any other suitable output mechanism.

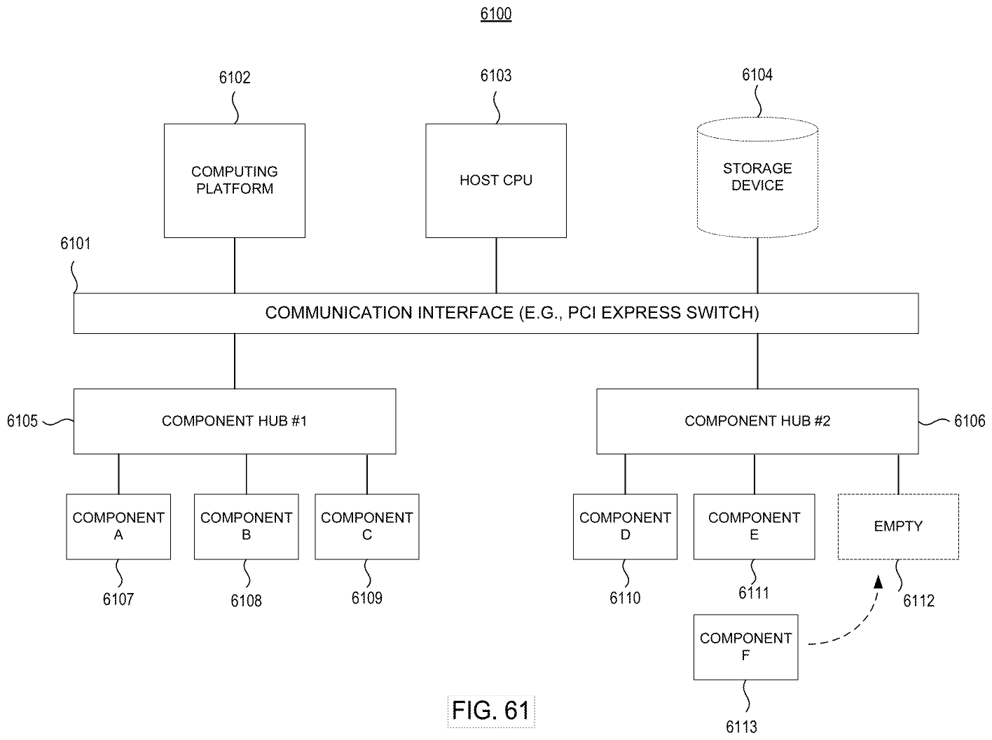

FIG. 61 shows a block diagram of an example architecture 6100 for replacing redundant components in an AV. In an embodiment, architecture 6100 includes communication interface 6101, computing platform 6102, host processor 6103, storage device 6104 and component hubs 6105a and 6105b. Component hub 6105a is coupled to components 6107, 6108 and 6109. Component hub 6105b is coupled to components 6110 and 6111. Component hub 6105b also includes an extra slot/port 6112 for receiving new component 6113 to replace a damaged component (e.g., a damaged camera). In an embodiment, each component hub 6105a, 105b operates as a data concentrator and/or router of data from components to computing platform 6102 (e.g., an automated driving server).

In the example shown, communication interface 6101 is a Peripheral Component Interconnect Express (PCIe) switch that provides hardware support for “I/O virtualization”, meaning upper layer protocols are abstracted from physical connections (e.g., HDBaseT connections). Components can be any hardware device with PnP capability, including but not limited to: sensors, actuators, controllers, speakers, I/O devices, etc.

In an embodiment, the PnP function is performed by the BIOS firmware during a boot process. At the appropriate step of the boot process, the BIOS will follow a procedure to discover and configure the PnP components in the AV. An example basic PnP configuration includes the following steps: 1) create a resource table of the available interrupt requests (IRQs), direct memory access (DMA) channels and I/O addresses, excluding any that are reserved for system components; 2) search for and identify PnP and non-PnP devices on AV buses or switches; 3) load the last known system configuration stored in non-volatile memory; 4) compare the current configuration to the last known configuration. If the current and last known configurations are unchanged; 5) continue with the boot.

If the current and last known configurations are changed, the following additional steps are performed: 6) begin a system reconfiguration by eliminating any resources in the resource table being used by non-PnP devices; 7) checking the BIOS settings to see if any additional system resources have been reserved for use by non-PnP components and eliminate any of these from the resource table; 8) assign resources to PnP cards from the resources remaining in the resource table, and inform the components of their new assignments; 9) update the configuration data by saving to it as a new system configuration; and 10) continue with the boot process.

After the basic configuration is completed, a redundancy configuration is performed that includes searching a redundancy table (e.g., stored in storage device 6104) to determine if the new component forms redundant pair with another component of the AV, where the redundant pair of components must be compatible to not violate the redundancy model of the AV. If the new component 6113 is in the redundancy table, the list of characteristics (e.g., performance specifications, sensor attributes) provided by the new component 6113 are compared to a list of characteristics required by the redundancy model that is stored in storage device 6104. If there is a mismatch of characteristics indicating incompatibility, then the driver of the AV or a technician (e.g., if the AV is in an auto repair shop) is notified of the incompatibility (e.g., through a display). In an embodiment, the AV may also be disabled so that it cannot be driven until a compatible component has been added that does not violate the redundancy model of the AV.

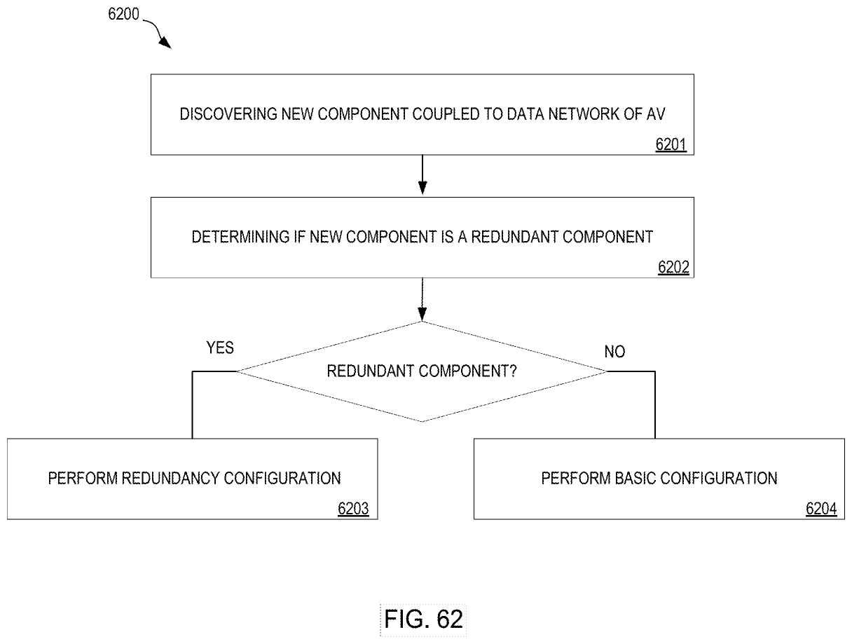

FIG. 62 shows a flow diagram of an example process 6200 of replacing redundant components in an AV.

Process 6200 begins by detecting a new component coupled to a data network of an AV (6201). For example, the component can be coupled to the data network through a PCIe switch. Some examples of components include but are not limited to: sensors, actuators, controllers and hubs coupled to multiple components.

Process 6200 continues by the AV OS discovering the new component with AV OS (6201), and determining if the new component is a redundant component and has a counterpart redundant component (6202). For example, a redundancy table can be searched to determine if the new component is replacing a redundant component and therefore must be compliant with a redundancy model for the AV, as described in reference to FIG. 61.

In accordance with the new component being a redundant component, process 6200 performs a redundancy configuration (6203). In accordance with the new component not being a redundant component, process 6200 performs a basic configuration (6204). The basic and redundant configuration steps were previously described with reference to FIG. 61. In an embodiment, the redundant configuration includes the basic configuration and additional steps to determine compliance of the new module with the redundancy model of the AV.

### Redundant Planning

In an embodiment, a perception module provides a scene description into an in-scope check module that determines if the scene description is within the operational domain of the autonomous vehicle (“in-scope”). The operational domain of the autonomous vehicle is a geographic region in which the autonomous vehicle is operating, including all fixed and dynamic objects in the geographic region that are known to the autonomous vehicle. An “in-scope” condition is violated when a scene description includes one or more objects (e.g., new stop sign, construction zone, policeman directing traffic, invalid road network graph) that are not within the operational domain of the autonomous vehicle.

If the scene description is “in-scope,” the perception module provides the scene description as input to two independent and redundant planning modules. Each planning module includes a behavior inference module and a motion planning module. The motion planning modules each generate a trajectory (or trajectory corridor) for the autonomous vehicle using a motion planning algorithm that takes as input the position of the autonomous vehicle and static map data. In an embodiment, the position of the autonomous vehicle is provided by a localization module, such as localization module 408, as described in reference to FIG. 4, or by a source external to the autonomous vehicle.

Each planning module receives the trajectory (or trajectory corridor) generated by the other planning module and evaluates the trajectory for a collision with at least one object in the scene description. The behavior inference modules use different behavior inference models. For example, a first behavior inference module implemented by a first planning module can evaluate a trajectory (or trajectory corridor) generated by a second planning module using a constant-velocity (CV) and/or constant-acceleration (CA) model. Similarly, a second behavior inference module implemented in the second planning module can evaluate the first trajectory (or trajectory corridor) generated by the first planning module using a machine learning algorithm.

In an embodiment, data inputs/outputs of each planning modules are subjected to independent diagnostic monitoring and plausibility checks to detect hardware and/or software errors associated with the planning modules. Because there are no common cause failures between the redundant planning modules, it is unlikely that the redundant planning modules will fail at the same time due to hardware and/or software errors. The results of the diagnostic monitoring and plausibility checks and the results of the trajectory evaluations determine an appropriate action for the autonomous vehicle, such as a safe stop maneuver or emergency braking.

In an embodiment, one of the planning modules is used during nominal operating conditions and the other planning module is used for safe stopping in an ego-lane (hereinafter also referred to as “degraded mode”). In an embodiment, the planning modules do not perform any functions other than evaluating the trajectory provided by the other planning module for collision with at least one object.

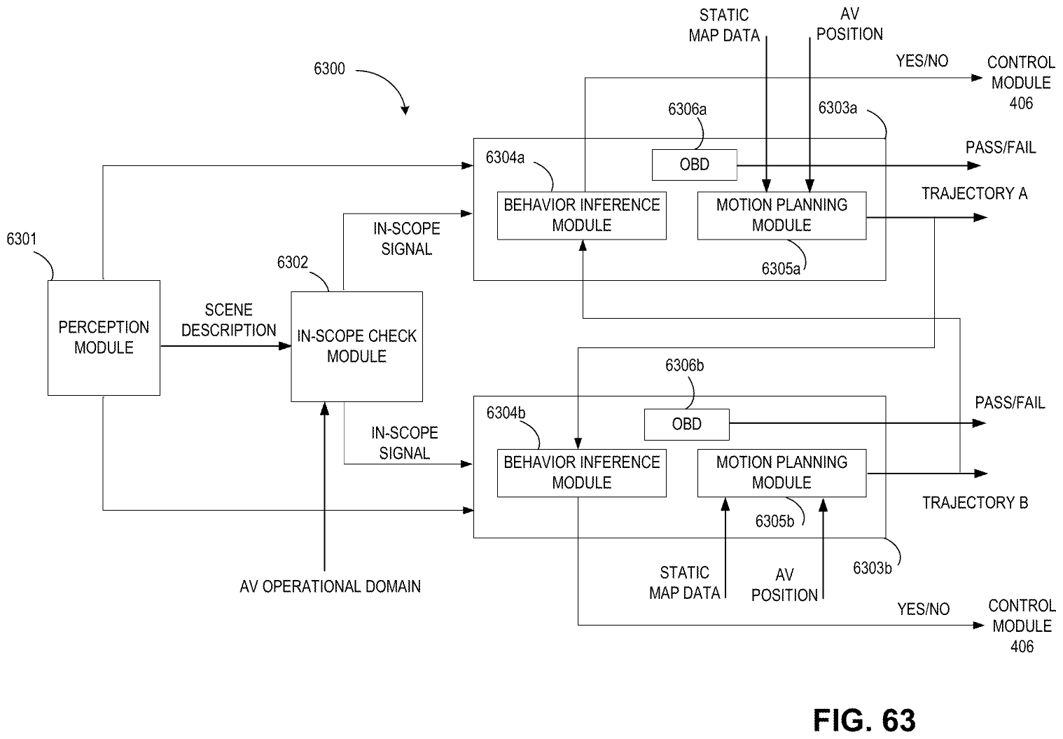

FIG. 63 shows a block diagram of a redundant planning system 6300, according to an embodiment. System 6300 includes perception module 6301, in-scope check module 6302 and planning modules 6303a, 6303b. Planning module 6303a further includes behavior inference module 6304a, motion planning module 6305a and onboard diagnostics (OBD) module 106a. Planning module 6303b further includes behavior inference module 6304b, motion planning module 6305b and OBD module 6306a.

Perception module 6301 (previously described as perception module 402 in reference to FIG. 4) identifies nearby physical objects using one or more sensors. In an embodiment, the objects are classified into types (e.g., pedestrian, bicycle, automobile, traffic sign, etc.), and a scene description including the classified objects 416 (also referred to as a “scene description”) is provided to redundant planning modules 6303a, 6303b. Redundant planning modules 6303a, 6303b also receive data (e.g., latitude, longitude, altitude) representing the AV position 418 from localization module 408 (shown in FIG. 4) or from a source external to the AV. In an embodiment, the scene description is provided over a wireless communications medium by a source external to the AV (e.g., a cloud-based source, another AV using V2V).

In-scope check module 6302 determines if the scene description is “in-scope” which means the scene description is within the operational domain of the AV. If “in-scope”, the in-scope check module 6302 outputs an in-scope signal. Depending on the defined operational domain of the AV, in-scope check module 6302 looks for “out-of-scope” conditions to determine if the operational domain of the AV has been violated. Some examples of out-of-scope conditions include but are not limited to: constructions zones, some weather conditions (for example, storms, heavy rains, dense fog, etc.), a policeman directing traffic and an invalid road network graph (e.g., a new stop sign, lane closure). If the autonomous vehicle is unaware that it is operating out-of-scope, safe operation of the autonomous vehicle cannot be guaranteed (e.g., the autonomous vehicle may run a stop sign). In an embodiment, the failure of the AV to pass the “in-scope” check results in a safe stop maneuver.

The in-scope signal is input to planning modules 6303a, 6303b. If “in-scope,” motion planning modules 6305a, 6305b independently generate trajectories for the AV, which are referred to in this example embodiment as trajectory A and trajectory B, respectively. The motion planning modules 6305a, 6305b use common or different motion planning algorithm, static map and AV position to independently generate the trajectories A and B, as described in reference to FIG. 9.

Trajectory A is input into behavior inference module 6304b of planning module 6303b and trajectory B is input into behavior inference module 6304a of planning module 6303a. Behavior inference modules 6304a, 6304b implement different behavior inference models to determine if trajectories A and B will collide with at least one object in the scene description. Any desired behavior inference model can be used to determine a collision with an object in the scene description. In an embodiment, behavior inference module 6304a uses a constant-velocity (CV) model and/or a constant-acceleration (CA) model to infer object behavior, and behavior inference module 6304b uses a machine learning model (e.g., a convolutional neural network, deep learning, support vector machine, classifier) to infer object behavior. Other examples of behavior inference models include but are not limited to: game-theoretic models, probabilistic models using partially observable Markov decision processes (POMDP), Gaussian mixture models parameterized by neural networks, nonparametric prediction models, inverse reinforcement learning (IRL) models and generative adversarial imitation learning models.

In an embodiment, the output signals (e.g., Yes/No) of the behavior inference modules 6304a, 6304b indicate whether or not the trajectories A and/or B collide with at least one object in the scene description. In the case of a collision detection, the output signals can be routed to another AV module to affect a “safe stop” maneuver or emergency braking, such as control module 406, as described in reference to FIG. 4. In an embodiment, a “safe stop maneuver” is a maneuver performed during an emergency (e.g., a system malfunction, an emergency stop initiated by a passenger in the autonomous vehicle, natural disasters, inclement weather conditions, road accidents involving the autonomous vehicle or other vehicles in the environment etc.) by the autonomous vehicle.

In an embodiment, OBD 6306a and OBD 6306b provide independent diagnostic coverage for planning modules 6303a, 6303b, respectively, including monitoring their respective inputs/outputs and performing plausibility checks to detect hardware and/or software errors. OBD 6306a and OBD 6306b output signals indicating the results of their respective diagnostic tests (e.g., Pass/Fail). In an embodiment, other output signals or data can be provided by OBD 6306a and OBD 6306b, such as codes (e.g., binary codes) indicating a type of failure and a severity level of the failure. In the case of a failure, the output signals are routed to another AV module to affect a “safe stop” maneuver or emergency braking, such as control module 406 described in reference to FIG. 4.

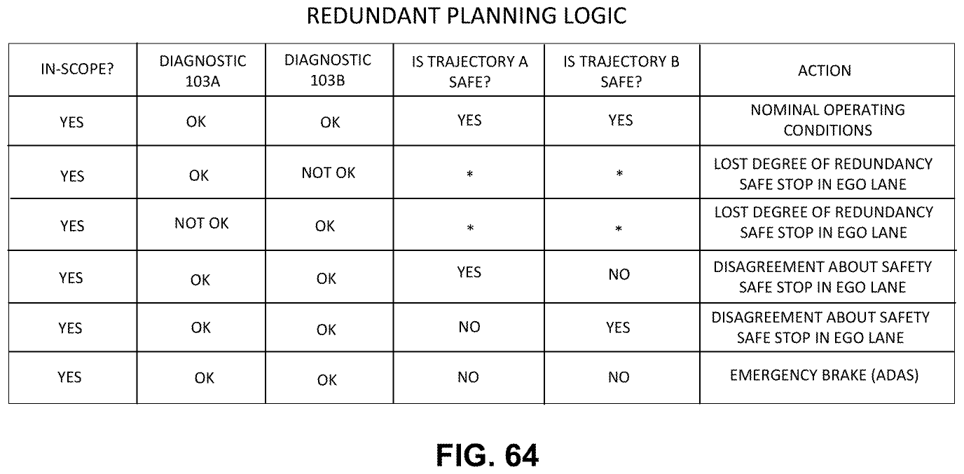

FIG. 64 shows a table illustrating redundant planning logic performed by the redundant planning modules shown in FIG. 63. Each row in the table represents a combination of output signals leading to a particular action to be performed by the AV. Referring to row 1 of the table, if the scene description is within the scope of the AV operational domain (“in-scope”), and there are no diagnostic failures or unsafe trajectories due to collisions, the AV maintains a nominal operating condition. Referring to rows 2 and 3 of the table, if “in-scope” and the diagnostics covering planning module 6303a or 6303b indicate failure, there is a lost degree of redundancy and the AV initiates a “safe stop” maneuver in an ego lane. Referring to rows 4 and 5, if “in-scope” and diagnostics of both planning modules 6303a, 6303b pass, and either planning module 6303a or planning module 6303b detects an unsafe trajectory due to a collision, then there is a disagreement about the safety of the trajectory between planning modules 6303a, 6303b, and the AV initiates a “safe stop” maneuver in an ego lane. Referring to row 6, if the diagnostics of both planning modules 103a, 103b pass, and both planning modules 103a, 103b have detected collisions, then the AV initiates an AEB using, for example, an Advanced Driver Assistance System (ADAS) component in the AV. In an embodiment, only planning module 103a is used during nominal operating conditions and planning module 103b is used only for safe stopping in the ego lane when the AV is operating in a “degraded” mode.

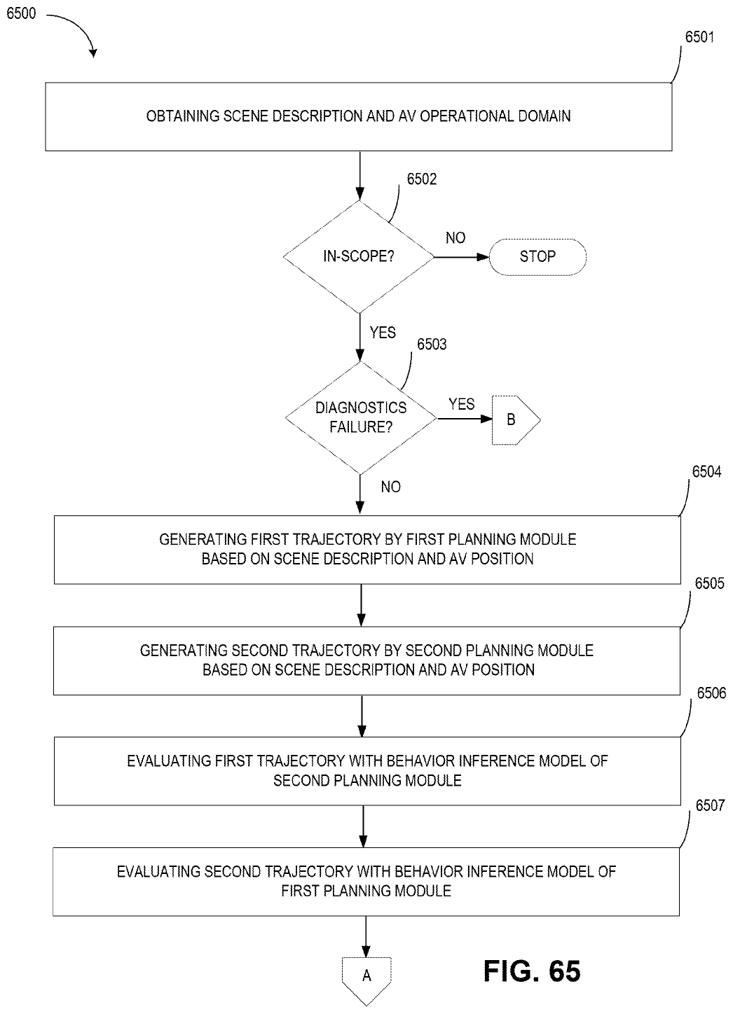

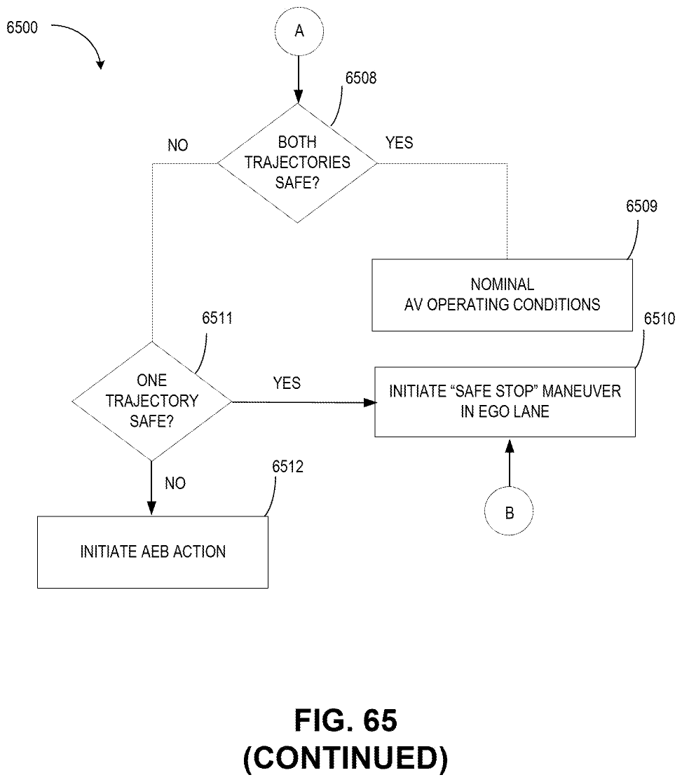

FIG. 65 shows a flow diagram of a redundant planning process 6500. Process 6500 can be implemented by the AV architecture shown in FIGS. 3 and 4. Process 6500 can begin by obtaining a scene description of the operating environment from a perception module or external source, and a description of the AV operational domain (6501). Process 6500 continues by determining (6502) if the scene description is within the operational domain of the AV (6502). If not, process 6500 stops. If yes, process 6500 determines (6503) if the diagnostics of one or both of the redundant planning modules indicate a failure of hardware and/or software. In accordance with determining a failure, a “safe stop” maneuver is initiated by the AV (6510).

In accordance with determining that there is no failure due to hardware and/or software, process 6500 continues by generating, by a first planning module, a first trajectory using the scene description and the AV position (6505), and generating, by a second planning module, a second trajectory using the scene description and the AV position (6506). Process 6500 continues by evaluating the second trajectory using a first behavior inference model of the first planning module for a collision, and evaluating the first trajectory using a second behavior inference model of the second planning module for a collision (6507). In accordance with process 6500 determining (6508) that both the first and second trajectory are safe, the AV operates under nominal conditions (6509) and redundancy is unaffected. In accordance with process 6500 determining (6511) that one of the first or second trajectories is unsafe, the AV performs a “safe stop” maneuver in an ego lane (6510). In accordance with process 6500 determining (6508) that the first and the second trajectories are unsafe, the AV performs emergency braking (6512) as a last resort.

### Redundancy Using Simulations

Simulations of AV processes, subsystems and systems are used to provide redundancy for the processes/subsystems/systems by using the output of a first process/subsystem/system as input into a simulation of a second process/subsystem/system, and using the output of the second process/subsystem/system as input into a simulation of the first process/subsystem/system. Additionally, each process/subsystem/system is subjected to independent diagnostic monitoring for software or hardware errors. A redundancy processor takes as inputs the outputs of each process/subsystem/system, the outputs of each simulation and the results of the diagnostic monitoring to determine if there is a potential failure of one or both of the processes or systems. In accordance with determining a failure of a process/subsystem/system, the autonomous vehicle performs a “safe stop” maneuver or other action (e.g., emergency brake). In an embodiment, one or more external factors (e.g., environmental conditions, road conditions, traffic conditions, AV characteristics, time of day) and/or a driver profile (e.g., age, skill level, driving patterns) are used to adjust the simulations (e.g., adjust one or more models used in the simulations).

As used herein, “simulation” means an imitation of the operation of a real-world process or system of an AV sensor or subsystem, which may or may not be represented by a “model” that represents key characteristics, behaviors and functions of the process or system.

As used herein, “model” means the purposeful abstraction of reality, resulting in a specification of the conceptualization and underlying assumptions and constraints of a real-world process or system.

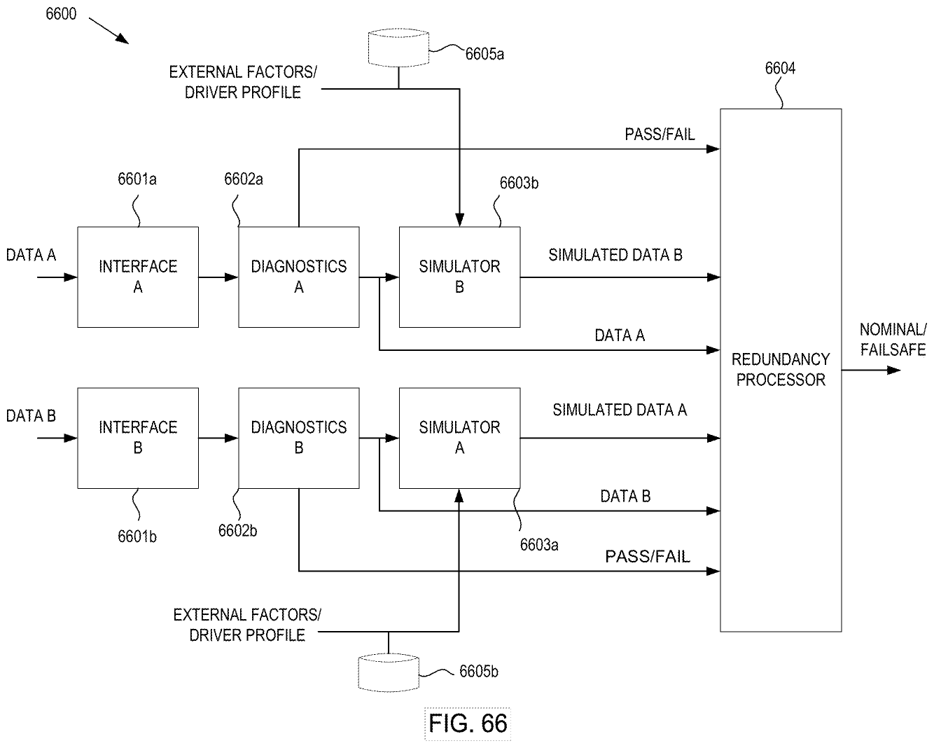

FIG. 66 shows a block diagram of a system 6600 for implementing redundancy using simulations. In an embodiment, system 6600 includes interfaces 6601a, 6601b, diagnostic modules 6602a, 6602b, simulators 6603a, 6603b and redundancy processor 6604. Diagnostic modules 6602a, 6602b are implemented in hardware and/or software, and simulators 6603a, 6603b are implemented in software that runs on one or more computer processors.

When operating in a nominal operating mode, Data A from a first AV process/subsystem/system is input to interface 101a, which converts and/or formats Data A into a form that is acceptable to simulator 6603b. The converted/formatted Data A is then input into diagnostic module 6602a, which monitors for hardware and software errors and outputs data or a signal indicating the result of the monitoring (e.g., Pass or Fail). Data A is then input into simulator 6603b (“Simulator B”), which performs a simulation of a second AV process/subsystem/system using Data A.

Concurrently (e.g., in parallel), Data B from the second AV process/subsystem/system is input to interface 101b, which converts and/or formats Data B into a form that is acceptable to simulator 6603a. The converted/formatted Data B is then input into diagnostic module 6602b, which monitors for hardware and software errors and outputs data or a signal indicating the result of the monitoring (e.g., Pass or Fail). Data B is then input into simulator 6603a (“Simulator A”), which performs a simulation of the first AV process/system using Data B.

In an embodiment, system 6600 is implemented using real-time (RT) simulations and hardware-in-the-Loop (HIL) techniques, where hardware (e.g., sensors, controllers, actuators) is coupled to RT simulators 6603a, 6603b by I/O interfaces 6601a, 6601b. In an embodiment, I/O interfaces 6601a, 6601b include analog-to-digital (AD) and digital-to-analog (DAC) converters that convert analog signals output by the hardware to digital values that can be processed by the RT simulations. The I/O interfaces 6601a, 6601 b can also provide electrical connections, power and data aggregation (e.g., buffers).

Data A, Data B, the outputs of diagnostic modules 6602a, 6602b and the outputs of simulators 103a, 103b (simulated Data A, Data B) are all input into redundancy processor 6604. Redundancy process 6604 applies logic to these inputs to determine whether or not a failure of the first or second process/system has occurred. In accordance with determining that a failure of the first or second process/system has occurred, the AV performs a “safe stop” maneuver or other action. In accordance with determining that a failure of the first or second process/system has not occurred, the AV continues operating in nominal mode.

In an embodiment, the logic implemented by redundancy processor 6604 is shown in Table I below.

TABLE I
Example Simulation Redundancy Logic

| Diagnostic A | Diagnostic B | Simulator A | Simulator B | |
|---|---|---|---|---|
| Fail? | Fail? | Fail? | Fail? | Action |
| N | N | N | N | Nominal |
| N | Y | * | * | Safe Stop |
| Y | N | * | * | Safe Stop |
| N | N | N | Y | Safe Stop |
| N | N | Y | N | Safe Stop |
| N | N | Y | Y | Emergency |
| | | | | Brake |

As shown in Table I above, if diagnostic modules A and B do not indicate a failure and simulators A and B do not indicate a failure, the AV continues in a nominal mode of operation. If at least one diagnostic module indicates failure or one simulator indicates failure, the AV performs a safe stop maneuver or other action using the process/system that has not failed. If both simulators indicate failure, the AV performs emergency braking.

In an embodiment, simulators 6603b, 6603a receive real-time data streams and/or historical data from storage devices 6605b, 6605a. The data streams and storage devices 105a, 105b provide external factors and/or a driver profile to simulators 6603a, 6603b which use the external factors and/or driver profile to adjust one or more models of the processes/systems being simulated. Some examples of external factors include but are not limited to: weather conditions (e.g., rain, snow, sleet, foggy, temperature, wind speed), road conditions (e.g., steep grades, closed lanes, detours), traffic conditions (e.g., traffic speed, accidents), time of day (e.g., daytime or nighttime), AV characteristics (e.g., make, model, year, configuration, fuel or battery level, tire pressure) and a driver profile (e.g., age, skill level, driving patterns). The external factors can be used to adjust or “tune” one or more models in simulators 6603a, 6603b. For example, certain sensors (e.g., LiDAR) may behave differently when operating in rain and other sensors (e.g., cameras) may behave differently when operating at nighttime or in fog.

An example driver profile includes the driver's age, skill level and historical driving patterns. The historical driving patterns can include but are not limited to: acceleration and braking patterns. Driving patterns can be learned over time using a machine learning algorithm (e.g., deep learning algorithm) implemented on a processor of the AV.

In an embodiment, one or both of simulators 6603a, 6603b implement a virtual world using fixed map data and a scene description provided by the perception module 408 that includes the AV and other fixed and dynamic objects (e.g., other vehicles, pedestrians, buildings, traffic lights). Simulators 6603a, 6603b simulate the AV in the virtual world (e.g., 2D or 3D simulation) with the external factors and/or driver profile to determine how the AV will perform and whether a failure is likely to occur.

In an embodiment, historical data stored in data storage devices 6605a, 6605b are used to perform data analytics to analyze past failures of AV processes/systems and to predict future failures of AV processes/systems.

To further illustrate the operation of system 6600, an example scenario will not be described. In this example scenario two redundant sensors are being simulated: a LiDAR sensor and a stereo camera. The AV is traveling on a road segment in a nominal mode of operation. The LiDAR outputs point cloud data that is processed by the perception module 402 shown in FIG. 4. The perception module 402 outputs a first scene description that includes one or more classified objects (e.g., vehicles, pedestrians) detected from the LiDAR point cloud data. Concurrent (e.g., in parallel) with the LiDAR processing, the stereo camera captures stereo images which are also input into the perception module 402. The perception module 402 outputs a second scene description of one or more classified objects detected from the stereo image data.

The LiDAR and stereo camera are included in independent HIL processes that run concurrently. A first HIL process includes the LiDAR hardware coupled through the first I/O interface 6601a to a first RT simulator 6603b that simulates operation of the stereo camera using the first scene description. A second HIL process includes the stereo camera hardware coupled through the second I/O interface 6601b to a second RT simulator 6603a that simulates the LiDAR hardware using the second scene description. Additionally, both the LiDAR and stereo camera are monitored by independent diagnostic modules 6602a, 6602b, respectively, for hardware and/or software errors. The simulators 6603a, 6603b are implemented on one or more hardware processors. The I/O interfaces 6601a, 6601b are hardware and/or software or firmware that provide electrical connections, supply power and perform data aggregation, conversion and formatting as needed for the simulators 103a, 103b.

The LiDAR simulator 6603b uses the position coordinates of the classified objects in the second scene description generated from the stereo camera data to compute a simulated LiDAR scene description. LiDAR depth data can be simulated using the location of the AV obtained from localization module 408 (FIG. 4) and ray-casting techniques. Concurrently, the stereo camera simulator 6603a uses the position coordinates of the objects in the first scene description generated from the LiDAR point cloud data to compute a simulated stereo camera scene description. Each simulator 103a, 103b provides as output their respective simulated scene descriptions to redundancy processor 6604. Additionally, each of the diagnostic modules 6602a, 6620b outputs a pass/fail indicator to the redundancy processor 6604.

The redundancy processor 104 executes the logic shown in Table I above. For example, if the diagnostic modules 102a, 102b do not indicate that the LiDAR or stereo camera hardware or software has failed, the LiDAR scene description matches the simulated LiDAR scene description (e.g., all classified objects are accounted for in both scene descriptions), and the stereo camera scene description matches the simulated stereo camera scene description, then the AV continues to operate in nominal mode. If the LiDAR and stereo camera hardware or software have not failed, and one of the LiDAR or stereo camera scene description does not match its corresponding simulated scene description, the AV performs a “safe stop” maneuver or other action. If one of the LiDAR or stereo camera has a hardware or software failure, the AV performs a “safe stop” maneuver or other action. If the LiDAR and stereo camera do not have a hardware or software error, and neither the LiDAR nor the stereo camera scene descriptions match their simulated scene descriptions, the AV applies an emergency brake.

The example scenario described above is not limited to perception/planning processes/subsystems/systems. Rather, simulators can be used to simulate processes/subsystems/systems used in other AV functions, such as localization and control. For example, a GNSS receiver can be simulated using inertial data (e.g., IMU data), LiDAR map-based localization data, visual odometry data (e.g., using image data), or RADAR or vision-based feature map data (e.g., using non-LiDAR series production sensors).

In an embodiment, one simulator uses the data output by the other simulator, e.g., as previously described in reference to FIGS. 13-29.

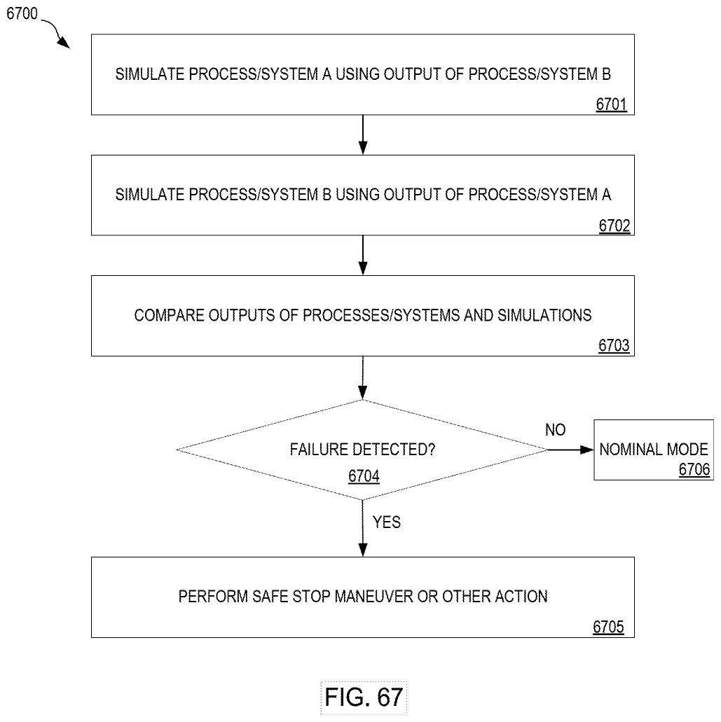

FIG. 67 shows a flow diagram of a process 6700 for redundancy using simulations. Process 6700 can be implemented by system 400 shown in FIG. 4.

Process 6700 begins by performing, by a first simulator, a simulation of a first AV process/system (e.g., simulating a LiDAR) using data (e.g., stereo camera data) output by a second AV process/system (e.g., a stereo camera) (6701), as described in reference to FIG. 66.

Process 6700 continues by performing, by a second simulator, a simulation of the first AV process/system using data output by the second AV process/system (6702).

Process 6700 continues by comparing outputs of the first and second processes and systems (e.g., scene descriptions based on LiDAR point cloud data and stereo camera data) with outputs of their corresponding simulated processes and systems (6703), and in accordance with determining (6704) that a failure has occurred (or will occur in the future based on a prediction model), causing the AV perform a “safe stop” maneuver or other action (6705). Otherwise, causing the AV to continue operating in nominal mode (6706).

In an embodiment, process 6700 includes monitoring, by independent diagnostic modules, the redundant processes or systems for hardware or software errors, and using the outputs of the diagnostic modules (e.g., pass/fail indicators) in combination with the outputs of the simulators to determine if a failure of one or both of the redundant processes or systems has occurred or will occur, and causing the AV to take action in response to the failure (e.g., “safe stop” maneuver, emergency braking, nominal mode).

### Union of Perception Inputs

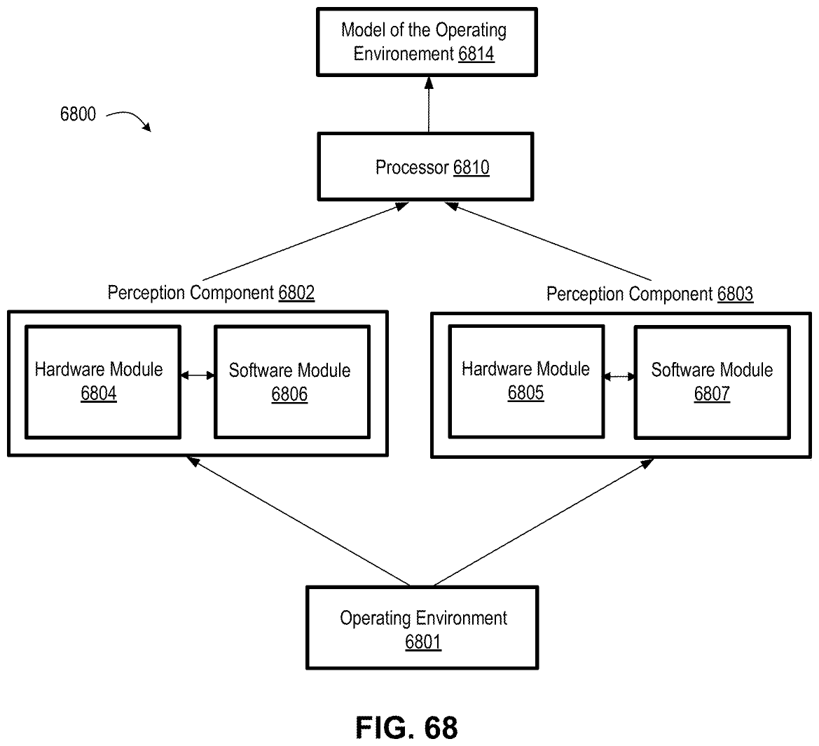

FIG. 68 shows a block diagram of a vehicle system for unionizing perception inputs to model an operating environment, according to an embodiment. A vehicle system 6800 includes two or more perception components, e.g., the perception components 6802 and 6803, each capable of independently performing a perception function with respect to the operating environment 6801. Example perception functions include the detection, tracking, and classification of various objects and backgrounds present in the operating environment 6801. In an embodiment, the perception components 6802 and 6803 are components of the perception module 402 shown in FIG. 4.

In an embodiment, the perception components implement both hardware and software-based perception techniques. For example, the perception component 6802 can include a hardware module 6804 consisting of complementary sensors such as LiDARs, RADARs, sonars, stereo vision systems, mono vision systems, etc., e.g., the sensors 121 shown in FIG. 1. The perception component 6802 can further include a software module 6806 executing one or more software algorithms to assist the perception function. For example, the software algorithms can include feedforward neural networks, recurrent neural networks, fully convolutional neural networks, region-based convolutional neural networks, You-Only-Look-Once (YOLO) detection models, single-shot detectors (SDD), stereo-matching algorithms, etc. The hardware module 6804 and the software module 6806 can share, compare, and cross-check their respective perception outputs to improve an overall perception accuracy for the perception component 6802.

In an embodiment, the perception components each perform an independent and complementary perception function. Results from different perception functions can be cross-checked and fused (e.g., combined) by a processor 6810. Depending on the operating environment, one perception function may be more suited to detecting certain objects or conditions, and the other perception function may be more suited to detecting other objects or conditions, and data from one can be used to augment data from the other in a complementary manner. As one example, the perception component 6802 can perform dense free space detection while the perception component 6803 can perform object-based detection and tracking. A free space is defined as an area in the operating environment 6801 that does not contain an obstacle and where a vehicle can safely drive. For example, unoccupied road surfaces are free space but road shoulders (sometimes referred to as “breakdown lanes”) are not. Free space detection is an essential perception function for autonomous/semi-autonomous driving as it is only safe for a vehicle to drive in free space. The goal of object-based detection and tracking, on the other hand, is to discover the current presence and to predict the future trajectory of an object in the operating environment 6801. Accordingly, data obtained using both perception functions can be combined to better understand the surrounding environment.

The processor 6810 compares and fuses the independent outputs from the perception components 6802 and 6803 to produce a unionized model of the operating environment 6814. In one example, each perception output from a perception component is associated with a confidence score indicating the probability that the output is accurate. The perception component generates a confidence score based on factors that can affect the accuracy of the associated data, e.g., data generated during a rainstorm may have a lower confidence score than data generated during clear weather. The degree of unionization is based on the confidence scores and the desired level of caution for the unionization. For example, if false positives are much preferred to false negatives, a detected object with a low confidence score will still be added to a detected free space with a high confidence score.

In one example, the perception component 6802 can use one or more LiDARs or cameras, e.g., mono or stereo cameras, to detect free space in the operating environment 6801. A LiDAR can directly output 3D object maps, but has limited operating range relative to other techniques and may encounter performance degradation in unfavorable weather conditions. In contrast, while a mono or stereo camera can sense different colors, a camera requires illumination for operation and can produce distorted data due to lighting variation.

In an embodiment, to obtain the performance advantages of the use of both LiDARs and cameras in detecting free space, the perception component 6802 can acquire redundant measurements using both types of sensors and fuse the perception data together. For example, the perception component 6802 can use a stereo camera to capture depth data beyond the operating range of a LiDAR. The perception component 6802 can then extend the 3D object map created by the LiDAR by matching spatial structures in the 3D object map with those in the stereo camera output.

In another example, the perception component can fuse data obtained from LiDARs and mono cameras. Mono cameras typically perceive objects in a two-dimensional image plane which impedes measurement of distance between objects. Accordingly, to assist with distance measurement, the outputs from the mono cameras can be first fed to a neural network, e.g., running in the software module 6806. In an embodiment, the neural network is trained to detect and estimate a distance between objects from mono camera images. In an embodiment, the perception component 6802 combines the distance information produced by the neural network with a 3D object map from the LiDAR.

In one example, the perception component 6803 can take redundant measurements of the operating environment 6801 using one or more 360° mono cameras and RADARs. For example, an object detected by a RADAR can be overlaid onto a panoramic image output captured by a 360° mono camera.

In an embodiment, the perception component 6803 uses one or more software algorithms for detecting and tracking objects in the operating environment 6801. For example, the software module 6807 can implement a multi-model object tracker that links objects detected by a category detector, e.g., a neural network classifier, to form an object trajectory. In an embodiment, the neural network classifier is trained to classify commonly-seen objects in the operating environment 6801 such as vehicles, pedestrians, road signs, road markings, etc. In an example, the object tracker can be a neural network trained to associate objects across a sequence of images. The neural network can use object characteristics such as position, shape, or color to perform the association.

In an embodiment, the processor 6810 compares the output from the perception component 6802 against the output from the perception component 6803 to detect a failure or failure rate of one of the perception components. For example, each perception component can assign a confidence score to its respective output as different perception functions, e.g., free space detection and object detection and tracking, and produces results with different confidence under different conditions. When an inconsistency appears, the processor 6810 disregards the output from the perception component with the lower confidence score. In another example, the vehicle system 6800 has a third perception component implementing a different perception method. In this example, the processor 6810 causes the third perception component to perform a third perception function and rely on the majority result, e.g., based on consistency in output between two of the three perception components.

In an embodiment, the processor 6810 causes the perception components 6802 and 6803 to provide safety checks on each other. For example, initially, the perception component 6802 is configured to detect free space in the operating environment 6801 using LiDARs, while the perception component 6803 is configured to detect and track objects using a combination of neural networks and stereo cameras. To perform the cross-safety checks, the processor 6810 can cause the neural networks and the stereo cameras to perform free space detection, and the LiDARS to perform object detection and tracking.

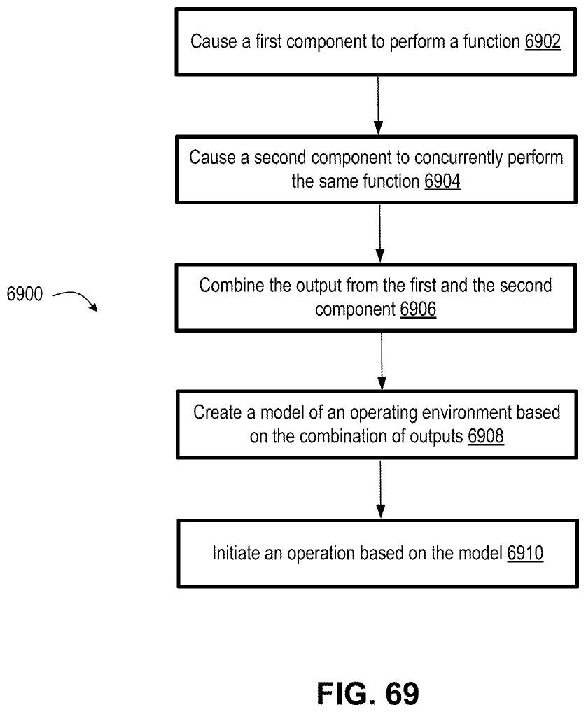

FIG. 69 shows an example process 6900 for unionizing perception inputs to create a model of an operation environment, according to an embodiment. For convenience, the example process 6900 will be described below as performed by a vehicle system, e.g., the vehicle system 6800 of FIG. 68.

The vehicle system causes a first component to perform a function (step 6902). For example, the function can be a perception function and the first component can be a hardware perception system including one or more LiDARs, stereo cameras, mono cameras, RADARs, sonars, etc. In another example, the first component can be a software program configured to receive and analyze data outputs from a hardware sensor. In an embodiment, the software program is a neural network trained to detect and track objects in image data or object maps.

The vehicle system concurrently causes a second component to perform the same function as the first component (step 6904). For example, the second component can be a hardware perception system or software program similar to the first component to perform a perception function on the operating environment.

After the first and the second components produce respective data outputs, the vehicle system combines and compares the outputs to create a model of the operating environment (steps 6906-6908). For example, the first component can be configured to detect free space in the operating environment while the second component can be configured to detect and track objects in the operating environment. The vehicle systems can compare the outputs from the first and the second components by matching their respective spatial features, and create a unionized model of the operating environment. The unionized model can be a more accurate representation of the operating environment compared to the output by the first or the second component alone.

After obtaining a unionized model of the operating environment, the vehicle system initiates an operation based on the characteristics of the model (step 6910). For example, the vehicle system can adjust vehicle speed and trajectory to avoid obstacles present in the model of the operating environment.

In the foregoing description, embodiments of the invention have been described with reference to numerous specific details that may vary from implementation to implementation. The description and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

Item 1. A system comprising:
two or more different autonomous vehicle operations subsystems, each of the two or more different autonomous vehicle operations subsystems being redundant with another of the two or more different autonomous vehicle operations subsystems;

wherein each operations subsystem of the two or more different autonomous vehicle operations subsystems comprises:

a solution proposer configured to propose solutions for autonomous vehicle operation based on current input data, and

a solution scorer configured to evaluate the proposed solutions for autonomous vehicle operation based on one or more cost assessments;

wherein the solution scorer of at least one of the two or more different autonomous vehicle operations subsystems is configured to evaluate both the proposed solutions from the solution proposer of the at least one of the two or more different autonomous vehicle operations subsystems and at least one of the proposed solutions from the solution proposer of at least one other of the two or more different autonomous vehicle operations subsystems; and

an output mediator coupled with the two or more different autonomous vehicle operations subsystems and configured to manage autonomous vehicle operation outputs from the two or more different autonomous vehicle operations subsystems.

Item 2. The system of item 1, wherein the two or more different autonomous vehicle operations subsystems are included in a perception stage of autonomous vehicle operation.

Item 3. The system of any preceding item, wherein the two or more different autonomous vehicle operations subsystems are included in a localization stage of autonomous vehicle operation.

Item 4. The system of any preceding item, wherein the two or more different autonomous vehicle operations subsystems are included in a planning stage of autonomous vehicle operation.

Item 5. The system of any preceding item, wherein the two or more different autonomous vehicle operations subsystems are included in a control stage of autonomous vehicle operation.

Item 6. The system of any preceding item, wherein the solution scorer of the at least one of the two or more different autonomous vehicle operations subsystems is configured to (i) determine a preferred one of the proposed solutions from two or more of the solution proposers of the at least one of the two or more different autonomous vehicle operations subsystems, and a preferred one of the alternative solutions from at least another one of the two or more different autonomous vehicle operations subsystems, (ii) compare the preferred solution with the preferred alternative solution, and (iii) select between the preferred solution and the preferred alternative solution based on the comparison.

Item 7. The system of any preceding item, wherein the solution scorer of the at least one of the two or more different autonomous vehicle operations subsystems is configured to compare and select between the proposed solution and the alternative solution based on a cost assessment that favors continuity with one or more prior solutions selected for operation of the autonomous vehicle.

Item 8. The system of any preceding item, wherein the solution scorer of the at least one of the two or more different autonomous vehicle operations subsystems is configured to compare the proposed solutions with more than one alternative solutions received from others of the two or more different autonomous vehicle operations subsystems, and select among the proposed solutions and the alternative solutions.

Item 9. The system of any of items 1-8, wherein the at least one other of the two or more different autonomous vehicle operations subsystems is configured to provide additional autonomous vehicle operations solutions that are not redundant with the autonomous vehicle operations solutions of the at least one of the two or more different autonomous vehicle operations subsystems.

Item 10. The system of any of items 1-8, wherein the at least one other of the two or more different autonomous vehicle operations subsystems is configured to only provide autonomous vehicle operations solutions that are redundant with the autonomous vehicle operations solutions of the at least one of the two or more different autonomous vehicle operations subsystems.

Item 11. The system of any of items 1-8, wherein each of the two or more different autonomous vehicle operations subsystems comprises a pipeline of operational stages, each stage in the pipeline comprises at least one solution scorer configured to evaluate proposed solutions from at least one solution proposer in the stage, and at least one solution scorer from each pipeline is configured to evaluate a proposed solution from another pipeline.

Item 12. The system of item 11, wherein the pipelines of operational stages comprise:
a first stage solution proposer, of a first pipeline;
a first stage solution scorer, of the first pipeline, configured to evaluate solutions from the first stage first pipeline solution proposer;
a second stage solution proposer, of the first pipeline;
a second stage solution scorer, of the first pipeline, configured to evaluate solutions from the second stage first pipeline solution proposer;
a first stage solution proposer, of a second pipeline;
a first stage solution scorer, of the second pipeline, configured to evaluate solutions from the first stage second pipeline solution proposer;
a second stage solution proposer, of the second pipeline; and
a second stage solution scorer, of the second pipeline, configured to evaluate solutions from the second stage second pipeline solution proposer;
wherein the first stage first pipeline solution scorer is configured to evaluate a solution from the first stage second pipeline solution proposer;
wherein the first stage second pipeline solution scorer is configured to evaluate a solution from the first stage first pipeline solution proposer;
wherein the second stage first pipeline solution scorer is configured to evaluate a solution from the second stage second pipeline solution proposer; and
wherein the second stage second pipeline solution scorer is configured to evaluate a solution from the second stage first pipeline solution proposer.

Item 13. The system of item 12, wherein components of the second pipeline including the first stage solution proposer, the first stage solution scorer, the second stage solution proposer, and the second stage solution scorer share a power supply.

Item 14. The system of item 12, wherein the first stage comprises a perception stage configured to determine a perceived current state of autonomous vehicle operation based on the current input data, and the second stage comprises a planning stage configured to determine a plan for autonomous vehicle operation based on output from the first stage.

Item 15. The system of item 14, wherein the first stage first pipeline solution proposer implements a perception generation mechanism comprising at least one of bottom-up perception (object detection), top-down task-driven attention, priors, or occupancy grids, and wherein the first stage first pipeline solution scorer implements a perception evaluation mechanism comprising at least one of computation of likelihood from sensor models.

Item 16. The system of item 12, wherein the first stage comprises a planning stage configured to determine a plan for autonomous vehicle operation based on the current input data, and the second stage comprises a control stage configured to determine a control signal for autonomous vehicle operation based on output from the first stage.

Item 17. The system of item 16, wherein the first stage first pipeline solution proposer implements a planning generation mechanism comprising at least one of random sampling, MPC, deep learning, or pre-defined primitives, and wherein the first stage first pipeline solution scorer implements a planning evaluation mechanism comprising at least one of trajectory scoring based on trajectory length, safety, or comfort.

Item 18. The system of item 12, wherein the first stage comprises a localization stage configured to determine a current position of an autonomous vehicle based on the current input data, and the second stage comprises a control stage configured to determine a control signal for autonomous vehicle operation based on output from the first stage.

Item 19. The system of item 12, wherein the pipelines of operational stages comprise:
a third stage solution proposer, of the first pipeline;
a third stage solution scorer, of the first pipeline, configured to evaluate solutions from the third stage first pipeline solution proposer;
a third stage solution proposer, of the second pipeline; and
a third stage solution scorer, of the second pipeline, configured to evaluate solutions from the third stage second pipeline solution proposer;
wherein the third stage first pipeline solution scorer is configured to evaluate a solution from the third stage second pipeline solution proposer; and
wherein the third stage second pipeline solution scorer is configured to evaluate a solution from the third stage first pipeline solution proposer.

Item 20. A method of operating an autonomous vehicle using the system of any of items 1-19

Item 21. A non-transitory computer-readable medium encoding instructions operable to cause data processing apparatus to operate an autonomous vehicle using the system of any of items 1-19.

Item 22. A method for operating, within an autonomous vehicle (AV) system of an AV, two or more redundant pipelines coupled with an output mediator, a first pipeline of the two or more redundant pipelines comprising a first perception module, a first localization module, a first planning module, and a first control module, and a second pipeline of the two or more redundant pipelines comprising a second perception module, a second localization module, a second planning module, and a second control module, wherein each of the first and second controller modules are connected with an output mediator, the method comprising:
receiving, by the first perception module, first sensor signals from a first set of sensors of an AV, and generating, by the first perception module, a first world view proposal based on the first sensor signals;
receiving, by the second perception module, second sensor signals from a second set of the sensors of the AV, and generating, by the second perception module, a second world view proposal based on the second sensor signals;
selecting, by the first perception module, one between the first world view proposal and the second world view proposal based on a first perception-cost function, and providing, by the first perception module, the selected one as a first world view to the first localization module;
selecting, by the second perception module, one between the first world view proposal and the second world view proposal based on a second perception-cost function, and providing, by the second perception module, the selected one as a second world view to the second localization module;
generating, by the first localization module, a first AV position proposal based on the first world view;
generating, by the second localization module, a second AV position proposal based on the second world view;
selecting, by the first localization module, one between the first AV position proposal and the second AV position proposal based on a first localization-cost function, and providing, by the first localization module, the selected one as a first AV position to the first planning module;
selecting, by the second localization module, one between the first AV position proposal and the second AV position proposal based on a second localization-cost function, and providing, by the second localization module, the selected one as a second AV position to the second planning module;
generating, by the first planning module, a first route proposal based on the first AV position;
generating, by the second planning module, a second route proposal based on the second AV position;
selecting, by the first planning module, one between the first route proposal and the second route proposal based on a first planning-cost function, and providing, by the first planning module, the selected one as a first route to the first control module;
selecting, by the second planning module, one between the first route proposal and the second route proposal based on a second planning-cost function, and providing, by the second planning module, the selected one as a second route to the second control module;
generating, by the first control module, a first control-signal proposal based on the first route;
generating, by the second control module, a second control-signal proposal based on the second route;
selecting, by the first control module, one between the first control-signal proposal and the second control-signal proposal based on a first control-cost function, and providing, by the first control module, the selected one as a first control signal to the output mediator;
selecting, by the second control module, one between the first control-signal proposal and the second control-signal proposal based on a second control-cost function, and providing, by the second control module, the selected one as a second control signal to the output mediator; and
selecting, by the output mediator, one between the first control signal and the second control signal, and providing, by the output mediator, the selected one as a control signal to an actuator of the AV.

Item 23. The method of item 22, wherein
the first sensor signals received from the first set of sensors comprise one or more lists of objects detected by corresponding sensors of the first set, and
the second sensor signals received from the second set of sensors comprise one or more lists of objects detected by corresponding sensors of the first set.

Item 24. The method of item 22, wherein
the generating of the first world view proposal comprises creating one or more first lists of objects detected by corresponding sensors of the first set, and
the generating of the second world view proposal comprises creating one or more lists of objects detected by corresponding sensors of the second set.

Item 25. The method of any one of items 22 to 24, wherein
the generating of the first world view proposal is performed based on a first perception proposal mechanism, and
the generating of the second world view proposal is performed based on a second perception proposal mechanism different from the first perception proposal mechanism.

Item 26. The method of any one of items 22 to 25, wherein
the first world view provided at least to the first localization module comprises a first object track of one or more objects detected by the first set of sensors, and
the second world view provided at least to the second localization module comprises a second object track of one or more objects detected by the second set of sensors.

Item 27. The method of any one of items 22 to 26, wherein the first set of sensors is different from the second set of sensors.

Item 28. The method of item 22, further comprising
receiving, by the first localization module, at least a portion of the first sensor signals from the first set of sensors, wherein the generating of the first AV position proposal is further based on the first sensor signals, and
receiving, by the second localization module, at least a portion of the second sensor signals from the second set of sensors, wherein the generating of the second AV position proposal is further based on the second sensor signals.

Item 29. The method of item 28, wherein the generating of the first and second AV position proposals uses one or more localization algorithms including map-based localization, LiDAR map-based localization, RADAR map-based localization, visual map-based localization, visual odometry, and feature-based localization.

Item 30. The method of any one of items 22 and 27-28, wherein
the generating of the first AV position proposal is performed based on a first localization algorithm, and
the generating of the second AV position proposal is performed based on a second localization algorithm different from the first localization algorithm.

Item 31. The method of any one of items 22 and 28 to 30, wherein
the first AV position provided at least to the first planning module comprises a first estimate of a current position of the AV, and
the second AV position provided at least to the second planning module comprises a second estimate of a current position of the AV.

Item 32. The method of item 22, further comprising
receiving, by the first planning module, the first world view from the first perception module, wherein the generating of the first route proposal is further based on the first world view, and
receiving, by the second planning module, the second world view from the second perception module, wherein the generating of the second route proposal is further based on the second world view.

Item 33. The method of item 22 or 32, wherein
the generating of the first route proposal is performed based on a first planning algorithm, and
the generating of the second route proposal is performed based on a second planning algorithm different from the first planning algorithm.

Item 34. The method of any one of items 22 and 32-33, wherein the generating of the first and second route proposals comprises proposing respective paths between the AV's current position and a destination of the AV.

Item 35. The method of any one of items 22 and 32 to 34, wherein the generating of the first and second route proposals comprises inferring behavior of the AV and one or more other vehicles.

Item 36. The method of item 35, wherein the behavior is inferred by comparing a list of detected objects with driving rules associated with a current location of the AV.

Item 37. The method of item 35, wherein the behavior is inferred by comparing a list of detected objects with locations in which vehicles are permitted to operate by driving rules associated with a current location of the vehicle.

Item 38. The method of item 35, wherein the behavior is inferred through a constant velocity or constant acceleration model for each detected object.

Item 39. The method of item 35, wherein the generating of the first and second route proposals comprises proposing respective paths that conform to the inferred behavior and avoids one or more detected objects.

Item 40. The method of item 32, wherein the selecting of the first and second route proposals comprises evaluating collision likelihood based on the respective world view and a behavior inference model.

Item 41. The method of item 22, further comprising
receiving, by the first control module, the first AV position from the first localization module, wherein the generating of the first control-signal proposal is further based on the first AV position, and
receiving, by the second control module, the second AV position from the second localization module, wherein the generating of the second control-signal proposal is further based on the second AV position.

Item 42. The method of item 22 or 41, wherein
the generating of the first control-signal proposal is performed based on a first control algorithm, and
the generating of the second control-signal proposal is performed based on a second control algorithm.

Item 43. A system comprising:
two or more different autonomous vehicle operations subsystems, each of the two or more different autonomous vehicle operations subsystems being redundant with another of the two or more different autonomous vehicle operations subsystems; and
an output mediator coupled with the two or more different autonomous vehicle operations subsystems and configured to manage autonomous vehicle operation outputs from the two or more different autonomous vehicle operations subsystems;
wherein the output mediator is configured to selectively promote different ones of the two or more different autonomous vehicle operations subsystems to a prioritized status based on current input data compared with historical performance data for the two or more different autonomous vehicle operations subsystems.

Item 44. The system of item 43, wherein the two or more different autonomous vehicle operations subsystems are included in a perception stage of autonomous vehicle operation.

Item 45. The system of any preceding item, wherein the two or more different autonomous vehicle operations subsystems are included in a localization stage of autonomous vehicle operation.

Item 46. The system of any preceding item, wherein the two or more different autonomous vehicle operations subsystems are included in a planning stage of autonomous vehicle operation.

Item 47. The system of any preceding item, wherein the two or more different autonomous vehicle operations subsystems are included in a control stage of autonomous vehicle operation.

Item 48. The system of any of items 43-47, wherein a first of the different ones of the two or more different autonomous vehicle operations subsystems is configured to provide additional autonomous vehicle operations decisions that are not redundant with autonomous vehicle operations decisions of a second of the different ones of the two or more different autonomous vehicle operations subsystems.

Item 49. The system of any of items 43-47, wherein a first of the different ones of the two or more different autonomous vehicle operations subsystems is configured to only provide autonomous vehicle operations decisions that are redundant with autonomous vehicle operations decisions of a second of the different ones of the two or more different autonomous vehicle operations subsystems.

Item 50. The system of any of items 43-47, wherein the output mediator is configured to promote an autonomous vehicle operations subsystem to the prioritized status only once the historical performance data shows a substantially better performance in a specific operational context.

Item 51. The system of any of items 43-50, wherein the output mediator is configured to promote an autonomous vehicle operations subsystem to the prioritized status based on results from a machine learning algorithm that operates on the historical performance data to determine one or more specific operational contexts for the autonomous vehicle in which one of the two or more different autonomous vehicle operations subsystems performs differently than remaining ones of the two or more different autonomous vehicle operations subsystems.

Item 52. The system of item 51, wherein the machine learning algorithm operates on historical performance data relating to use of the two or more different autonomous vehicle operations subsystems in different autonomous vehicles in a fleet of autonomous vehicles.

Item 53. The system of items 43, 51 or 52, wherein the output mediator is configured to selectively promote the different ones of the two or more different autonomous vehicle operations subsystems to the prioritized status based on the current input data indicating a current operational context is either city streets or highway driving conditions, and based on the historical performance data indicating that the different ones of the two or more different autonomous vehicle operations subsystems perform differently in the current operational context than remaining ones of the two or more different autonomous vehicle operations subsystems.

Item 54. The system of items 43, 51 or 52, wherein the output mediator is configured to selectively promote the different ones of the two or more different autonomous vehicle operations subsystems to the prioritized status based on the current input data indicating a current operational context involves specific weather conditions, and based on the historical performance data indicating that the different ones of the two or more different autonomous vehicle operations subsystems perform differently in the current operational context than remaining ones of the two or more different autonomous vehicle operations subsystems.

Item 55. The system of items 43, 51 or 52, wherein the output mediator is configured to selectively promote the different ones of the two or more different autonomous vehicle operations subsystems to the prioritized status based on the current input data indicating a current operational context involves specific traffic conditions, and based on the historical performance data indicating that the different ones of the two or more different autonomous vehicle operations subsystems perform differently in the current operational context than remaining ones of the two or more different autonomous vehicle operations subsystems.

Item 56. The system of items 43, 51 or 52, wherein the output mediator is configured to selectively promote the different ones of the two or more different autonomous vehicle operations subsystems to the prioritized status based on the current input data indicating a current operational context is during a particular time of day, and based on the historical performance data indicating that the different ones of the two or more different autonomous vehicle operations subsystems perform differently in the current operational context than remaining ones of the two or more different autonomous vehicle operations subsystems.

Item 57. The system of items 43, 51 or 52, wherein the output mediator is configured to selectively promote the different ones of the two or more different autonomous vehicle operations subsystems to the prioritized status based on the current input data indicating a current operational context involves specific speed ranges, and based on the historical performance data indicating that the different ones of the two or more different autonomous vehicle operations subsystems perform differently in the current operational context than remaining ones of the two or more different autonomous vehicle operations subsystems.

Item 58. The system of any of items 43-57, wherein each of the two or more different autonomous vehicle operations subsystems implement both perception and planning functionality for autonomous vehicle operation.

Item 59. The system of any of items 43-57, wherein each of the two or more different autonomous vehicle operations subsystems implement both perception and control functionality for autonomous vehicle operation.

Item 60. A method of operating an autonomous vehicle using the system of any of items 43-59.

Item 61. A non-transitory computer-readable medium encoding instructions operable to cause data processing apparatus to operate an autonomous vehicle using the system of any of items 43-59.

Item 62. A method performed by an output mediator for controlling output of two or more different autonomous vehicle operations subsystems of an autonomous vehicle, one of which having prioritized status, the method comprising:
receiving, under a current operational context, outputs from the two or more different autonomous vehicle operations subsystems;
in response to determining that at least one of the received outputs is different from the other ones, promoting one of the autonomous vehicle operations subsystems which corresponds to the current operational context to prioritized status; and
controlling issuance of the output of the autonomous vehicle operations subsystem having the prioritized status for operating the autonomous vehicle.

Item 63. The method of item 62, wherein controlling issuance of an output from the autonomous vehicle operations subsystem having the prioritized status comprises instructing the autonomous vehicle operations subsystem having the prioritized status to transmit its output to a component of the autonomous vehicle which is disposed down-stream from the output mediator and uses the transmitted output for operating the autonomous vehicle.

Item 64. The method of item 62, wherein controlling issuance of an output from the autonomous vehicle operations subsystem having the prioritized status comprises transmitting the output of the autonomous vehicle operations subsystem having the prioritized status to a component of the autonomous vehicle which is disposed down-stream from the output mediator and uses the transmitted output for operating the autonomous vehicle.

Item 65. The method of any one of items 62-64, wherein the promoting is performed in response to determining that the autonomous vehicle operations subsystem corresponding to the current operational context lacks prioritized status.

Item 66. The method of any one of items 62-64, further comprising
receiving, during the next clock cycle and under the same current operational context, other outputs from the two or more different autonomous vehicle operations subsystems; and
in response to determining that the received outputs are the same, controlling issuance of the other output of the autonomous vehicle operations subsystem having the prioritized status whether or not the autonomous vehicle operations subsystem having the prioritized status corresponds to the current operational context.

Item 67. The method of any one of items 62-64, further comprising

receiving, during the next clock cycle and under the same current operational context, other outputs from the two or more different autonomous vehicle operations subsystems; and
in response to determining that at least one of the received other outputs is different from the other ones, determining that the autonomous vehicle operations subsystem corresponding to the current operational context has prioritized status.

Item 68. The method of any one of items 62-65, wherein prior to promoting one of the autonomous vehicle operations subsystems which corresponds to the current operational context to prioritized status, the method further comprises
accessing current input data,
determining the current operational context based on the current input data, and
identifying the autonomous vehicle operations subsystem corresponding to the current operational context.

Item 69. The method of item 68, wherein determining the current operational context based on the current input data is performed by using an input data/context look-up-table.

Item 70. The method of item 69, wherein input data referenced by the input data/context look-up-table comprises one or more of traffic data, map data, AV location data, time-of-day data, speed data or weather data.

Item 71. The method of item 68, wherein identifying the autonomous vehicle operations subsystem corresponding to the current operational context is performed by using context/subsystem look-up-table.

Item 72. The method of any one of items 62-71, wherein
the two or more autonomous vehicle operations subsystems are a plurality of perception modules and their outputs are respective world views, and
the method comprises controlling issuance, to a planning module disposed down-stream from the output mediator, of the world view provided by the perception module having prioritized status.

Item 73. The method of any one of items 62-71, wherein
the two or more autonomous vehicle operations subsystems are a plurality of planning modules and their outputs are respective routes, and
the method comprises controlling issuance, to a control module disposed down-stream from the output mediator, of the route provided by the planning module having prioritized status.

Item 74. The method of any one of items 62-71, wherein
the two or more autonomous vehicle operations subsystems are a plurality of localization modules and their outputs are respective AV positions, and
the method comprises controlling issuance, to a control module disposed down-stream from the output mediator, of the AV position provided by the localization module having prioritized status.

Item 75. The method of any one of items 62-71, wherein
the two or more autonomous vehicle operations subsystems are a plurality of control modules and their outputs are respective control signals, and
the method comprises controlling issuance, to an actuator disposed down-stream from the output mediator, of the control signal provided by the control module having prioritized status.

Item 76. An autonomous vehicle, comprising:

a first control system configured to, in accordance with at least one input, provide output that affects a control operation of the autonomous vehicle while the autonomous vehicle is in an autonomous driving mode and while the first control system is selected;

a second control system configured to, in accordance with at least one input, provide output that affects the control operation of the autonomous vehicle while the autonomous vehicle is in the autonomous driving mode and while the second control system is selected; and

at least one processor configured to select at least one of the first control system and the second control system to affect the control operation of the autonomous vehicle.

Item 77. The autonomous vehicle of item 76, wherein the at least one processor is configured to select at least one of the first control system and the second control system in accordance with performance of the first control system and the second control system over a period of time.

Item 78. The autonomous vehicle of any of items 76-77, wherein the at least one processor is configured for identifying a failure of at least one of the first control system and the second control system.

Item 79. The autonomous vehicle of any of items 76-78, wherein the at least one processor is configured for selecting the second control system in accordance with identifying a failure of the first control system.

Item 80. The autonomous vehicle of any of items 76-79, wherein the at least one processor is configured for

identifying an environmental condition that interferes with the operation of at least one of the first control system and the second control system, and

selecting at least one of the first control system and the second control system in accordance with the identified environmental condition.

Item 81. The autonomous vehicle of any of items 76-80, wherein the first control system is configured for receiving feedback from a first feedback system and the second control system is configured for receiving feedback from a second feedback system.

Item 82. The autonomous vehicle of item 81, wherein the at least one processor is configured to compare the feedback from the first feedback system and the second feedback system to identify a failure of at least one of the first control system and the second control system.

Item 83. The autonomous vehicle of any of items 76-82, wherein the first control system operates in accordance with a first input, and the second control system operates in accordance with a second input.

Item 84. The autonomous vehicle of any of items 76-82, wherein the first control system operates in accordance with a first input, and the second control system operates in accordance with the first input.

Item 85. The autonomous vehicle of item 76-84, wherein the first control system is configured to use a first algorithm when affecting the control operation and the second control system is configured to use a second algorithm when affecting the control operation.

Item 86. The autonomous vehicle of item 85, wherein the first algorithm and the second algorithm are control feedback algorithms.

Item 87. The autonomous vehicle of any of items 85-86, wherein the first algorithm adjusts steering angle, and the second algorithm adjusts throttle control.

Item 88. The autonomous vehicle of any of items 76-86, wherein the first control system is configured to use a steering mechanism to affect steering and the second control system is configured to use functionality other than the steering mechanism to affect steering.

Item 89. The autonomous vehicle of item 88, wherein the functionality other than the steering mechanism includes at least one of direct control of the autonomous vehicle's wheels, and direct control of the autonomous vehicle's axels.

Item 90. The autonomous vehicle of any of items 76-86, wherein the first control system is configured to use a throttle control mechanism to affect acceleration and the second control system is configured to use functionality other than the throttle control mechanism to affect acceleration.

Item 91. The autonomous vehicle of item 90, wherein the functionality other than the throttle control mechanism includes at least one of direct control of the autonomous vehicle's engine and the direct control of the autonomous vehicle's fuel system.

Item 92. The autonomous vehicle of any of items 76-91, wherein the control operation controls at least one of the speed of the autonomous vehicle and the orientation of the autonomous vehicle.

Item 93. The autonomous vehicle of any of items 76-92, wherein the control operation controls at least one of the speed smoothness of the autonomous vehicle and the orientation smoothness of the autonomous vehicle.

Item 94. The autonomous vehicle of any of items 76-93, wherein the control operation controls at least one of the acceleration, jerk, jounce, snap, and crackle of the autonomous vehicle.

Item 95. The autonomous vehicle of any of items 76-94, wherein the at least one processor includes at least one of an arbiter module and a diagnostics module.

Item 96. An autonomous vehicle, comprising:
a first sensor configured to produce a first sensor data stream from one or more environmental inputs external to the autonomous vehicle while the autonomous vehicle is in an operational driving state;
a second sensor configured to produce a second sensor data stream from the one or more environmental inputs external to the autonomous vehicle while the autonomous vehicle is in the operational driving state, the first sensor and the second sensor being configured to detect a same type of information; and
a processor coupled with the first sensor and the second sensor, wherein the processor is configured to detect an abnormal condition based on a difference between the first sensor data stream and the second sensor data stream, and wherein the processor is configured to switch among the first sensor, the second sensor, or both as an input to control the autonomous vehicle in response to a detection of the abnormal condition.

Item 97. The autonomous vehicle of item 96, wherein the processor is configured to capture a first set of data values within the first sensor data stream over a sampling time window, wherein the processor is configured to capture a second set of data values within the second sensor data stream over the sampling time window, and wherein the processor is configured to detect the abnormal condition by determining a deviation between the first set of data values and the second set of data values.

Item 98. The autonomous vehicle of item 97, wherein the processor is configured to control a duration of the sampling time window responsive to a driving condition.

Item 99. The autonomous vehicle of item 97, wherein a duration of the sampling time window is predetermined.

Item 100. The autonomous vehicle of one of items 96-99, wherein the processor is configured to determine the difference based on a first sample of the first sensor data stream and a second sample of the second sensor data stream, the first sample and the second sample corresponding to a same time index.

Item 101. The autonomous vehicle of item 100, wherein the processor is configured to detect the abnormal condition based on the difference exceeding a predetermined threshold.

Item 102. The autonomous vehicle of one of items 96-101, wherein the processor is configured to determine the difference based on a detection of a missing sample within the first sensor data stream.

Item 103. The autonomous vehicle of one of items 96-102, wherein the first sensor and the second sensor use one or more different sensor characteristics to detect the same type of information.

Item 104. The autonomous vehicle of item 103, wherein the first sensor is associated with the abnormal condition, and wherein the processor, in response to the detection of the abnormal condition, is configured to perform a transformation of the second sensor data stream to produce a replacement version of the first sensor data stream.

Item 105. The autonomous vehicle of one of items 96-102, wherein the second sensor is a redundant version of the first sensor.

Item 106. The autonomous vehicle of one of items 96-105, wherein the processor, in response to the detection of the abnormal condition, is configured to perform a diagnostic routine on the first sensor, the second sensor, or both to resolve the abnormal condition.

Item 107. A method of operating an autonomous vehicle, comprising:
producing, via a first sensor, a first sensor data stream from one or more environmental inputs external to the autonomous vehicle while the autonomous vehicle is in an operational driving state;
producing, via a second sensor, a second sensor data stream from the one or more environmental inputs external to the autonomous vehicle while the autonomous vehicle is in the operational driving state, the first sensor and the second sensor being configured to detect a same type of information;
detecting an abnormal condition based on a difference between the first sensor data stream and the second sensor data stream; and
switching among the first sensor, the second sensor, or both as an input to control the autonomous vehicle in response to the detected abnormal condition.

Item 108. The method of item 107, comprising:
capturing a first set of data values within the first sensor data stream over a sampling time window; and
capturing a second set of data values within the second sensor data stream over the sampling time window,
wherein detecting the abnormal condition comprises determining a deviation between the first set of data values and the second set of data values.

Item 109. The method of item 108, comprising:
controlling a duration of the sampling time window responsive to a driving condition.

Item 110. The method of item 108, wherein a duration of the sampling time window is predetermined.

Item 111. The method of one of items 107-110, wherein the difference is based on a first sample of the first sensor data stream and a second sample of the second sensor data stream, the first sample and the second sample corresponding to a same time index.

Item 112. The method of item 111, wherein detecting the abnormal condition comprises determining whether the difference exceeds a predetermined threshold.

Item 113. The method of one of items 107-112, wherein the difference is based on a detection of a missing sample within the first sensor data stream.

Item 114. The method of one of items 107-113, wherein the first sensor and the second sensor use one or more different sensor characteristics to detect the same type of information.

Item 115. The method of item 114, comprising:
performing, in response to the detection of the abnormal condition, a transformation of the second sensor data stream to produce a replacement version of the first sensor data stream, wherein the first sensor is associated with the abnormal condition.

Item 116. The method of one of items 107-113, wherein the second sensor is a redundant version of the first sensor.

Item 117. The method of one of items 107-116, comprising:
performing, in response to the detection of the abnormal condition, a diagnostic routine on the first sensor, the second sensor, or both to resolve the abnormal condition.

Item 118. An autonomous vehicle, comprising:

a control system configured to affect a control operation of the autonomous vehicle;

a control processor in communication with the control system, the control processor configured to determine instructions for execution by the control system;

a telecommunications system in communication with the control system, the telecommunications system configured to receive instructions from an external source;

wherein the control processor is configured to determine instructions that are executable by the control system from the instructions received from the external source and is configured to enable the external source in communication with the telecommunications system to control the control system when one or more specified conditions are detected.

Item 119. The autonomous vehicle of item 118, wherein the control processor is configured to determine if data received from one or more sensors on the autonomous vehicle meets the one or more specified conditions, and in accordance with the determination enable the telecommunications system to control the control system.

Item 120. The autonomous vehicle of item 118, wherein the one or more specified conditions detected by the control processor includes an emergency condition.

Item 121. The autonomous vehicle of item 118, wherein the control processor detects the one or more specified conditions from input received from an occupant of the autonomous vehicle.

Item 122. The autonomous vehicle of item 121, wherein the input is received from a notification interface within an interior of the autonomous vehicle.

Item 123. The autonomous vehicle of item 118, wherein the one or more specified conditions include environmental conditions.

Item 124. The autonomous vehicle of item 118, wherein the one or more specified conditions include a failure of the control processor.

Item 125. The autonomous vehicle of item 118, wherein the control processor is configured to determine if the autonomous vehicle is on a previously untraveled road as one of the specified conditions, and in accordance with the determination enable the telecommunications system to control the control system.

Item 126. The autonomous vehicle of item 125, wherein the determination that the autonomous vehicle is on a previously untraveled road is made using data from a database of traveled roads.

Item 127. The autonomous vehicle of item 118, wherein the telecommunications system receives instructions based on inputs made by a teleoperator.

Item 128. An autonomous vehicle, comprising:

a control system configured to affect a first control operation of the autonomous vehicle;

a control processor in communication with the control system, the control processor configured to determine instructions for execution by the control system;

a telecommunications system in communication with the control system, the telecommunications system configured to receive instructions from an external source; and

a processor configured to determine instructions that are executable by the control system from the instructions received from the external source and to enable the control processor or the external source in communication with the telecommunications system to operate the control system.

Item 129. The autonomous vehicle of item 128, wherein the control processor is configured to enable the telecommunications system to operate the control system when one or more specified conditions are detected.

Item 130. The autonomous vehicle of item 129, wherein the one or more specified conditions detected by the control processor includes an emergency condition.

Item 131. The autonomous vehicle of item 129, wherein the control processor detects the one or more specified conditions from input received from an occupant of the autonomous vehicle.

Item 132. The autonomous vehicle of item 131, wherein the input is received from a notification interface within an interior of the autonomous vehicle.

Item 133. The autonomous vehicle of item 128, wherein the one or more specified conditions include environmental conditions.

Item 134. The autonomous vehicle of item 129, wherein the one or more specified conditions include a failure of the control processor.

Item 135. The autonomous vehicle of item 129, wherein the control processor is configured to determine if the autonomous vehicle is on a previously untraveled road as one of the specified conditions, and in accordance with the determination enable the telecommunications system to control the control system.

Item 136. The autonomous vehicle of item 128, wherein the determination that the autonomous vehicle is on a previously untraveled road is made using data from a database of traveled roads.

Item 137. The autonomous vehicle of item 129, wherein the external source receives instructions based on inputs made by a teleoperator.

Item 138. An autonomous vehicle, comprising:

a first control system configured to affect a first control operation of the autonomous vehicle;

a second control system configured to affect the first control operation of the autonomous vehicle; and

a telecommunications system in communication with the first control system, the telecommunications system configured to receive instructions from an external source;

a control processor configured to determine instructions to affect the first control operation from the instructions received from the external source and is configured to determine an ability of the telecommunications system to communicate with the external source and in accordance with the determination select the first control system or the second control system.

Item 139. The autonomous vehicle of item 138, wherein determining the ability of the telecommunications system to communicate with the external source includes determining a metric of signal strength of a wireless network over which the telecommunications system transmits the instructions.

Item 140. The autonomous vehicle of item 138, wherein the first control system uses a first algorithm and the second control system uses a second algorithm different from the first control system.

Item 141. The autonomous vehicle of item 140, wherein an output of the first algorithm affects the first control operation to generate a movement of the autonomous vehicle that is more aggressive than an output of the second algorithm.

Item 142. The autonomous vehicle of item 140, wherein an output of the first algorithm affects the first control operation to generate a movement of the autonomous vehicle that is more conservative than an output of the second algorithm.

Item 143. The autonomous vehicle of item 142, wherein the control processor is configured to default to use of the first control system.

Item 144. The autonomous vehicle of item 138, wherein determining an ability of the telecommunications system to communicate with the external source includes determining an indication that a wireless signal receiver on the autonomous vehicle is damaged.

Item 145. A method, comprising:

at a first autonomous vehicle having one or more sensors:

determining an aspect of an operation of the first autonomous vehicle based on data received from the one or more sensors;

receiving data originating at one or more other autonomous vehicles; and

using the determination and the received data to carry out the operation.

Item 146. The method of item 145, further comprising:
transmitting at least a portion of the data received from the one or more sensors to at least one of the other autonomous vehicles.

Item 147. The method of either item 145 or item 146, wherein the data received from the one or more sensors comprises at least one of an indication of an object in the environment of the first autonomous vehicle or a condition of the road.

Item 148. The method of any one of items 145-147, wherein the data originating at the one or more other autonomous vehicles comprises an indication of a period of time for which the data originating at the one or more other autonomous vehicles is valid.

Item 149. The method of any one of items 145-148, wherein the one or more other autonomous vehicles traversed the road prior to the first autonomous vehicle traversing the road, and wherein the data originating at the one or more other autonomous vehicles comprises an indication of the condition of the road when the one or more other autonomous vehicles traversed the road.

Item 150. The method of any one of items 145-149, wherein the data originating at the one or more other autonomous vehicles comprises an indication of one or more paths traversed by the one or more other autonomous vehicles.

Item 151. The method of item 150, wherein the data originating at the one or more other autonomous vehicles further comprises an indication of one or more modifications to a traffic pattern along the one or more paths traversed by the one or more other autonomous vehicles.

Item 152. The method of item 150, wherein the data originating at the one or more other autonomous vehicles further comprises an indication of one or more obstacles along the one or more paths traversed by the one or more other autonomous vehicles.

Item 153. The method of item 150, wherein the data originating at the one or more other autonomous vehicles further comprises an indication of a change with respect to one or more objects along the one or more paths traversed by the one or more other autonomous vehicles.

Item 154. The method of item 150, further comprising:
determining, based on the data originating at the one or more other autonomous vehicles, that a destination of the one or more other autonomous vehicles is similar to a destination of the first autonomous vehicle, and
responsive to determining that the destination of the one or more other autonomous vehicles is similar to the destination of the first autonomous vehicle, transmitting a request to the one or more other autonomous vehicles to form a vehicular platoon.

Item 155. The method of any one of items 145-154, wherein the data originating at the one or more other autonomous vehicles comprises an indication of a condition of the environment of the one or more other autonomous vehicles.

Item 156. The method of item 155, further comprising modifying the route of the first autonomous vehicle based on the indication of the condition of the environment of the one or more other autonomous vehicles.

Item 157. The method of any one of items 145-156, wherein the data originating at the one or more other autonomous vehicles comprises a status of the one or more other autonomous vehicles.

Item 158. The method of any one of items 145-157, wherein the status of the one or more other autonomous vehicles comprises at least one of a location of the one or more other autonomous vehicles, a velocity of the one or more other autonomous vehicles, or an acceleration of the one or more other autonomous vehicles.

Item 159. The method of item any one of items 145-158, further comprising using a communications engine of the first autonomous vehicle to transmit information to and/or receive information from an external control system configured to control an operation of the first autonomous vehicle and the one or more other autonomous vehicles.

Item 160. The method of any one of items 145-159, further comprising using a communications engine of the first autonomous vehicle to transmit information to and/or receive information from the one or more autonomous vehicles through one or more peer-to-peer network connections.

Item 161. The method of any one of items 145-161, wherein the operation is one of planning a route of the first autonomous vehicle, identifying an object in an environment of the first autonomous vehicle, evaluating a condition of a road to be traversed by the first autonomous vehicle, or interpreting signage in the environment of the autonomous vehicle.

Item 162. A first device comprising:

one or more processors;

memory; and

one or more programs stored in memory, the one or more programs including instructions for performing the method of any one of items 145-161.

Item 163. A non-transitory computer-readable storage medium comprising one or more programs for execution by one or more processors of a first device, the one or more programs including instructions which, when executed by the one or more processors, cause the first device to perform the method of any one of items 145-161.

Item 164. A method comprising:
performing, by an autonomous vehicle (AV), an autonomous driving function of the AV in an environment;
receiving, by an internal wireless communication device of the AV, an external message from an external wireless communication device that is located in the environment;
comparing, by one or more processors of the AV, an output of the function with content of the external message or with data generated based on the content; and
in accordance with results of the comparing, causing the AV to perform a maneuver.

Item 165. The method of item 164, wherein the function is localization and the content includes a location of the AV or locations of objects in the environment.

Item 166. The method of item 164, wherein the function is perception and the content includes objects and their respective locations in the environment.

Item 167. The method of item 166, further comprising:
updating, by the one or more processors, a scene description of the environment with the objects using their respective locations; and
performing the perception function using the updated scene description.

Item 168. The method of any one of items 164, wherein the external message is broadcast or transmitted from one or more other vehicles operating in the environment.

Item 169. The method of item 164, wherein the content includes a driving state of the AV or the driving state of one or more of the other vehicles.

Item 170. The method of item 164, wherein the content includes traffic light state data.

Item 171. The method of item 164, wherein the content is used to enforce a speed limit on the operation of the AV.

Item 172. The method of item 164, wherein the content is used to create or update a scene description generated internally by the AV.

Item 173. The method of any one of items 164-172, wherein the maneuver is a safe stop maneuver or a limp mode.

Item 174. The method of any one of items 164-172, wherein the content includes a public message and one or more encrypted private messages.

Item 175. An autonomous vehicle (AV) system comprising:

one or more processors;

memory; and

one or more programs stored in memory, the one or more programs including instructions for performing the method of any one of items 164-174.

Item 176. A non-transitory computer-readable storage medium comprising one or more programs for execution by one or more processors of an autonomous vehicle (AV) system, the one or more programs including instructions which, when executed by the one or more processors, cause the AV system to perform the method of any one of items 164-174.

Item 177. A method comprising:

discovering, by an operating system (OS) of an autonomous vehicle (AV), a new component coupled to a data network of the AV;

determining, by the AV OS, if the new component is a redundant component;

in accordance with the new component being a redundant component,
performing a redundancy configuration of the new component; and

in accordance with the new component not being a redundant component,
performing a basic configuration of the new component,

wherein the method is performed by one or more special-purpose computing devices.

Item 178. The method of item 177, where performing a basic configuration of the new component, further comprises:
starting a boot process;
creating a resource table of available interrupt requests, direct memory access (DMA) channels and input/output (I/O) addresses;
loading a last known configuration for the new component;
comparing a current configuration of the new component to the last known configuration of the new component;
in accordance with the current and last known configurations being unchanged,

continuing with the boot process.

Item 179. The method of item 178, wherein in accordance with the current and last known configurations being changed:
removing any reserved system resources from the resource table;
assigning resources to the new component from the resources remaining in the resource table;
informing the new component of its new assignment; and
updating the configuration data for the new component; and
continuing with the boot process.

Item 180. The method of item 177, wherein the new component is a hub that couples to a plurality of components.

Item 181. The method of item 177, wherein determining if the new component is a redundant component comprises searching a redundancy table for the new component.

Item 182. The method of item 177, wherein performing a redundancy configuration for the new component comprises determining if the new component is compliant with a redundancy model of the AV.

Item 183. The method of item 182, wherein determining if the new component is compliant with a redundancy mode of the AV further comprises:
comparing one or more characteristics of the new component with one or more characteristics required by the redundancy model; and
determining that the new component is compliant with the redundancy model based on the comparing.

Item 184. The method of item 183, wherein the characteristics are performance specifications or sensor attributes.

Item 185. The method of item 183, wherein comparing one or more characteristics includes determining that an algorithm used by the new component is the same or different than an algorithm used by a corresponding redundant component of the AV.

Item 186. The method of item 185, wherein the new component is a stereo camera and the corresponding redundant component is a LiDAR.

Item 187. An autonomous vehicle comprising:

one or more computer processors;

one or more non-transitory storage media storing instructions which, when executed by the one or more computer processors, cause performance of operations comprising:

discovering, by an operating system (OS) of the autonomous vehicle (AV), a new component coupled to a data network of the AV;

determining, by the AV OS, if the new component is a redundant component;

in accordance with the new component being a redundant component,
performing a redundancy configuration of the new component; and

in accordance with the new component not being a redundant component,
performing a basic configuration of the new component,

wherein the method is performed by one or more special-purpose computing devices.

Item 188. One or more non-transitory storage media storing instructions which, when executed by one or more computing devices, cause performance of the method recited in item 177.

Item 189. A method comprising performing a machine-executed operation involving instructions which, when executed by one or more computing devices, cause performance of operations comprising:

discovering, by an operating system (OS) of an autonomous vehicle (AV), a new component coupled to a data network of the AV;

determining, by the AV OS, if the new component is a redundant;

in accordance with the new component being a redundant component,
performing a redundancy configuration of the new component; and

in accordance with the new component not being a redundant component,
performing a basic configuration of the new component,

wherein the machine-executed operation is at least one of sending said instructions, receiving said instructions, storing said instructions, or executing said instructions.

Item 190. A method comprising:

obtaining, from a perception module of an autonomous vehicle (AV), a scene description, the scene description including one or more objects detected by one or more sensors of the AV;

determining if the scene description falls within an operational domain of the AV;

in accordance with the scene description falling within the operational domain of the AV:
generating, by a first motion planning module of the AV, a first trajectory of the AV using at least in part the scene description and a position of the AV;
generating, by a second motion planning module of the AV, a second trajectory of the AV using at least in part the scene description and the AV position;
evaluating, by a first behavior inference model of the first route planning module, the second trajectory to determine if it collides with the one or more objects in the scene description;
evaluating, by a second behavior inference model of the second planning module, the first trajectory to determine if it collides with the one or more objects in the scene description, wherein the second behavior inference model is different than the first behavior inference model; and
determining, based on the evaluating, if the first or second trajectory collides with the one or more objects included in the scene description; and
in accordance with determining that the first or second trajectory collides with the one or more objects in the scene description,

causing the AV to perform a safe stop maneuver or emergency braking.

Item 191. The method of item 190, wherein the first behavior inference model is a constant-velocity model or a constant-acceleration model, and the second behavior inference model is a machine learning model.

Item 192. The method of item 190, wherein the first or second behavior inference model is a probabilistic model using partially observable Markov decision processes (POMDP).

Item 193. The method of item 190, wherein the first or second behavior inference model is a Gaussian mixture model parameterized by neural networks.

Item 194. The method of item 190, wherein the first or second behavior inference model is an inverse reinforcement learning (IRL) model.

Item 195. The method of item 190, further comprising:
providing a first diagnostic coverage or the first planning module;
providing a second diagnostic coverage for the second planning module;
determining, based on the first and second diagnostic coverages, if there is a hardware or software error associated with the first or second planning modules; and
in accordance with determining that there is no hardware or software error associated with the first and second planning modules, and that the first or second trajectory collides with the one or more objects in the scene description,
causing the AV to perform a safe stop maneuver.

Item 196. The method of item 195, further comprising:
in accordance with determining that there is a hardware or software error associated with the first or second planning module,
causing the AV to perform a safe stop maneuver.

Item 197. The method of item 190, further comprising:
providing a first diagnostic coverage for the first route planning system;
providing a second diagnostic coverage for the second route planning system; and
determining, based on the diagnostic coverage, if there is a hardware or software error associated with the first or second planning modules; and
in accordance with determining that there is no hardware or software error in the AV, and that the first and second trajectory collide with the one or more objects in the scene description,
causing the AV to perform emergency braking.

Item 198. The method of item 190, wherein the scene description is at least partially obtained from a source external to the AV through a wireless communication medium.

Item 199. The method of item 190, wherein the scene description is at least partially obtained from another autonomous vehicle over a wireless communication medium.

Item 200. An autonomous vehicle comprising:

one or more computer processors; and

one or more non-transitory storage media storing instructions which, when executed by the one or more computer processors, cause performance of the method of any one of items 1-10.

Item 201. One or more non-transitory storage media storing instructions that when executed by one or more computing devices, cause performance of the method of any one of items 190-199.

Item 202. A method performed by an autonomous vehicle (AV), the method comprising:
performing, by a first simulator, a first simulation of a first AV process/system using data output by a second AV process/system;
performing, by a second simulator, a second simulation of the second AV process/system using data output by the first AV process/system;
comparing, by one or more processors, the data output by the first and second process/system with data output by the first and second simulators; and
in accordance with a result of the comparing, causing the AV to perform a safe mode maneuver or other action.

Item 203. The method of item 202, further comprising:
performing, by a first diagnostic device, a first diagnostic monitoring of the first AV process/system;
performing, by a second diagnostic device, a second diagnostic monitoring of the second AV process/system; and
in accordance with the first and second diagnostic monitoring, causing the AV to perform a safe mode maneuver or other action.

Item 204. The method of item 202, further comprising:
receiving, by the first or second simulator one or more external factors; and

adjusting, by the first or second simulator one or more models based on the external factors.

Item 205. The method of item 204, wherein the external factors include weather conditions.

Item 206. The method of item 204, wherein the external factors include road conditions.

Item 207. The method of item 204, wherein the external factors include traffic conditions.

Item 208. The method of item 204, wherein the external factors include AV characteristics.

Item 209. The method of item 204, wherein the external factors include time of day.

Item 210. The method of item 202, further comprising:
receiving, by the first or second simulator a driver profile; and
adjusting, by the first or second simulator one or more models based on the driver profile.

Item 211. The method of item 210, wherein the driver profile includes a driving pattern/

Item 212. An autonomous vehicle comprising:

one or more computer processors;

one or more non-transitory storage media storing instructions which, when executed by the one or more computer processors, cause performance of operations comprising:
performing, by a first simulator, a first simulation of a first AV process/system using data output by a second AV process/system;
performing, by a second simulator, a second simulation of the second AV process/system using data output by the first AV process/system;
comparing, by one or more processors, the data output by the first and second process/system with data output by the first and second simulators; and
in accordance with a result of the comparing, causing the AV to perform a safe mode maneuver or other action.

Item 213. One or more non-transitory storage media storing instructions which, when executed by one or more computing devices, cause performance of the method recited in item 202.

Item 214. A method comprising performing a machine-executed operation involving instructions which, when executed by one or more computing devices, cause performance of operations comprising:
performing, by a first simulator, a first simulation of a first AV process/system using data output by a second AV process/system;
performing, by a second simulator, a second simulation of the second AV process/system using data output by the first AV process/system;
comparing, by one or more processors, the data output by the first and second process/system with data output by the first and second simulators; and
in accordance with a result of the comparing, causing the AV to perform a safe mode maneuver or other action,

wherein the machine-executed operation is at least one of sending said instructions, receiving said instructions, storing said instructions, or executing said instructions.

Item 215. A system comprising:
a component infrastructure including a set of interacting components implementing a system for an autonomous vehicle (AV), the infrastructure including:
a first component performing a function for operation of the AV;
a second component performing the first function for operation of the AV concurrently with the first software component;
a perception circuit confirmed for creating a model of an operating environment of the AV by combining or comparing a first output from the first component with a second output from the second component; and
initiating an operation mode to perform the function on the AV based on the model of the operating environment.

Item 216. The system of item 215, wherein the function is perception, the first component implements dense free space detection and the second component implements object-based detection and tracking.

Item 217. The system of item 216, wherein the dense free space detection uses output of a dense light detection and ranging (LiDAR) sensor and redundant measurements from one or more stereo or mono cameras.

Item 218. The system of item 216, wherein the dense free space detection uses sensor data fusion.

Item 219. The system of item 216, wherein the sensor data fusion uses light detection and ranging (LiDAR) output with stereo camera depth data.

Item 220. The system of item 218, wherein the sensor data fusion uses light detection and ranging (LiDAR) output with output of a free space neural network coupled to one or more mono cameras.

Item 221. The system of item 216, wherein the object-based detection and tracking uses measurements from one or more 360° mono cameras and one or more RADARs.

Item 222. The system of item 216, wherein the object-based detection and tracking uses a neural network classifier for classifying objects with a multiple model object tracker for tracking the objects.

Item 223. The system of item 216, wherein the object-based detection and tracking uses a neural network for classifying objects with a neural network for tracking the objects.

Item 224. The system of item 215, wherein the perception circuit is configured for:
comparing outputs of the first and second components;
detecting a failure of the first component or the second component; and
in accordance with detecting the failure, exclusively using the other component to provide the function for the AV.

Item 225. The system of item 215, wherein the perception circuit is configured for:
comparing outputs of the first and second components;
in accordance with the comparing, causing the first component to provide a safety check on the second component or the second component to provide a safety check on the first component.

1. An autonomous vehicle, comprising:
a first sensor configured to produce a first sensor data stream from one or more environmental inputs external to the autonomous vehicle while the autonomous vehicle is in an operational driving state;
a second sensor configured to produce a second sensor data stream from the one or more environmental inputs external to the autonomous vehicle while the autonomous vehicle is in the operational driving state, the first sensor and the second sensor being configured to detect a same type of information; and
a processor coupled with the first sensor and the second sensor, wherein the processor is configured to detect an abnormal condition based on a difference between the first sensor data stream and the second sensor data stream, and wherein the processor is configured to switch among the first sensor, the second sensor, or both as an input to control the autonomous vehicle in response to a detection of the abnormal condition.

2. The autonomous vehicle of claim 1, wherein the processor is configured to capture a first set of data values within the first sensor data stream over a sampling time window, wherein the processor is configured to capture a second set of data values within the second sensor data stream over the sampling time window, and wherein the processor is configured to detect the abnormal condition by determining a deviation between the first set of data values and the second set of data values.

3. The autonomous vehicle of claim 2, wherein the processor is configured to control a duration of the sampling time window responsive to a driving condition.

4. The autonomous vehicle of claim 2, wherein a duration of the sampling time window is predetermined.

5. The autonomous vehicle of claim 1, wherein the processor is configured to determine the difference based on a first sample of the first sensor data stream and a second sample of the second sensor data stream, the first sample and the second sample corresponding to a same time index.

6. The autonomous vehicle of claim 5, wherein the processor is configured to detect the abnormal condition based on the difference exceeding a predetermined threshold.

7. The autonomous vehicle of claim 1, wherein the processor is configured to determine the difference based on a detection of a missing sample within the first sensor data stream.

8. The autonomous vehicle of claim 1, wherein the first sensor and the second sensor use one or more different sensor characteristics to detect the same type of information.

9. The autonomous vehicle of claim 8, wherein the first sensor is associated with the abnormal condition, and wherein the processor, in response to the detection of the abnormal condition, is configured to perform a transformation of the second sensor data stream to produce a replacement version of the first sensor data stream.

10. The autonomous vehicle of claim 1, wherein the second sensor is a redundant version of the first sensor.

11. The autonomous vehicle of claim 1, wherein the processor, in response to the detection of the abnormal condition, is configured to perform a diagnostic routine on the first sensor, the second sensor, or both to resolve the abnormal condition.

12. A method of operating an autonomous vehicle, comprising:
producing, via a first sensor, a first sensor data stream from one or more environmental inputs external to the autonomous vehicle while the autonomous vehicle is in an operational driving state;
producing, via a second sensor, a second sensor data stream from the one or more environmental inputs external to the autonomous vehicle while the autonomous vehicle is in the operational driving state, the first sensor and the second sensor being configured to detect a same type of information;
detecting an abnormal condition based on a difference between the first sensor data stream and the second sensor data stream; and
switching among the first sensor, the second sensor, or both as an input to control the autonomous vehicle in response to the detected abnormal condition.

13. The method of claim 12, comprising:
capturing a first set of data values within the first sensor data stream over a sampling time window; and
capturing a second set of data values within the second sensor data stream over the sampling time window,
wherein detecting the abnormal condition comprises determining a deviation between the first set of data values and the second set of data values.

14. The method of claim 13, comprising:
controlling a duration of the sampling time window responsive to a driving condition.

15. The method of claim 13, wherein a duration of the sampling time window is predetermined.

16. The method of claim 12, wherein the difference is based on a first sample of the first sensor data stream and a second sample of the second sensor data stream, the first sample and the second sample corresponding to a same time index.

17. The method of claim 16, wherein detecting the abnormal condition comprises determining whether the difference exceeds a predetermined threshold.

18. The method of claim 12, wherein the difference is based on a detection of a missing sample within the first sensor data stream.

19. The method of claim 12, wherein the first sensor and the second sensor use one or more different sensor characteristics to detect the same type of information.

20. The method of claim 19, comprising:
performing, in response to the detection of the abnormal condition, a transformation of the second sensor data stream to produce a replacement version of the first sensor data stream, wherein the first sensor is associated with the abnormal condition.

21. The method of claim 12, wherein the second sensor is a redundant version of the first sensor.

22. The method of claim 12, comprising:
performing, in response to the detection of the abnormal condition, a diagnostic routine on the first sensor, the second sensor, or both to resolve the abnormal condition.

23. One or more non-transitory storage media storing instructions which, when executed by one or more computing devices, cause the one or more computing devices to perform operations comprising:
producing, via a first sensor, a first sensor data stream from one or more environmental inputs external to the autonomous vehicle while the autonomous vehicle is in an operational driving state;
producing, via a second sensor, a second sensor data stream from the one or more environmental inputs external to the autonomous vehicle while the autonomous vehicle is in the operational driving state, the first sensor and the second sensor being configured to detect a same type of information;
detecting an abnormal condition based on a difference between the first sensor data stream and the second sensor data stream; and
switching among the first sensor, the second sensor, or both as an input to control the autonomous vehicle in response to the detected abnormal condition.
